(19) United States
(12) Patent Application Publication
(10) Pub. No.: US 2023/0419227 A1
(43) Pub. Date: Dec. 28, 2023

(54) SYSTEM FOR QUANTIATIVE CALUCULATION OF THE IMPACT RATE OF RETURN OF A FINANCIAL ALLOCATION

(71) Applicant: Howard W. Buffett, Omaha, NE (US)

(72) Inventor: Howard W. Buffett, Omaha, NE (US)

(21) Appl. No.: 18/038,305

(22) PCT Filed: Nov. 19, 2021
(86) PCT No.: PCT/US21/60174

§ 371 Date: May 23, 2023

Related U.S. Application Data
(60) Provisional application No. 63/117,947, filed on Nov. 24, 2020.

(51) Int. Cl. G06Q 10/0637

(52) U.S. Cl. CPC G06Q 10/06375

(57) ABSTRACT

A system to quantitatively assess how efficient an organization's financial allocations (e.g. investments, grants, program budgets) are at accomplishing any type of social, environmental, economic, and/or governance-related impact. Organizations may calculate the impact rate of return (iRR) of an activity or set of activities across impact themes by transforming qualitative and quantitative data into a single quantitative measurement. In this system, a service provider provides a computer-based program (e.g. via a website, such as SaaS, or through software installed on a computer) for calculating the iRR of an activity. By using the standardized iRR system, organizations can compare the societal impact that different allocations accomplish, and may use the iRR system to track, manage towards, and report that impact over time. The iRR system is advantageous because it combines relative and absolute measures of impact with forward- and backward-looking analysis into a model that is easy to understand and communicate.

### REFERENCE TO RELATED APPLICATIONS

This application is a national stage entry under 35 U.S.C. § 371(f) of PCT/US21/60174 entitled “SYSTEM FOR QUANTITATIVE CALCULATION OF THE IMPACT RATE OF RETURN OF A FINANCIAL ALLOCATION” filed Nov. 19, 2022, which claims the benefit of priority to U.S. Provisional Patent Application No. 63/117,947 filed Nov. 24, 2020, entitled “SYSTEM FOR QUANTITATIVE CALCULATION OF THE IMPACT RATE OF RETURN OF A FINANCIAL ALLOCATION” which are both incorporated by reference in their entirety.

### BACKGROUND

Companies, investors, governments, foundations, charities, and the public are placing a growing focus on understanding the societal benefits and detriments (impact) of their actions. As organizations allocate financial resources (such as investments for profit-seeking allocations, or grants for non-profit-seeking allocations, collectively referred to herein as financial allocations or allocations) towards activities, these organizations desire to calculate the amount of societal benefit or detriment that such financial allocations yield in relation to their dollar cost. Measuring the impact of such financial allocations from a social, environmental, economic, or governance perspective (impact theme) poses challenges as calculating these measurements in a quantitative way is difficult. Such analysis is complex and requires first identifying and second combining calculations for five elements of an activity's impact: type of impact, quantity of impact, quality of impact, cost of impact, and time of impact. Conventional methods are unable to synthesize many of these factors as required for calculating the impact value of money into a single quantitative measurement. Given that a financial allocation's activities may relate in varying degrees across impact themes, ascertaining the quantitative impact of an allocation across themes is challenging. It also follows that measuring the quantitative impact of an allocation to compare the impact between different activities is difficult.

For example, if a company builds affordable housing units in an area that requires the clearing of old growth forest, this activity will have an impact that spans across social and environmental themes. The affordable housing units will have a direct relationship to the social impact theme of more families and individuals having access to affordable housing. The activity of clearing old growth forest to build affordable housing units will have another direct impact on the environmental theme by destroying natural resources and ecosystems. Measuring and assessing these impacts in a quantitative manner is desired by those involved with the activity to make better decisions related to implementation of the activity. This quantitative measurement would also allow the affordable housing unit project to be compared to another activity, such as installing solar panels on the rooftop of a company headquarters to compare the impacts of the allocations in these activities.

One of the largest conventional methods for assessing the social, environmental, economic, or governance impact of a financial allocation is general qualitative results, typically in the form of written anecdotes. By definition such qualitative results do not include numeric values, and any comparison on impacts across social, environmental, economic, or governance themes is a general “feel” comparison. And it follows that any comparison on the impact of financial allocations from activity to activity is also qualitative, and is again just a best comparative estimate of the impact of the activity.

Another conventional method for assessing the social, environmental, economic, or governance impact of a financial allocation is survey results, such as those conducted by Gallup, 60 Decibels, Edelman, Nielsen, and others. Because such surveys are of a group of people (e.g. participants, beneficiaries, stakeholders, citizens) who are affected by the impact of an activity, they provide results that are a general “feel”, and focus mainly on the quality of impact delivered by an activity. Such tools are unable to factor in other various activity specific factors, such as cost effectiveness or time of impact. As such, these methods are unable to synthesize many of the factors required for calculating the impact value of money into a single quantitative measurement.

Another conventional method for measuring the social, environmental, economic, or governance impact of a financial allocation is the Impact Reporting and Investment Standards (IRIS) and the related IRIS+ tool. This tool includes a catalog of metrics aimed at quantitatively evaluating the impact an activity has on one or more impact themes. However, this conventional tool lacks the ability to assign a single quantitative value that financial allocation in an activity has on a particular theme for use in a comparison manner both across themes for the same activity or across activities. Because this tool is designed as a set of standardized metrics, it focuses mainly on the magnitude of impact of an activity, and lacks the ability to factor in other various activity specific factors, such as cost effectiveness or time of impact. As such the measurement by the IRIS+ tool only quantitatively measures a single element of impact.

Another conventional method for measuring the impact of an activity is the Impact Management Project (IMP). This tool includes evolving standards for consensus of impact measurement, management, and reporting. Like the IRIS+ conventional method, this tool lacks the ability to assign a single quantitative value that a financial allocation in an activity has on a particular societal benefit for use in a comparison manner both across benefits for the same activity or across activities. Further, this tool lacks the ability to factor cost effectiveness into its analysis.

Another conventional method for measuring the impact of a financial allocation in an activity is monetization, which is employed by tools such as the Rise Fund's Impact Multiple of Money (IMM), Robin Hood's Benefit-Cost Ratio, New York University's Return on Sustainability Investment (ROSI), Harvard University's Impact-Weighted Accounts, Social Return on Investment (SROI), and others. These tools attempt to calculate the dollar value of societal benefits created by financial allocations, namely grants, investments, or program budgets, by estimating the amount of societally beneficial economic value those activities create. However, this conventional method is limited to measures that can be monetized, it relies on assumptions about the potential economic value of activities which may be subject to biases, and it lacks the ability to factor in qualitative attributes as well as quality ratings into its analysis.

Another set of conventional methods assess the impact of environmental, social, and governance (ESG) related factors from investments or business activities through the tracking, disclosure, reporting, and/or analysis of such factors, and includes methods employed by ESG-related tracking and analysis software, ESG-related data providers, ESG-related rating agencies, ESG-related indices, ESG-related benchmarking tools, ESG-related reporting frameworks, ESG-related sustainability disclosure standards, and other ESG- and sustainability-related ranking initiatives. Examples of such efforts include Cority, Goby, Novisto, Rimes, ISS-Oekom, Refinitiv, S&P Global Market Intelligence, Bloomberg, EcoVadis CSR assessment, FTSE Russell ESG Ratings, Investor Shareholder Services, MSCI, Sustainalytics, Thomson Reuters ESG, Vigeo Eiris, Bloomberg Gender-Equality Index (GEI), Dow Jones Sustainability Indices (DJSI), Integrated Governance Index (IGI), Thomson Reuters D&I Index, International Integrated Reporting Council (IIRC), Workforce Disclosure Initiative (WDI), World Bank Environmental and Social Standards (ESS), Carbon Disclosure Project (CDP), Climate Disclosure Standards Board (CDSB), Global Reporting Initiative (GRI), Sustainability Accounting Standards Board (SASB), Corporate Knights Global 100 Ranking, JUST Capital, SAM Corporate Sustainability Assessment (CSA), SustainAbility, and others. Because these tools are designed for narrow functions related to ESG-related data aggregation, analysis, reporting, and/or ratings, they lack the ability to factor in other various activity specific factors, such as cost effectiveness, quality of impact delivery, or time of impact. As such, these methods are unable to synthesize many of the factors required for calculating the impact value of money into a single quantitative measurement.

Another set of conventional methods, which rate the impact of business activities, investments, or investment funds include the B Impact Assessment, the GIIRS Rating, the Actis Impact Score, iPAR, the Inter-American Development Bank (IDB) Group's IDB Invest DELTA (Development Effectiveness Learning, Tracking and Assessment) Tool, the International Finance Corporation's (IFC) Anticipated Impact Measurement and Monitoring (AIMM) system, Community Vision's Social Impact Rating system, BlueHub Capital's scoring rubric, Root Capital's Expected Impact Rating, Partners Group impact framework (drawing from the Impact Management Project), the World Benchmarking Alliance impact benchmarks, and the Impak impact rating score. These tools rate, score, standardize, and/or index the measure of benefits created by corporations, by investments, or by investment funds. Because these tools are designed for rating, scoring, and benchmarking, they lack the ability to factor in other various activity specific factors, such as cost effectiveness or time of impact into a single quantitative measurement.

Another conventional method for measuring the impact of a financial allocation on social, environmental, economic, or governance indicators is the Opportunity Zone Community Impact Assessment Tool. This tool assesses the potential quality of impact of local development projects in federally created tax incentive investment zones called Opportunity Zones, and is designed to engage community stakeholders in the assessment process. However, this conventional tool lacks the ability to factor in cost effectiveness or time of impact for various activities into a single quantitative measurement.

Another set of conventional methods assess the environmental impact of real estate, construction, and built assets, and includes real estate-related tracking and analysis software, real estate-related data providers, real estate-related rating agencies, real estate-related benchmarking tools, real estate-related reporting frameworks, real estate-related disclosure standards, and other real estate-related ranking initiatives. Examples of such efforts include the Leadership in Energy and Environmental Design (LEED) rating system, Measurabl, the Global Real Estate Sustainability Benchmark (GRESB), green|light Certification, Green Globes Building Certification, WELL Certification, the Energy Star program, the Urban Land Institute Greenprint Center for Building Performance benchmark, and others. However, these tools are designed for narrow purposes related to real estate data aggregation, analysis, reporting, rating, and certification, and therefore they lack the ability to factor in other various activity specific factors, such as quality of impact delivery, or time of impact. As such, these methods are unable to synthesize many of the factors required for calculating the impact value of money into a single quantitative measurement.

Another conventional tool for classifying measures of social, environmental, economic, or governance related impact is the United Nations Global indicator framework for the Sustainable Development Goals (UN SDGs or SDGs) and targets of the 2030 Agenda for Sustainable Development. This set of 231 unique indicators (247 non-unique indicators) was developed by the UN Inter-Agency and Expert Group on SDG Indicators (IAEG-SDGs) and is made available to countries to monitor progress made on implementation of the Sustainable Development Goals based on data produced by national statistical systems. However, this conventional tool lacks the ability to assign a single quantitative value that a financial allocation in an activity has on a particular theme for use in a comparison manner both across themes for the same activity or across activities. Because this tool is designed as a set of standardized metrics, it focuses mainly on the magnitude of impact of an activity, and lacks the ability to factor in other various activity specific factors, such as quality of impact, cost effectiveness or time of impact. As such, this tool only quantitatively measure a single element of impact.

Another conventional method for measuring the impact of a financial allocation in an activity is the Disability-Adjusted Life Year (DALY) (as well as a related tool, the Quality-Adjusted Life Year (QALY) which is more narrowly focused). The DALY is widely used by the World Health Organization (WHO) as a measure of the burden of a health problem. DALY is often used to rank disease risk factors and estimate differences in health-related activities on a per-dollar basis. This method attempts to quantify mortality and morbidity into a single number, but is limited to use within health-related fields, and is unable to synthesize many of the factors required for calculating the impact value of money into a single quantitative measurement.

Another conventional method for measuring the impact of a financial allocation in an activity is the Best Available Charitable Option (BACO), developed by the Acumen Fund (or Acumen). BACO allows users to calculate how much social good they could create per dollar invested over the lifetime of an investment compared to a traditional philanthropic grant with the same goals. However, this method is limited to calculating cost effectiveness comparisons, the analysis focuses on impact magnitude and cost, the approach is mainly used for ex-ante estimations, it is unable to incorporate measures for quality of impact, and it does not calculate a rate of impact delivered on a per dollar basis to factor into a single quantitative measurement.

Another conventional method for measuring the impact of a financial allocation in an activity is the Social Internal Rate of Return, used by the intergovernmental Organisation for Economic Cooperation and Development (OECD). This method is used to calculate economic evaluations and aggregate outputs of public sector financial allocations at the national level, namely in education. However, this method is narrowly focused on education, is unable to incorporate measures for quality of impact, and does not calculate a rate of impact achieved on a per dollar basis to factor into a single quantitative measurement.

Another conventional method for measuring social progress at a national level is the Social Progress Index, which is published by the Social Progress Imperative. The Index aggregates fifty social and environmental indicators across 163 countries, and across three aspects of social progress: basic human needs, foundations of well-being, and opportunity. As an index, this method focuses on aggregating and comparing the magnitude of impact across its indicators, and it does not take into account activity specific factors, such as cost effectiveness or time of impact. Therefore, it is unable to synthesize many of the factors required for calculating the impact value of money into a single quantitative measurement.

In addition to the limitations these conventional methods encounter in synthesizing all five elements of impact measurement (i.e. type of impact, quantity of impact, quality of impact, cost of impact, and time of impact) into a single analysis as noted above, these conventional methods are limited in their ability to identify a unit of measurement associated with the quantity of impact of an activity, and a quantitative indicator or indicators associated with the quality of impact of an activity. The IRIS+ conventional method assists in identifying quantitative indicators of an activity (quality of impact), but does not identify a single unit of measurement of an activity (quantity of impact). Similarly, the IMP conventional method assists in identifying the unit of measurement of an activity (quantity of impact), but is limited to only measuring the number of individuals affected by an activity, and the method does not identify the associated quantitative indicators of an activity (quality of impact).

Therefore, it is desirable for a system to quantitatively assess the impact value of money of at least one activity within an impact theme by transforming qualitative and quantitative indicators into a single quantitative measurement. It is further desirable for the system to quantitatively assess the impact value of money of at least one activity across impact themes by transforming qualitative and quantitative indicators into a single quantitative measurement. It is further desirable for the system to accurately identify and associate the quality of impact and the quantity of impact of an activity or activities.

### SUMMARY

There is provided a computer-implemented method for quantitatively calculating an impact rate of return (iRR) of an activity via a computer network, the method comprising: receiving an iRR calculation input at a first computer system, the iRR calculation input having been transmitted via the computer network from a second computer system, the iRR calculation input comprising a request to begin calculation of the iRR, the first computer system being associated with a service provider, the second computer system being associated with an entity; transmitting a plurality of selection outputs from the first computer system to the second computer system via the computer network, each of the selection outputs being configured to cause a respective selection to be provided to the second computer system, wherein providing each respective selection includes causing a webpage having the respective selection to be displayed via a display of the second computer system, the webpage being associated with a website of the service provider; receiving a plurality of selection inputs at the first computer system, the each of the selection inputs being associated with a respective one of the selections provided to the second computer system and each of the selection inputs having been transmitted from the second computer system to the first computer system via the computer network, each of the selection inputs comprising a selected option and storing the selected option by the first computer system; processing the selected options by the first computer system to determine the iRR associated with the activity, storing the iRR associated with the activity by the first computer system; and based upon the stored iRR, transmitting an iRR output to the second computer system via the computer network, the iRR output configured to cause the stored iRR to be provided to the second computer system, wherein providing the stored iRR includes causing the webpage having the stored iRR to be displayed via the display of the second computer system.

Optionally, processing the selected options includes calculating the following algorithm:

$$f ( M ) = \{ \begin{matrix}- \frac{\frac{K}{G} ⋁ {Log}_{b} K ⋁ K}{( 1 - \vert M ⋁ \frac{{\sum }_{i = 1}^{N} {Q}_{i}}{100} \vert ) \times ( {Log}_{b} \frac{C}{K} ) \times T} & - 1 < M < 0 \\ \frac{\frac{K}{G} ⋁ {Log}_{b} K ⋁ K}{( 1 - M ⋁ \frac{{\sum }_{i = 1}^{N} {Q}_{i}}{100} ) \times ( {Log}_{b} \frac{C}{K} ) \times T} & 0 \leq M < 1\end{matrix}$$

where

$$\frac{K}{G} ⋁ {Log}_{b} K ⋁ K$$

is an impact quantity of the activity,

where

$$M ⋁ \frac{{\sum }_{i = 1}^{N} {Q}_{i}}{100}$$

is an impact multiplier value of the activity,

where

$${Log}_{b} \frac{C}{K}$$

is an impact efficiency of the activity, such that

$$0 < {Log}_{b} \frac{C}{K} ,$$

where T is a time period of the activity, such that 0<T, T∈

[symbol]

where K is a number of key impact indicator units, KII, of the activity,

where G is an impact goal of the entity expressed in terms of K,

where b is a base of a logarithmic function, such that 1<b, b∈ [symbol] ,

where M is an impact multiplier value of the activity, such that −1<M<1, M∈ [symbol] ,

where i is an impact metric point value, Q is a set of the impact metric point values and N is a number of values in the set Q,

where C is a cost of the activity, and

where v is the operator “or”.

Optionally, the selection outputs, respective selections, associated selection inputs, and respective selected options comprise: an impact theme selection output, an impact theme selection, an impact theme selection input and a selected impact theme, and/or an impact area selection output, an impact area selection, an impact area selection input and a selected impact area, and/or an impact area sub-category selection output, an impact area sub-category selection, an impact area sub-category selection input, a selected impact area sub-category, and/or a KII selection output, a KII selection, a KII selection input, and a selected KII, and/or, an impact metric selection output, an impact metric selection, an impact metric selection input, and a selected impact metric, and/or, an impact metric score range selection output, an impact metric score range selection, an impact metric score range selection input, and a selected impact metric score range, and/or, an impact metric score selection output, an impact metric score selection, an impact metric score selection input, and a selected impact metric score, and/or, an impact goal selection output, an impact goal selection, an impact goal selection input, and a selected impact goal, and/or, a KII delivery selection output, a KII delivery selection, a KII delivery selection input, and a selected KII delivery, and/or, a time period selection output, a time period selection, a time period selection input, and a selected time period, and/or, an activity cost selection output, an activity cost selection, an activity cost an activity cost selection input, and a selected activity cost.

Optionally, the impact area selection is transmitted based on the stored selected impact theme, and/or the impact area sub-category is transmitted based on the stored selected impact area, and/or the KIT selection output is transmitted based on the stored selected impact area, and/or the impact metric selection output is transmitted based on the stored selected impact area sub-category, and/or the impact metric score range selection output is transmitted based on the stored selected impact metrics, and/or the impact metric score selection output is transmitted based on the stored impact metric score range, and/or the impact goal output is transmitted based on the stored selected KII, and/or the KII delivery output is transmitted based on the stored selected KII.

Optionally, the processing the selected options by the first computer system to determine the iRR associated with the activity comprises: processing an impact metric score rate, the impact metric score rate being processed by the first computer system, where the processing is configured to assign an impact metric score rate to the impact metric based upon the stored impact metric score and to store the impact metric score rate by the first computer system; processing an impact metric point value, the impact metric point value being processed by the first computer system, where the processing is configured to assign the impact metric with an impact metric point value by multiplying the stored impact metric score rate and the stored impact metric possible point value and to store the impact metric point value by the first computer system; processing an impact multiplier value, the impact multiplier value being processed by the first computer system, where the processing is configured to assign the impact multiplier value by dividing the impact metric point value by 100 and to store the impact multiplier value; based upon the stored KII delivery and the stored impact goal, processing the impact quantity, the impact quantity being processed by the first computer system, where the processing is configured to assign the impact quantity of the activity by dividing the stored KII delivery by the stored impact goal and to store the impact quantity by the first computer system; based upon the stored activity cost and stored KII delivery, processing an impact efficiency, the impact efficiency being processed by the first computer system, where the processing is configured to assign the impact efficiency of the activity, and to store the impact efficiency by the first computer system; based upon the stored impact multiplier value, the stored KII delivery, the stored time period, the stored impact quantity, and the stored impact efficiency, processing the iRR, the iRR being processed by the first computer system, where the processing is configured to assign the iRR of the activity by and to store the iRR associated with the activity by the first computer system.

Optionally, processing the selected options by the first computer system to determine the iRR associated with the activity comprises: calculating an impact efficiency based on a stored activity cost and a stored KII delivery by the first computer system, processing an upper impact efficiency and lower impact efficiency based on stored upper and lower activity costs and stored upper and lower KII deliveries, and utilizing a log base 100, or benchmarking the impact efficiency to determine the log base value.

Optionally, the display of the impact metric score range selections comprises five pro rata percentiles.

Optionally, the entity is selected from the group consisting of a government agency, a for-profit legal entity, a non-profit legal entity, and an individual user.

Optionally, the impact theme selection output comprises a social impact theme, an environmental impact theme, an economic impact theme, and a governance impact theme.

Optionally, the impact theme selection input comprises the social impact theme, and wherein the impact area selection comprises housing and shelter, smallholders and family farmers, education, connectivity, employment, health and human services, equity and access, financial services and inclusion, community and stakeholder engagement, safety, and other.

Optionally, the impact theme selection input comprises the environmental impact theme, and wherein the impact area selection comprises natural resources and ecosystems, climate, energy pollution and waste, food production, materials, animals and wildlife, buildings and real assets, and other.

Optionally, the impact theme selection input comprises the economic impact theme, and wherein the impact area selection comprises infrastructure, real estate and property value, economic indicators, community or stakeholder ownership, economic performance, economic practices, research and development, and other.

Optionally, the impact theme selection input comprises the governance impact theme, and wherein the impact area selection comprises diversity and inclusion, corruption, transparency and disclosure, pay and compensation, governance practices, operations and strategy, human rights, anti-competitive behavior, risk management, environmental standards, and other.

Optionally, the impact metric selection comprises at least two selected impact metrics and is configured to store each of the at least two selected impact metrics in association with the impact area sub-category; and wherein processing the impact metric weight comprises pro-rata assignment of at least two impact metric sub-weights to the at least two impact metrics, and wherein processing the impact metric possible point value comprises assigning each of the at least two impact metric sub-weights an impact metric possible point sub-value, wherein each of the impact metric possible point sub-values is the product of the stored impact metric value and each of the respective at least two impact metric sub-weights; and wherein providing the impact metric score range selection includes at least two impact metric score ranges to be displayed in association with the corresponding impact metrics of the at least two impact metrics via the display of the second computer system, and wherein the impact metric score range selection input comprises at least two selected impact metric score ranges and is configured to store each of the at least two selected impact metric score ranges in association with the respective impact metrics of the at least two impact metrics; and wherein providing the impact metric score selection comprises at least two impact metric scores to be displayed in association with the corresponding impact metrics of the at least two impact metrics via the display of the second computer system, and wherein the impact metric score selection input comprises at least two selected impact metric scores and is configured to store each of the at least two selected impact metric scores in association with the respective impact metrics of the at least two impact metrics; and wherein processing the impact metric score rate comprises assigning each of the at least two impact metrics an impact metric score; processing the impact metric point value comprises assigning each of the at least two impact metrics an impact metric point sub-value, the processing configured to store the at least two impact metric point sub-values, wherein each of the impact metric possible point sub-values is the product of each of the stored impact metric rates and the at least two impact metric possible point sub-values for each respective impact metric of the at least two impact metrics.

Optionally, the impact area sub-category selection input comprises at least two selected impact area sub-categories and is configured to store the at least two selected impact area sub-categories in association with the respective impact area of the at least two impact areas; and wherein providing the impact metric selection includes causing the webpage having the impact metric selections to be displayed in association with the corresponding impact area sub-categories of the at least two impact area sub-categories via the display of the second computer system.

Optionally, the impact area selection input comprises at least two selected impact areas and is configured to store each of the at least two selected impact areas in association with the corresponding impact theme; and wherein providing the impact area sub-category selection includes causing the webpage having the impact area sub-category selections to be displayed in association with the corresponding impact area of the at least two selected impact areas via the display of the second computer system, and wherein providing the KII selection includes causing the webpage having the KII selections to be displayed in association with the corresponding impact area for each of the at least two impact areas via the display of the second computer system; and wherein the KII selection input comprises at least two selected KIIs and is configured to store each of the at least two selected KIIs by the first computer system.

Optionally, the iRR calculation input further comprises account login information and transmitting the impact theme selection output is based upon validating the account login information, wherein providing the impact theme selection includes causing a webpage having impact theme selections and an activity name entry to be displayed via a display of the second computer system, the webpage being associated with a website of the service provider, wherein the impact theme selection input comprising a selected impact theme and activity name and storing the selected impact theme and activity name by the first computer system, and the computer-implemented method further comprises: transmitting a multi-time period output to the second computer system via the computer network, the multi-time period output causing a selection to determine the iRR calculation over a multi-time-period to be provided to the second computer system, wherein providing the multi-time-period output includes causing the webpage having the multi-time period iRR calculation selection to be displayed via the display of the second computer system; receiving a multi-time-period input, the multi-time-period input having been transmitted from the second computer system to the first computer system via the computer network, the multi-time period input comprising an affirmative multi-time-period iRR calculation selection and storing the affirmative multi-time-period iRR calculation in association with the stored iRR; and receiving a continued iRR calculation input, the continued iRR calculation having been transmitted from the second computer system to the first computer system via the computer network, the continued iRR calculation input comprising the account login information and a request to continue the iRR calculation and validating the account login information and beginning a continued iRR calculation at the transmitting the impact metric score selection output.

Optionally, the iRR calculation input comprises a request to begin calculation of the iRR from a template, where the template comprises one or more predetermined, stored selections.

There is further provided, a non-transitory computer-readable medium having computer-executable instructions for performing a method for quantitatively calculating the impact rate of return (iRR) of an activity via a computing device, as described above.

There is further provided, a first computer system configured to perform the computer-implemented method as described above.

In aspects, a method for quantitatively calculating the impact rate of return (iRR) of an activity via a computer network, the method including receiving an iRR calculation input at a first computer system, the iRR calculation input having been transmitted via the computer network from a second computer system, the iRR calculation input comprising a request to begin calculation of the iRR, the first computer system being associated with a service provider, the second computer system being associated with a business entity; transmitting an impact theme selection output from the first computer system to the second computer system via the computer network, the impact theme selection output configured for causing the impact theme selection to be provided to the second computer system, wherein providing the impact theme selection includes causing a webpage having impact theme selections to be displayed via a display of the second computer system, the webpage being associated with a website of the service provider; receiving an impact theme selection input at the first computer system, the impact theme selection input having been transmitted from the second computer system to the first computer system via the computer network, the impact theme selection input comprising a selected impact theme and configured for storing the selected impact theme by the first computer system; based upon the stored selected impact theme, transmitting an impact area selection output to the second computer system via the computer network, the impact area selection output configured for causing the impact area selection to be provided to the second computer system, wherein providing the impact area selection includes causing the webpage having the impact area selections to be displayed via the display of the second computer system; receiving an impact area selection input, the impact area selection input having been transmitted from the second computer system to the first computer system via the computer network, the impact area selection input comprising a selected impact area and configured for storing the selected impact area by the first computer system; based upon the stored selected impact area, transmitting an impact area sub-category selection output to the second computer system via the computer network, the impact area sub-category selection output configured for causing the impact area sub-category selection to be provided to the second computer system, wherein providing the impact area sub-category selection includes causing the webpage having impact area sub-category selections to be displayed via the display of the second computer system; receiving an impact area sub-category selection input, the impact area sub-category selection input having been transmitted from the second computer system to the first computer system via the computer network, the impact area sub-category selection input comprising a selected impact area sub-category and configured for storing the selected impact area sub-category by the first computer system; based upon the stored selected impact area, transmitting a KII selection output to the second computer system via the computer network, the KII selection output configured for causing the KII selection to be provided to the second computer system, wherein providing the KII selection includes causing the webpage having KII selections to be displayed via the display of the second computer system; receiving a KII selection input, the KII selection input having been transmitted from the second computer system to the first computer system via the computer network, the KII selection input comprising a selected KII and configured for storing the selected KII by the first computer system; based upon the stored selected impact area sub-category, transmitting an impact metric selection output to the second computer system via the computer network, the impact metric selection output configured for causing an impact metric selection to be provided to the second computer system, wherein providing the impact metric selection includes causing the webpage having impact metric selections to be displayed via the display of the second computer system; receiving an impact metric selection input, the impact metric selection input having been transmitted from the second computer system to the first computer system via the computer network, the impact metric selection input comprising a selected impact metric and configured for storing the selected impact metric by the first computer system; processing an impact metric value, the impact metric value being processed by the first computer system, the processing of the impact metric value configured to assign an impact metric value to the impact metric and store the impact metric value; processing an impact metric weight, the impact metric weight being processed by the first computer system, the processing of the impact metric weight configured to assign an impact metric weight to the impact metric and store the impact metric weight; processing an impact metric possible point value, the impact metric possible point value being processed by the first computer system, the processing of the impact metric possible point value configured to assign an impact metric possible point value to the impact metric and to store the impact metric possible point value in association with the impact metric, wherein the impact metric possible point value is the product of the stored impact metric value and the impact metric weight; based upon the stored selected impact metrics, transmitting an impact metric score range selection output to the second computer system via the computer network, the impact metric score range selection output configured for causing an impact metric score range selection to be provided to the second computer system, wherein providing the impact metric score range selection includes causing the webpage having impact metric score range selections to be displayed via the display of the second computer system; receiving an impact metric score range selection input, the impact metric score range selection input having been transmitted from the second computer system to the first computer system via the computer network, the impact metric score range selection input comprising an impact metric score range for the impact metric and configured for storing the impact metric score range in association with the impact metric by the first computer system; based upon the stored impact metric score range, transmitting an impact metric score selection output to the second computer system via the computer network, the impact metric score selection output configured for causing an impact metric score selection to be provided to the second computer system, wherein providing the impact metric score selection includes causing the webpage having impact metric score selections to be displayed via the display of the second computer system; receiving an impact metric score selection input, the impact metric score selection input having been transmitted from the second computer system to the first computer system via the computer network, the impact metric score selection input comprising a selected impact metric score for the impact metric and configured for storing the selected impact metric score in association with the impact metric by the first computer system; processing an impact metric score rate, the impact metric score rate being processed by the first computer system, where the processing is configured to assign an impact metric score rate to the impact metric based upon the stored impact metric score and to store the impact metric score rate by the first computer system; processing an impact metric point value, the impact metric point value being processed by the first computer system, where the processing is configured to assign the impact metric with an impact metric point value by multiplying the stored impact metric score rate and the stored impact metric possible point value and to store the impact metric point value by the first computer system; processing an impact multiplier value, the impact multiplier value being processed by the first computer system, where the processing is configured to assign the impact multiplier value by dividing the impact metric point value by 100 and to store the impact multiplier value; based upon the stored selected KII, transmitting an impact goal output to the second computer system via the computer network, the impact goal output configured for causing an impact goal to be provided to the second computer system, wherein providing the impact goal includes causing the webpage having an impact goal corresponding to the stored selected KII to be displayed via the display of the second computer system; receiving an impact goal input, the impact goal input having been transmitted from the second computer system to the first computer system via the computer network, the impact goal input comprising the impact goal and configured for storing the impact goal in association with the stored selected KII by the first computer system; based upon the stored selected KII, transmitting a KII delivery output to the second computer system via the computer network, the KII delivery output configured for causing a KII delivery to be provided to the second computer system, wherein providing the KII delivery includes causing the webpage having a KII delivery corresponding to the stored selected KII to be displayed via the display of the second computer system; receiving a KIT delivery input, the KII delivery input having been transmitted from the second computer system to the first computer system via the computer network, the KII delivery input comprising the KII delivery and configured for storing the KII delivery in association with the stored selected KII by the first computer system; based upon the stored KII delivery and the stored impact goal, processing the impact quantity, the impact quantity being processed by the first computer system, where the processing is configured to assign the impact quantity of the activity by dividing the stored KII delivery by the stored impact goal and to store the impact quantity by the first computer system; transmitting a time period output to the second computer system via the computer network, the time period output configured for causing a time period entry to be provided to the second computer system, wherein providing the time period entry includes causing the webpage having a time period entry to be displayed via the display of the second computer system; receiving a time period input, the time period input having been transmitted from the second computer system to the first computer system via the computer network, the time period input comprising the time period and configured for storing the time period in years by the first computer system; transmitting an activity cost output to the second computer system via the computer network, the activity cost output configured for causing an activity cost entry to be provided to the second computer system, wherein providing the activity cost entry includes causing the webpage having an activity cost entry to be displayed via the display of the second computer system; receiving an activity cost input, the activity cost input having been transmitted from the second computer system to the first computer system via the computer network, the activity cost input comprising the activity cost and configured for storing the activity cost by the first computer system; based upon the stored activity cost and stored KII delivery, processing an impact efficiency, the impact efficiency being processed by the first computer system, where the processing is configured to assign the impact efficiency of the activity, and to store the impact efficiency by the first computer system; based upon the stored impact multiplier value, the stored KII delivery, the stored time period, the stored impact quantity, and the stored impact efficiency, processing the iRR, the iRR being processed by the first computer system, where the processing is configured to assign the iRR of the activity by and to store the iRR associated with the activity by the first computer system; based upon the stored iRR, transmitting an iRR output to the second computer system via the computer network, the iRR output configured for causing the stored iRR to be provided to the second computer system, wherein providing the stored iRR includes causing the webpage having the stored iRR to be displayed via the display of the second computer system.

In aspects, a method for quantitatively calculating the impact rate of return (iRR) of an activity via a computer network, the method including receiving an iRR calculation input at a first computer system, the iRR calculation input having been transmitted via the computer network from a second computer system, the iRR calculation input comprising a request to begin calculation of the iRR, the first computer system being associated with a service provider, the second computer system being associated with a business entity; transmitting a sub-category selection output to the second computer system via the computer network, the sub-category selection output configured for causing impact area sub-category selections to be provided to the second computer system, wherein providing the impact area sub-category selections includes causing the webpage having impact area sub-category selections to be displayed via the display of the second computer system; receiving a sub-category selection input, the sub-category selection input having been transmitted from the second computer system to the first computer system via the computer network, the sub-category selection input comprising a selected impact area sub-category and configured for storing the selected impact area sub-category by the first computer system; based upon the stored selected impact area sub-category, transmitting a sub-category KII selection output to the second computer system via the computer network, the sub-category KII selection output configured for causing the KII selection to be provided to the second computer system, wherein providing the KII selection includes causing the webpage having KII selections to be displayed via the display of the second computer system; receiving a sub-category KII selection input, the sub-category KII selection input having been transmitted from the second computer system to the first computer system via the computer network, the sub-category KII selection input comprising a selected KII and configured for storing the selected KII by the first computer system; transmitting an impact multiplier selection output to the second computer system via the computer network, the impact multiplier selection output configured for causing an impact multiplier selection to be provided to the second computer system, wherein providing the impact multiplier selection includes causing the webpage having impact multiplier selections to be displayed via the display of the second computer system; receiving an impact multiplier selection input, the impact multiplier selection input having been transmitted from the second computer system to the first computer system via the computer network, the impact multiplier selection input comprising a selected impact multiplier and configured for storing the selected impact multiplier by the first computer system; based upon the stored selected KII, transmitting an impact goal output to the second computer system via the computer network, the impact goal output configured for causing an impact goal to be provided to the second computer system, wherein providing the impact goal includes causing the webpage having an impact goal corresponding to the KII to be displayed via the display of the second computer system; receiving an impact goal input, the impact goal input having been transmitted from the second computer system to the first computer system via the computer network, the impact goal input comprising the impact goal and configured for storing the impact goal in association with the stored KII by the first computer system; based upon the stored selected KII, transmitting a KII delivery output to the second computer system via the computer network, the KII delivery output configured for causing a KII delivery to be provided to the second computer system, wherein providing the KII delivery includes causing the webpage having a KII delivery corresponding to the KII to be displayed via the display of the second computer system; receiving a KII delivery input, the KII delivery input having been transmitted from the second computer system to the first computer system via the computer network, the KII delivery input comprising the KII delivery and configured for storing the KII delivery in association with the KII by the first computer system; based upon the stored KII delivery and the stored impact goal, processing the impact quantity, the impact quantity being processed by the first computer system, where the processing is configured to assign the impact quantity of the activity by dividing the stored KII delivery by the stored impact goal and to store the impact quantity by the first computer system; transmitting a time period output to the second computer system via the computer network, the time period output configured for causing a time period entry to be provided to the second computer system, wherein providing the time period entry includes causing the webpage having a time period entry to be displayed via the display of the second computer system; receiving a time period input, the time period input having been transmitted from the second computer system to the first computer system via the computer network, the time period input comprising the time period and configured for storing the time period in years by the first computer system; transmitting an activity cost output to the second computer system via the computer network, the activity cost output configured for causing an activity cost entry to be provided to the second computer system, wherein providing the activity cost entry includes causing the webpage having an activity cost entry to be displayed via the display of the second computer system; receiving an activity cost input, the activity cost input having been transmitted from the second computer system to the first computer system via the computer network, the activity cost input comprising the activity cost and configured for storing the activity cost by the first computer system; based upon the stored activity cost and stored KII delivery, processing an impact efficiency, the impact efficiency being processed by the first computer system, where the processing is configured to assign the impact efficiency of the activity, and to store the impact efficiency by the first computer system; based upon the stored impact multiplier value, the stored impact goal, the stored time period, the stored impact quantity, and the stored impact efficiency, processing the iRR, the iRR being processed by the first computer system, where the processing is configured to assign the iRR of the activity by and to store the iRR associated with the activity by the first computer system; based upon the stored iRR, transmitting an iRR output to the second computer system via the computer network, the iRR output configured for causing the stored iRR to be provided to the second computer system, wherein providing the stored iRR includes causing the webpage having the stored iRR to be displayed via the display of the second computer system.

In aspects, a method for quantitatively calculating the impact rate of return (iRR) of an activity via a computer network, the method including receiving an iRR calculation input at a first computer system, the iRR calculation input having been transmitted via the computer network from a second computer system, the iRR calculation input comprising a request to begin calculation of the iRR, the first computer system being associated with a service provider, the second computer system being associated with a business entity; transmitting a sub-category selection output to the second computer system via the computer network, the sub-category selection output configured for causing impact area sub-category selections to be provided to the second computer system, wherein providing the impact area sub-category selections includes causing the webpage having impact area sub-category selections to be displayed via the display of the second computer system; receiving a sub-category selection input, the sub-category selection input having been transmitted from the second computer system to the first computer system via the computer network, the sub-category selection input comprising a selected impact area sub-category and configured for storing the selected impact area sub-category by the first computer system; based upon the stored selected impact area sub-category, transmitting a sub-category KII selection output to the second computer system via the computer network, the sub-category KII selection output configured for causing the KII selection to be provided to the second computer system, wherein providing the KII selection includes causing the webpage having KII selections to be displayed via the display of the second computer system; receiving a sub-category KII selection input, the sub-category KII selection input having been transmitted from the second computer system to the first computer system via the computer network, the sub-category KII selection input comprising a selected KII and configured for storing the selected KII by the first computer system; transmitting an impact multiplier selection output to the second computer system via the computer network, the impact multiplier selection output configured for causing an impact multiplier selection to be provided to the second computer system, wherein providing the impact multiplier selection includes causing the webpage having impact multiplier selections to be displayed via the display of the second computer system; receiving an impact multiplier selection input, the impact multiplier selection input having been transmitted from the second computer system to the first computer system via the computer network, the impact multiplier selection input comprising a selected impact multiplier and configured for storing the selected impact multiplier by the first computer system; based upon the stored selected KII, transmitting a KII delivery output to the second computer system via the computer network, the KII delivery output configured for causing a KII delivery to be provided to the second computer system, wherein providing the KII delivery includes causing the webpage having a KII delivery corresponding to the KII to be displayed via the display of the second computer system; receiving a KII delivery input, the KII delivery input having been transmitted from the second computer system to the first computer system via the computer network, the KII delivery input comprising the KII delivery and configured for storing the KII delivery in association with the KII by the first computer system; based upon the stored KII delivery, processing the impact quantity, the impact quantity being processed by the first computer system, where the processing is configured to store the impact quantity by the first computer system; transmitting a time period output to the second computer system via the computer network, the time period output configured for causing a time period entry to be provided to the second computer system, wherein providing the time period entry includes causing the webpage having a time period entry to be displayed via the display of the second computer system; receiving a time period input, the time period input having been transmitted from the second computer system to the first computer system via the computer network, the time period input comprising the time period and configured for storing the time period in years by the first computer system; transmitting an activity cost output to the second computer system via the computer network, the activity cost output configured for causing an activity cost entry to be provided to the second computer system, wherein providing the activity cost entry includes causing the webpage having an activity cost entry to be displayed via the display of the second computer system; receiving an activity cost input, the activity cost input having been transmitted from the second computer system to the first computer system via the computer network, the activity cost input comprising the activity cost and configured for storing the activity cost by the first computer system; based upon the stored activity cost and stored KII delivery, processing an impact efficiency, the impact efficiency being processed by the first computer system, where the processing is configured to assign the impact efficiency of the activity, and to store the impact efficiency by the first computer system; based upon the stored impact multiplier value, the stored KII delivery, the stored time period, the stored impact quantity, and the stored impact efficiency, processing the iRR, the iRR being processed by the first computer system, where the processing is configured to assign the iRR of the activity by and to store the iRR associated with the activity by the first computer system; based upon the stored iRR, transmitting an iRR output to the second computer system via the computer network, the iRR output configured for causing the stored iRR to be provided to the second computer system, wherein providing the stored iRR includes causing the webpage having the stored iRR to be displayed via the display of the second computer system.

In aspects non-transitory computer-readable medium having computer-executable instructions for performing a method for quantitatively calculating the impact rate of return (iRR) of an activity via a computing device, the method including: receiving an iRR calculation input at the computing device, the iRR calculation input having been input via a display of the computing device, the iRR calculation input comprising a request to begin calculation of the iRR, the computing device being associated with a business entity; displaying an impact theme selection output, the impact theme selection output configured for causing the impact theme selections to be displayed via the display of the computing device; receiving an impact theme selection input at the computing device, the impact theme selection input having been input via a display of the computing device, the impact theme selection input comprising a selected impact theme and configured for storing the selected impact theme by the computing device; based upon the stored selected impact theme, displaying an impact area selection output, the impact area selection output configured for causing the impact area selections to be displayed via the display of the computing device; receiving an impact area selection input, the impact area selection input having been input via a display of the computing device, the impact area selection input comprising a selected impact area and configured for storing the selected impact area by the computing device; based upon the stored selected impact area, displaying an impact area sub-category selection output via a display of the computing device, the impact area sub-category selection output configured for causing the impact area sub-category selections to be displayed via the display of the computing device; receiving an impact area sub-category selection input, the impact area sub-category selection input having been input via a display of the computing device, the impact area sub-category selection input comprising a selected impact area sub-category and configured for storing the selected impact area sub-category by the computing device; based upon the stored selected impact area, displaying a KII selection output via the display of the computing device, the KII selection output configured for causing the KII selections to be displayed via the display of the computing device; receiving a KII selection input, the KII selection input having been input via a display of the computing device, the KII selection input comprising a selected KII and configured for storing the selected KII by the computing device; based upon the stored selected impact area sub-category, displaying an impact metric selection output via the display of the computing device, the impact metric selection output configured for causing impact metric selections to be displayed via the display of the computing device; receiving an impact metric selection input, the impact metric selection input having been via the display of the computing device, the impact metric selection input comprising a selected impact metric and configured for storing the selected impact metric by the computing device; processing an impact metric value, the impact metric value being processed by the computing device, the processing of the impact metric value configured to assign an impact metric value to the impact metric and store the impact metric value; processing an impact metric weight, the impact metric weight being processed by the computing device, the processing of the impact metric weight configured to assign an impact metric weight to the impact metric and store the impact metric weight; processing an impact metric possible point value, the impact metric possible point value being processed by the computing device, the processing of the impact metric possible point value configured to assign an impact metric possible point value to the impact metric and to store the impact metric possible point value in association with the impact metric, wherein the impact metric possible point value is the product of the stored impact metric value and the impact metric weight; based upon the stored selected impact metrics, displaying an impact metric score range selection output via the display of the computing device, the impact metric score range selection output configured for causing impact metric score range selections to be displayed via the display of the computing device; receiving an impact metric score range selection input, the impact metric score range selection input having been input via the display of the computing device, the impact metric score range selection input comprising an impact metric score range for the impact metric and configured for storing the impact metric score range in association with the impact metric by the computing device; based upon the stored impact metric score range, displaying an impact metric score selection output via the display of the computing device, the impact metric score selection output configured for causing impact metric score selections to be displayed via the display of the computing device; receiving an impact metric score selection input, the impact metric score selection input having been input via the display of the computing device, the impact metric score selection input comprising a selected impact metric score for the impact metric and configured for storing the selected impact metric score in association with the impact metric by the computing device; processing an impact metric score rate, the impact metric score rate being processed by the computing device, where the processing is configured to assign an impact metric score rate to the impact metric based upon the stored impact metric score and to store the impact metric score rate by the computing device; processing an impact metric point value, the impact metric point value being processed by the computing device, where the processing is configured to assign the impact metric with an impact metric point value by multiplying the stored impact metric score rate and the stored impact metric possible point value and to store the impact metric point value by the computing device; processing an impact multiplier value, the impact multiplier value being processed by the computing device, where the processing is configured to assign the impact multiplier value by dividing the impact metric point value by 100 and to store the impact multiplier value; based upon the stored selected KII, displaying an impact goal output via the display of the computing device, the impact goal output configured for causing an impact goal corresponding to the stored selected KII to be displayed via the display of the computing device; receiving an impact goal input, the impact goal input having been input via the display of the computing device, the impact goal input comprising the impact goal and configured for storing the impact goal in association with the stored selected KII by the computing device; based upon the stored selected KII, displaying a KII delivery output via the display of the computing device, the KII delivery output configured for causing a KII delivery corresponding to the stored selected KII to be displayed via the display of the computing device; receiving a KII delivery input, the KII delivery input having been input via the display of the computing device, the KII delivery input comprising the KII delivery and configured for storing the KII delivery in association with the stored selected KII by the computing device; based upon the stored KII delivery and the stored impact goal, processing the impact quantity, the impact quantity being processed by the computing device, where the processing is configured to assign the impact quantity of the activity by dividing the stored KII delivery by the stored impact goal and to store the impact quantity by the computing device; displaying a time period output via the display of the computing device, the time period output configured for causing a time period entry to be displayed via the display of the computing device; receiving a time period input, the time period input having been via the display of the computing device, the time period input comprising the time period and configured for storing the time period in years by the computing device; displaying an activity cost output via the display of the computing device, the activity cost output configured for causing an activity cost entry to be displayed via the display of computing device; receiving an activity cost input, the activity cost input having been input via the display of the computing device, the activity cost input comprising the activity cost and configured for storing the activity cost by the computing device; based upon the stored activity cost and stored KII delivery, processing an impact efficiency, the impact efficiency being processed by the computing device, where the processing is configured to assign the impact efficiency of the activity, and to store the impact efficiency by the computing device; based upon the stored impact multiplier value, the stored KII delivery, the stored time period, the stored impact quantity, and the stored impact efficiency, processing the iRR, the iRR being processed by the computing device, where the processing is configured to assign the iRR of the activity by and to store the iRR associated with the activity by the computing device; based upon the stored iRR, displaying an iRR output via the display of the computing device, the iRR output configured for causing the stored iRR to be displayed via the display of the computing device.

In aspects, non-transitory computer-readable medium having computer-executable instructions for performing a method for quantitatively calculating the impact rate of return (iRR) of an activity via a computer network, the method including: receiving an iRR calculation input at a first computer system, the iRR calculation input having been transmitted via the computer network from a second computer system, the iRR calculation input comprising a request to begin calculation of the iRR, the first computer system being associated with a service provider, the second computer system being associated with a business entity; transmitting an impact theme selection output from the first computer system to the second computer system via the computer network, the impact theme selection output configured for causing the impact theme selection to be provided to the second computer system, wherein providing the impact theme selection includes causing a webpage having impact theme selections to be displayed via a display of the second computer system, the webpage being associated with a website of the service provider; receiving an impact theme selection input at the first computer system, the impact theme selection input having been transmitted from the second computer system to the first computer system via the computer network, the impact theme selection input comprising a selected impact theme and configured for storing the selected impact theme by the first computer system; based upon the stored selected impact theme, transmitting an impact area selection output to the second computer system via the computer network, the impact area selection output configured for causing the impact area selection to be provided to the second computer system, wherein providing the impact area selection includes causing the webpage having the impact area selections to be displayed via the display of the second computer system; receiving an impact area selection input, the impact area selection input having been transmitted from the second computer system to the first computer system via the computer network, the impact area selection input comprising a selected impact area and configured for storing the selected impact area by the first computer system; based upon the stored selected impact area, transmitting an impact area sub-category selection output to the second computer system via the computer network, the impact area sub-category selection output configured for causing the impact area sub-category selection to be provided to the second computer system, wherein providing the impact area sub-category selection includes causing the webpage having impact area sub-category selections to be displayed via the display of the second computer system; receiving an impact area sub-category selection input, the impact area sub-category selection input having been transmitted from the second computer system to the first computer system via the computer network, the impact area sub-category selection input comprising a selected impact area sub-category and configured for storing the selected impact area sub-category by the first computer system; based upon the stored selected impact area, transmitting a KII selection output to the second computer system via the computer network, the KII selection output configured for causing the KII selection to be provided to the second computer system, wherein providing the KII selection includes causing the webpage having KII selections to be displayed via the display of the second computer system; receiving a KII selection input, the KII selection input having been transmitted from the second computer system to the first computer system via the computer network, the KII selection input comprising a selected KII and configured for storing the selected KII by the first computer system; based upon the stored selected impact area sub-category, transmitting an impact metric selection output to the second computer system via the computer network, the impact metric selection output configured for causing an impact metric selection to be provided to the second computer system, wherein providing the impact metric selection includes causing the webpage having impact metric selections to be displayed via the display of the second computer system; receiving an impact metric selection input, the impact metric selection input having been transmitted from the second computer system to the first computer system via the computer network, the impact metric selection input comprising a selected impact metric and configured for storing the selected impact metric by the first computer system; processing an impact metric value, the impact metric value being processed by the first computer system, the processing of the impact metric value configured to assign an impact metric value to the impact metric and store the impact metric value; processing an impact metric weight, the impact metric weight being processed by the first computer system, the processing of the impact metric weight configured to assign an impact metric weight to the impact metric and store the impact metric weight; processing an impact metric possible point value, the impact metric possible point value being processed by the first computer system, the processing of the impact metric possible point value configured to assign an impact metric possible point value to the impact metric and to store the impact metric possible point value in association with the impact metric, wherein the impact metric possible point value is the product of the stored impact metric value and the impact metric weight; based upon the stored selected impact metrics, transmitting an impact metric score range selection output to the second computer system via the computer network, the impact metric score range selection output configured for causing an impact metric score range selection to be provided to the second computer system, wherein providing the impact metric score range selection includes causing the webpage having impact metric score range selections to be displayed via the display of the second computer system; receiving an impact metric score range selection input, the impact metric score range selection input having been transmitted from the second computer system to the first computer system via the computer network, the impact metric score range selection input comprising an impact metric score range for the impact metric and configured for storing the impact metric score range in association with the impact metric by the first computer system; based upon the stored impact metric score range, transmitting an impact metric score selection output to the second computer system via the computer network, the impact metric score selection output configured for causing an impact metric score selection to be provided to the second computer system, wherein providing the impact metric score selection includes causing the webpage having impact metric score selections to be displayed via the display of the second computer system; receiving an impact metric score selection input, the impact metric score selection input having been transmitted from the second computer system to the first computer system via the computer network, the impact metric score selection input comprising a selected impact metric score for the impact metric and configured for storing the selected impact metric score in association with the impact metric by the first computer system; processing an impact metric score rate, the impact metric score rate being processed by the first computer system, where the processing is configured to assign an impact metric score rate to the impact metric based upon the stored impact metric score and to store the impact metric score rate by the first computer system; processing an impact metric point value, the impact metric point value being processed by the first computer system, where the processing is configured to assign the impact metric with an impact metric point value by multiplying the stored impact metric score rate and the stored impact metric possible point value and to store the impact metric point value by the first computer system; processing an impact multiplier value, the impact multiplier value being processed by the first computer system, where the processing is configured to assign the impact multiplier value by dividing the impact metric point value by 100 and to store the impact multiplier value; based upon the stored selected KII, transmitting an impact goal output to the second computer system via the computer network, the impact goal output configured for causing an impact goal to be provided to the second computer system, wherein providing the impact goal includes causing the webpage having an impact goal corresponding to the stored selected KII to be displayed via the display of the second computer system; receiving an impact goal input, the impact goal input having been transmitted from the second computer system to the first computer system via the computer network, the impact goal input comprising the impact goal and configured for storing the impact goal in association with the stored selected KII by the first computer system; based upon the stored selected KII, transmitting a KII delivery output to the second computer system via the computer network, the KII delivery output configured for causing a KII delivery to be provided to the second computer system, wherein providing the KII delivery includes causing the webpage having a KII delivery corresponding to the stored selected KII to be displayed via the display of the second computer system; receiving a KIT delivery input, the KII delivery input having been transmitted from the second computer system to the first computer system via the computer network, the KII delivery input comprising the KII delivery and configured for storing the KII delivery in association with the stored selected KII by the first computer system; based upon the stored KII delivery and the stored impact goal, processing the impact quantity, the impact quantity being processed by the first computer system, where the processing is configured to assign the impact quantity of the activity by dividing the stored KII delivery by the stored impact goal and to store the impact quantity by the first computer system; transmitting a time period output to the second computer system via the computer network, the time period output configured for causing a time period entry to be provided to the second computer system, wherein providing the time period entry includes causing the webpage having a time period entry to be displayed via the display of the second computer system; receiving a time period input, the time period input having been transmitted from the second computer system to the first computer system via the computer network, the time period input comprising the time period and configured for storing the time period in years by the first computer system; transmitting an activity cost output to the second computer system via the computer network, the activity cost output configured for causing an activity cost entry to be provided to the second computer system, wherein providing the activity cost entry includes causing the webpage having an activity cost entry to be displayed via the display of the second computer system; receiving an activity cost input, the activity cost input having been transmitted from the second computer system to the first computer system via the computer network, the activity cost input comprising the activity cost and configured for storing the activity cost by the first computer system; based upon the stored activity cost and stored KII delivery, processing an impact efficiency, the impact efficiency being processed by the first computer system, where the processing is configured to assign the impact efficiency of the activity, and to store the impact efficiency by the first computer system; based upon the stored impact multiplier value, the stored KII delivery, the stored time period, the stored impact quantity, and the stored impact efficiency, processing the iRR, the iRR being processed by the first computer system, where the processing is configured to assign the iRR of the activity by and to store the iRR associated with the activity by the first computer system; based upon the stored iRR, transmitting an iRR output to the second computer system via the computer network, the iRR output configured for causing the stored iRR to be provided to the second computer system, wherein providing the stored iRR includes causing the webpage having the stored iRR to be displayed via the display of the second computer system.

In aspects, a method for quantitatively calculating the impact rate of return (iRR) of an activity via a computer network, the method including: receiving an iRR calculation input at a first computer system, the iRR calculation input having been transmitted via the computer network from a second computer system, the iRR calculation input comprising a request to begin calculation of the iRR, the first computer system being associated with a service provider, the second computer system being associated with a business entity; transmitting an impact theme selection output from the first computer system to the second computer system via the computer network, the impact theme selection output configured for causing the impact theme selection to be provided to the second computer system, wherein providing the impact theme selection includes causing a webpage having impact theme selections to be displayed via a display of the second computer system, the webpage being associated with a website of the service provider; receiving an impact theme selection input at the first computer system, the impact theme selection input having been transmitted from the second computer system to the first computer system via the computer network, the impact theme selection input comprising a selected impact theme and configured for storing the selected impact theme by the first computer system; based upon the stored selected impact theme, transmitting an impact area selection output to the second computer system via the computer network, the impact area selection output configured for causing the impact area selection to be provided to the second computer system, wherein providing the impact area selection includes causing the webpage having the impact area selections to be displayed via the display of the second computer system; receiving an impact area selection input, the impact area selection input having been transmitted from the second computer system to the first computer system via the computer network, the impact area selection input comprising a selected impact area and configured for storing the selected impact area by the first computer system; based upon the stored selected impact area, transmitting an impact area sub-category selection output to the second computer system via the computer network, the impact area sub-category selection output configured for causing the impact area sub-category selection to be provided to the second computer system, wherein providing the impact area sub-category selection includes causing the webpage having impact area sub-category selections to be displayed via the display of the second computer system; receiving an impact area sub-category selection input, the impact area sub-category selection input having been transmitted from the second computer system to the first computer system via the computer network, the impact area sub-category selection input comprising a selected impact area sub-category and configured for storing the selected impact area sub-category by the first computer system; based upon the stored selected impact area, transmitting a KII selection output to the second computer system via the computer network, the KII selection output configured for causing the KII selection to be provided to the second computer system, wherein providing the KII selection includes causing the webpage having KII selections to be displayed via the display of the second computer system; receiving a KII selection input, the KII selection input having been transmitted from the second computer system to the first computer system via the computer network, the KII selection input comprising a selected KII and configured for storing the selected KII by the first computer system; based upon the stored selected impact area sub-category, transmitting an impact metric selection output to the second computer system via the computer network, the impact metric selection output configured for causing an impact metric selection to be provided to the second computer system, wherein providing the impact metric selection includes causing the webpage having impact metric selections to be displayed via the display of the second computer system; receiving an impact metric selection input, the impact metric selection input having been transmitted from the second computer system to the first computer system via the computer network, the impact metric selection input comprising a selected impact metric and configured for storing the selected impact metric by the first computer system; processing an impact metric value, the impact metric value being processed by the first computer system, the processing of the impact metric value configured to assign an impact metric value to the impact metric and store the impact metric value; processing an impact metric weight, the impact metric weight being processed by the first computer system, the processing of the impact metric weight configured to assign an impact metric weight to the impact metric and store the impact metric weight; processing an impact metric possible point value, the impact metric possible point value being processed by the first computer system, the processing of the impact metric possible point value configured to assign an impact metric possible point value to the impact metric and to store the impact metric possible point value in association with the impact metric, wherein the impact metric possible point value is the product of the stored impact metric value and the impact metric weight; transmitting an impact metric score rate selection output to the second computer system via the computer network, the impact metric score rate selection output configured for causing an impact metric score rate selection to be provided to the second computer system, wherein providing the impact metric score rate selection includes causing the webpage having an impact metric score rate selection to be displayed by the second computer system; receiving an impact metric score rate selection input, the impact metric score rate selection input having been transmitted from the second computer system to the first computer system via the computer network, the impact metric score rate selection input comprising the selected impact metric score rate and configured for storing the selected impact metric score rate in association with the stored impact metric by the first computer system; based upon the stored selected impact metrics, transmitting an impact metric score range selection output to the second computer system via the computer network, the impact metric score range selection output configured for causing an impact metric score range selection to be provided to the second computer system, wherein providing the impact metric score range selection includes causing the webpage having impact metric score range selections to be displayed via the display of the second computer system; receiving an impact metric score range selection input, the impact metric score range selection input having been transmitted from the second computer system to the first computer system via the computer network, the impact metric score range selection input comprising an impact metric score range for the impact metric and configured for storing the impact metric score range in association with the impact metric by the first computer system; based upon the stored impact metric score range, transmitting an impact metric score selection output to the second computer system via the computer network, the impact metric score selection output configured for causing an impact metric score selection to be provided to the second computer system, wherein providing the impact metric score selection includes causing the webpage having impact metric score selections to be displayed via the display of the second computer system; receiving an impact metric score selection input, the impact metric score selection input having been transmitted from the second computer system to the first computer system via the computer network, the impact metric score selection input comprising a selected impact metric score for the impact metric and configured for storing the selected impact metric score in association with the impact metric by the first computer system; processing an impact metric score rate, the impact metric score rate being processed by the first computer system, where the processing is configured to assign an impact metric score rate to the impact metric based upon the stored impact metric score and to store the impact metric score rate by the first computer system; processing an impact metric point value, the impact metric point value being processed by the first computer system, where the processing is configured to assign the impact metric with an impact metric point value by multiplying the stored impact metric score rate and the stored impact metric possible point value and to store the impact metric point value by the first computer system; processing an impact multiplier value, the impact multiplier value being processed by the first computer system, where the processing is configured to assign the impact multiplier value by dividing the impact metric point value by 100 and to store the impact multiplier value; based upon the stored selected KII, transmitting an impact goal output to the second computer system via the computer network, the impact goal output configured for causing an impact goal to be provided to the second computer system, wherein providing the impact goal includes causing the webpage having an impact goal corresponding to the stored selected KII to be displayed via the display of the second computer system; receiving an impact goal input, the impact goal input having been transmitted from the second computer system to the first computer system via the computer network, the impact goal input comprising the impact goal and configured for storing the impact goal in association with the stored selected KII by the first computer system; based upon the stored selected KII, transmitting a KII delivery output to the second computer system via the computer network, the KII delivery output configured for causing a KII delivery to be provided to the second computer system, wherein providing the KII delivery includes causing the webpage having a KII delivery corresponding to the stored selected KII to be displayed via the display of the second computer system; receiving a KII delivery input, the KII delivery input having been transmitted from the second computer system to the first computer system via the computer network, the KII delivery input comprising the KII delivery and configured for storing the KII delivery in association with the stored selected KII by the first computer system; based upon the stored KII delivery and the stored impact goal, processing the impact quantity, the impact quantity being processed by the first computer system, where the processing is configured to assign the impact quantity of the activity by dividing the stored KII delivery by the stored impact goal and to store the impact quantity by the first computer system; transmitting a time period output to the second computer system via the computer network, the time period output configured for causing a time period entry to be provided to the second computer system, wherein providing the time period entry includes causing the webpage having a time period entry to be displayed via the display of the second computer system; receiving a time period input, the time period input having been transmitted from the second computer system to the first computer system via the computer network, the time period input comprising the time period and configured for storing the time period in years by the first computer system; transmitting an activity cost output to the second computer system via the computer network, the activity cost output configured for causing an activity cost entry to be provided to the second computer system, wherein providing the activity cost entry includes causing the webpage having an activity cost entry to be displayed via the display of the second computer system; receiving an activity cost input, the activity cost input having been transmitted from the second computer system to the first computer system via the computer network, the activity cost input comprising the activity cost and configured for storing the activity cost by the first computer system; based upon the stored activity cost and stored KII delivery, processing an impact efficiency, the impact efficiency being processed by the first computer system, where the processing is configured to assign the impact efficiency of the activity, and to store the impact efficiency by the first computer system; based upon the stored impact multiplier value, the stored KII delivery, the stored time period, the stored impact quantity, and the stored impact efficiency, processing the iRR, the iRR being processed by the first computer system, where the processing is configured to assign the iRR of the activity by and to store the iRR associated with the activity by the first computer system; based upon the stored iRR, transmitting an iRR output to the second computer system via the computer network, the iRR output configured for causing the stored iRR to be provided to the second computer system, wherein providing the stored iRR includes causing the webpage having the stored iRR to be displayed via the display of the second computer system.

In aspects, a method for quantitatively calculating the impact rate of return (iRR) of an activity via a computer network, the method including: receiving an iRR calculation input at a first computer system, the iRR calculation input having been transmitted via the computer network from a second computer system, the iRR calculation input comprising a request to begin calculation of the iRR, the first computer system being associated with a service provider, the second computer system being associated with a business entity; transmitting an impact theme selection output from the first computer system to the second computer system via the computer network, the impact theme selection output configured for causing the impact theme selection to be provided to the second computer system, wherein providing the impact theme selection includes causing a webpage having impact theme selections to be displayed via a display of the second computer system, the webpage being associated with a website of the service provider; receiving an impact theme selection input at the first computer system, the impact theme selection input having been transmitted from the second computer system to the first computer system via the computer network, the impact theme selection input comprising a selected impact theme and configured for storing the selected impact theme by the first computer system; based upon the stored selected impact theme, transmitting an impact area selection output to the second computer system via the computer network, the impact area selection output configured for causing the impact area selection to be provided to the second computer system, wherein providing the impact area selection includes causing the webpage having the impact area selections to be displayed via the display of the second computer system; receiving an impact area selection input, the impact area selection input having been transmitted from the second computer system to the first computer system via the computer network, the impact area selection input comprising a selected impact area and configured for storing the selected impact area by the first computer system; based upon the stored selected impact area, transmitting an impact area sub-category selection output to the second computer system via the computer network, the impact area sub-category selection output configured for causing the impact area sub-category selection to be provided to the second computer system, wherein providing the impact area sub-category selection includes causing the webpage having impact area sub-category selections to be displayed via the display of the second computer system; receiving an impact area sub-category selection input, the impact area sub-category selection input having been transmitted from the second computer system to the first computer system via the computer network, the impact area sub-category selection input comprising a selected impact area sub-category and configured for storing the selected impact area sub-category by the first computer system; based upon the stored selected impact area, transmitting a KII selection output to the second computer system via the computer network, the KII selection output configured for causing the KII selection to be provided to the second computer system, wherein providing the KII selection includes causing the webpage having KII selections to be displayed via the display of the second computer system; receiving a KII selection input, the KII selection input having been transmitted from the second computer system to the first computer system via the computer network, the KII selection input comprising a selected KII and configured for storing the selected KII by the first computer system; based upon the stored selected impact area sub-category, transmitting an impact metric selection output to the second computer system via the computer network, the impact metric selection output configured for causing an impact metric selection to be provided to the second computer system, wherein providing the impact metric selection includes causing the webpage having impact metric selections to be displayed via the display of the second computer system; receiving an impact metric selection input, the impact metric selection input having been transmitted from the second computer system to the first computer system via the computer network, the impact metric selection input comprising at least two selected impact metrics and configured for storing the selected at least two impact metrics by the first computer system; processing an impact metric value, the impact metric value being processed by the first computer system, the processing of the impact metric value configured to assign an impact metric value to each of the at least two impact metrics on a pro-rata basis and store the impact metric values in association with the respective impact metric of the at least two impact metrics; transmitting an impact metric sub-weight selection output to the second computer system via the computer network, the impact metric sub-weight selection output configured for causing an impact metric sub-weight selection to be provided to the second computer system, wherein providing the impact metric sub-weight selection includes causing the webpage having impact metric sub-weight selections to be displayed via the display of the second computer system; receiving an impact metric sub-weight selection input, the impact metric sub-weight selection input having been transmitted from the second computer system to the first computer system via the computer network, the impact metric sub-weight selection input comprising impact metric sub-weights for the at least two impact metrics and configured for storing the impact metric sub-weight in association with the respective impact metric of the at least two impact metrics by the first computer system; processing an impact metric possible point value, the impact metric possible point value being processed by the first computer system, the processing of the impact metric possible point value configured to assign an impact metric possible point value to each of the at least two impact metrics and to store the impact metric possible point values in association with the respective impact metric of the at least two impact metrics, wherein the impact metric possible point value is the product of the stored impact metric value and the impact metric weight; based upon the stored selected at least two impact metrics, transmitting an impact metric score range selection output to the second computer system via the computer network, the impact metric score range selection output configured for causing an impact metric score range selection to be provided to the second computer system, wherein providing the impact metric score range selection includes causing the webpage having impact metric score range selections to be displayed via the display of the second computer system; receiving an impact metric score range selection input, the impact metric score range selection input having been transmitted from the second computer system to the first computer system via the computer network, the impact metric score range selection input comprising an impact metric score range for each of the at least two impact metrics and configured for storing the impact metric score range in association with the respective impact metric of the at least two impact metrics by the first computer system; based upon the stored impact metric score range, transmitting an impact metric score selection output to the second computer system via the computer network, the impact metric score selection output configured for causing an impact metric score selection to be provided to the second computer system, wherein providing the impact metric score selection includes causing the webpage having impact metric score selections to be displayed via the display of the second computer system; receiving an impact metric score selection input, the impact metric score selection input having been transmitted from the second computer system to the first computer system via the computer network, the impact metric score selection input comprising a selected impact metric score for each of the at least two impact metrics and configured for storing the selected impact metric scores in association with the respective impact metric of the at least two impact metrics by the first computer system; processing an impact metric score rate, the impact metric score rate being processed by the first computer system, where the processing is configured to assign an impact metric score rate to each of the at least two impact metrics based upon the stored impact metric score and to store the impact metric score rate in association with the respective impact metric of the at least two impact metrics by the first computer system; processing an impact metric point value, the impact metric point value being processed by the first computer system, where the processing is configured to assign each of the at least two impact metrics with an impact metric point sub-value by multiplying the stored impact metric score rate and the stored impact metric possible point value and to store the impact metric point sub-value in association with the respective impact metric of the at least two impact metrics by the first computer system; processing an impact multiplier value, the impact multiplier value being processed by the first computer system, where the processing is configured to assign the impact multiplier value by dividing the summed impact metric point sub-values by 100 and to store the impact multiplier value; based upon the stored selected KII, transmitting an impact goal output to the second computer system via the computer network, the impact goal output configured for causing an impact goal to be provided to the second computer system, wherein providing the impact goal includes causing the webpage having an impact goal corresponding to the stored selected KII to be displayed via the display of the second computer system; receiving an impact goal input, the impact goal input having been transmitted from the second computer system to the first computer system via the computer network, the impact goal input comprising the impact goal and configured for storing the impact goal in association with the stored selected KII by the first computer system; based upon the stored selected KII, transmitting a KII delivery output to the second computer system via the computer network, the KII delivery output configured for causing a KII delivery to be provided to the second computer system, wherein providing the KII delivery includes causing the webpage having a KII delivery corresponding to the stored selected KII to be displayed via the display of the second computer system; receiving a KII delivery input, the KII delivery input having been transmitted from the second computer system to the first computer system via the computer network, the KII delivery input comprising the KII delivery and configured for storing the KII delivery in association with the stored selected KII by the first computer system; based upon the stored KII delivery and the stored impact goal, processing the impact quantity, the impact quantity being processed by the first computer system, where the processing is configured to assign the impact quantity of the activity by dividing the stored KII delivery by the stored impact goal and to store the impact quantity by the first computer system; transmitting a time period output to the second computer system via the computer network, the time period output configured for causing a time period entry to be provided to the second computer system, wherein providing the time period entry includes causing the webpage having a time period entry to be displayed via the display of the second computer system; receiving a time period input, the time period input having been transmitted from the second computer system to the first computer system via the computer network, the time period input comprising the time period and configured for storing the time period in years by the first computer system; transmitting an activity cost output to the second computer system via the computer network, the activity cost output configured for causing an activity cost entry to be provided to the second computer system, wherein providing the activity cost entry includes causing the webpage having an activity cost entry to be displayed via the display of the second computer system; receiving an activity cost input, the activity cost input having been transmitted from the second computer system to the first computer system via the computer network, the activity cost input comprising the activity cost and configured for storing the activity cost by the first computer system; based upon the stored activity cost and stored KII delivery, processing an impact efficiency, the impact efficiency being processed by the first computer system, where the processing is configured to assign the impact efficiency of the activity, and to store the impact efficiency by the first computer system; based upon the stored impact multiplier value, the stored KII delivery, the stored time period, the stored impact quantity, and the stored impact efficiency, processing the iRR, the iRR being processed by the first computer system, where the processing is configured to assign the iRR of the activity by and to store the iRR associated with the activity by the first computer system; based upon the stored iRR, transmitting an iRR output to the second computer system via the computer network, the iRR output configured for causing the stored iRR to be provided to the second computer system, wherein providing the stored iRR includes causing the webpage having the stored iRR to be displayed via the display of the second computer system.

In aspects, a method for quantitatively calculating the impact rate of return (iRR) of an activity via a computer network, the method including: receiving an iRR calculation input at a first computer system, the iRR calculation input having been transmitted via the computer network from a second computer system, the iRR calculation input comprising a request to begin calculation of the iRR and account login information, the first computer system being associated with a service provider, the second computer system being associated with a business entity; based upon validating the account login information, transmitting an impact theme selection output from the first computer system to the second computer system via the computer network, the impact theme selection output configured for causing the impact theme selection to be provided to the second computer system, wherein providing the impact theme selection includes causing a webpage having impact theme selections and an activity name entry to be displayed via a display of the second computer system, the webpage being associated with a website of the service provider; receiving an impact theme selection input at the first computer system, the impact theme selection input having been transmitted from the second computer system to the first computer system via the computer network, the impact theme selection input comprising a selected impact theme and activity name and configured for storing the selected impact theme and activity name by the first computer system; based upon the stored selected impact theme, transmitting an impact area selection output to the second computer system via the computer network, the impact area selection output configured for causing the impact area selection to be provided to the second computer system, wherein providing the impact area selection includes causing the webpage having the impact area selections to be displayed via the display of the second computer system; receiving an impact area selection input, the impact area selection input having been transmitted from the second computer system to the first computer system via the computer network, the impact area selection input comprising a selected impact area and configured for storing the selected impact area by the first computer system; based upon the stored selected impact area, transmitting an impact area sub-category selection output to the second computer system via the computer network, the impact area sub-category selection output configured for causing the impact area sub-category selection to be provided to the second computer system, wherein providing the impact area sub-category selection includes causing the webpage having impact area sub-category selections to be displayed via the display of the second computer system; receiving an impact area sub-category selection input, the impact area sub-category selection input having been transmitted from the second computer system to the first computer system via the computer network, the impact area sub-category selection input comprising a selected impact area sub-category and configured for storing the selected impact area sub-category by the first computer system; based upon the stored selected impact area, transmitting a KII selection output to the second computer system via the computer network, the KII selection output configured for causing the KIT selection to be provided to the second computer system, wherein providing the KII selection includes causing the webpage having KII selections to be displayed via the display of the second computer system; receiving a KII selection input, the KII selection input having been transmitted from the second computer system to the first computer system via the computer network, the KII selection input comprising a selected KII and configured for storing the selected KII by the first computer system; based upon the stored selected impact area sub-category, transmitting an impact metric selection output to the second computer system via the computer network, the impact metric selection output configured for causing an impact metric selection to be provided to the second computer system, wherein providing the impact metric selection includes causing the webpage having impact metric selections to be displayed via the display of the second computer system; receiving an impact metric selection input, the impact metric selection input having been transmitted from the second computer system to the first computer system via the computer network, the impact metric selection input comprising a selected impact metric and configured for storing the selected impact metric by the first computer system; processing an impact metric value, the impact metric value being processed by the first computer system, the processing of the impact metric value configured to assign an impact metric value to the impact metric and store the impact metric value; processing an impact metric weight, the impact metric weight being processed by the first computer system, the processing of the impact metric weight configured to assign an impact metric weight to the impact metric and store the impact metric weight; processing an impact metric possible point value, the impact metric possible point value being processed by the first computer system, the processing of the impact metric possible point value configured to assign an impact metric possible point value to the impact metric and to store the impact metric possible point value in association with the impact metric, wherein the impact metric possible point value is the product of the stored impact metric value and the impact metric weight; based upon the stored selected impact metrics, transmitting an impact metric score range selection output to the second computer system via the computer network, the impact metric score range selection output configured for causing an impact metric score range selection to be provided to the second computer system, wherein providing the impact metric score range selection includes causing the webpage having impact metric score range selections to be displayed via the display of the second computer system; receiving an impact metric score range selection input, the impact metric score range selection input having been transmitted from the second computer system to the first computer system via the computer network, the impact metric score range selection input comprising an impact metric score range for the impact metric and configured for storing the impact metric score range in association with the impact metric by the first computer system; based upon the stored impact metric score range, transmitting an impact metric score selection output to the second computer system via the computer network, the impact metric score selection output configured for causing an impact metric score selection to be provided to the second computer system, wherein providing the impact metric score selection includes causing the webpage having impact metric score selections to be displayed via the display of the second computer system; receiving an impact metric score selection input, the impact metric score selection input having been transmitted from the second computer system to the first computer system via the computer network, the impact metric score selection input comprising a selected impact metric score for the impact metric and configured for storing the selected impact metric score in association with the impact metric by the first computer system; processing an impact metric score rate, the impact metric score rate being processed by the first computer system, where the processing is configured to assign an impact metric score rate to the impact metric based upon the stored impact metric score and to store the impact metric score rate by the first computer system; processing an impact metric point value, the impact metric point value being processed by the first computer system, where the processing is configured to assign the impact metric with an impact metric point value by multiplying the stored impact metric score rate and the stored impact metric possible point value and to store the impact metric point value by the first computer system; processing an impact multiplier value, the impact multiplier value being processed by the first computer system, where the processing is configured to assign the impact multiplier value by dividing the impact metric point value by 100 and to store the impact multiplier value; based upon the stored selected KII, transmitting an impact goal output to the second computer system via the computer network, the impact goal output configured for causing an impact goal to be provided to the second computer system, wherein providing the impact goal includes causing the webpage having an impact goal corresponding to the stored selected KII to be displayed via the display of the second computer system; receiving an impact goal input, the impact goal input having been transmitted from the second computer system to the first computer system via the computer network, the impact goal input comprising the impact goal and configured for storing the impact goal in association with the stored selected KII by the first computer system; based upon the stored selected KII, transmitting a KII delivery output to the second computer system via the computer network, the KII delivery output configured for causing a KII delivery to be provided to the second computer system, wherein providing the KII delivery includes causing the webpage having a KII delivery corresponding to the stored selected KII to be displayed via the display of the second computer system; receiving a KII delivery input, the KII delivery input having been transmitted from the second computer system to the first computer system via the computer network, the KII delivery input comprising the KII delivery and configured for storing the KII delivery in association with the stored selected KII by the first computer system; based upon the stored KII delivery and the stored impact goal, processing the impact quantity, the impact quantity being processed by the first computer system, where the processing is configured to assign the impact quantity of the activity by dividing the stored KII delivery by the stored impact goal and to store the impact quantity by the first computer system; transmitting a time period output to the second computer system via the computer network, the time period output configured for causing a time period entry to be provided to the second computer system, wherein providing the time period entry includes causing the webpage having a time period entry to be displayed via the display of the second computer system; receiving a time period input, the time period input having been transmitted from the second computer system to the first computer system via the computer network, the time period input comprising the time period and configured for storing the time period in years by the first computer system; transmitting an activity cost output to the second computer system via the computer network, the activity cost output configured for causing an activity cost entry to be provided to the second computer system, wherein providing the activity cost entry includes causing the webpage having an activity cost entry to be displayed via the display of the second computer system; receiving an activity cost input, the activity cost input having been transmitted from the second computer system to the first computer system via the computer network, the activity cost input comprising the activity cost and configured for storing the activity cost by the first computer system; based upon the stored activity cost and stored KII delivery, processing an impact efficiency, the impact efficiency being processed by the first computer system, where the processing is configured to assign the impact efficiency of the activity, and to store the impact efficiency by the first computer system; based upon the stored impact multiplier value, the stored KII delivery, the stored time period, the stored impact quantity, and the stored impact efficiency, processing the iRR, the iRR being processed by the first computer system, where the processing is configured to assign the iRR of the activity by and to store the iRR associated with the activity by the first computer system; transmitting a multi-time period output to the second computer system via the computer network, the multi-time period output configured for causing a selection to determine the iRR calculation over a multi-time-period to be provided to the second computer system, wherein providing the multi-time-period output includes causing the webpage having the multi-time period iRR calculation selection to be displayed via the display of the second computer system; receiving a multi-time-period input, the multi-time-period input having been transmitted from the second computer system to the first computer system via the computer network, the multi-time period input comprising an affirmative multi-time-period iRR calculation selection and configured for storing the affirmative multi-time-period iRR calculation in association with the stored iRR; receiving a continued iRR calculation input, the continued iRR calculation having been transmitted from the second computer system to the first computer system via the computer network, the continued iRR calculation input comprising the account login information and a request to continue the iRR calculation and configured for validating the account login information and beginning a continued iRR calculation at the transmitting the impact metric score selection output.

In aspects, a method for quantitatively calculating the impact rate of return (iRR) of an activity via a computer network, the method including: receiving an iRR calculation input at a first computer system, the iRR calculation input having been transmitted via the computer network from a second computer system, the iRR calculation input comprising a request to begin calculation of the iRR and account login information, the first computer system being associated with a service provider, the second computer system being associated with a business entity; based upon validating the account login information, transmitting an impact theme selection output from the first computer system to the second computer system via the computer network, the impact theme selection output configured for causing the impact theme selection to be provided to the second computer system, wherein providing the impact theme selection includes causing a webpage having impact theme selections and an activity name entry to be displayed via a display of the second computer system, the webpage being associated with a website of the service provider; receiving an impact theme selection input at the first computer system, the impact theme selection input having been transmitted from the second computer system to the first computer system via the computer network, the impact theme selection input comprising a selected impact theme and activity name and configured for storing the selected impact theme and activity name by the first computer system; based upon the stored selected impact theme, transmitting an impact area selection output to the second computer system via the computer network, the impact area selection output configured for causing the impact area selection to be provided to the second computer system, wherein providing the impact area selection includes causing the webpage having the impact area selections to be displayed via the display of the second computer system; receiving an impact area selection input, the impact area selection input having been transmitted from the second computer system to the first computer system via the computer network, the impact area selection input comprising a selected impact area and configured for storing the selected impact area by the first computer system; based upon the stored selected impact area, transmitting an impact area sub-category selection output to the second computer system via the computer network, the impact area sub-category selection output configured for causing the impact area sub-category selection to be provided to the second computer system, wherein providing the impact area sub-category selection includes causing the webpage having impact area sub-category selections to be displayed via the display of the second computer system; receiving an impact area sub-category selection input, the impact area sub-category selection input having been transmitted from the second computer system to the first computer system via the computer network, the impact area sub-category selection input comprising a selected impact area sub-category and configured for storing the selected impact area sub-category by the first computer system; based upon the stored selected impact area, transmitting a KII selection output to the second computer system via the computer network, the KII selection output configured for causing the KIT selection to be provided to the second computer system, wherein providing the KII selection includes causing the webpage having KII selections to be displayed via the display of the second computer system; receiving a KII selection input, the KII selection input having been transmitted from the second computer system to the first computer system via the computer network, the KII selection input comprising a selected KII and configured for storing the selected KII by the first computer system; based upon the stored selected impact area sub-category, transmitting an impact metric selection output to the second computer system via the computer network, the impact metric selection output configured for causing an impact metric selection to be provided to the second computer system, wherein providing the impact metric selection includes causing the webpage having impact metric selections to be displayed via the display of the second computer system; receiving an impact metric selection input, the impact metric selection input having been transmitted from the second computer system to the first computer system via the computer network, the impact metric selection input comprising a selected impact metric and configured for storing the selected impact metric by the first computer system; processing an impact metric value, the impact metric value being processed by the first computer system, the processing of the impact metric value configured to assign an impact metric value to the impact metric and store the impact metric value; processing an impact metric weight, the impact metric weight being processed by the first computer system, the processing of the impact metric weight configured to assign an impact metric weight to the impact metric and store the impact metric weight; processing an impact metric possible point value, the impact metric possible point value being processed by the first computer system, the processing of the impact metric possible point value configured to assign an impact metric possible point value to the impact metric and to store the impact metric possible point value in association with the impact metric, wherein the impact metric possible point value is the product of the stored impact metric value and the impact metric weight; based upon the stored selected impact metrics, transmitting an impact metric score range selection output to the second computer system via the computer network, the impact metric score range selection output configured for causing an impact metric score range selection to be provided to the second computer system, wherein providing the impact metric score range selection includes causing the webpage having impact metric score range selections to be displayed via the display of the second computer system; receiving an impact metric score range selection input, the impact metric score range selection input having been transmitted from the second computer system to the first computer system via the computer network, the impact metric score range selection input comprising an impact metric score range for the impact metric and configured for storing the impact metric score range in association with the impact metric by the first computer system; based upon the stored impact metric score range, transmitting an impact metric score selection output to the second computer system via the computer network, the impact metric score selection output configured for causing an impact metric score selection to be provided to the second computer system, wherein providing the impact metric score selection includes causing the webpage having impact metric score selections to be displayed via the display of the second computer system; receiving an impact metric score selection input, the impact metric score selection input having been transmitted from the second computer system to the first computer system via the computer network, the impact metric score selection input comprising a selected impact metric score for the impact metric and configured for storing the selected impact metric score in association with the impact metric by the first computer system; processing an impact metric score rate, the impact metric score rate being processed by the first computer system, where the processing is configured to assign an impact metric score rate to the impact metric based upon the stored impact metric score and to store the impact metric score rate by the first computer system; processing an impact metric point value, the impact metric point value being processed by the first computer system, where the processing is configured to assign the impact metric with an impact metric point value by multiplying the stored impact metric score rate and the stored impact metric possible point value and to store the impact metric point value by the first computer system; processing an impact multiplier value, the impact multiplier value being processed by the first computer system, where the processing is configured to assign the impact multiplier value by dividing the impact metric point value by 100 and to store the impact multiplier value; based upon the stored selected KII, transmitting an impact goal output to the second computer system via the computer network, the impact goal output configured for causing an impact goal to be provided to the second computer system, wherein providing the impact goal includes causing the webpage having an impact goal corresponding to the stored selected KII to be displayed via the display of the second computer system; receiving an impact goal input, the impact goal input having been transmitted from the second computer system to the first computer system via the computer network, the impact goal input comprising the impact goal and configured for storing the impact goal in association with the stored selected KII by the first computer system; based upon the stored selected KII, transmitting a KII delivery output to the second computer system via the computer network, the KII delivery output configured for causing a KII delivery to be provided to the second computer system, wherein providing the KII delivery includes causing the webpage having a KII delivery corresponding to the stored selected KII to be displayed via the display of the second computer system; receiving a KII delivery input, the KII delivery input having been transmitted from the second computer system to the first computer system via the computer network, the KII delivery input comprising the KII delivery and configured for storing the KII delivery in association with the stored selected KII by the first computer system; based upon the stored KII delivery and the stored impact goal, processing the impact quantity, the impact quantity being processed by the first computer system, where the processing is configured to assign the impact quantity of the activity by dividing the stored KII delivery by the stored impact goal and to store the impact quantity by the first computer system; transmitting a time period output to the second computer system via the computer network, the time period output configured for causing a time period entry to be provided to the second computer system, wherein providing the time period entry includes causing the webpage having a time period entry to be displayed via the display of the second computer system; receiving a time period input, the time period input having been transmitted from the second computer system to the first computer system via the computer network, the time period input comprising the time period and configured for storing the time period in years by the first computer system; transmitting an activity cost output to the second computer system via the computer network, the activity cost output configured for causing an activity cost entry to be provided to the second computer system, wherein providing the activity cost entry includes causing the webpage having an activity cost entry to be displayed via the display of the second computer system; receiving an activity cost input, the activity cost input having been transmitted from the second computer system to the first computer system via the computer network, the activity cost input comprising the activity cost and configured for storing the activity cost by the first computer system; based upon the stored activity cost and stored KII delivery, processing an impact efficiency, the impact efficiency being processed by the first computer system, where the processing is configured to assign the impact efficiency of the activity, and to store the impact efficiency by the first computer system; based upon the stored impact multiplier value, the stored KII delivery, the stored time period, the stored impact quantity, and the stored impact efficiency, processing the iRR for an associated time period, the iRR being processed by the first computer system, where the processing is configured to assign the iRR of the activity by and to store the iRR associated with the activity with the associated time period by the first computer system; transmitting an iRR and multi-time-period output to the second computer system via the computer network, the iRR and multi-time-period output configured for causing the iRR and a selection to determine the iRR calculation over a multi-time period to be provided to the second computer system, wherein providing the iRR and multi-time-period output includes causing the webpage having the iRR and multi-time-period iRR calculation selection to be displayed via the display of the second computer system; receiving a multi-time-period request input, the multi-time-period request input having been transmitted from the second computer system to the first computer system via the computer network, the multi-time-period request input comprising an affirmative multi-time-period request and configured for storing the affirmative multi-time-period request in association with the stored iRR as a multi-time-period iRR; receiving a continued iRR calculation input, the continued iRR calculation input having been transmitted from the second computer system to the first computer system via the computer network, the continued iRR calculation input comprising the account login information and a request to continue the iRR calculation and configured for validating the account login information and beginning a continued iRR calculation at the transmitting the impact metric score selection output.

In aspects, a method for quantitatively calculating the impact rate of return (iRR) of an activity via a computer network, the method including: receiving an iRR calculation input at a first computer system, the iRR calculation input having been transmitted via the computer network from a second computer system, the iRR calculation input comprising a request to begin calculation of the iRR, the first computer system being associated with a service provider, the second computer system being associated with a business entity; transmitting an impact theme selection output from the first computer system to the second computer system via the computer network, the impact theme selection output configured for causing the impact theme selection to be provided to the second computer system, wherein providing the impact theme selection includes causing a webpage having impact theme selections to be displayed via a display of the second computer system, the webpage being associated with a website of the service provider; receiving an impact theme selection input at the first computer system, the impact theme selection input having been transmitted from the second computer system to the first computer system via the computer network, the impact theme selection input comprising a selected impact theme and configured for storing the selected impact theme by the first computer system; based upon the stored selected impact theme, transmitting an impact area selection output to the second computer system via the computer network, the impact area selection output configured for causing the impact area selection to be provided to the second computer system, wherein providing the impact area selection includes causing the webpage having the impact area selections to be displayed via the display of the second computer system; receiving an impact area selection input, the impact area selection input having been transmitted from the second computer system to the first computer system via the computer network, the impact area selection input comprising a selected impact area and configured for storing the selected impact area by the first computer system; based upon the stored selected impact area, transmitting an impact area sub-category selection output to the second computer system via the computer network, the impact area sub-category selection output configured for causing the impact area sub-category selection to be provided to the second computer system, wherein providing the impact area sub-category selection includes causing the webpage having impact area sub-category selections to be displayed via the display of the second computer system; receiving an impact area sub-category selection input, the impact area sub-category selection input having been transmitted from the second computer system to the first computer system via the computer network, the impact area sub-category selection input comprising a selected impact area sub-category and configured for storing the selected impact area sub-category by the first computer system; based upon the stored selected impact area, transmitting a KII selection output to the second computer system via the computer network, the KII selection output configured for causing the KII selection to be provided to the second computer system, wherein providing the KII selection includes causing the webpage having KII selections to be displayed via the display of the second computer system; receiving a KII selection input, the KII selection input having been transmitted from the second computer system to the first computer system via the computer network, the KII selection input comprising a selected KII and configured for storing the selected KII by the first computer system; based upon the stored selected impact area sub-category, transmitting an impact metric selection output to the second computer system via the computer network, the impact metric selection output configured for causing an impact metric selection to be provided to the second computer system, wherein providing the impact metric selection includes causing the webpage having impact metric selections to be displayed via the display of the second computer system; receiving an impact metric selection input, the impact metric selection input having been transmitted from the second computer system to the first computer system via the computer network, the impact metric selection input comprising a selected impact metric and configured for storing the selected impact metric by the first computer system; processing an impact metric value, the impact metric value being processed by the first computer system, the processing of the impact metric value configured to assign an impact metric value to the impact metric and store the impact metric value; processing an impact metric weight, the impact metric weight being processed by the first computer system, the processing of the impact metric weight configured to assign an impact metric weight to the impact metric and store the impact metric weight; processing an impact metric possible point value, the impact metric possible point value being processed by the first computer system, the processing of the impact metric possible point value configured to assign an impact metric possible point value to the impact metric and to store the impact metric possible point value in association with the impact metric, wherein the impact metric possible point value is the product of the stored impact metric value and the impact metric weight; based upon the stored selected impact metrics, transmitting an impact metric score range selection output to the second computer system via the computer network, the impact metric score range selection output configured for causing an impact metric score range selection to be provided to the second computer system, wherein providing the impact metric score range selection includes causing the webpage having impact metric score range selections to be displayed via the display of the second computer system; receiving an impact metric score range selection input, the impact metric score range selection input having been transmitted from the second computer system to the first computer system via the computer network, the impact metric score range selection input comprising an impact metric score range for the impact metric and configured for storing the impact metric score range in association with the impact metric by the first computer system; based upon the stored impact metric score range selection input, transmitting an impact metric score determination output to the second computer system via the computer network, the impact metric score determination output configured for causing an impact metric score determination to be provided to the second computer system, wherein providing the impact metric score determination includes causing the webpage having an impact metric score determination selection and information entry to be displayed via the display of the second computer system; receiving an impact metric score determination input, the impact metric score determination input having been transmitted from the second computer system to the first computer system via the computer network, the impact metric score range selection input comprising an affirmative impact metric score determination selection and the information entry of a third party and configured for storing the affirmative impact metric score determination selection and the information entry in association with the impact metric by the first computer system; based the stored affirmative impact metric score determination, transmitting an impact metric score selection output to a third computer system via the computer network, the impact metric score selection output configured for causing an impact metric score selection to be provided to the third computer system, wherein providing the impact metric score selection includes causing the webpage having impact metric score selections to be displayed via the display of the third computer system, the third computer system associated with a third party; receiving an impact metric score selection input, the impact metric score selection input having been transmitted from the third computer system to the first computer system via the computer network, the impact metric score selection input comprising a selected impact metric score for the impact metric and configured for storing the selected impact metric score in association with the impact metric by the first computer system; processing an impact metric score selection value, the impact metric score selection value being processed by the first computer system, where the processing is configured to assign the impact metric score selection to the impact metric and to store the impact metric score selection in association with the impact metric; processing an impact metric score rate, the impact metric score rate being processed by the first computer system, where the processing is configured to assign an impact metric score rate to the impact metric based upon the stored impact metric score and to store the impact metric score rate by the first computer system; processing an impact metric point value, the impact metric point value being processed by the first computer system, where the processing is configured to assign the impact metric with an impact metric point value by multiplying the stored impact metric score rate and the stored impact metric possible point value and to store the impact metric point value by the first computer system; processing an impact multiplier value, the impact multiplier value being processed by the first computer system, where the processing is configured to assign the impact multiplier value by dividing the impact metric point value by 100 and to store the impact multiplier value; based upon the stored selected KII, transmitting an impact goal output to the second computer system via the computer network, the impact goal output configured for causing an impact goal to be provided to the second computer system, wherein providing the impact goal includes causing the webpage having an impact goal corresponding to the stored selected KII to be displayed via the display of the second computer system; receiving an impact goal input, the impact goal input having been transmitted from the second computer system to the first computer system via the computer network, the impact goal input comprising the impact goal and configured for storing the impact goal in association with the stored selected KII by the first computer system; based upon the stored selected KII, transmitting a KII delivery output to the second computer system via the computer network, the KII delivery output configured for causing a KII delivery to be provided to the second computer system, wherein providing the KII delivery includes causing the webpage having a KII delivery corresponding to the stored selected KII to be displayed via the display of the second computer system; receiving a KII delivery input, the KII delivery input having been transmitted from the second computer system to the first computer system via the computer network, the KII delivery input comprising the KII delivery and configured for storing the KII delivery in association with the stored selected KII by the first computer system; based upon the stored KII delivery and the stored impact goal, processing the impact quantity, the impact quantity being processed by the first computer system, where the processing is configured to assign the impact quantity of the activity by dividing the stored KII delivery by the stored impact goal and to store the impact quantity by the first computer system; transmitting a time period output to the second computer system via the computer network, the time period output configured for causing a time period entry to be provided to the second computer system, wherein providing the time period entry includes causing the webpage having a time period entry to be displayed via the display of the second computer system; receiving a time period input, the time period input having been transmitted from the second computer system to the first computer system via the computer network, the time period input comprising the time period and configured for storing the time period in years by the first computer system; transmitting an activity cost output to the second computer system via the computer network, the activity cost output configured for causing an activity cost entry to be provided to the second computer system, wherein providing the activity cost entry includes causing the webpage having an activity cost entry to be displayed via the display of the second computer system; receiving an activity cost input, the activity cost input having been transmitted from the second computer system to the first computer system via the computer network, the activity cost input comprising the activity cost and configured for storing the activity cost by the first computer system; based upon the stored activity cost and stored KII delivery, processing an impact efficiency, the impact efficiency being processed by the first computer system, where the processing is configured to assign the impact efficiency of the activity, and to store the impact efficiency by the first computer system; based upon the stored impact multiplier value, the stored KII delivery, the stored time period, the stored impact quantity, and the stored impact efficiency, processing the iRR, the iRR being processed by the first computer system, where the processing is configured to assign the iRR of the activity by and to store the iRR associated with the activity by the first computer system; based upon the stored iRR, transmitting an iRR output to the second computer system via the computer network, the iRR output configured for causing the stored iRR to be provided to the second computer system, wherein providing the stored iRR includes causing the webpage having the stored iRR to be displayed via the display of the second computer system.

A method for quantitatively calculating the impact rate of return (iRR) of an activity via a computer network, the method comprising: receiving an iRR calculation input at a first computer system, the iRR calculation input having been transmitted via the computer network from a second computer system, the iRR calculation input comprising a request to begin calculation of the iRR, the first computer system being associated with a service provider, the second computer system being associated with a business entity; transmitting an impact theme selection output from the first computer system to the second computer system via the computer network, the impact theme selection output configured for causing the impact theme selection to be provided to the second computer system, wherein

providing the impact theme selection includes causing a webpage having impact theme selections to be displayed via a display of the second computer system, the webpage being associated with a website of the service provider; receiving an impact theme selection input at the first computer system, the impact theme selection input having been transmitted from the second computer system to the first computer system via the computer network, the impact theme selection input comprising a selected impact theme and configured for storing the selected impact theme by the first computer system; based upon the stored selected impact theme, transmitting an impact area selection output to the second computer system via the computer network, the impact area selection output configured for causing the impact area selection to be provided to the second computer system, wherein providing the impact area selection includes causing the webpage having the impact area selections to be displayed via the display of the second computer system; receiving an impact area selection input, the impact area selection input having been transmitted from the second computer system to the first computer system via the computer network, the impact area selection input comprising a selected impact area and configured for storing the selected impact area by the first computer system; based upon the stored selected impact area, transmitting an impact area sub-category selection output to the second computer system via the computer network, the impact area sub-category selection output configured for causing the impact area sub-category selection to be provided to the second computer system, wherein providing the impact area sub-category selection includes causing the webpage having impact area sub-category selections to be displayed via the display of the second computer system; receiving an impact area sub-category selection input, the impact area sub-category selection input having been transmitted from the second computer system to the first computer system via the computer network, the impact area sub-category selection input comprising a selected impact area sub-category and configured for storing the selected impact area sub-category by the first computer system; based upon the stored selected impact area, transmitting a KII selection output to the second computer system via the computer network, the KII selection output configured for causing the KII selection to be provided to the second computer system, wherein providing the KII selection includes causing the webpage having KII selections to be displayed via the display of the second computer system; receiving a KII selection input, the KIT selection input having been transmitted from the second computer system to the first computer system via the computer network, the KII selection input comprising a selected KII and configured for storing the selected KII by the first computer system; based upon the stored selected impact area sub-category, transmitting an impact metric selection output to the second computer system via the computer network, the impact metric selection output configured for causing an impact metric selection to be provided to the second computer system, wherein providing the impact metric selection includes causing the webpage having impact metric selections to be displayed via the display of the second computer system; receiving an impact metric selection input, the impact metric selection input having been transmitted from the second computer system to the first computer system via the computer network, the impact metric selection input comprising a selected impact metric and configured for storing the selected impact metric by the first computer system; processing an impact metric value, the impact metric value being processed by the first computer system, the processing of the impact metric value configured to assign an impact metric value to the impact metric and store the impact metric value; transmitting a survey request output to the second computer system via the computer network, the survey request output configured for causing a survey request selection and an information entry to be provided to the second computer system, wherein providing the survey request includes causing the webpage having the survey request selection and the information entry to be displayed via the display of the second computer system; receiving a survey request input, the survey request input having been transmitted from the second computer system to the first computer system via the computer network, the survey request input comprising an affirmative survey request and the information entry associated with a third party and configured for storing the survey request input by the first computer system; based upon the stored survey request input, transmitting a third party survey output to a third computer system via the computer network, the third party survey output configured for causing an impact metric weight entry to be provided to the third computer system, wherein providing the third party survey request includes causing the webpage having the impact metric weight entry to be displayed via the display of the third computer system, the third computer system associated with a third party; receiving a third party survey input, the third party survey input having been transmitted from the third computer system to the first computer system via the computer network, the third party survey input comprising an impact metric weight and configured for storing the impact metric weight in association with the impact metric by the first computer system; processing an impact metric possible point value, the impact metric possible point value being processed by the first computer system, the processing of the impact metric possible point value configured to assign an impact metric possible point value to the impact metric and to store the impact metric possible point value in association with the impact metric, wherein the impact metric possible point value is the product of the stored impact metric value and the impact metric weight; based upon the stored selected impact metrics, transmitting an impact metric score range selection output to the second computer system via the computer network, the impact metric score range selection output configured for causing an impact metric score range selection to be provided to the second computer system, wherein providing the impact metric score range selection includes causing the webpage having impact metric score range selections to be displayed via the display of the second computer system; receiving an impact metric score range selection input, the impact metric score range selection input having been transmitted from the second computer system to the first computer system via the computer network, the impact metric score range selection input comprising an impact metric score range for the impact metric and configured for storing the impact metric score range in association with the impact metric by the first computer system; based upon the stored impact metric score range, transmitting an impact metric score selection output to the second computer system via the computer network, the impact metric score selection output configured for causing an impact metric score selection to be provided to the second computer system, wherein providing the impact metric score selection includes causing the webpage having impact metric score selections to be displayed via the display of the second computer system; receiving an impact metric score selection input, the impact metric score selection input having been transmitted from the second computer system to the first computer system via the computer network, the impact metric score selection input comprising a selected impact metric score for the impact metric and configured for storing the selected impact metric score in association with the impact metric by the first computer system; processing an impact metric score rate, the impact metric score rate being processed by the first computer system, where the processing is configured to assign an impact metric score rate to the impact metric based upon the stored impact metric score and to store the impact metric score rate by the first computer system; processing an impact metric point value, the impact metric point value being processed by the first computer system, where the processing is configured to assign the impact metric with an impact metric point value by multiplying the stored impact metric score rate and the stored impact metric possible point value and to store the impact metric point value by the first computer system; processing an impact multiplier value, the impact multiplier value being processed by the first computer system, where the processing is configured to assign the impact multiplier value by dividing the impact metric point value by 100 and to store the impact multiplier value; based upon the stored selected KII, transmitting an impact goal output to the second computer system via the computer network, the impact goal output configured for causing an impact goal to be provided to the second computer system, wherein providing the impact goal includes causing the webpage having an impact goal corresponding to the stored selected KII to be displayed via the display of the second computer system; receiving an impact goal input, the impact goal input having been transmitted from the second computer system to the first computer system via the computer network, the impact goal input comprising the impact goal and configured for storing the impact goal in association with the stored selected KII by the first computer system; based upon the stored selected KII, transmitting a KII delivery output to the second computer system via the computer network, the KII delivery output configured for causing a KII delivery to be provided to the second computer system, wherein providing the KII delivery includes causing the webpage having a KII delivery corresponding to the stored selected KII to be displayed via the display of the second computer system; receiving a KII delivery input, the KII delivery input having been transmitted from the second computer system to the first computer system via the computer network, the KII delivery input comprising the KII delivery and configured for storing the KII delivery in association with the stored selected KII by the first computer system; based upon the stored KII delivery and the stored impact goal, processing the impact quantity, the impact quantity being processed by the first computer system, where the processing is configured to assign the impact quantity of the activity by dividing the stored KII delivery by the stored impact goal and to store the impact quantity by the first computer system; transmitting a time period output to the second computer system via the computer network, the time period output configured for causing a time period entry to be provided to the second computer system, wherein providing the time period entry includes causing the webpage having a time period entry to be displayed via the display of the second computer system; receiving a time period input, the time period input having been transmitted from the second computer system to the first computer system via the computer network, the time period input comprising the time period and configured for storing the time period in years by the first computer system; transmitting an activity cost output to the second computer system via the computer network, the activity cost output configured for causing an activity cost entry to be provided to the second computer system, wherein providing the activity cost entry includes causing the webpage having an activity cost entry to be displayed via the display of the second computer system; receiving an activity cost input, the activity cost input having been transmitted from the second computer system to the first computer system via the computer network, the activity cost input comprising the activity cost and configured for storing the activity cost by the first computer system; based upon the stored activity cost and stored KII delivery, processing an impact efficiency, the impact efficiency being processed by the first computer system, where the processing is configured to assign the impact efficiency of the activity, and to store the impact efficiency by the first computer system; based upon the stored impact multiplier value, the stored KII delivery, the stored time period, the stored impact quantity, and the stored impact efficiency, processing the iRR, the iRR being processed by the first computer system, where the processing is configured to assign the iRR of the activity by and to store the iRR associated with the activity by the first computer system; based upon the stored iRR, transmitting an iRR output to the second computer system via the computer network, the iRR output configured for causing the stored iRR to be provided to the second computer system, wherein providing the stored iRR includes causing the webpage having the stored iRR to be displayed via the display of the second computer system.

In aspects, a method for quantitatively calculating the impact rate of return (iRR) of an activity via a computer network, the method including: receiving an iRR calculation input at a first computer system, the iRR calculation input having been transmitted via the computer network from a second computer system, the iRR calculation input comprising a request to begin calculation of the iRR, the first computer system being associated with a service provider, the second computer system being associated with a business entity; transmitting an impact theme selection output from the first computer system to the second computer system via the computer network, the impact theme selection output configured for causing the impact theme selection to be provided to the second computer system, wherein providing the impact theme selection includes causing a webpage having impact theme selections to be displayed via a display of the second computer system, the webpage being associated with a website of the service provider; receiving an impact theme selection input at the first computer system, the impact theme selection input having been transmitted from the second computer system to the first computer system via the computer network, the impact theme selection input comprising a selected impact theme and configured for storing the selected impact theme by the first computer system; based upon the stored selected impact theme, transmitting an impact area selection output to the second computer system via the computer network, the impact area selection output configured for causing the impact area selection to be provided to the second computer system, wherein providing the impact area selection includes causing the webpage having the impact area selections to be displayed via the display of the second computer system; receiving an impact area selection input, the impact area selection input having been transmitted from the second computer system to the first computer system via the computer network, the impact area selection input comprising a selected impact area and configured for storing the selected impact area by the first computer system; based upon the stored selected impact area, transmitting an impact area sub-category selection output to the second computer system via the computer network, the impact area sub-category selection output configured for causing the impact area sub-category selection to be provided to the second computer system, wherein providing the impact area sub-category selection includes causing the webpage having impact area sub-category selections to be displayed via the display of the second computer system; receiving an impact area sub-category selection input, the impact area sub-category selection input having been transmitted from the second computer system to the first computer system via the computer network, the impact area sub-category selection input comprising a selected impact area sub-category and configured for storing the selected impact area sub-category by the first computer system; based upon the stored selected impact area, transmitting a KII selection output to the second computer system via the computer network, the KII selection output configured for causing the KII selection to be provided to the second computer system, wherein providing the KII selection includes causing the webpage having KII selections to be displayed via the display of the second computer system; receiving a KII selection input, the KII selection input having been transmitted from the second computer system to the first computer system via the computer network, the KII selection input comprising a selected KII and configured for storing the selected KII by the first computer system; based upon the stored selected impact area sub-category, transmitting an impact metric selection output to the second computer system via the computer network, the impact metric selection output configured for causing an impact metric selection to be provided to the second computer system, wherein providing the impact metric selection includes causing the webpage having impact metric selections to be displayed via the display of the second computer system; receiving an impact metric selection input, the impact metric selection input having been transmitted from the second computer system to the first computer system via the computer network, the impact metric selection input comprising a selected impact metric and configured for storing the selected impact metric by the first computer system; processing an impact metric value, the impact metric value being processed by the first computer system, the processing of the impact metric value configured to assign an impact metric value to the impact metric and store the impact metric value; processing an impact metric weight, the impact metric weight being processed by the first computer system, the processing of the impact metric weight configured to assign an impact metric weight to the impact metric and store the impact metric weight; processing an impact metric possible point value, the impact metric possible point value being processed by the first computer system, the processing of the impact metric possible point value configured to assign an impact metric possible point value to the impact metric and to store the impact metric possible point value in association with the impact metric, wherein the impact metric possible point value is the product of the stored impact metric value and the impact metric weight; based upon the stored selected impact metrics, transmitting an impact metric score range selection output to the second computer system via the computer network, the impact metric score range selection output configured for causing an impact metric score range selection to be provided to the second computer system, wherein providing the impact metric score range selection includes causing the webpage having impact metric score range selections to be displayed via the display of the second computer system; receiving an impact metric score range selection input, the impact metric score range selection input having been transmitted from the second computer system to the first computer system via the computer network, the impact metric score range selection input comprising an impact metric score range for the impact metric and configured for storing the impact metric score range in association with the impact metric by the first computer system; based upon the stored impact metric score range, transmitting an impact metric score selection output to the second computer system via the computer network, the impact metric score selection output configured for causing an impact metric score selection to be provided to the second computer system, wherein providing the impact metric score selection includes causing the webpage having impact metric score selections to be displayed via the display of the second computer system; receiving an impact metric score selection input, the impact metric score selection input having been transmitted from the second computer system to the first computer system via the computer network, the impact metric score selection input comprising a selected impact metric score for the impact metric and configured for storing the selected impact metric score in association with the impact metric by the first computer system; processing an impact metric score rate, the impact metric score rate being processed by the first computer system, where the processing is configured to assign an impact metric score rate to the impact metric based upon the stored impact metric score and to store the impact metric score rate by the first computer system; processing an impact metric point value, the impact metric point value being processed by the first computer system, where the processing is configured to assign the impact metric with an impact metric point value by multiplying the stored impact metric score rate and the stored impact metric possible point value and to store the impact metric point value by the first computer system; processing an impact multiplier value, the impact multiplier value being processed by the first computer system, where the processing is configured to assign the impact multiplier value by dividing the impact metric point value by 100 and to store the impact multiplier value; based upon the stored selected KII, transmitting an impact goal output to the second computer system via the computer network, the impact goal output configured for causing an impact goal to be provided to the second computer system, wherein providing the impact goal includes causing the webpage having an impact goal corresponding to the stored selected KII to be displayed via the display of the second computer system; receiving an impact goal input, the impact goal input having been transmitted from the second computer system to the first computer system via the computer network, the impact goal input comprising the impact goal and configured for storing the impact goal in association with the stored selected KII by the first computer system; based upon the stored selected KII, transmitting a KII delivery output to the second computer system via the computer network, the KII delivery output configured for causing a KII delivery to be provided to the second computer system, wherein providing the KII delivery includes causing the webpage having a KII delivery corresponding to the stored selected KII to be displayed via the display of the second computer system; receiving a KIT delivery input, the KII delivery input having been transmitted from the second computer system to the first computer system via the computer network, the KII delivery input comprising the KII delivery and configured for storing the KII delivery in association with the stored selected KII by the first computer system; based upon the stored KII delivery and the stored impact goal, processing the impact quantity, the impact quantity being processed by the first computer system, where the processing is configured to assign the impact quantity of the activity by dividing the stored KII delivery by the stored impact goal and to store the impact quantity by the first computer system; transmitting a time period output to the second computer system via the computer network, the time period output configured for causing a time period entry to be provided to the second computer system, wherein providing the time period entry includes causing the webpage having a time period entry to be displayed via the display of the second computer system; receiving a time period input, the time period input having been transmitted from the second computer system to the first computer system via the computer network, the time period input comprising the time period and configured for storing the time period in years by the first computer system; transmitting an activity cost output to the second computer system via the computer network, the activity cost output configured for causing an activity cost entry to be provided to the second computer system, wherein providing the activity cost entry includes causing the webpage having an activity cost entry to be displayed via the display of the second computer system; receiving an activity cost input, the activity cost input having been transmitted from the second computer system to the first computer system via the computer network, the activity cost input comprising the activity cost and configured for storing the activity cost by the first computer system; based upon the stored activity cost and stored KII delivery, processing an impact efficiency, the impact efficiency being processed by the first computer system, where the processing is configured to assign the impact efficiency of the activity, and to store the impact efficiency by the first computer system; based upon the stored impact multiplier value, the stored KII delivery, the stored time period, the stored impact quantity, and the stored impact efficiency, processing the iRR, the iRR being processed by the first computer system, where the processing is configured to assign the iRR of the activity by and to store the iRR associated with the activity by the first computer system; based upon the stored iRR, transmitting an iRR output to the second computer system via the computer network, the iRR output configured for causing the stored iRR and adjustable inputs to be provided to the second computer system, wherein providing the stored iRR and adjustable inputs includes causing the webpage having the stored iRR and adjustable inputs to be displayed via the display of the second computer system; receiving a modification input, the modification input having been transmitted from the second computer system to the first computer system via the computer network, the modification input comprising a modified qualitative and quantitative indicator and configured for storing the modified qualitative and quantitative indicator in association with its corresponding stored qualitative and quantitative indicator; based upon the stored modified qualitative and quantitative indicator, processing a modification input, the modification input being processed by the first computer system, where the processing is configured to calculate a modified iRR based upon the stored modified qualitative and quantitative indicator, and to store the modified iRR by the first computer system; transmitting a modified iRR output to the second computer system via the computer network, the modified iRR output configured for causing the stored modified iRR and adjustable inputs to be provided to the second computer system, wherein providing the stored modified iRR and adjustable inputs includes causing the webpage having the stored modified iRR and adjustable inputs to be displayed via the display of the second computer system.

In aspects, a method for quantitatively calculating the impact rate of return (iRR) of an activity via a computer network, the method including: receiving an iRR calculation input at a first computer system, the iRR calculation input having been transmitted via the computer network from a second computer system, the iRR calculation input comprising a request to begin calculation of the iRR, the first computer system being associated with a service provider, the second computer system being associated with a business entity; transmitting an impact theme selection output from the first computer system to the second computer system via the computer network, the impact theme selection output configured for causing the impact theme selection to be provided to the second computer system, wherein providing the impact theme selection includes causing a webpage having impact theme selections to be displayed via a display of the second computer system, the webpage being associated with a website of the service provider; receiving an impact theme selection input at the first computer system, the impact theme selection input having been transmitted from the second computer system to the first computer system via the computer network, the impact theme selection input comprising a selected impact theme and configured for storing the selected impact theme by the first computer system; based upon the stored selected impact theme, transmitting an impact area selection output to the second computer system via the computer network, the impact area selection output configured for causing the impact area selection to be provided to the second computer system, wherein providing the impact area selection includes causing the webpage having the impact area selections to be displayed via the display of the second computer system; receiving an impact area selection input, the impact area selection input having been transmitted from the second computer system to the first computer system via the computer network, the impact area selection input comprising a selected impact area and configured for storing the selected impact area by the first computer system; based upon the stored selected impact area, transmitting an impact area sub-category selection output to the second computer system via the computer network, the impact area sub-category selection output configured for causing the impact area sub-category selection to be provided to the second computer system, wherein providing the impact area sub-category selection includes causing the webpage having impact area sub-category selections to be displayed via the display of the second computer system; receiving an impact area sub-category selection input, the impact area sub-category selection input having been transmitted from the second computer system to the first computer system via the computer network, the impact area sub-category selection input comprising a selected impact area sub-category and configured for storing the selected impact area sub-category by the first computer system; based upon the stored selected impact area, transmitting a KII selection output to the second computer system via the computer network, the KII selection output configured for causing the KII selection to be provided to the second computer system, wherein providing the KII selection includes causing the webpage having KII selections to be displayed via the display of the second computer system; receiving a KII selection input, the KII selection input having been transmitted from the second computer system to the first computer system via the computer network, the KII selection input comprising a selected KII and configured for storing the selected KII by the first computer system; based upon the stored selected impact area sub-category, transmitting an impact metric selection output to the second computer system via the computer network, the impact metric selection output configured for causing an impact metric selection to be provided to the second computer system, wherein providing the impact metric selection includes causing the webpage having impact metric selections to be displayed via the display of the second computer system; receiving an impact metric selection input, the impact metric selection input having been transmitted from the second computer system to the first computer system via the computer network, the impact metric selection input comprising a selected impact metric and configured for storing the selected impact metric by the first computer system; processing an impact metric value, the impact metric value being processed by the first computer system, the processing of the impact metric value configured to assign an impact metric value to the impact metric and store the impact metric value; processing an impact metric weight, the impact metric weight being processed by the first computer system, the processing of the impact metric weight configured to assign an impact metric weight to the impact metric and store the impact metric weight; processing an impact metric possible point value, the impact metric possible point value being processed by the first computer system, the processing of the impact metric possible point value configured to assign an impact metric possible point value to the impact metric and to store the impact metric possible point value in association with the impact metric, wherein the impact metric possible point value is the product of the stored impact metric value and the impact metric weight; based upon the stored selected impact metrics, transmitting an impact metric score range selection output to the second computer system via the computer network, the impact metric score range selection output configured for causing an impact metric score range selection to be provided to the second computer system, wherein providing the impact metric score range selection includes causing the webpage having impact metric score range selections to be displayed via the display of the second computer system; receiving an impact metric score range selection input, the impact metric score range selection input having been transmitted from the second computer system to the first computer system via the computer network, the impact metric score range selection input comprising an impact metric score range for the impact metric and configured for storing the impact metric score range in association with the impact metric by the first computer system; based upon the stored impact metric score range, transmitting an impact metric score selection output to the second computer system via the computer network, the impact metric score selection output configured for causing an impact metric score selection to be provided to the second computer system, wherein providing the impact metric score selection includes causing the webpage having impact metric score selections to be displayed via the display of the second computer system; receiving an impact metric score selection input, the impact metric score selection input having been transmitted from the second computer system to the first computer system via the computer network, the impact metric score selection input comprising a selected impact metric score for the impact metric and configured for storing the selected impact metric score in association with the impact metric by the first computer system; processing an impact metric score rate, the impact metric score rate being processed by the first computer system, where the processing is configured to assign an impact metric score rate to the impact metric based upon the stored impact metric score and to store the impact metric score rate by the first computer system; processing an impact metric point value, the impact metric point value being processed by the first computer system, where the processing is configured to assign the impact metric with an impact metric point value by multiplying the stored impact metric score rate and the stored impact metric possible point value and to store the impact metric point value by the first computer system; processing an impact multiplier value, the impact multiplier value being processed by the first computer system, where the processing is configured to assign the impact multiplier value by dividing the impact metric point value by 100 and to store the impact multiplier value; based upon the stored selected KII, transmitting an impact goal output to the second computer system via the computer network, the impact goal output configured for causing an impact goal to be provided to the second computer system, wherein providing the impact goal includes causing the webpage having an impact goal corresponding to the stored selected KII to be displayed via the display of the second computer system; receiving an impact goal input, the impact goal input having been transmitted from the second computer system to the first computer system via the computer network, the impact goal input comprising the impact goal and configured for storing the impact goal in association with the stored selected KII by the first computer system; based upon the stored selected KII, transmitting a KII delivery output to the second computer system via the computer network, the KII delivery output configured for causing a KII delivery to be provided to the second computer system, wherein providing the KII delivery includes causing the webpage having a KII delivery corresponding to the stored selected KII to be displayed via the display of the second computer system; receiving a KIT delivery input, the KII delivery input having been transmitted from the second computer system to the first computer system via the computer network, the KII delivery input comprising the KII delivery and configured for storing the KII delivery in association with the stored selected KII by the first computer system; based upon the stored KII delivery and the stored impact goal, processing the impact quantity, the impact quantity being processed by the first computer system, where the processing is configured to assign the impact quantity of the activity by dividing the stored KII delivery by the stored impact goal and to store the impact quantity by the first computer system; transmitting a time period output to the second computer system via the computer network, the time period output configured for causing a time period entry to be provided to the second computer system, wherein providing the time period entry includes causing the webpage having a time period entry to be displayed via the display of the second computer system; receiving a time period input, the time period input having been transmitted from the second computer system to the first computer system via the computer network, the time period input comprising the time period and configured for storing the time period in years by the first computer system; transmitting an activity cost output to the second computer system via the computer network, the activity cost output configured for causing an activity cost entry to be provided to the second computer system, wherein providing the activity cost entry includes causing the webpage having an activity cost entry to be displayed via the display of the second computer system; receiving an activity cost input, the activity cost input having been transmitted from the second computer system to the first computer system via the computer network, the activity cost input comprising the activity cost and configured for storing the activity cost by the first computer system; transmitting a custom impact efficiency benchmarking output to the second computer system via the computer network, the custom impact efficiency benchmarking output configured for causing a custom impact efficiency benchmarking selection to be provided to the second computer system, wherein providing the custom impact efficiency benchmarking selection includes causing the webpage having the custom impact efficiency benchmarking selection to be displayed via the display of the second computer system; receiving a custom impact efficiency benchmarking input, the custom impact efficiency benchmarking input having been transmitted from the second computer system to the first computer system via the computer network, the custom impact efficiency benchmarking input comprising a custom impact efficiency benchmark and configured for storing the custom impact efficiency benchmark by the first computer system; based upon the stored custom impact efficiency benchmark, processing a custom impact efficiency benchmark, the custom impact efficiency benchmark being processed by the first computer system, where the processing is configured for determining the log base value of an impact efficiency and for storage of the log base value of the impact efficiency; based upon the stored activity cost, stored KII delivery, and stored log base value of the impact efficiency, processing the impact efficiency, the impact efficiency being processed by the first computer system, where the processing is configured to assign the impact efficiency of the activity, and to store the impact efficiency by the first computer system; based upon the stored impact multiplier value, the stored KII delivery, the stored time period, the stored impact quantity, and the stored impact efficiency, processing the iRR, the iRR being processed by the first computer system, where the processing is configured to assign the iRR of the activity by and to store the iRR associated with the activity by the first computer system; based upon the stored iRR, transmitting an iRR output to the second computer system via the computer network, the iRR output configured for causing the stored iRR to be provided to the second computer system, wherein providing the stored iRR includes causing the webpage having the stored iRR to be displayed via the display of the second computer system.

In aspects, a method for quantitatively calculating the impact rate of return (iRR) of an activity via a computer network, the method including: receiving an iRR calculation input at a first computer system, the iRR calculation input having been transmitted via the computer network from a second computer system, the iRR calculation input comprising a request to begin calculation of the iRR, the first computer system being associated with a service provider, the second computer system being associated with a business entity; transmitting an impact search entry output from the first computer system to the second computer system via the computer network, the impact search entry output configured for causing the impact search entry to be provided to the second computer system, wherein providing the impact search entry includes causing a webpage having an impact search entry to be displayed via a display of the second computer system, the webpage being associated with a website of the service provider; receiving an impact search entry input at the first computer system, the impact search entry input having been transmitted from the second computer system to the first computer system via the computer network, the impact search entry input comprising a search query having impact keywords and KII keywords and configured for storing the search query by the first computer system; processing the stored impact search entry, the stored impact search entry being processed by the first computer system, the processing of the stored impact search entry configured for associating the impact keywords with impact area sub-categories associated with the activity, for associating the KII keywords with KIIs associated with the activity, and for storing the associated impact area sub-categories and the associated KIIs; based upon the stored associated impact area sub-categories, transmitting a keyword impact area sub-category selection output to the second computer system via the computer network, the keyword impact area sub-category selection output configured for causing the impact area sub-category selection to be provided to the second computer system, wherein providing the impact area sub-category selection includes causing the webpage having impact area sub-category selections to be displayed via the display of the second computer system; receiving a keyword impact area sub-category selection input, the keyword impact area sub-category selection input having been transmitted from the second computer system to the first computer system via the computer network, the keyword impact area sub-category selection input comprising a selected impact area sub-category and configured for storing the selected impact area sub-category by the first computer system; based upon the stored associated KIIs, transmitting a keyword KII selection output to the second computer system via the computer network, the keyword KII selection output configured for causing the KII selection to be provided to the second computer system, wherein providing the KII selection includes causing the webpage having KII selections to be displayed via the display of the second computer system; receiving a keyword KII selection input, the keyword KII selection input having been transmitted from the second computer system to the first computer system via the computer network, the keyword KII selection input comprising a selected KII and configured for storing the selected KII by the first computer system; based upon the stored selected impact area sub-category, transmitting an impact metric selection output to the second computer system via the computer network, the impact metric selection output configured for causing an impact metric selection to be provided to the second computer system, wherein providing the impact metric selection includes causing the webpage having impact metric selections to be displayed via the display of the second computer system; receiving an impact metric selection input, the impact metric selection input having been transmitted from the second computer system to the first computer system via the computer network, the impact metric selection input comprising a selected impact metric and configured for storing the selected impact metric by the first computer system; processing an impact metric value, the impact metric value being processed by the first computer system, the processing of the impact metric value configured to assign an impact metric value to the impact metric and store the impact metric value; processing an impact metric weight, the impact metric weight being processed by the first computer system, the processing of the impact metric weight configured to assign an impact metric weight to the impact metric and store the impact metric weight; processing an impact metric possible point value, the impact metric possible point value being processed by the first computer system, the processing of the impact metric possible point value configured to assign an impact metric possible point value to the impact metric and to store the impact metric possible point value in association with the impact metric, wherein the impact metric possible point value is the product of the stored impact metric value and the impact metric weight; based upon the stored selected impact metrics, transmitting an impact metric score range selection output to the second computer system via the computer network, the impact metric score range selection output configured for causing an impact metric score range selection to be provided to the second computer system, wherein providing the impact metric score range selection includes causing the webpage having impact metric score range selections to be displayed via the display of the second computer system; receiving an impact metric score range selection input, the impact metric score range selection input having been transmitted from the second computer system to the first computer system via the computer network, the impact metric score range selection input comprising an impact metric score range for the impact metric and configured for storing the impact metric score range in association with the impact metric by the first computer system; based upon the stored impact metric score range, transmitting an impact metric score selection output to the second computer system via the computer network, the impact metric score selection output configured for causing an impact metric score selection to be provided to the second computer system, wherein providing the impact metric score selection includes causing the webpage having impact metric score selections to be displayed via the display of the second computer system; receiving an impact metric score selection input, the impact metric score selection input having been transmitted from the second computer system to the first computer system via the computer network, the impact metric score selection input comprising a selected impact metric score for the impact metric and configured for storing the selected impact metric score in association with the impact metric by the first computer system; processing an impact metric score rate, the impact metric score rate being processed by the first computer system, where the processing is configured to assign an impact metric score rate to the impact metric based upon the stored impact metric score and to store the impact metric score rate by the first computer system; processing an impact metric point value, the impact metric point value being processed by the first computer system, where the processing is configured to assign the impact metric with an impact metric point value by multiplying the stored impact metric score rate and the stored impact metric possible point value and to store the impact metric point value by the first computer system; processing an impact multiplier value, the impact multiplier value being processed by the first computer system, where the processing is configured to assign the impact multiplier value by dividing the impact metric point value by 100 and to store the impact multiplier value; based upon the stored selected KII, transmitting an impact goal output to the second computer system via the computer network, the impact goal output configured for causing an impact goal to be provided to the second computer system, wherein providing the impact goal includes causing the webpage having an impact goal corresponding to the stored selected KII to be displayed via the display of the second computer system; receiving an impact goal input, the impact goal input having been transmitted from the second computer system to the first computer system via the computer network, the impact goal input comprising the impact goal and configured for storing the impact goal in association with the stored selected KII by the first computer system; based upon the stored selected KII, transmitting a KII delivery output to the second computer system via the computer network, the KII delivery output configured for causing a KII delivery to be provided to the second computer system, wherein providing the KII delivery includes causing the webpage having a KII delivery corresponding to the stored selected KII to be displayed via the display of the second computer system; receiving a KII delivery input, the KII delivery input having been transmitted from the second computer system to the first computer system via the computer network, the KII delivery input comprising the KII delivery and configured for storing the KII delivery in association with the stored selected KII by the first computer system; based upon the stored KII delivery and the stored impact goal, processing the impact quantity, the impact quantity being processed by the first computer system, where the processing is configured to assign the impact quantity of the activity by dividing the stored KII delivery by the stored impact goal and to store the impact quantity by the first computer system; transmitting a time period output to the second computer system via the computer network, the time period output configured for causing a time period entry to be provided to the second computer system, wherein providing the time period entry includes causing the webpage having a time period entry to be displayed via the display of the second computer system; receiving a time period input, the time period input having been transmitted from the second computer system to the first computer system via the computer network, the time period input comprising the time period and configured for storing the time period in years by the first computer system; transmitting an activity cost output to the second computer system via the computer network, the activity cost output configured for causing an activity cost entry to be provided to the second computer system, wherein providing the activity cost entry includes causing the webpage having an activity cost entry to be displayed via the display of the second computer system; receiving an activity cost input, the activity cost input having been transmitted from the second computer system to the first computer system via the computer network, the activity cost input comprising the activity cost and configured for storing the activity cost by the first computer system; based upon the stored activity cost and stored KII delivery, processing an impact efficiency, the impact efficiency being processed by the first computer system, where the processing is configured to assign the impact efficiency of the activity, and to store the impact efficiency by the first computer system; based upon the stored impact multiplier value, the stored KII delivery, the stored time period, the stored impact quantity, and the stored impact efficiency, processing the iRR, the iRR being processed by the first computer system, where the processing is configured to assign the iRR of the activity by and to store the iRR associated with the activity by the first computer system; based upon the stored iRR, transmitting an iRR output to the second computer system via the computer network, the iRR output configured for causing the stored iRR to be provided to the second computer system, wherein providing the stored iRR includes causing the webpage having the stored iRR to be displayed via the display of the second computer system.

In aspects, a method for quantitatively calculating the impact rate of return (iRR) of an activity from a template via a computer network, the method including: receiving an iRR calculation input at a first computer system, the iRR calculation input having been transmitted via the computer network from a second computer system, the iRR calculation input comprising a request to begin calculation of the iRR from a template, the first computer system being associated with a service provider, the second computer system being associated with a business entity, where the template comprises predetermined, stored selections of an impact theme, an impact area, an impact area sub-category, a KII, an impact metric, and an impact metric score range, and processed values of an impact metric value, an impact metric weight, and impact metric possible point value based upon the predetermined, stored impact metric score range, transmitting an impact metric score selection output to the second computer system via the computer network, the impact metric score selection output configured for causing an impact metric score selection to be provided to the second computer system, wherein providing the impact metric score selection includes causing the webpage having impact metric score selections to be displayed via the display of the second computer system; receiving an impact metric score selection input, the impact metric score selection input having been transmitted from the second computer system to the first computer system via the computer network, the impact metric score selection input comprising a selected impact metric score for the predetermined, stored impact metric and configured for storing the selected impact metric score in association with the predetermined, stored impact metric by the first computer system; processing an impact metric score rate, the impact metric score rate being processed by the first computer system, where the processing is configured to assign an impact metric score rate to the impact metric based upon the stored impact metric score and to store the impact metric score rate by the first computer system; processing an impact metric point value, the impact metric point value being processed by the first computer system, where the processing is configured to assign the impact metric with an impact metric point value by multiplying the stored impact metric score rate and the predetermined, stored impact metric possible point value and to store the impact metric point value by the first computer system; processing an impact multiplier value, the impact multiplier value being processed by the first computer system, where the processing is configured to assign the impact multiplier value by dividing the impact metric point value by 100 and to store the impact multiplier value; based upon the predetermined, stored selected KII, transmitting an impact goal output to the second computer system via the computer network, the impact goal output configured for causing an impact goal to be provided to the second computer system, wherein providing the impact goal includes causing the webpage having an impact goal corresponding to the predetermined, stored selected KII to be displayed via the display of the second computer system; receiving an impact goal input, the impact goal input having been transmitted from the second computer system to the first computer system via the computer network, the impact goal input comprising the impact goal and configured for storing the impact goal in association with the predetermined, stored selected KII by the first computer system; based upon the predetermined, stored selected KII, transmitting a KII delivery output to the second computer system via the computer network, the KII delivery output configured for causing a KII delivery to be provided to the second computer system, wherein providing the KII delivery includes causing the webpage having a KII delivery corresponding to the predetermined, stored selected KII to be displayed via the display of the second computer system; receiving a KII delivery input, the KII delivery input having been transmitted from the second computer system to the first computer system via the computer network, the KII delivery input comprising the KII delivery and configured for storing the KII delivery in association with the predetermined, stored selected KII by the first computer system; based upon the stored KII delivery and the stored impact goal, processing the impact quantity, the impact quantity being processed by the first computer system, where the processing is configured to assign the impact quantity of the activity by dividing the stored KII delivery by the stored impact goal and to store the impact quantity by the first computer system; transmitting a time period output to the second computer system via the computer network, the time period output configured for causing a time period entry to be provided to the second computer system, wherein providing the time period entry includes causing the webpage having a time period entry to be displayed via the display of the second computer system; receiving a time period input, the time period input having been transmitted from the second computer system to the first computer system via the computer network, the time period input comprising the time period and configured for storing the time period in years by the first computer system; transmitting an activity cost output to the second computer system via the computer network, the activity cost output configured for causing an activity cost entry to be provided to the second computer system, wherein providing the activity cost entry includes causing the webpage having an activity cost entry to be displayed via the display of the second computer system; receiving an activity cost input, the activity cost input having been transmitted from the second computer system to the first computer system via the computer network, the activity cost input comprising the activity cost and configured for storing the activity cost by the first computer system; based upon the stored activity cost and stored KII delivery, processing an impact efficiency, the impact efficiency being processed by the first computer system, where the processing is configured to assign the impact efficiency of the activity, and to store the impact efficiency by the first computer system; based upon the stored impact multiplier value, the stored KII delivery, the stored time period, the stored impact quantity, and the stored impact efficiency, processing the iRR, the iRR being processed by the first computer system, where the processing is configured to assign the iRR of the activity by and to store the iRR associated with the activity by the first computer system; based upon the stored iRR, transmitting an iRR output to the second computer system via the computer network, the iRR output configured for causing the stored iRR to be provided to the second computer system, wherein providing the stored iRR includes causing the webpage having the stored iRR to be displayed via the display of the second computer system.

### FIGURES

FIG. 1 is a flow chart representing a method 100 for quantitatively assessing the impact value of money within an impact theme or across impact themes.

FIG. 2 is a block diagram 200 representing a system for implementing the method shown in FIGS. 1, and 4-15.

FIGS. 3a-3z are prophetic representations of graphical user interfaces implementing the method of FIG. 1 on the system of FIG. 2.

FIG. 4 is a flow chart representing a second method 400 for quantitatively assessing the impact value of money within an impact theme or across impact themes.

FIGS. 4a and 4b are prophetic representations of graphical user interfaces implementing the method of FIG. 4 on the system of FIG. 2.

FIG. 5 is a flow chart representing a third method 500 for quantitatively assessing the impact value of money within an impact theme or across impact themes.

FIG. 6 is a flow chart representing a fourth method 600 for quantitatively assessing the impact value of money within an impact theme or across impact themes.

FIGS. 6a and 6b are prophetic representations of graphical user interfaces implementing the method of FIG. 6 on the system of FIG. 2

FIG. 7 is a flow chart representing a fifth method 700 for quantitatively assessing the impact value of money within an impact theme or across impact themes.

FIGS. 7a and 7b are prophetic representations of graphical user interfaces implementing the method of FIG. 7 on the system of FIG. 2.

FIG. 8 is a flow chart representing a sixth method 800 for quantitatively assessing the impact value of money within and impact theme or across impact themes.

FIGS. 8a-8c are prophetic representations of graphical user interfaces implementing the method of FIG. 8 on the system of FIG. 2.

FIG. 9 is a flow chart presenting a seventh method 900 for quantitatively assessing the impact value of money within an impact theme or across impact themes.

FIGS. 9a-9d are prophetic representations of graphical user interfaces implementing the method of FIG. 9 on the system of FIG. 2.

FIG. 10 is a flow chart presenting an eighth method 1000 for quantitatively assessing the impact value of money within an impact theme or across impact themes.

FIGS. 10a and 10b are prophetic representations of graphical user interfaces implementing the method of FIG. 10 on the system of FIG. 2.

FIG. 11 is a flow chart presenting a ninth method 1100 for quantitatively assessing the impact value of money within an impact theme or across impact themes.

FIGS. 11a-11d are prophetic representations of graphical user interfaces implementing the method of FIG. 11 on the system of FIG. 2.

FIG. 12 is a flow chart presenting a tenth method 1200 for quantitatively assessing the impact value of money within an impact theme or across impact themes.

FIGS. 12a-12c are prophetic representations of graphical user interfaces implementing the method of FIG. 12 on the system of FIG. 2.

FIGS. 13a-13i are prophetic representations of graphical user interfaces implement the method of FIG. 1 having upper and lower inputs.

FIG. 14 is a flow chart presenting an eleventh method 1400 for quantitatively assessing the impact value of money by calculating the iRR of an activity having a custom benchmarked efficiency.

FIGS. 14a and 14b are prophetic representations of graphical user interfaces implementing the method of FIG. 14 on the system of FIG. 2.

FIG. 15 is a flow chart presenting a twelfth method 1500 used by the system for assessing the impact value of money by calculating the iRR of an activity where a user may search for the type of impact delivered in association with an activity.

FIGS. 15a and 15b are prophetic representations of graphical user interfaces implementing the method of FIG. 15 on the system of FIG. 2.

FIG. 16 is a table representing systematic selection of impact themes, impact areas, impact area sub-categories, impact metrics, KIIs, and impact keywords.

FIG. 17 is a table representing systematic selection of impact themes and impact areas.

FIG. 18 is a table representing systematic selection of KII keywords and KIIs.

### DETAILED DESCRIPTION

As used herein the following terms utilize the accompanying definitions.

“Assess” or “assessing” means predicting, tracking, analyzing, reporting, and monitoring the iRR via the algorithm.

“Impact value of money” means a single quantitative measurement for the qualitative and quantitative effects of an activity within an impact theme or across themes, represented as an impact rate of return.

“Impact rate of return” ® or “iRR” ® is the calculation that determines the impact value of money and is expressed as a percentage. For example, an iRR of 20% may be a desired iRR indicating that an activity has a satisfactory rate of societal impact, whereas an iRR of −20% may be an undesired iRR indicating that an activity has a detrimental rate of societal impact. (Impact rate of return and iRR are both registered trademarks of Global Impact LLC).

“Activity” or “project” or “investment” means either starting an action or ceasing an action related to an impact theme.

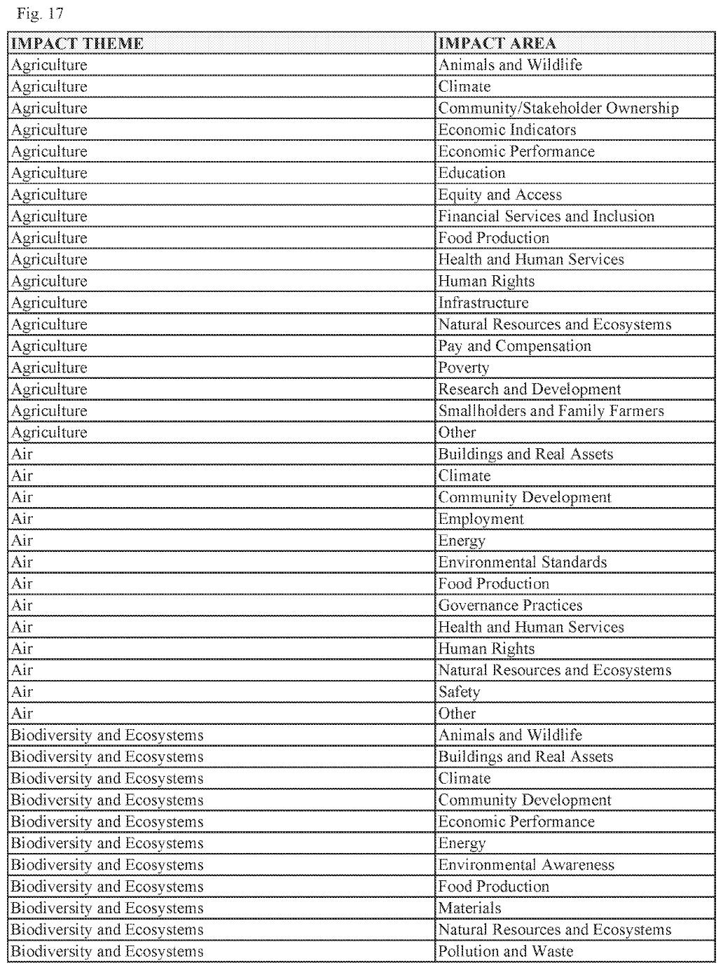

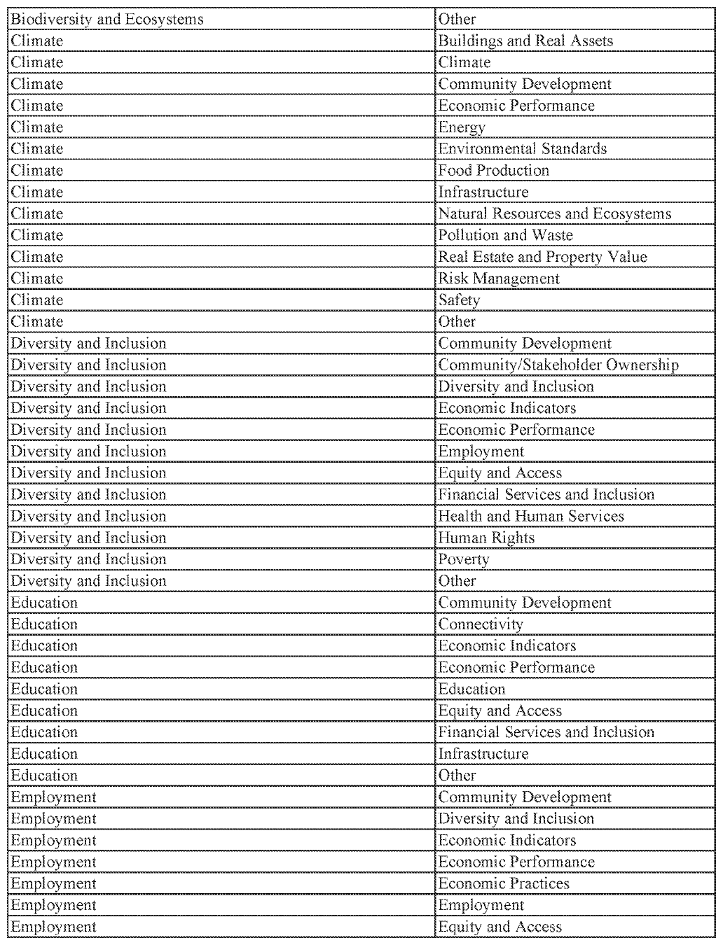

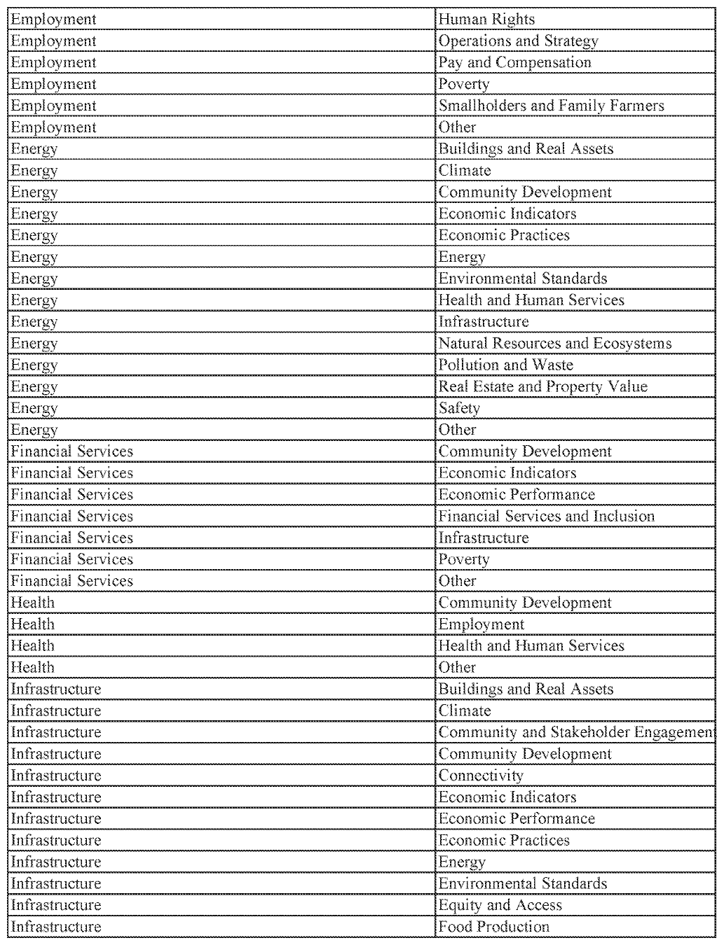

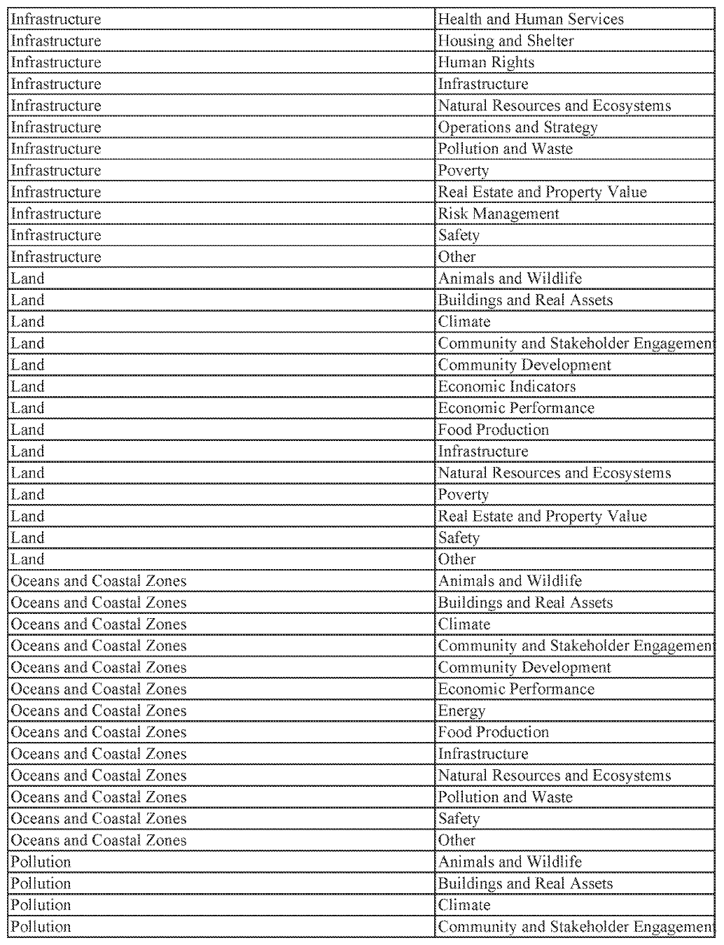

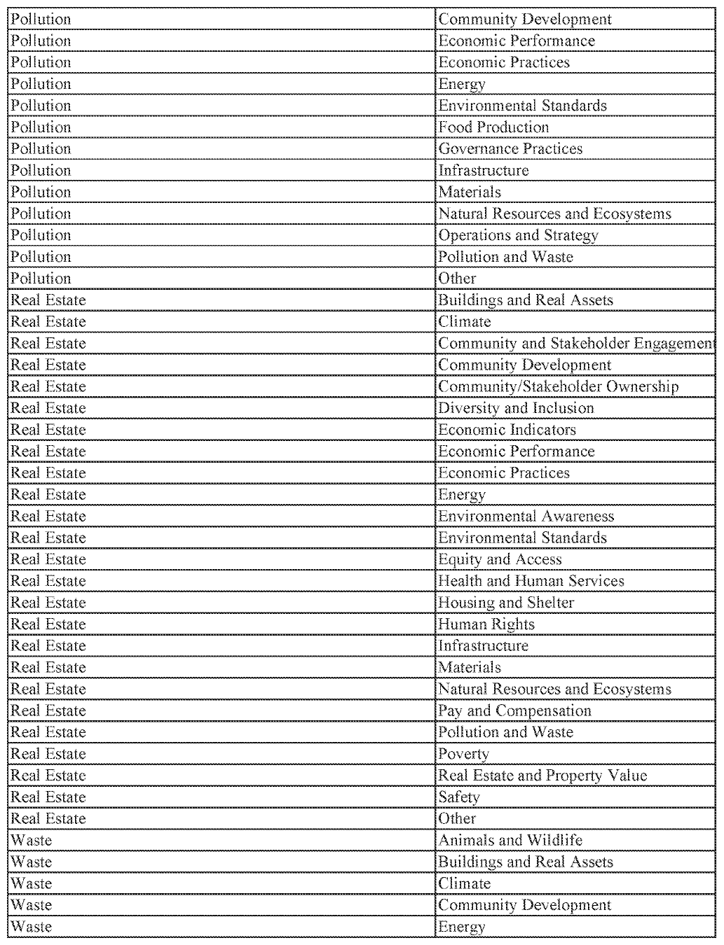

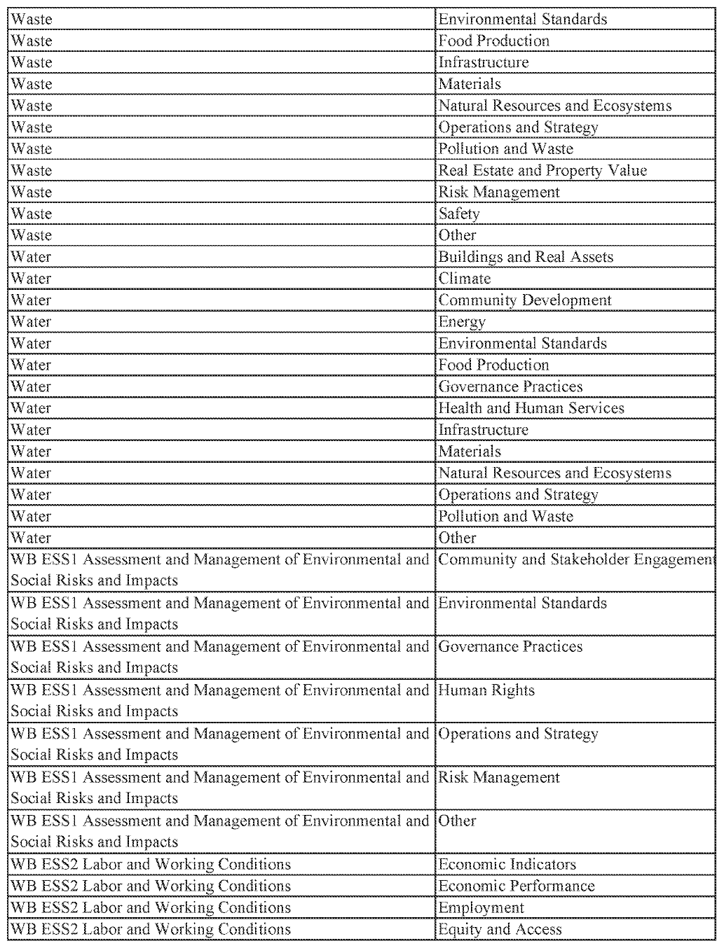

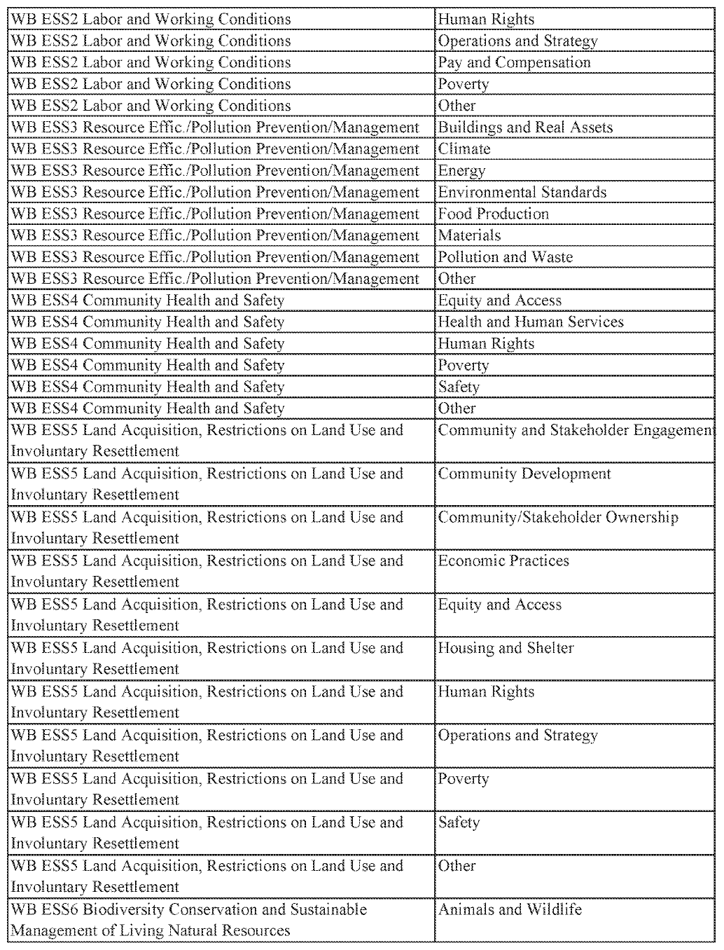

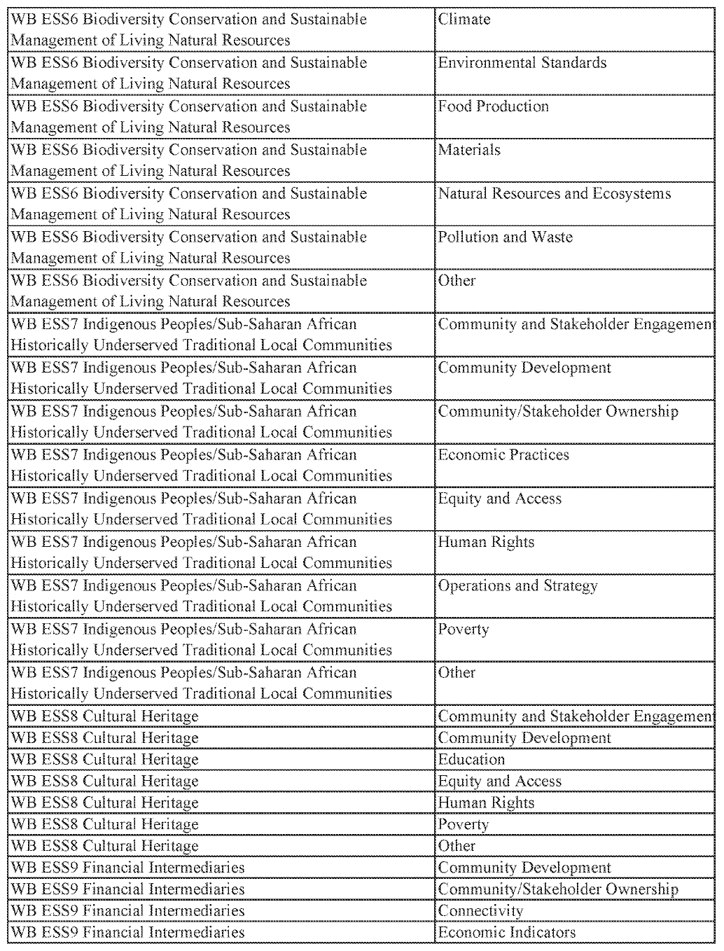

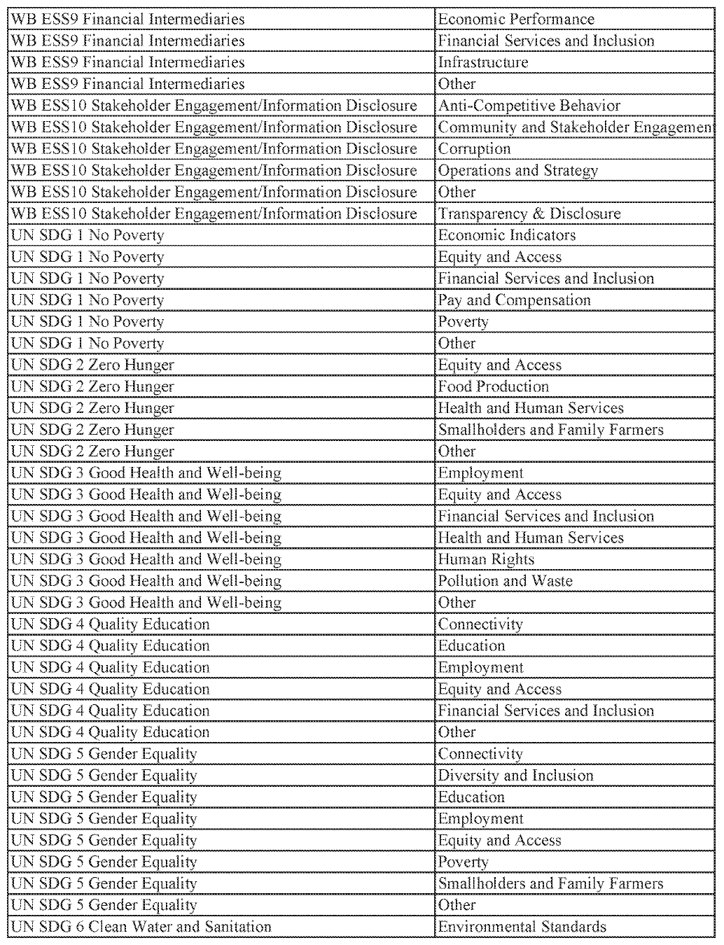

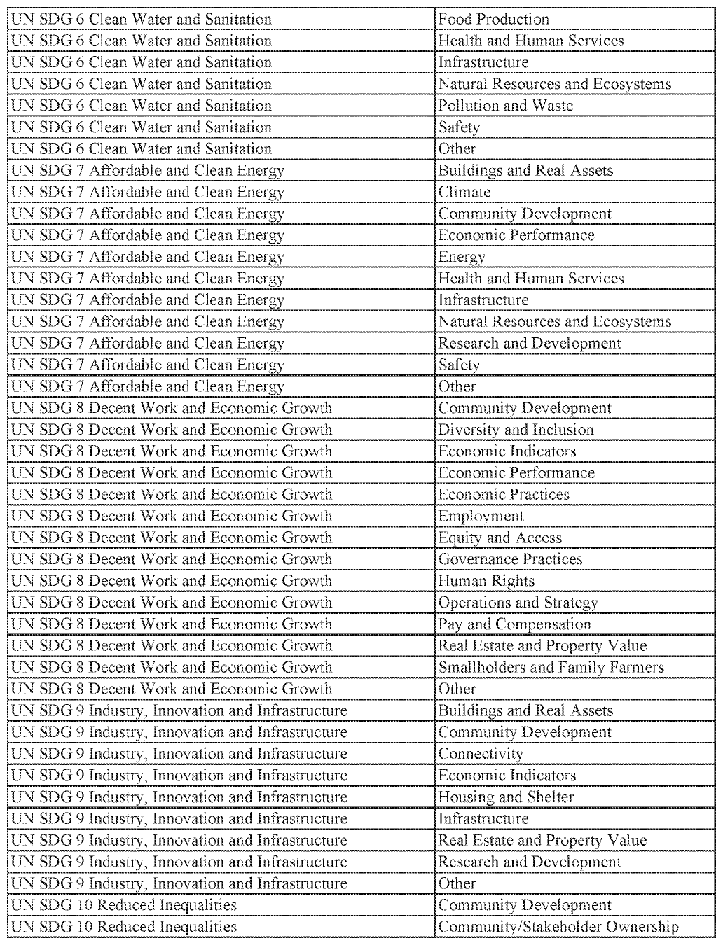

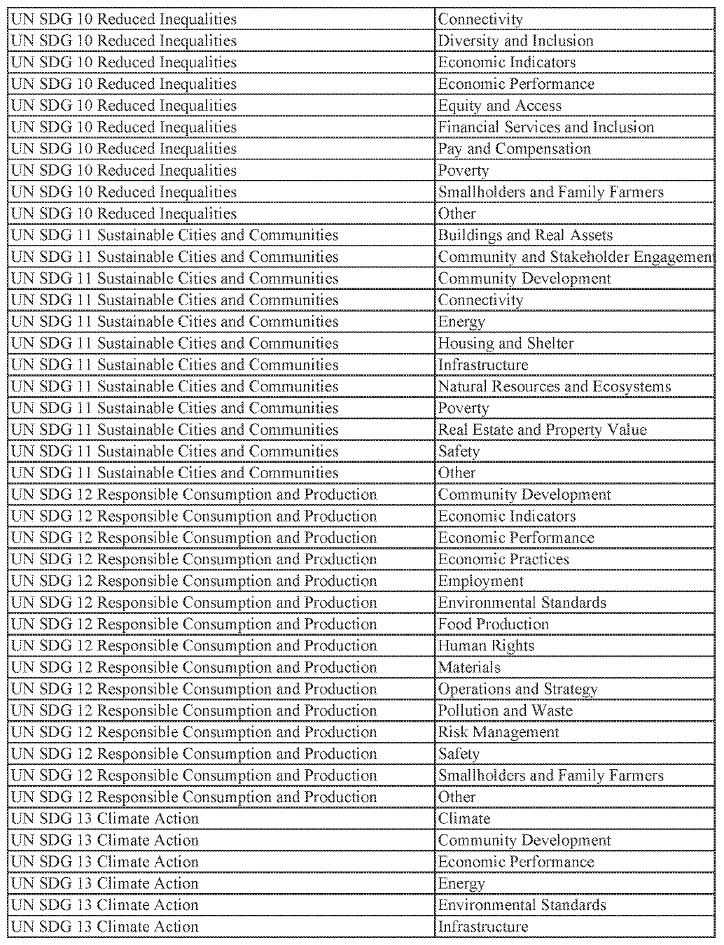

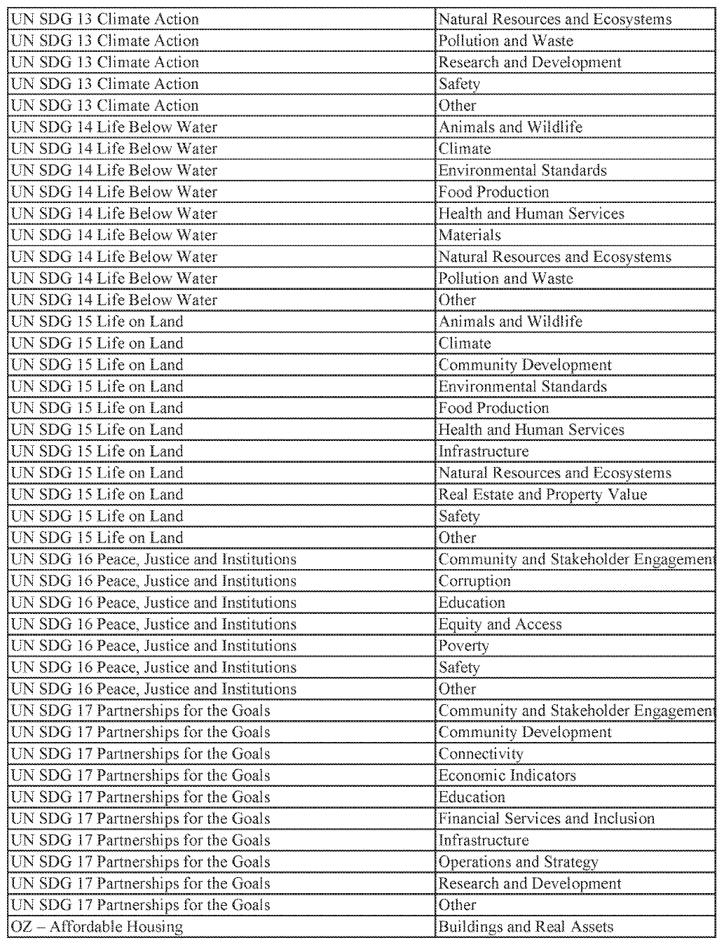

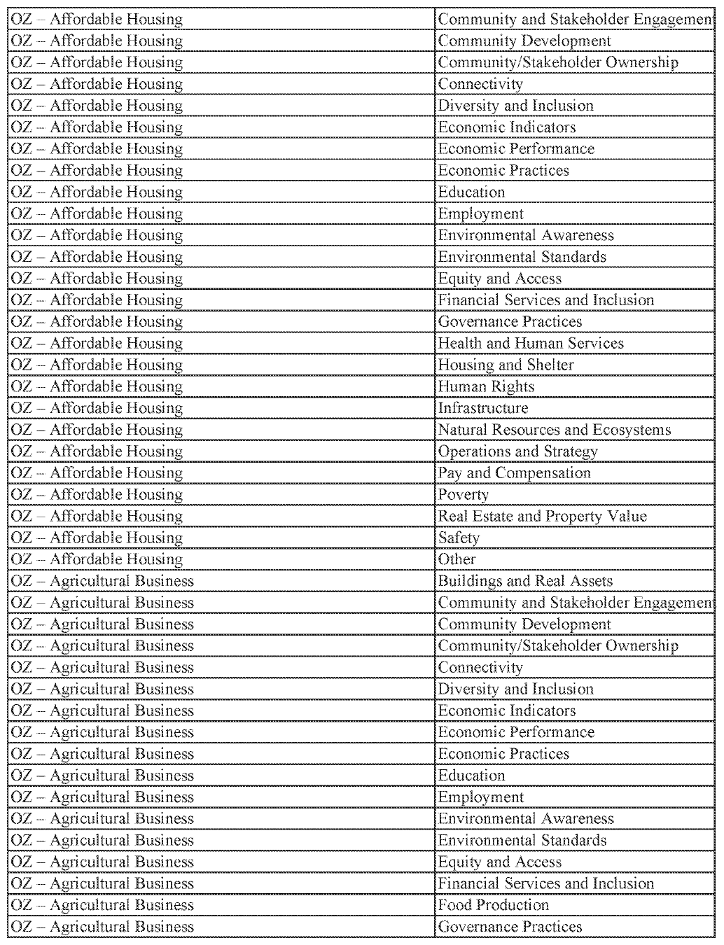

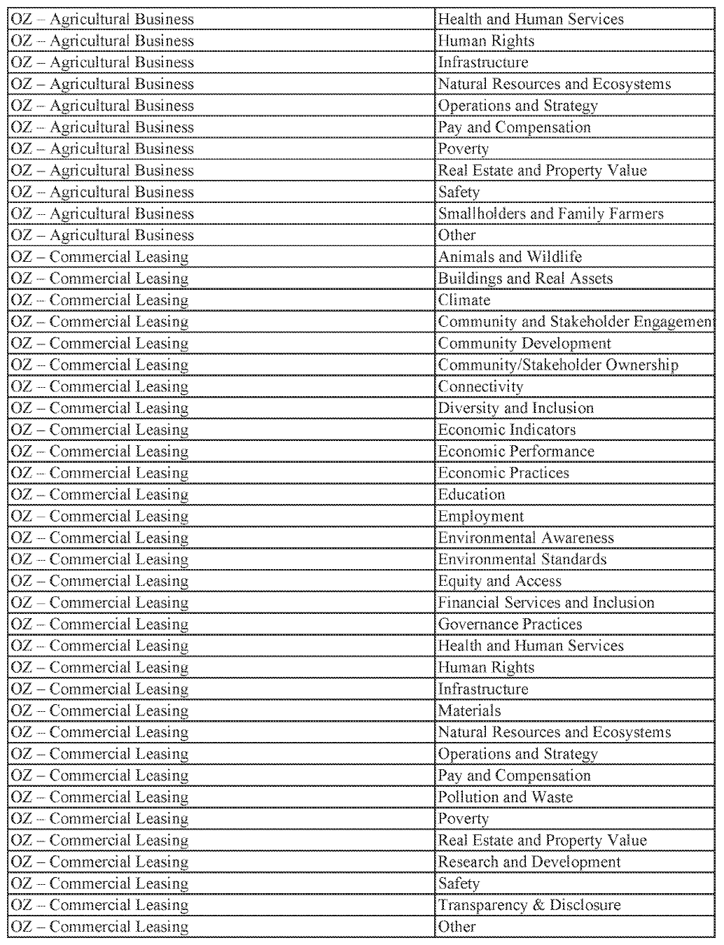

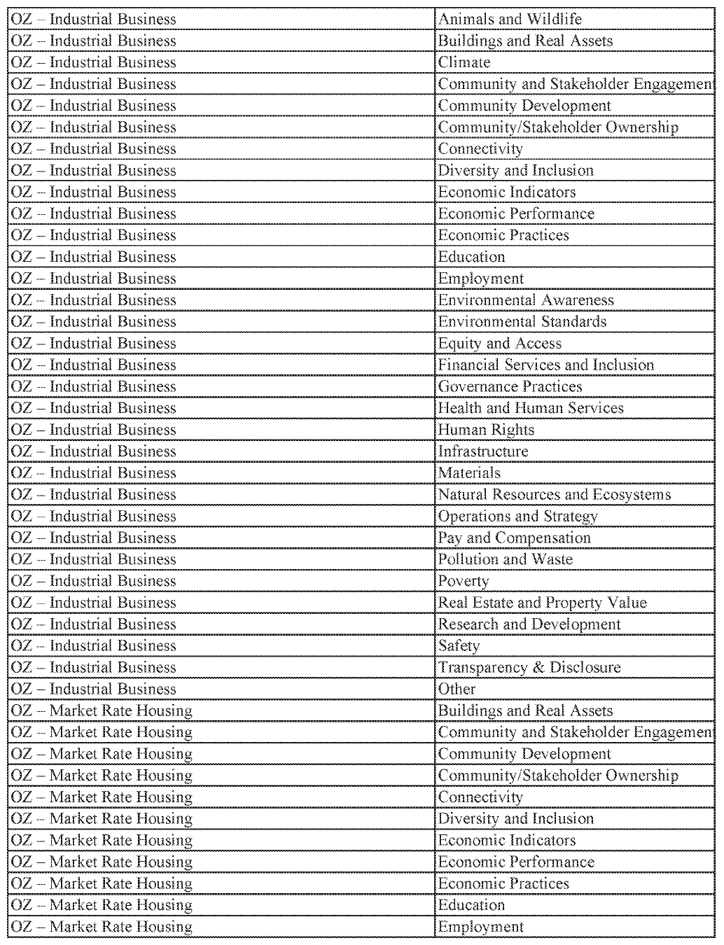

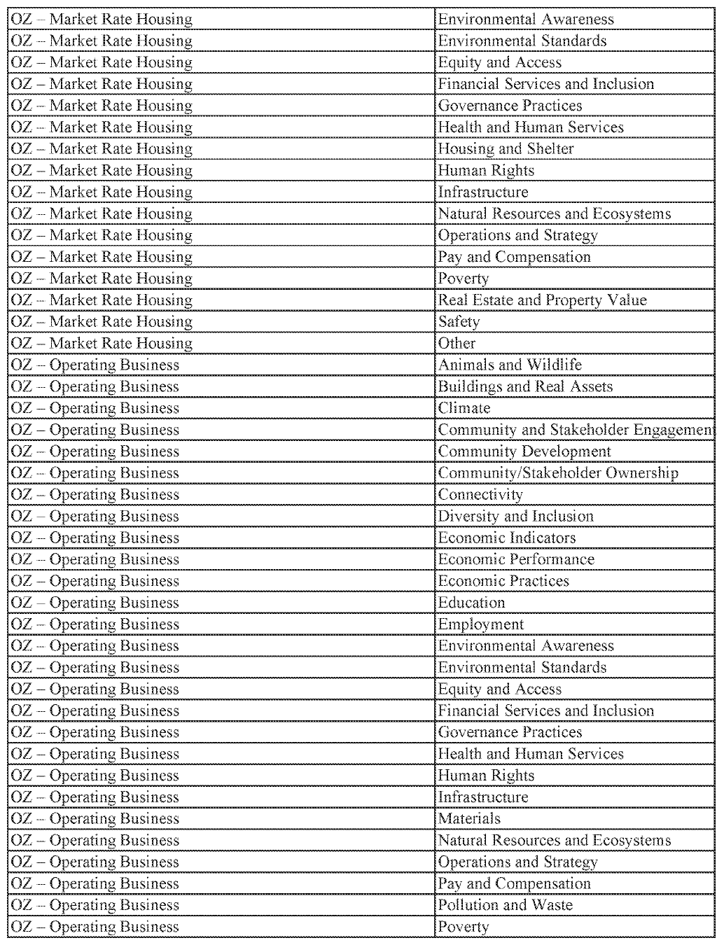

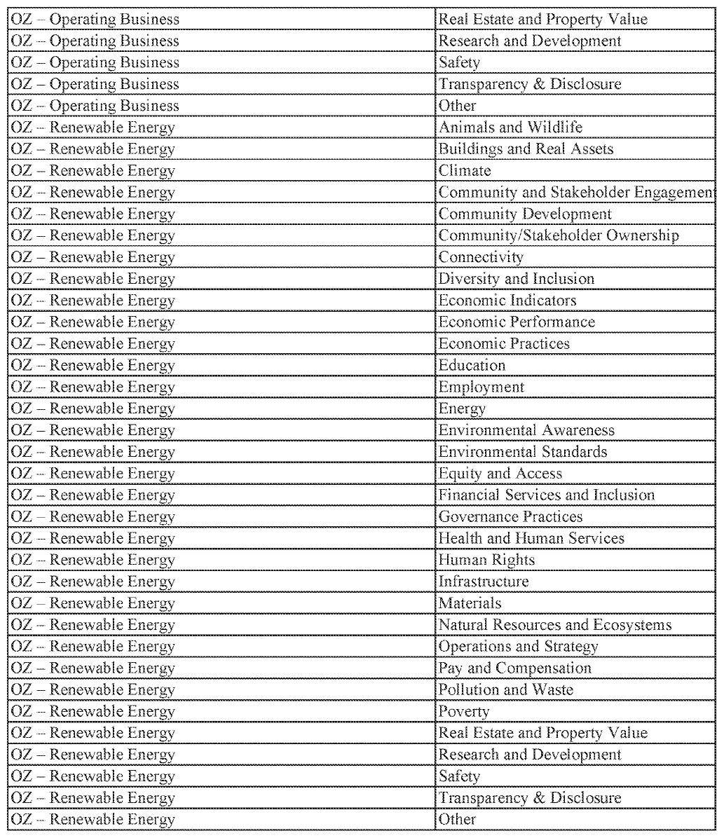

“Impact theme” means a broad category of societal or planetary benefits or detriments that individuals, organizations, or governments can create in the world. Impact themes may be based on type of impact. For example, impact themes based on type of impact include social impact, environmental impact, economic impact, and governance impact. Impact themes may be based on foci of the activity. For example, impact themes based on foci may affect more than one impact area across themes and include agriculture, air, biodiversity and ecosystems, climate, diversity and inclusion, education, employment, energy, financial services, health, infrastructure, land, oceans and costal zones, pollution, real estate, waste, and water. Impact themes may be based on objectives of the activity assessing performance under a pre-determined standard. For example, impact themes based on assessing objectives may affect more than one impact area across themes under a pre-determined standard and include opportunity zones (i.e. an economic development designation to incentivize investment in distressed areas in the United States), the United Nations Sustainable Development Goals (the “UN SDGs”) (i.e. objectives set forth by the United Nations that countries can adopt to reduce poverty and other deprivations), and the World Bank Environmental and Social Standards Framework (the “WB ESS”) (i.e. objectives that enable the World Bank and its partners to better manage environmental and social risks of projects in order to improve development outcomes). The WB ESS objectives that are impact themes in FIG. 17 are attributed to: 2016 “World Bank Environmental and Social Framework.” World Bank, Washington, DC. License: Creative Commons Attribution CC BY 3.0 IGO. This attribution extends only to the ten WB ESS objectives.

“Qualitative and quantitative indicators” are the variables that go into assessing the iRR. These variables include key impact indicators (representing type and quantity of impact), impact goal (representing type and quantity of impact), impact multiplier values (representing quality of impact), impact metrics (representing quality of impact), impact quantity (representing quantity of impact), cost (representing cost of impact), impact efficiency (representing cost effectiveness of impact), and time periods (representing time of impact).

“Key impact indicator” or “KII” means a unit of measurement of an activity within an impact area, and which indicates the activity's quantity of impact. A KII may be the unit of measurement of an activity within an impact area sub-category.

“Impact metric point value” is a quantitative (numeric value) quality measurement of an impact metric, where each impact metric has an associated numeric value from −100-100, for a respective activity.

“Impact area” means all modalities within an impact theme.

“Impact area sub-category” is the manner in which impact is delivered within an impact area, and which indicates the activity's type of impact.

“Impact metric” is the type of quantitative indicator measured to determine the quality of impact delivered by that indicator through a KII. The impact metric may be third party certification, validation, or method of analysis, such as LEED certification.

“Impact multiplier value” is the quantitative measurement of all impact metrics with a numeric value from −0.999-0.999, where closer to −0.999 indicates detrimental quality impact delivery as measured by those metrics and closer to 0.999 indicates high quality impact delivery as measured by those metrics. For the purpose of the iRR calculation, the impact multiplier value is figured as an absolute value.

“Cost” means a measure of an activity's cost in currency (i.e. fiat currency of a sovereign nation).

“Impact efficiency” means a measure of an activity's cost per KII unit, as calculated by applying a logarithmic function to the total cost of an activity divided by the total number of that activity's KII units expected, in delivery, or delivered, as determined by whether the analysis is ex-ante (before the activity), ex-hoc (during the activity), or ex-post (after the activity). The terms “expected”, “delivery”, and “delivered” are used interchangeably in reference to KII units throughout the application. For example, this would be KII units expected in an ex-ante analysis, KII units in delivery in an ex-hoc analysis, or KII units delivered in an ex-post analysis. The logarithm normalizes the activity's cost per KII unit into an impact efficiency within the determination of the iRR allowing the iRR to compare impact of activities for the same impact area sub-category or impact of activities for different impact area sub-categories across different themes. The KII value is a value greater than 0.0.

“Log base” means the base of a logarithmic function applied to a variable.

“Time period” means the length of time during which an activity is evaluated.

“Impact quantity” means a measure of the quantity of impact an activity may deliver over the activity's time period within the context of an impact theme, as may be calculated by taking the value of the ratio of delivered KII units over the impact goal. The impact quantity may be alternatively calculated by applying a logarithmic function to the total KII units delivered, or by using the total number of KII units delivered.

“Impact goal” means the desired number of key impact indicator units resulting from an activity or set of activities.

“Search query” means the word or words a business entity user uses to describe the manner in which impact is delivered in connection with an activity.

“Impact keyword” means the word or words in a search query that are associated with impact area sub-categories.

“KII keyword” means the word or words in the search query that are associated with KIIs.

“Stored” or “storing” means the processing element of the computing device directing the storage of a value or information in the memory using non-transient software code and data stored in the memory of the computing device to carry out the storing of the value or information.

“Processing” means the processing element of a computing device using computer readable non-transient software code and data stored in the memory of the computing device to carry out a processing function.

“Transmitting” means the processing element of a computing device using computer readable non-transient software code and data stored in the memory of the computing device to carry out transmitting an output.

“Receiving” means the processing element of a computing device using computer readable non-transient software code and data stored in the memory of the computing device to carry out receiving an input.

“Displaying” means the processing element of a computing device using computer readable non-transient software code and data stored in the memory of the computing device to direct display of an output by a display of the computing device when a non-transitory computer-readable medium having computer executable instructions is installed on a computing device.

“Validating” or “validate” means the processing element of a computing device using computer readable non-transient software code and data stored in the memory of the computing device to direct authentication of account login information associated with a registered account.

A system to quantitatively assess the impact value of money of at least one activity within an impact theme and across impact themes by transforming qualitative and quantitative indicators into a single quantitative measurement is described. Additionally, the system accurately identifies and associates the quality of impact (impact multiplier value) and the quantity of impact (KII) of an activity or activities. In the system described herein, a service provider provides a computer-based (e.g. online or installed) program (e.g. via a website of the service provider or through software installed on a computer) for calculating the iRR of an activity, to monitor the iRR as the activity progresses over time, and to compare the iRR of the activity (1) in different impact themes and (2) to the iRR of other activities. The system allows a business entity to assess the impact value of money for one or more of their activities within one or more impact themes.

By assessing the impact value of money for one or more activities before an activity begins, the system provides a business entity the ability to predict the iRR of the activity and the option to modify its activity management plans to consider how these modifications affect the iRR. Moreover, by assessing the impact value of money over time during the course of an activity, the system provides the business entity the ability to track (e.g. logging information) and monitor (e.g. reviewing logged information) the iRR of the activity as it progresses. This gives the business entity to the ability to modify its management plans for the activity during the performance of the activity to produce desired changes in the iRR. Finally, as the system transforms qualitative and quantitative measurements into a single quantitative measurement (the iRR), the system provides business entities the ability to benchmark the iRR of their activities against other activities.

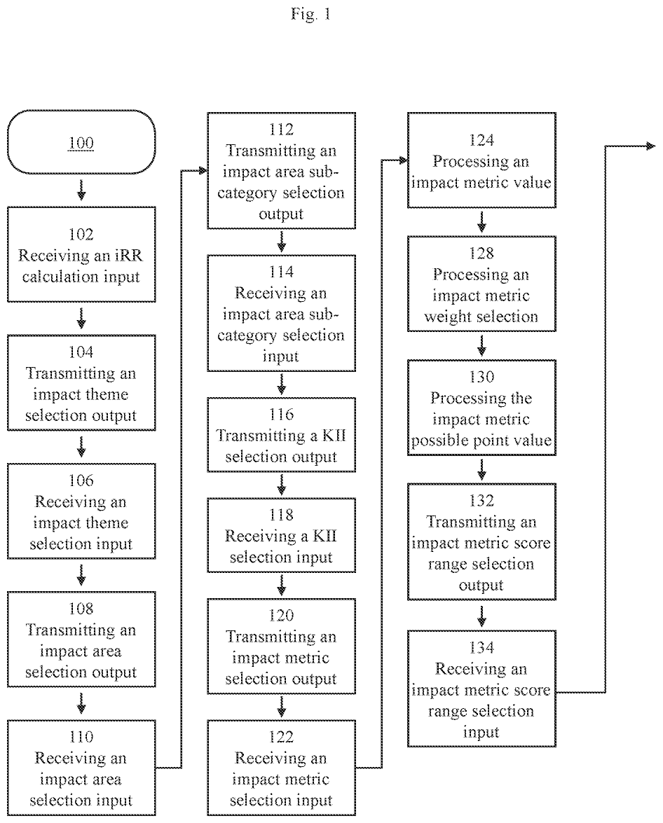

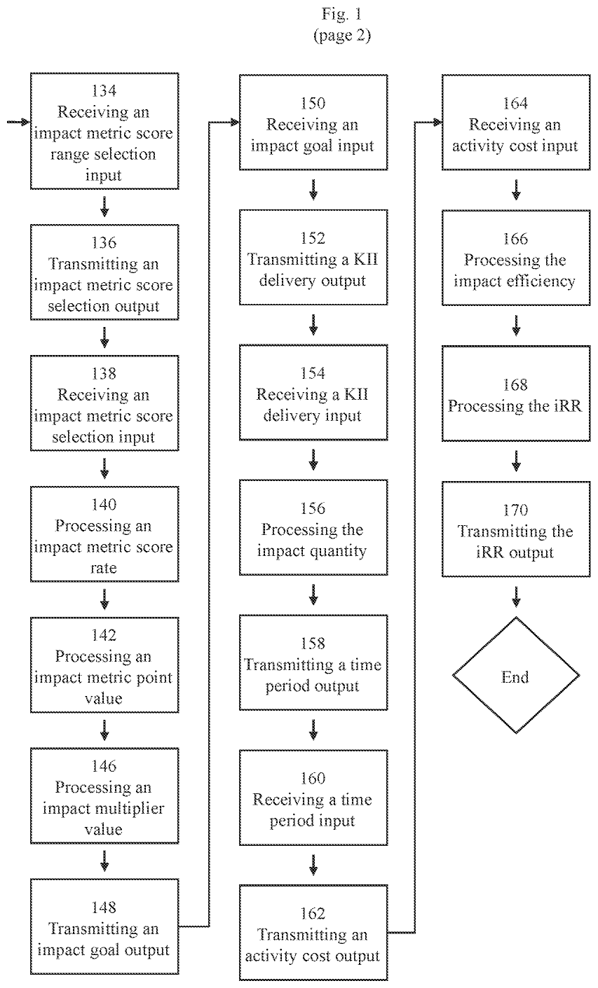

FIG. 1 represents a method 100 used by the system for assessing the impact value of money by calculating the iRR of an activity. The method utilizes the following algorithm:

$$f ( M ) = \{ \begin{matrix}- \frac{\frac{K}{G} ⋁ {Log}_{b} K ⋁ K}{( 1 - \vert M ⋁ \frac{{\sum }_{i = 1}^{N} {Q}_{i}}{100} \vert ) \times ( {Log}_{b} \frac{C}{K} ) \times T} & - 1 < M < 0 \\ \frac{\frac{K}{G} ⋁ {Log}_{b} K ⋁ K}{( 1 - M ⋁ \frac{{\sum }_{i = 1}^{N} {Q}_{i}}{100} ) \times ( {Log}_{b} \frac{C}{K} ) \times T} & 0 \leq M < 1\end{matrix}$$

where the impact quantity of an activity is represented as

$$\frac{K}{G} ⋁ {Log}_{b} K ⋁ K$$

where the impact multiplier value of an activity is represented as

$$M ⋁ \frac{{\sum }_{i = 1}^{N} {Q}_{i}}{100}$$

where the impact efficiency of an activity is represented as

$${Log}_{b} \frac{C}{K} ,$$

such that

$$0 < {Log}_{b} \frac{C}{K}$$

where T is the time period of an activity, such that 0<T, T∈ [symbol] ,

where K is the number of key impact indicator units of an activity

where G is the impact goal of a business entity user expressed in terms of K

where b is the base of a logarithmic function, such that 1<b, b∈

[symbol]

where M is the impact multiplier value of an activity, such that −1<M<1, M∈

[symbol]

where N is the number of values in the set Q

where i is an impact metric point value

where Q is the set of impact metric point values

where C is the cost of an activity, and

where v is the operator “or”.

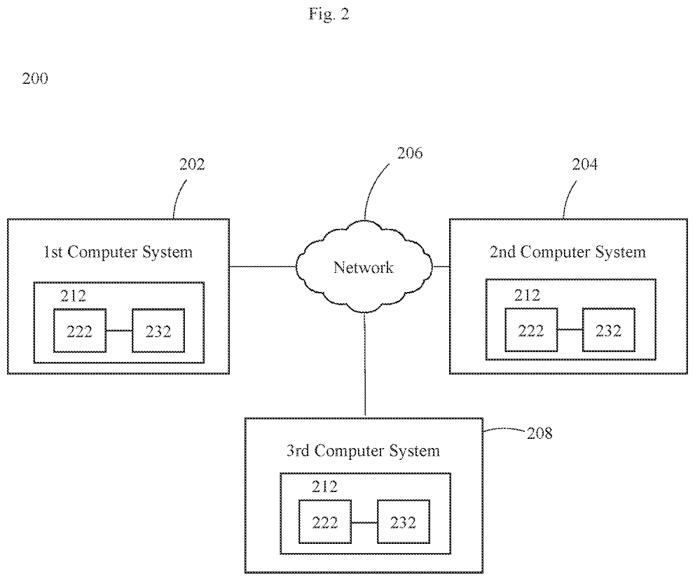

FIG. 2 is a block diagram of a system for implementing the methods of calculation of the iRR, where the system may include a first computer system 202, a second computer system 204, and a third computer system 208. The calculation of the iRR may be provided as computer-based (e.g. online, web-based) services via an Internet site (e.g. website) associated with a provider of the services (e.g. service provider). A first computer system 202 is associated with the service provider. The first computer system 202 may include one or more computing devices 212 (e.g. servers, nodes, computers). As used herein, the “computing device” may refer to a general purpose device that can be programmed to carry out various sets of arithmetic or logical operations. Further, the computing device may include one or more processing elements 222 (e.g. processors, central processing unit (CPU)) and some form of memory 232 (e.g. data storage device, database), the memory being connected to (e.g. communicatively coupled with) the processing element(s). The computing device may further include one or more user interface devices (e.g. user input devices), such as a keyboard, mouse, display, and/or the like, which are connected to (e.g. communicatively coupled with) the processing element(s). As used herein, the term “server” may refer to software (and suitable computer hardware) which is configured for providing (or helping to provide) a network service. For example, the term “server” may refer to software which is executed on a dedicated computer (e.g. hosted by a networked computer) or executed on a computer in a shared hosting environment. Further, the term “server” may refer to the dedicated computer itself. Further, the term “server” may refer to a computer program which may execute to service the requests of other computer programs. In embodiments in which the first computer system 202 includes multiple computing devices, the multiple computing devices of the first computer system may be connected to (e.g. communicatively coupled with) each other, including through application program interfaces (APIs).

A second computer system 204 is associated with a business entity (e.g. government agency, for-profit, non-profit, individual user) that desires to carry out the analysis of an activity and to calculate an iRR associated with the activity. Such analysis may be conducted ex-ante, ex hoc, or ex-post, and each of these time frames is referenced throughout this application, and while a particular time frame may be referenced it is for example purposes only and is not limiting as to the timing of analysis of any activity. For example, the business entity may be a real estate development company, a charity focused on improving access to pre-K education, or a manufacturing company.

The second computer system 204 may include one or more computing devices (e.g. servers, nodes, computers). The second computer system 204 may include multiple computing devices, the multiple computing devices of the second computer system 204 may be connected to (e.g. communicatively coupled with) each other. In examples, the second computer system (e.g. business entity computer system) 204 is remotely located from the first computer system (e.g. service provider computer system) 202.

The system may include a third computer system 208 that may be associated with a third party providing services to the business entity, that may be affected by the activity, or that has interest in the activity. For example, the third party may be a general contractor, a project manager, or a consultant that provides services to the business entity in association with the activity. Or for example, the third party may be an individual affected by the activity, such as a community member living within or near the activity. Or for example, the third party may have interest in the activity, such as an activist or organizer involved in the activity. The third party may have relevant information and data for inclusion into the calculation of the iRR associated with the activity.

The third computer system 208 may include one or more computing devices (e.g. servers, nodes, computers). The third computer system 208 may include multiple computing devices, the multiple computing devices of the third computer system 208 may be connected to (e.g. communicatively coupled with) each other. For example, the third computer system (e.g. business entity computer system) 208 is remotely located from the first computer system (e.g. service provider computer system) 202.

A user of the second computer system 204, such as an employee of the business entity, may utilize the second computer system 204 to access the website associated with the service provider. Further, a web page of the website including an iRR calculation request (e.g. icon, link, menu selection) may be displayed via a display of the second computer system 204. The user of the second computer system 204 may then provide an input which selects the iRR calculation request, thereby causing the iRR calculation request (i.e. the iRR calculation input) to be transmitted to the first computer system 202 over the network 206.

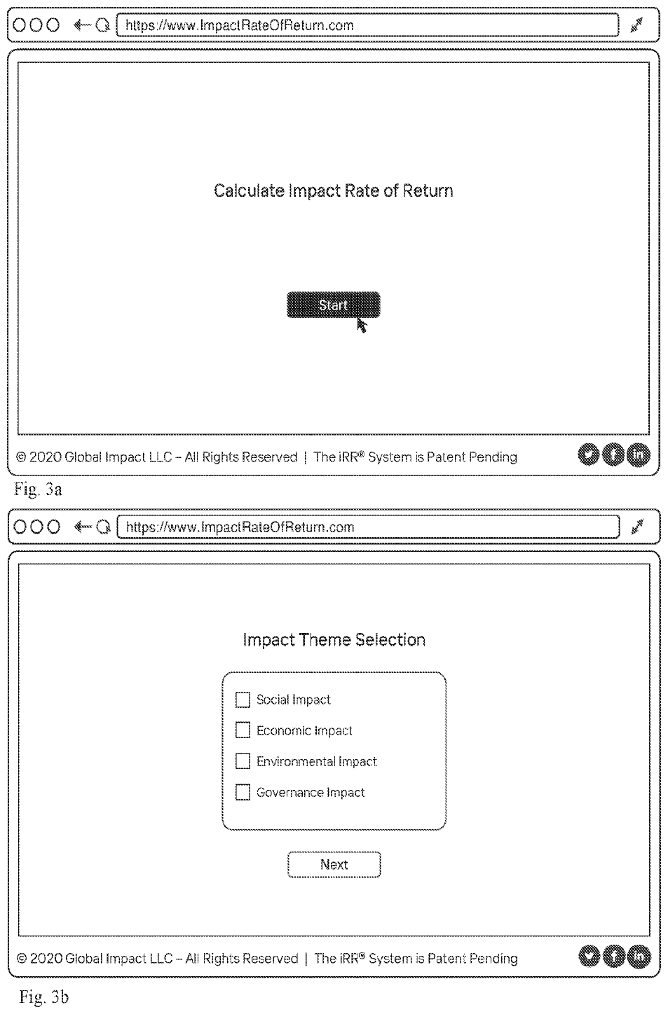

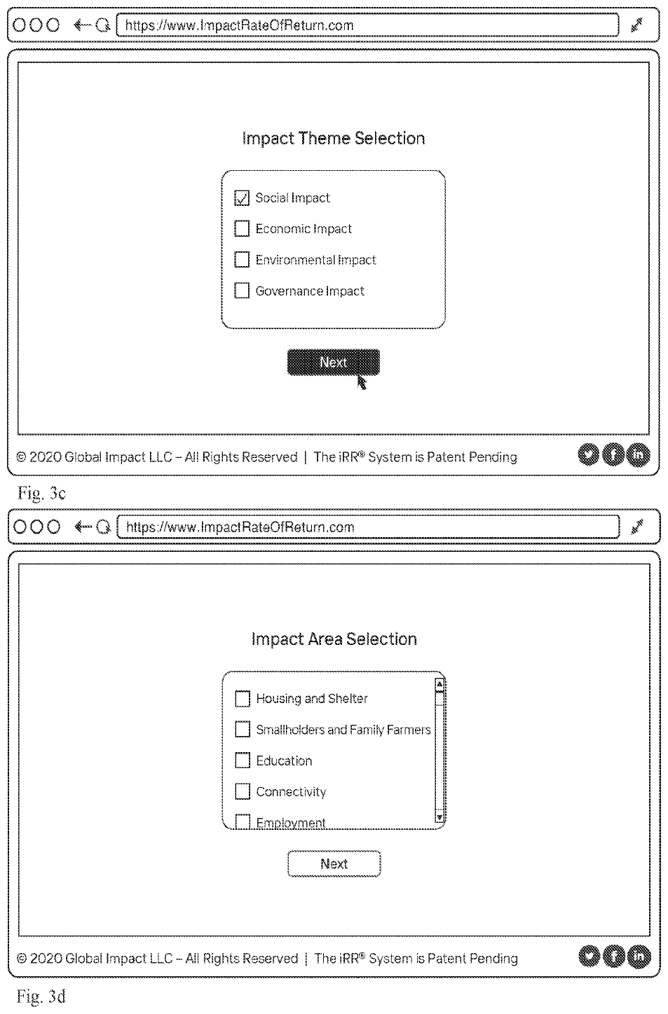

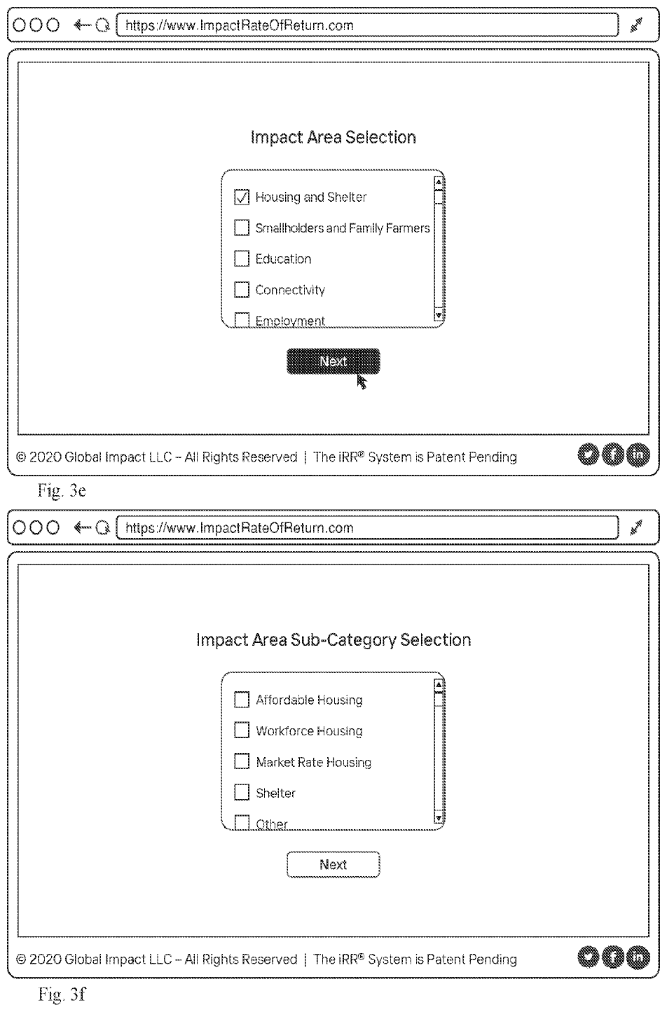

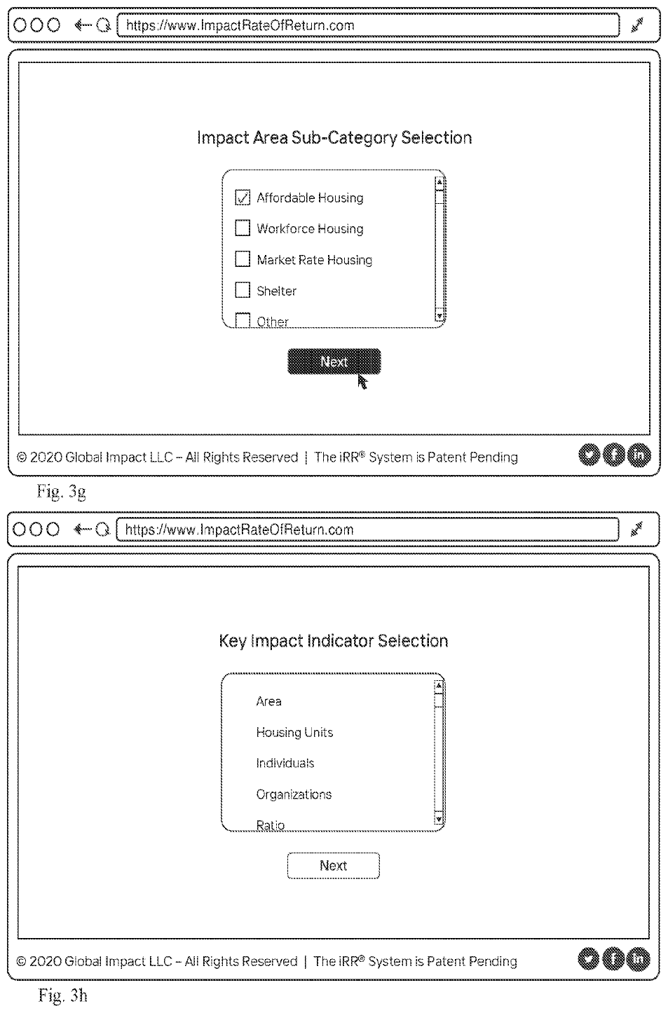

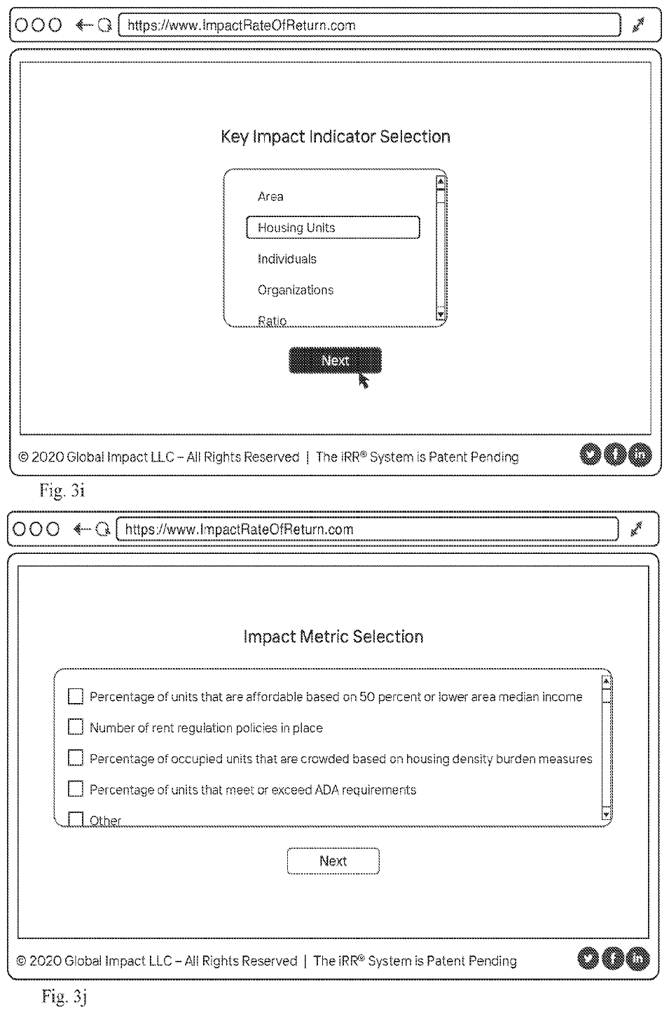

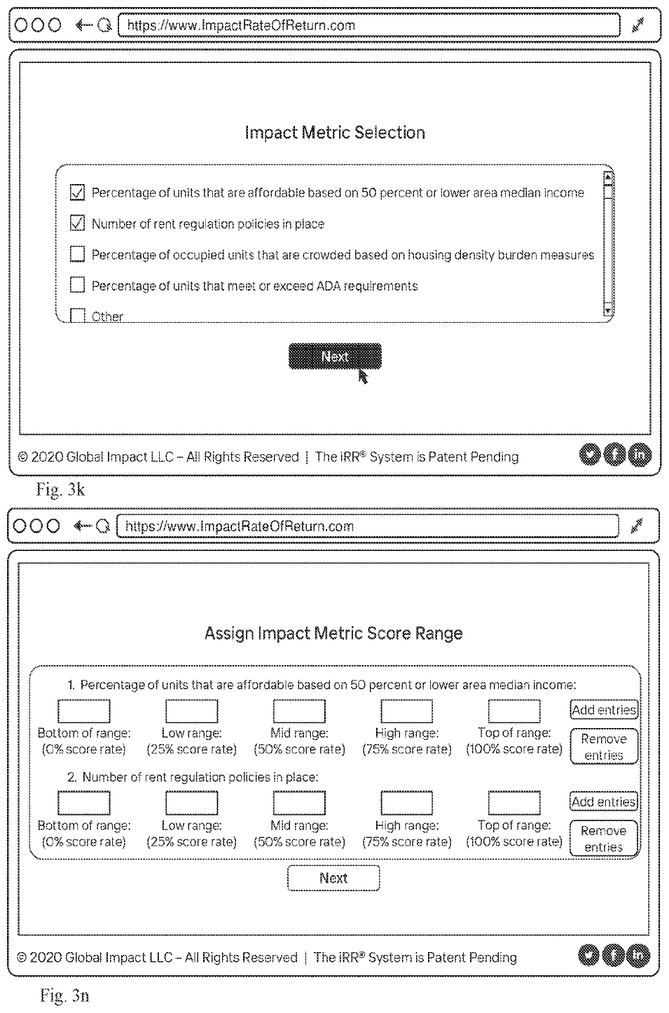

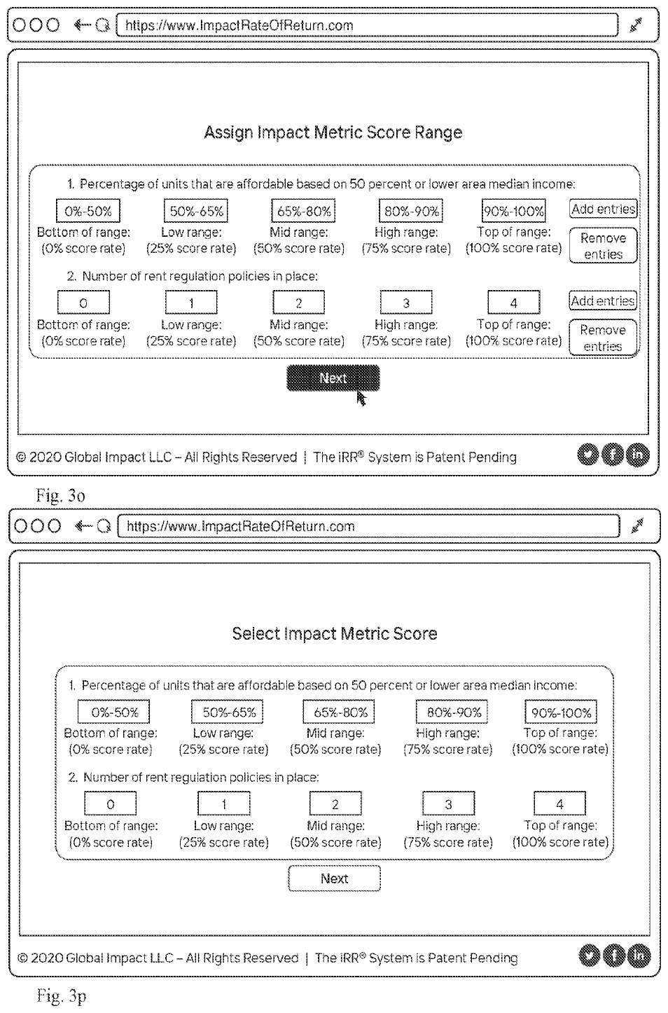

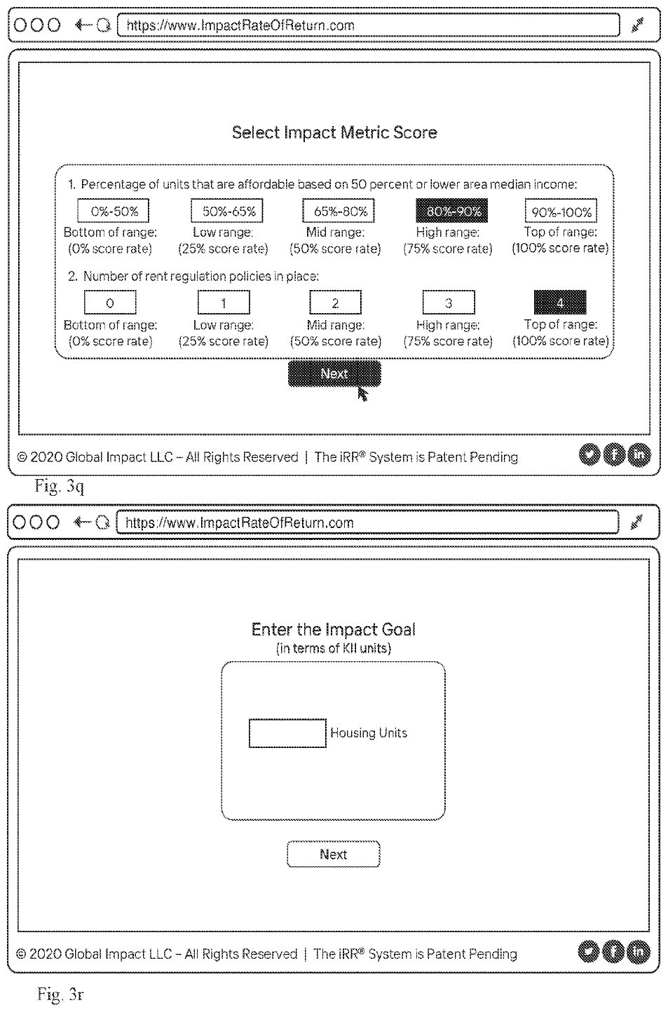

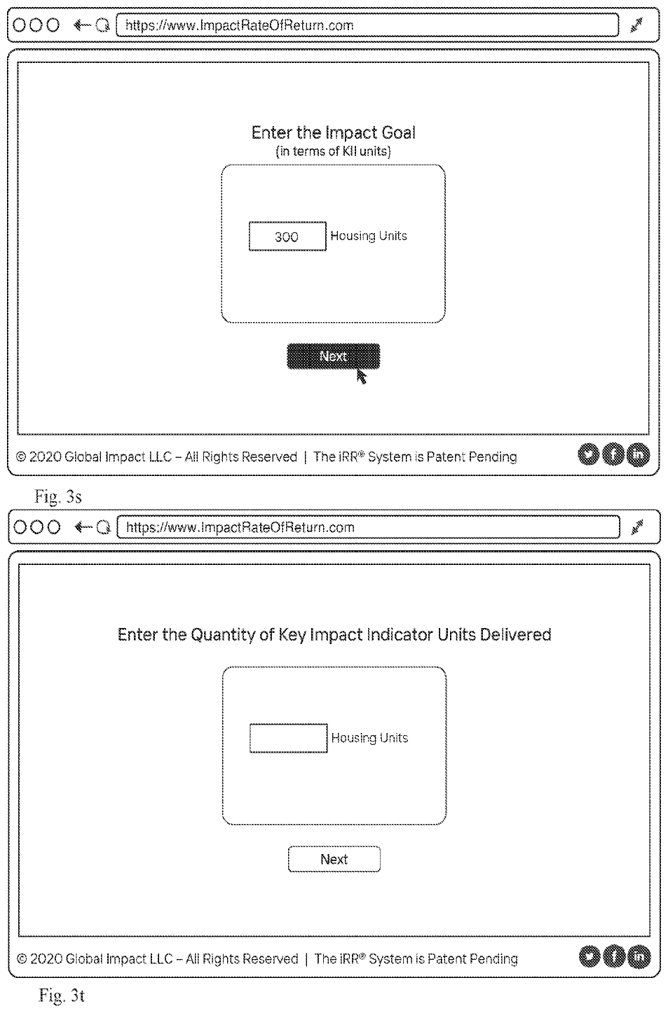

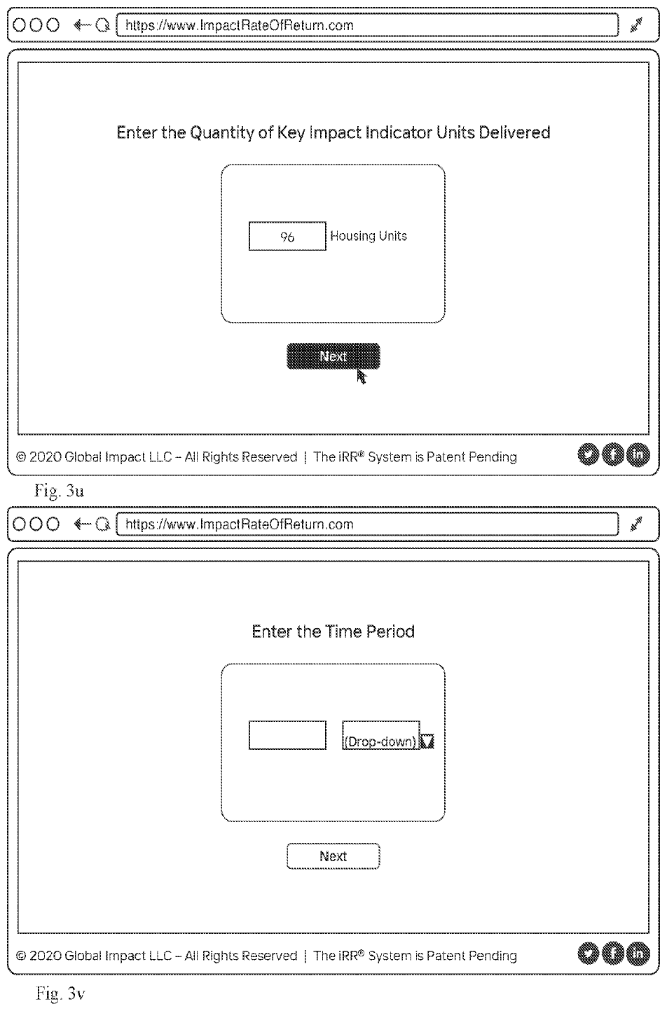

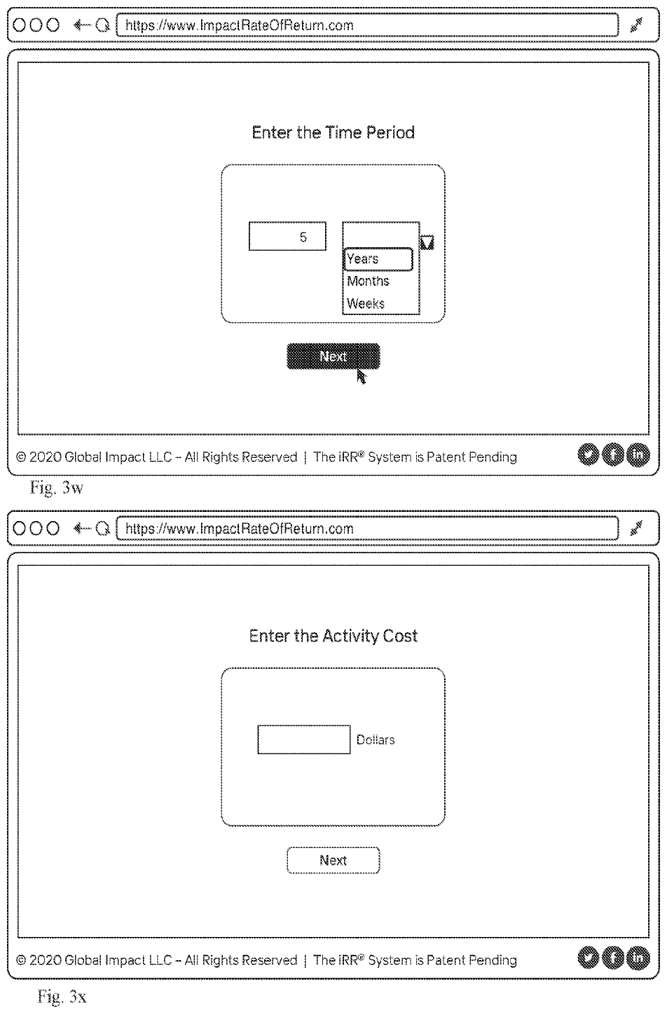

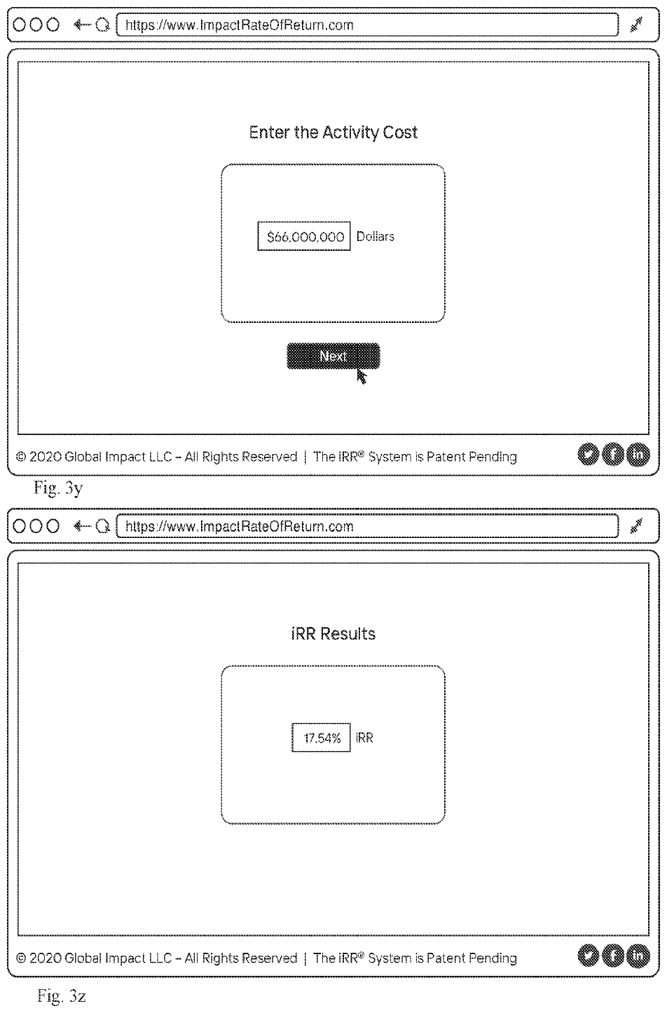

In 102, a first computer system receives an iRR calculation input, as represented in FIG. 3a. The iRR calculation input having been transmitted via a computer network 206 from a second computer system 204. The iRR calculation input includes a request to begin calculation of the iRR.

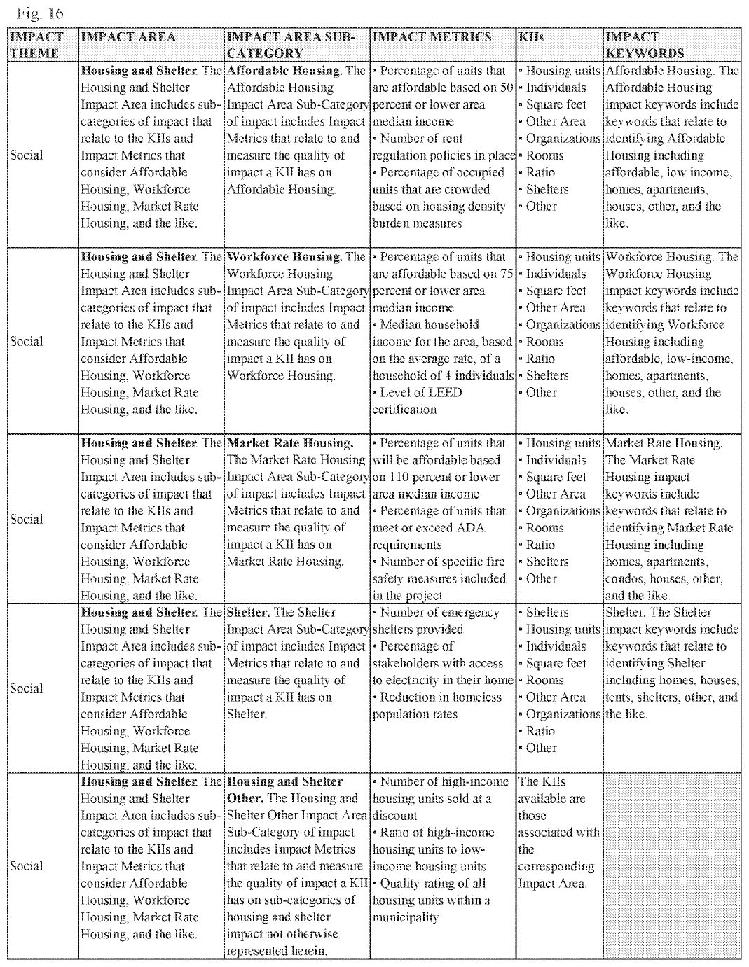

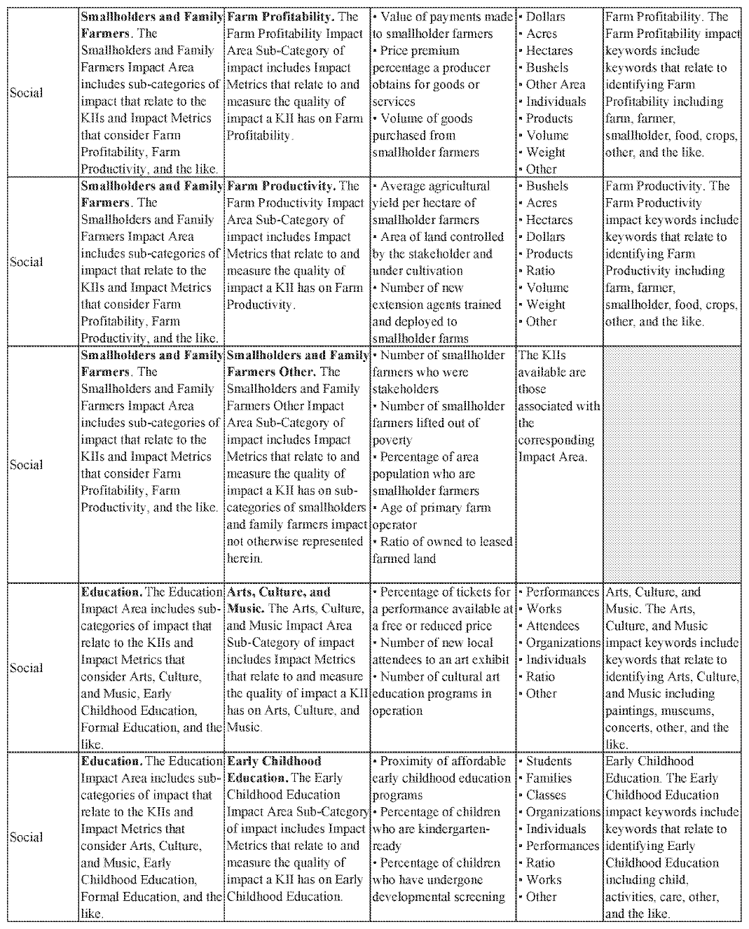

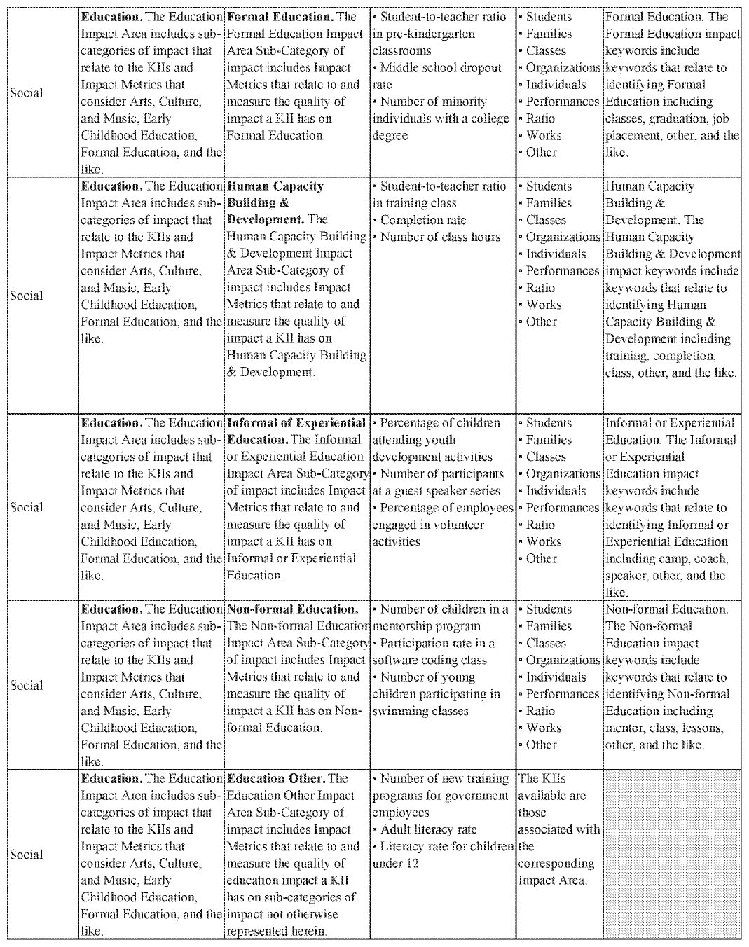

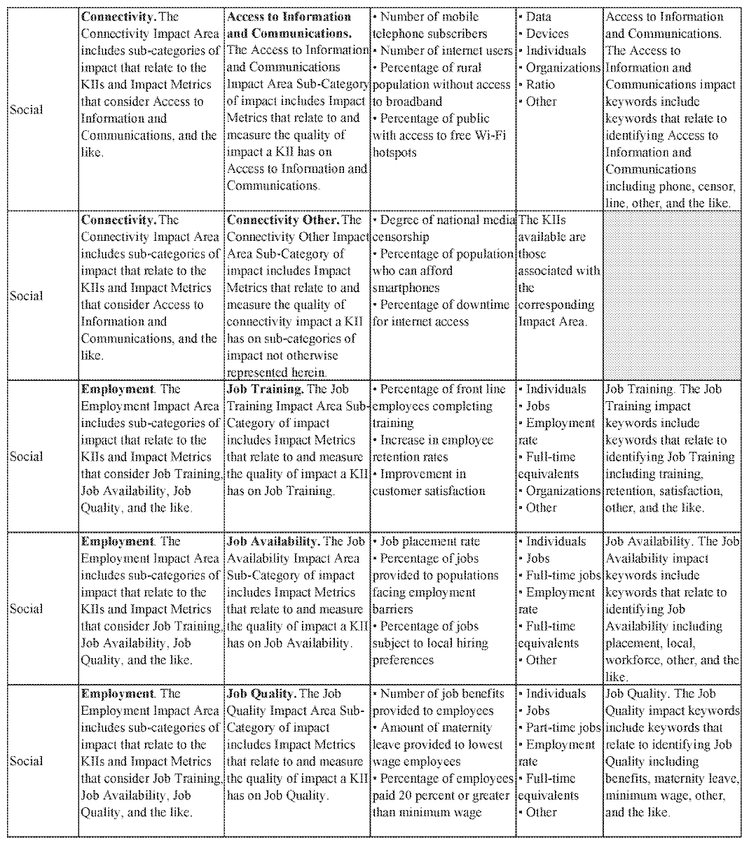

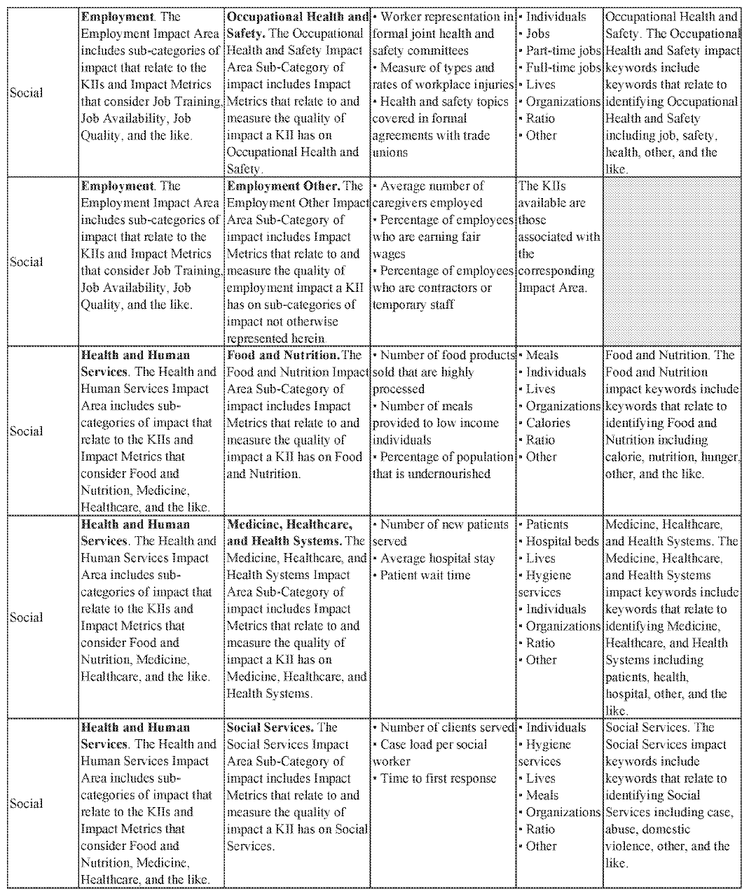

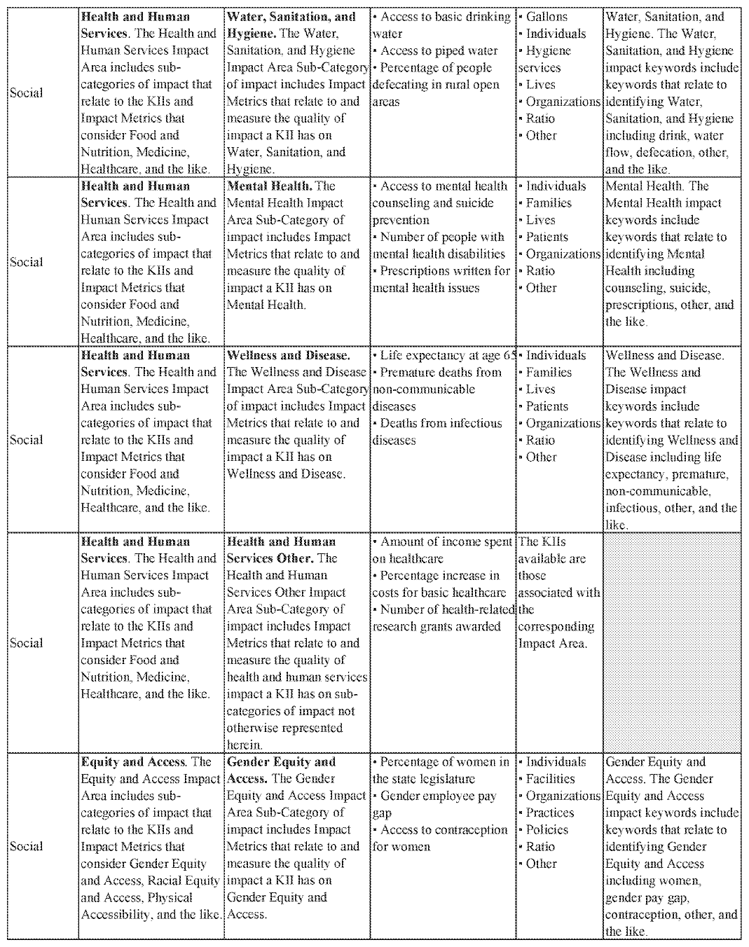

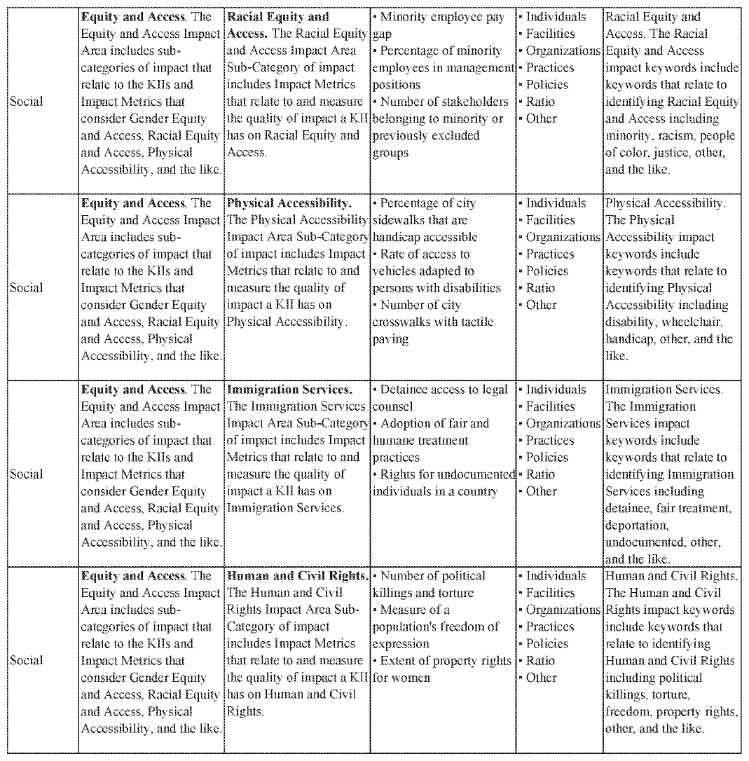

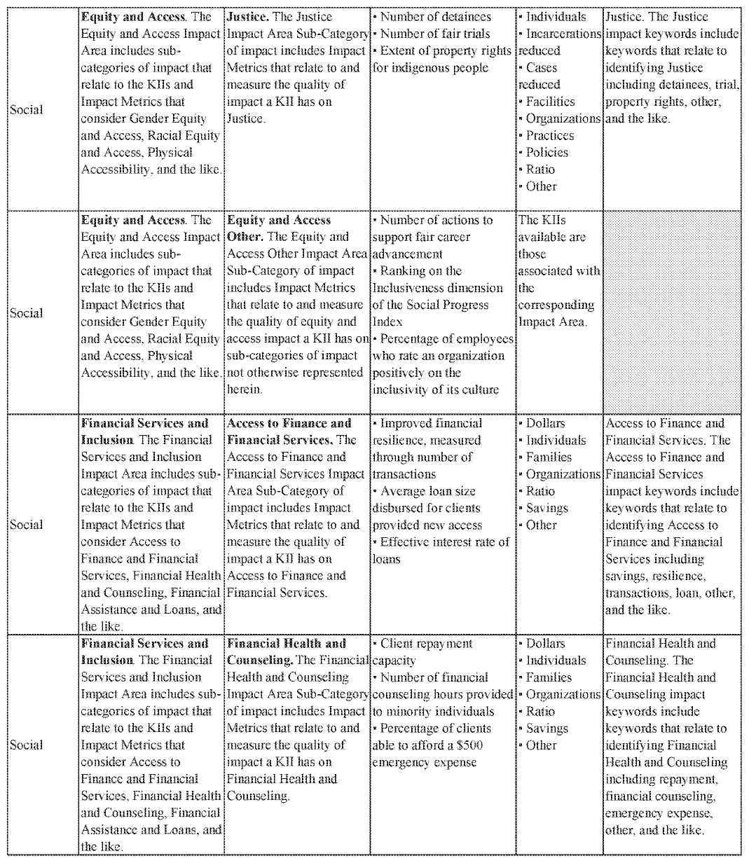

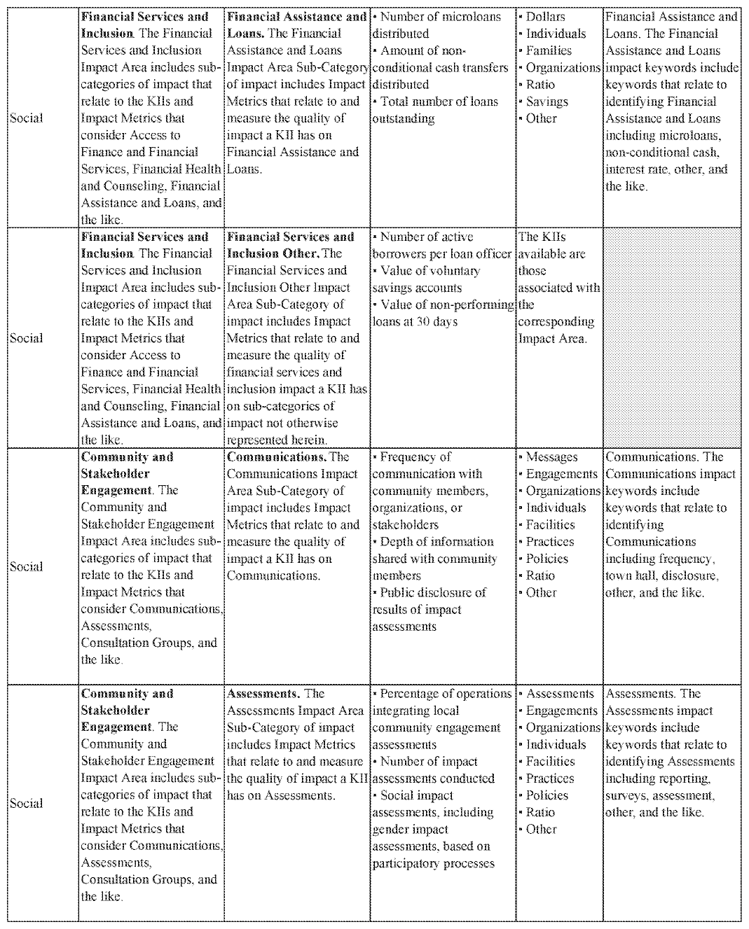

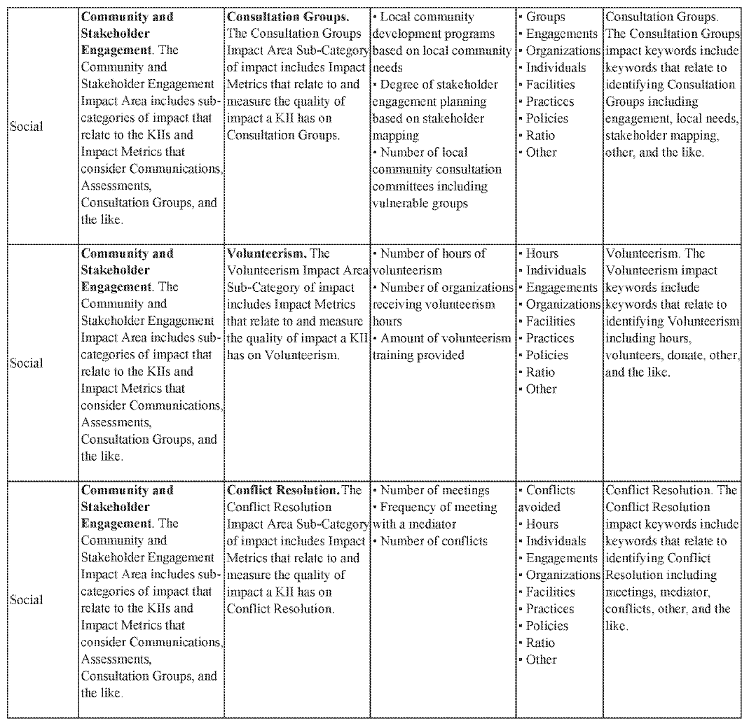

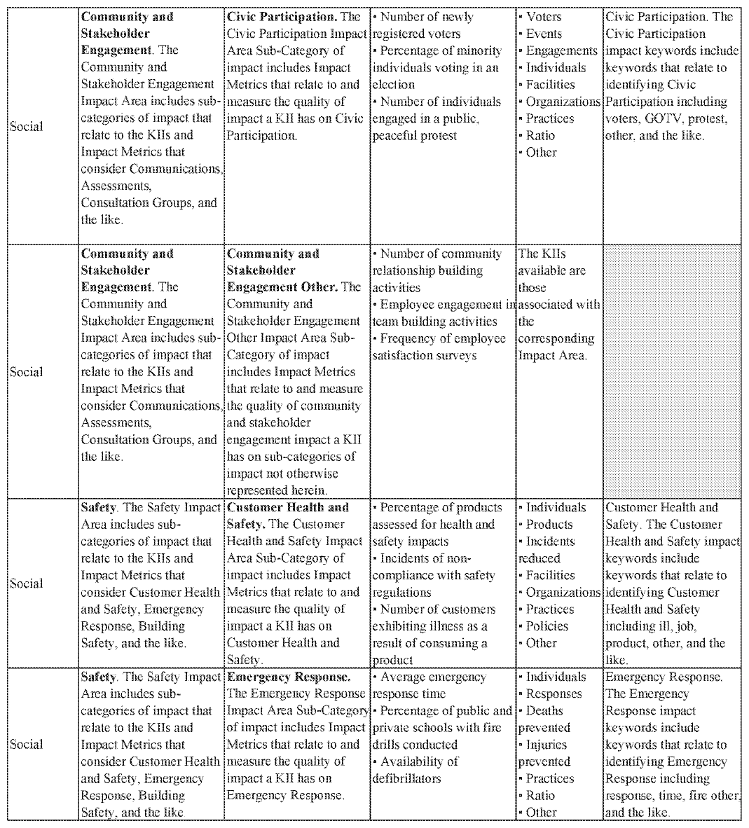

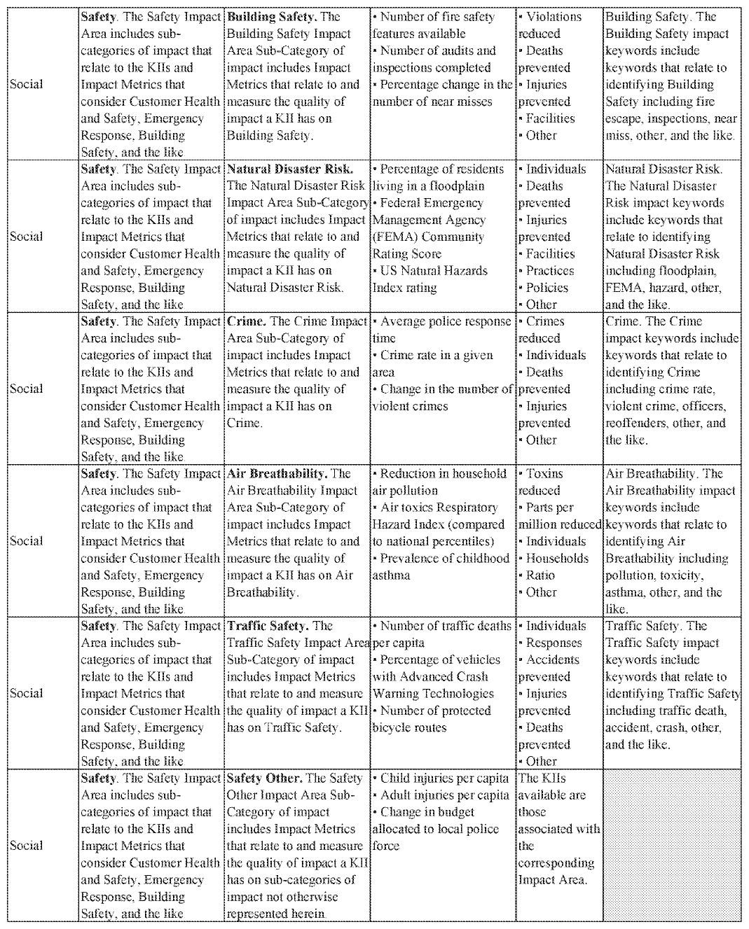

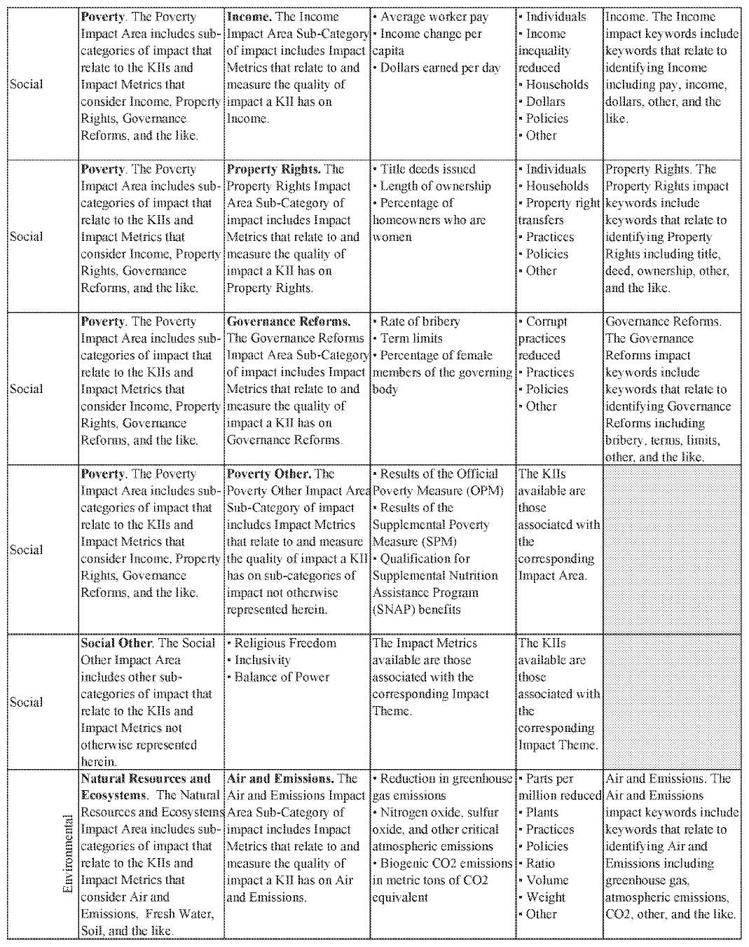

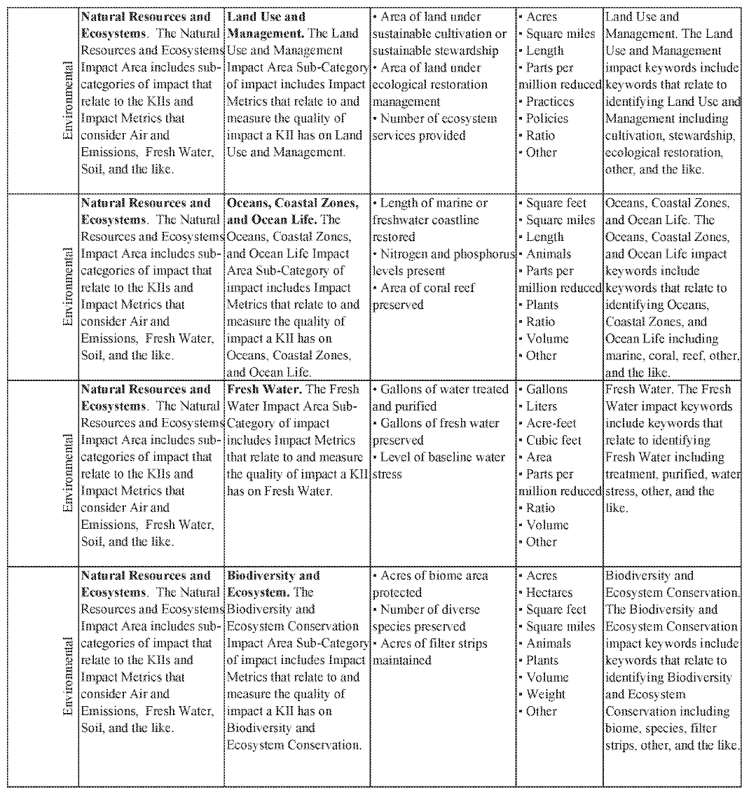

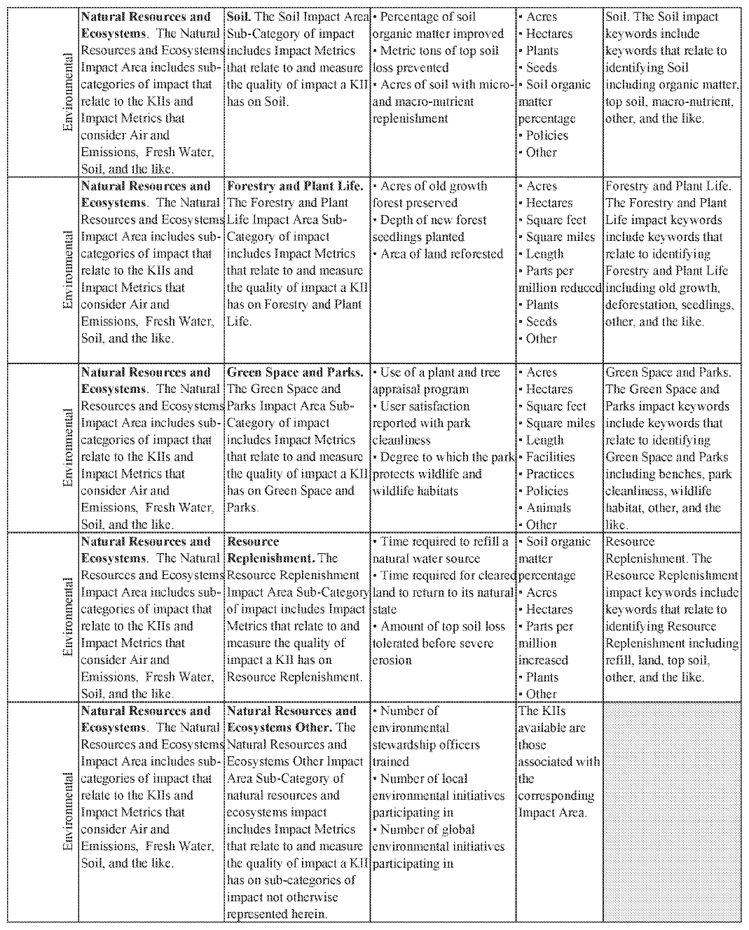

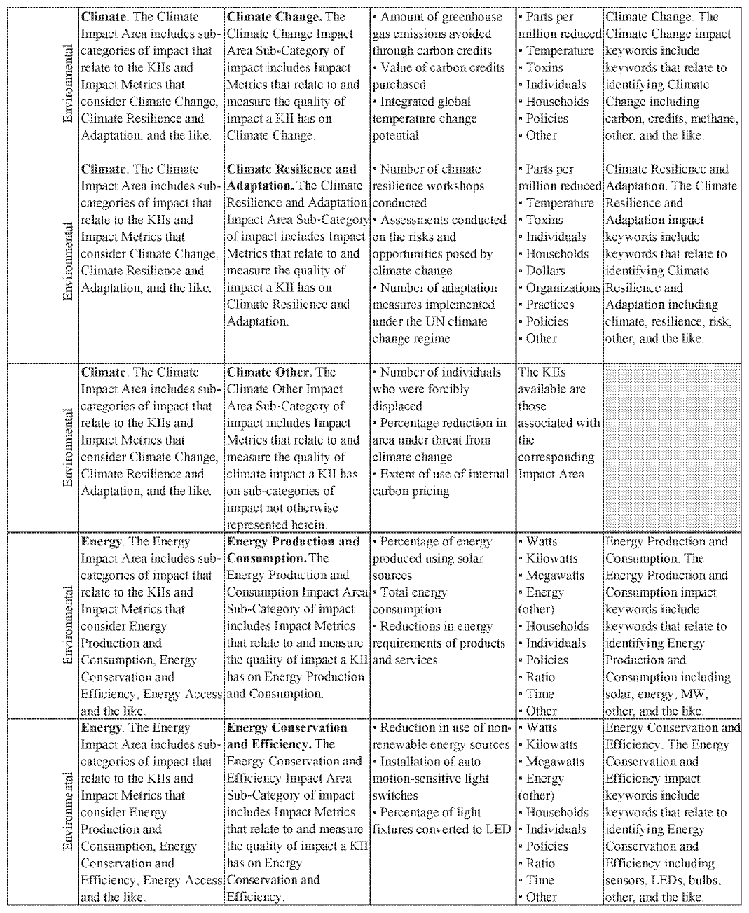

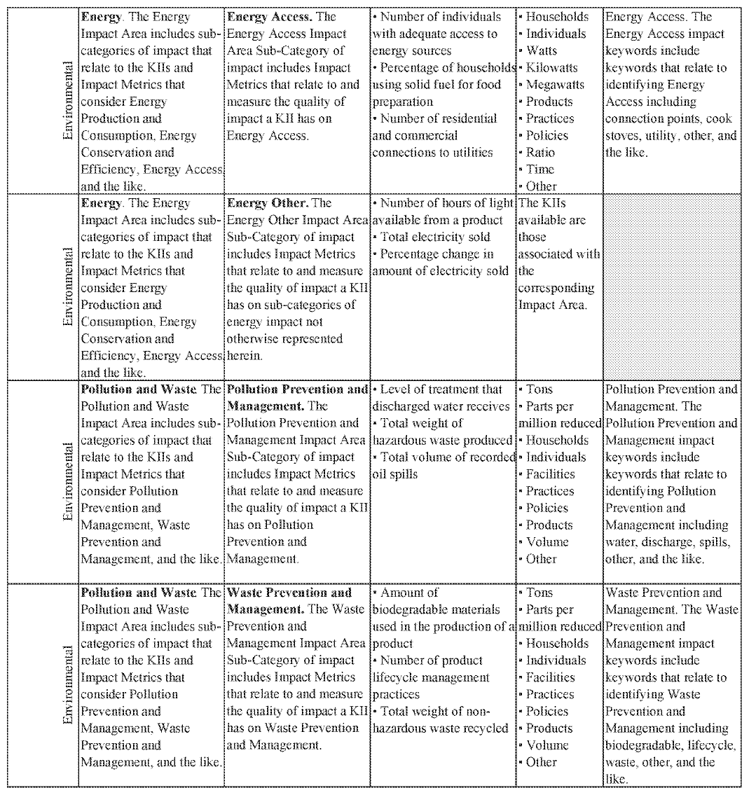

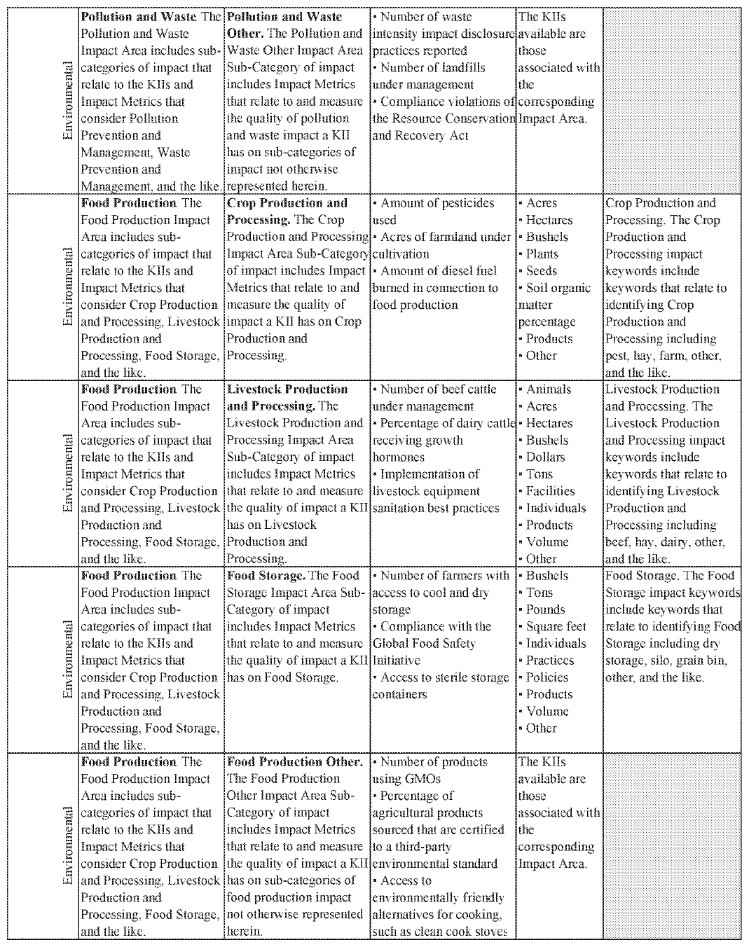

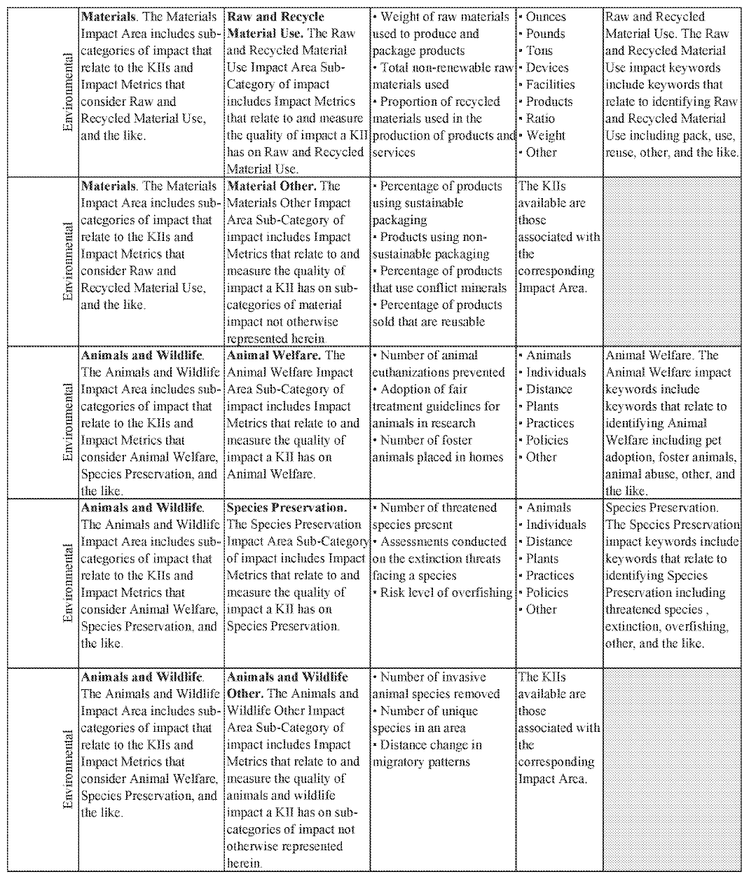

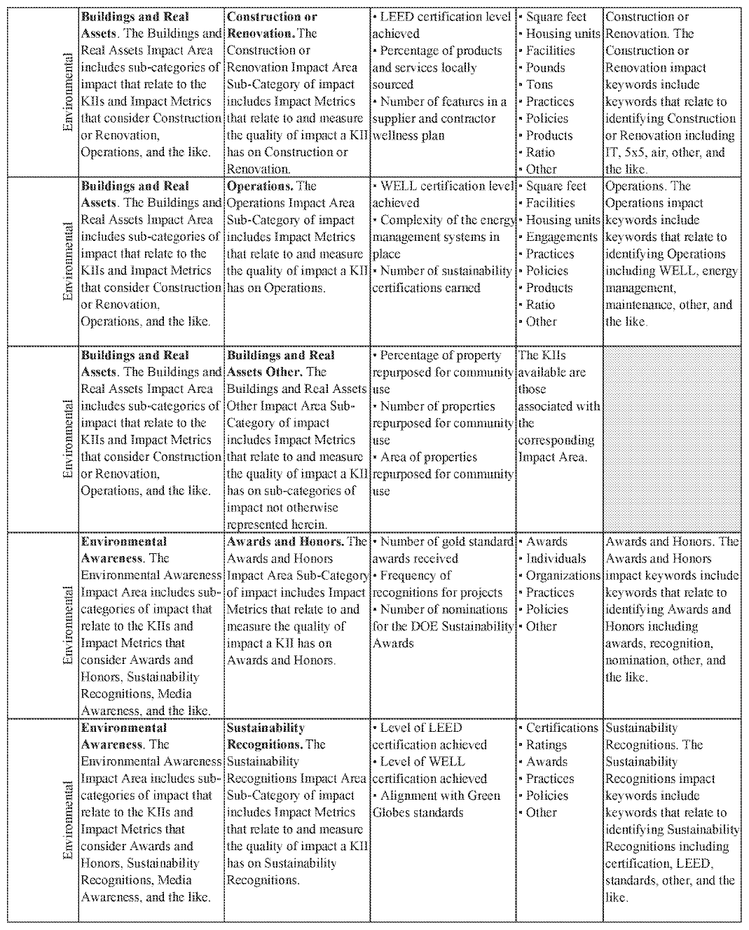

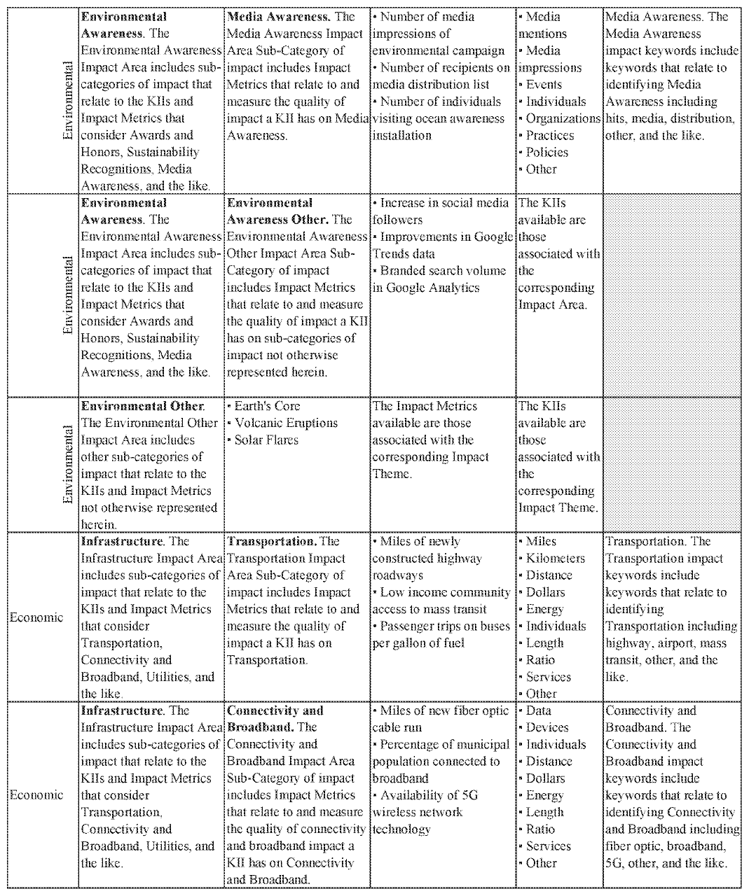

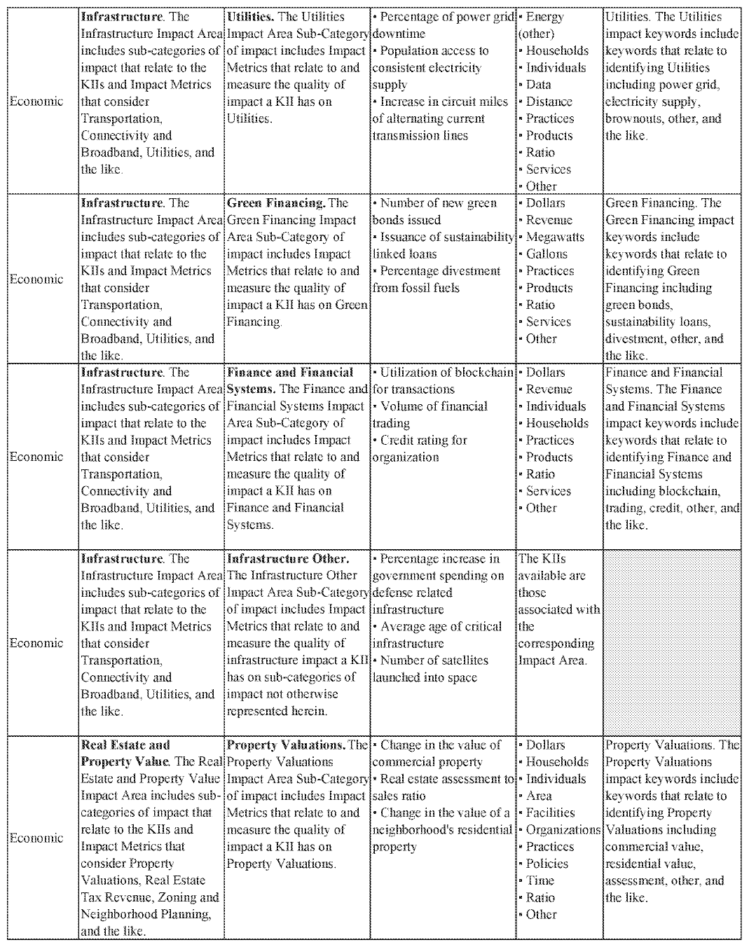

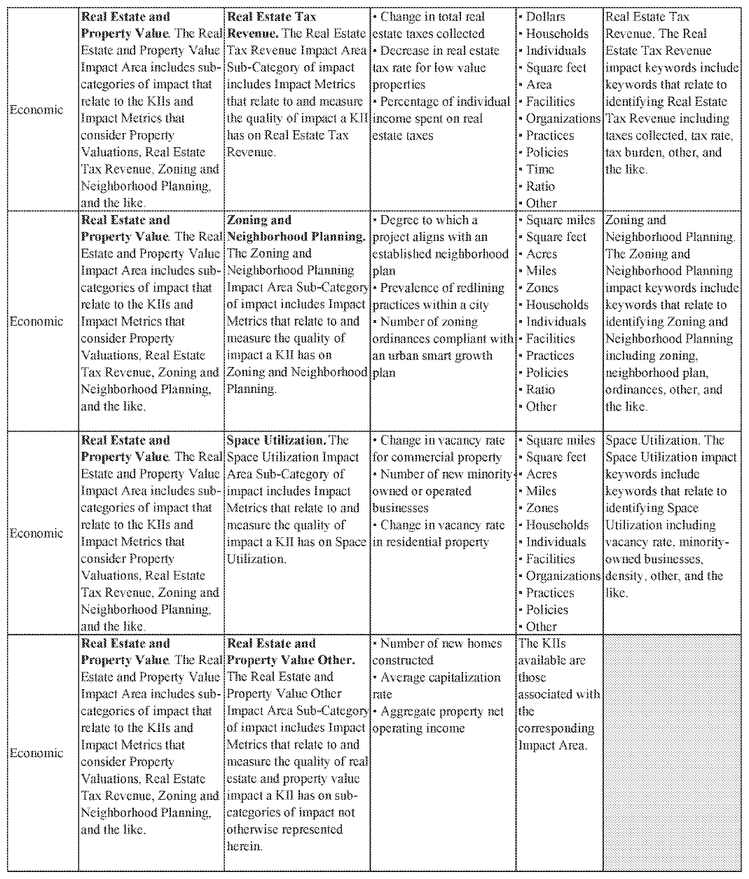

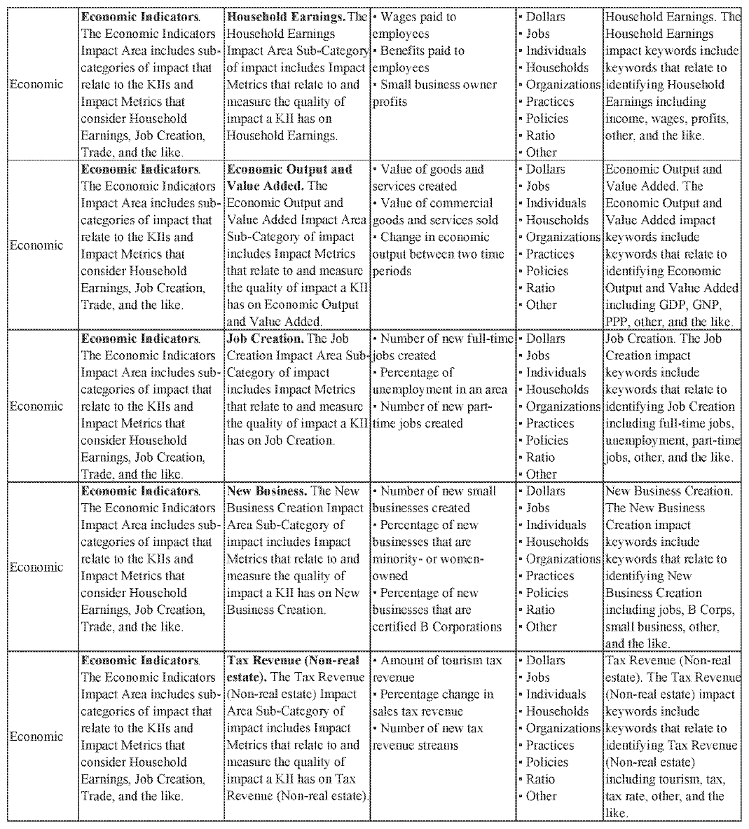

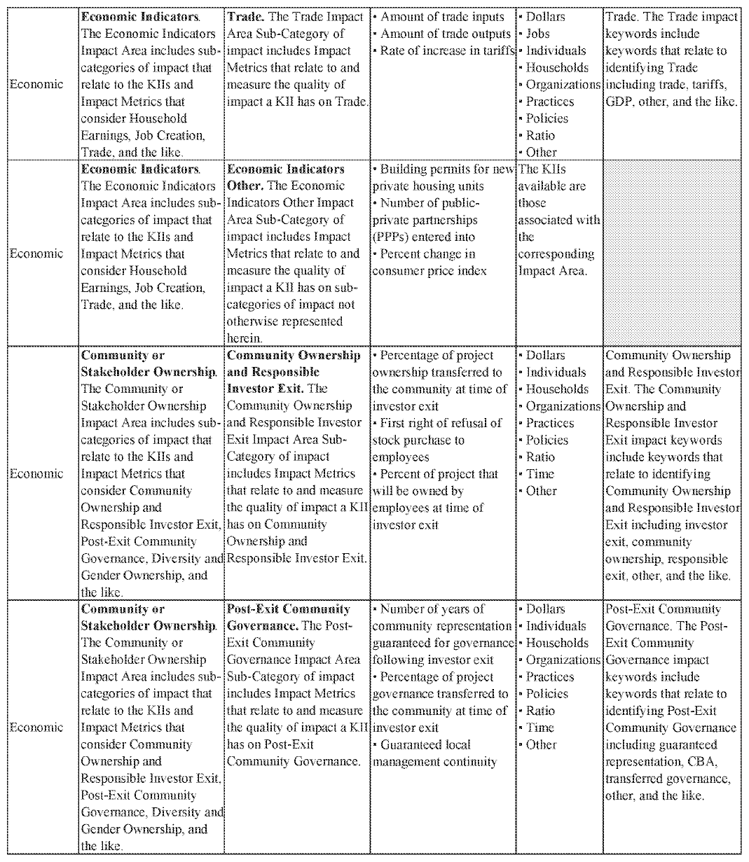

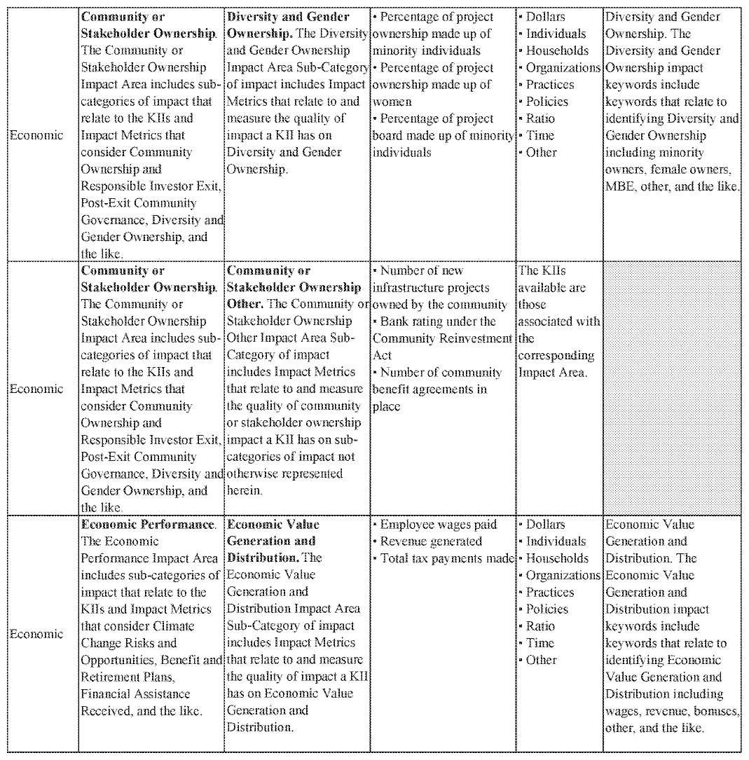

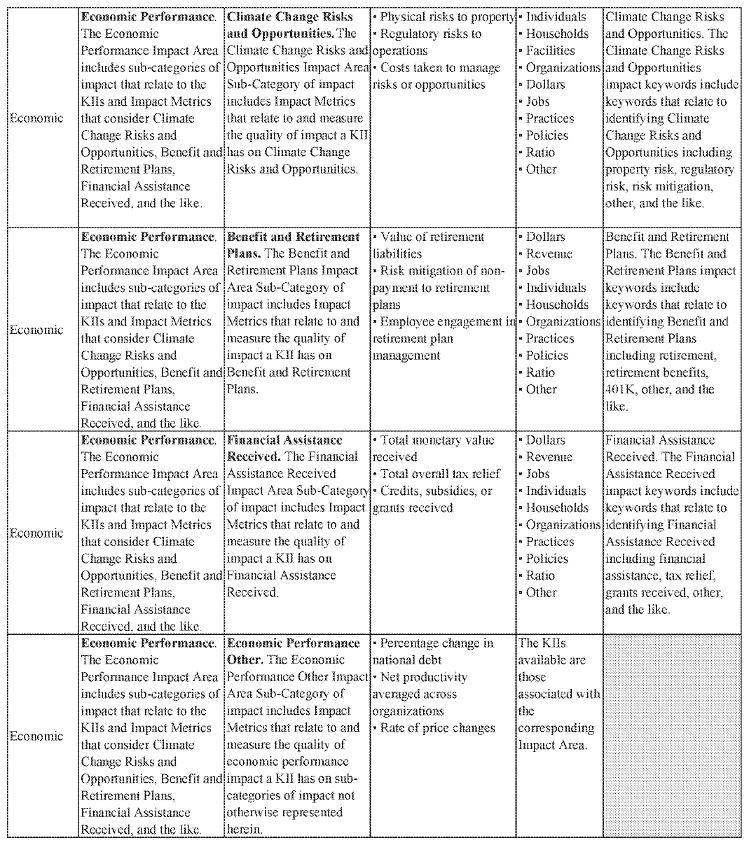

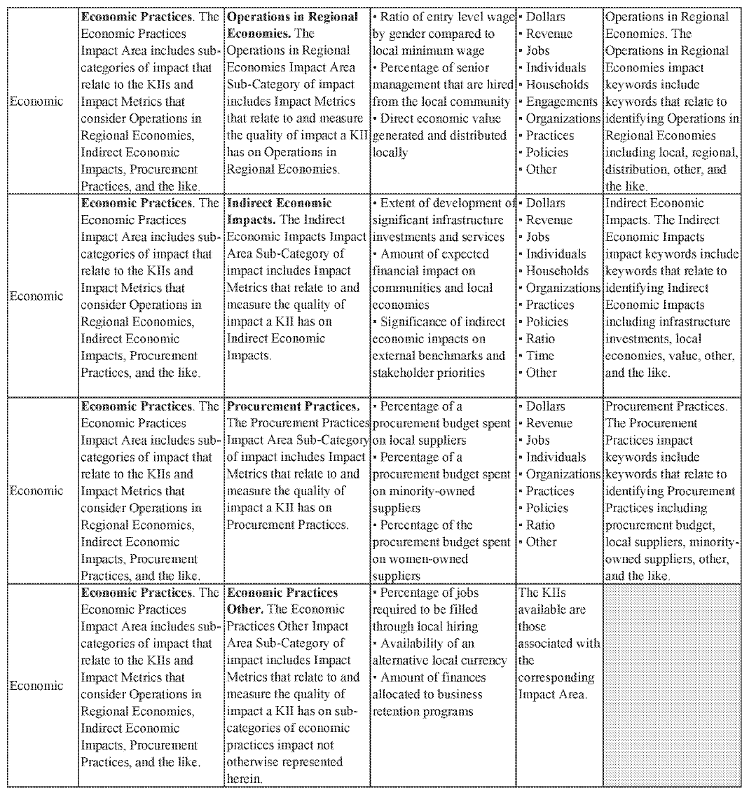

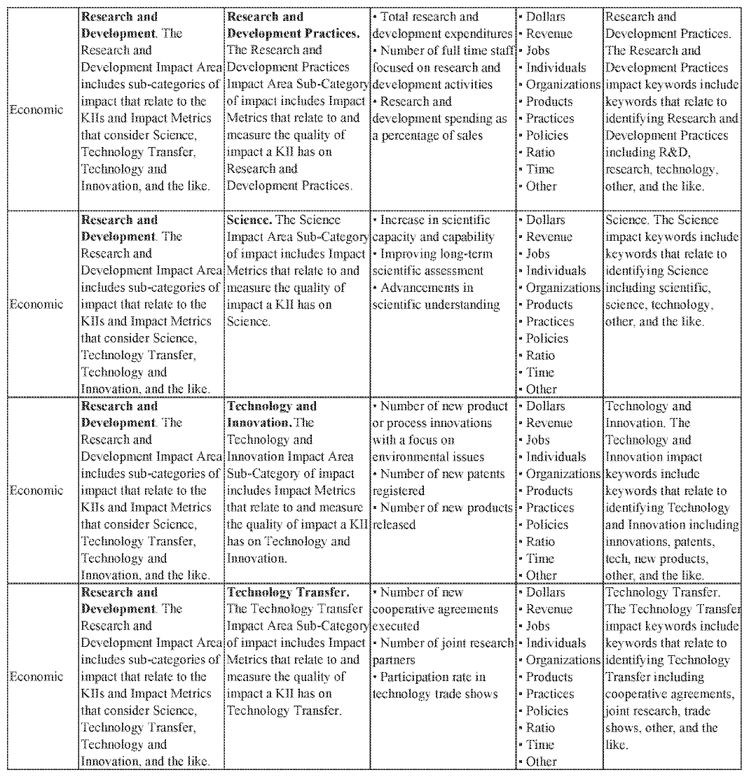

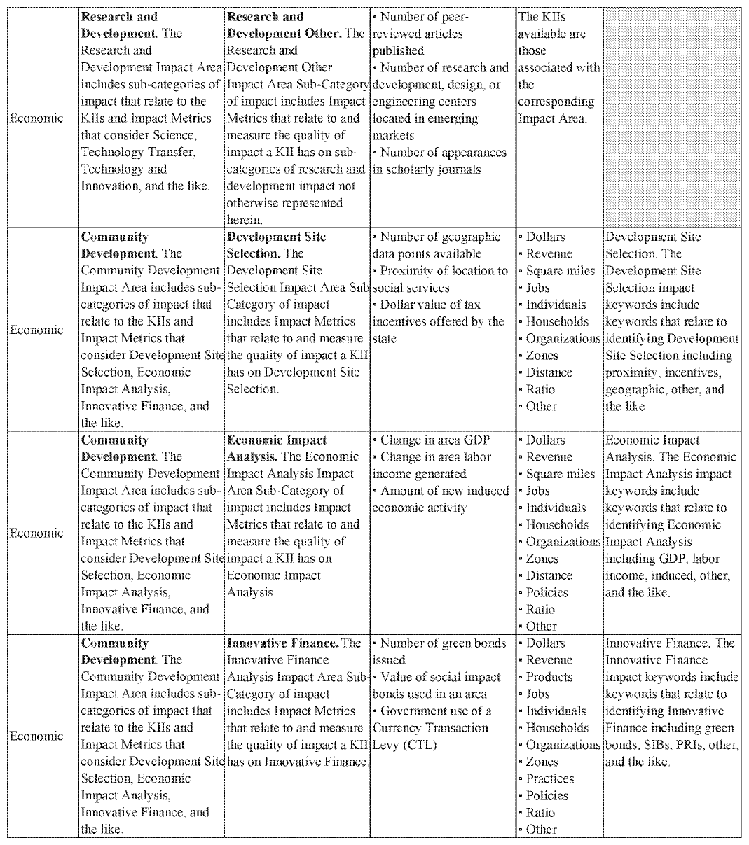

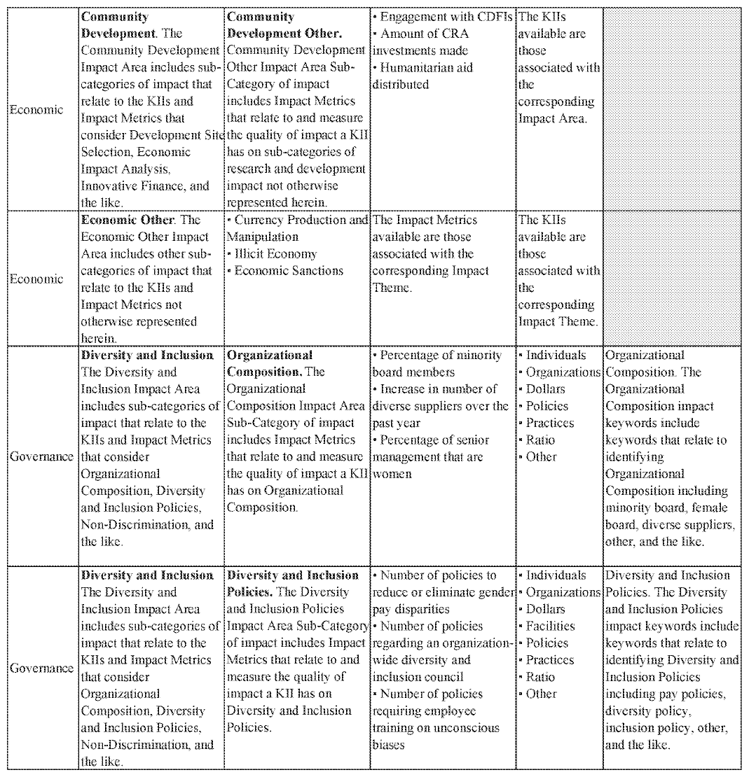

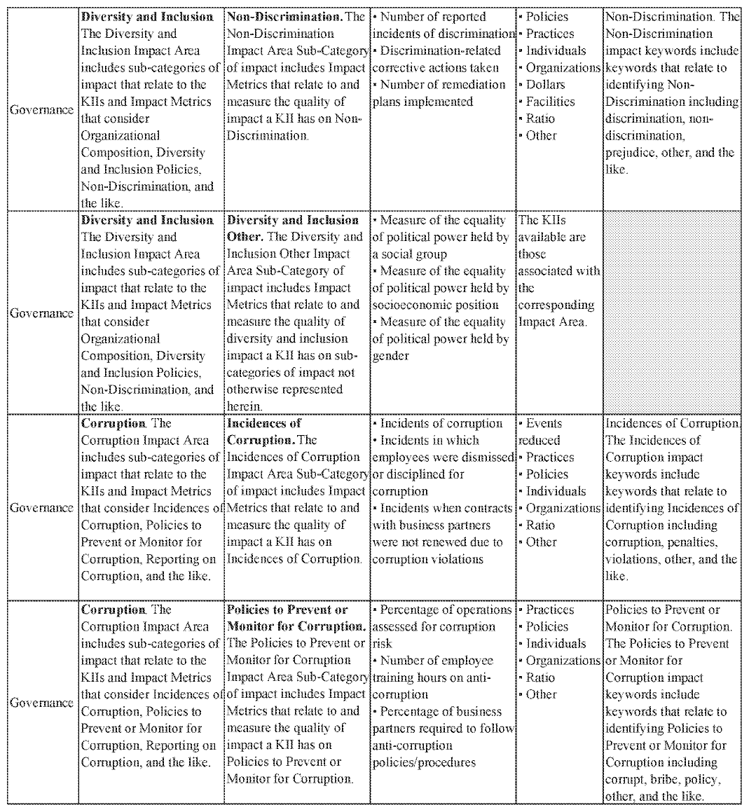

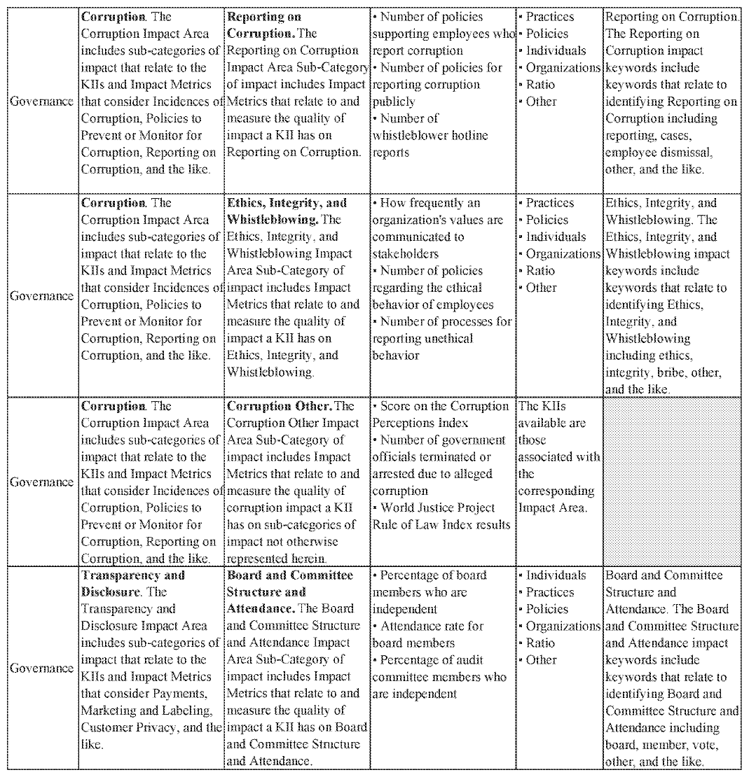

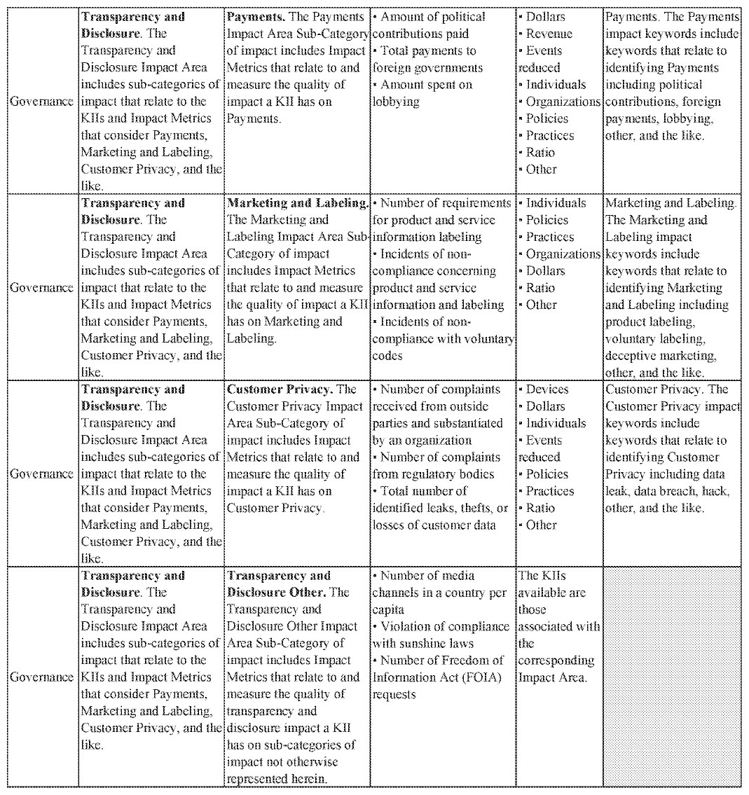

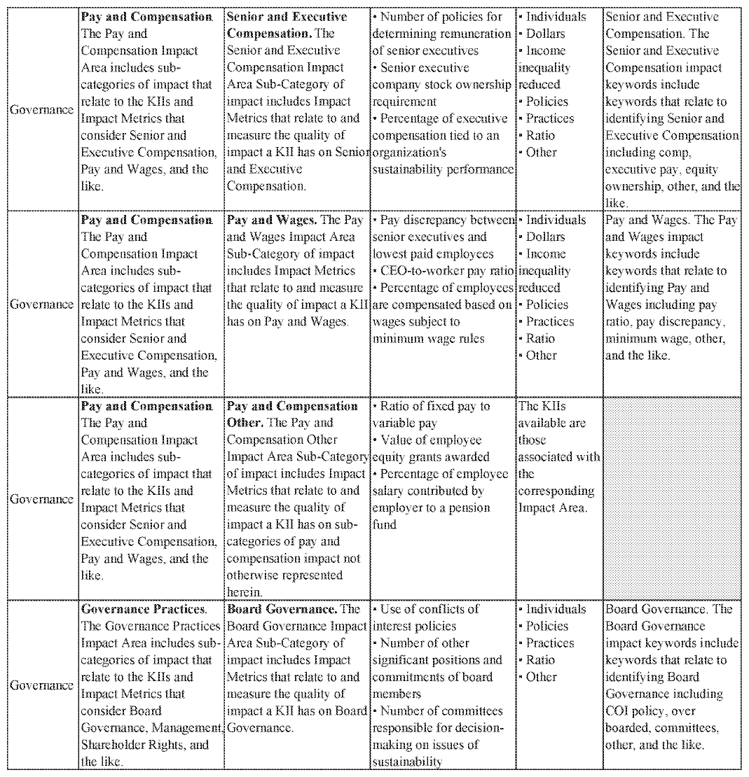

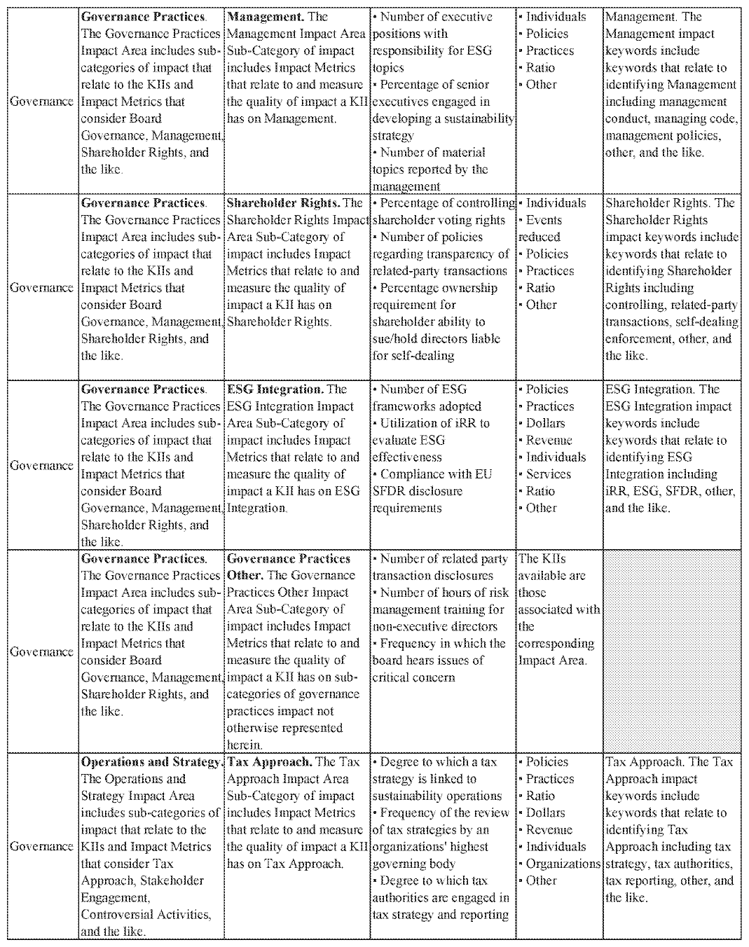

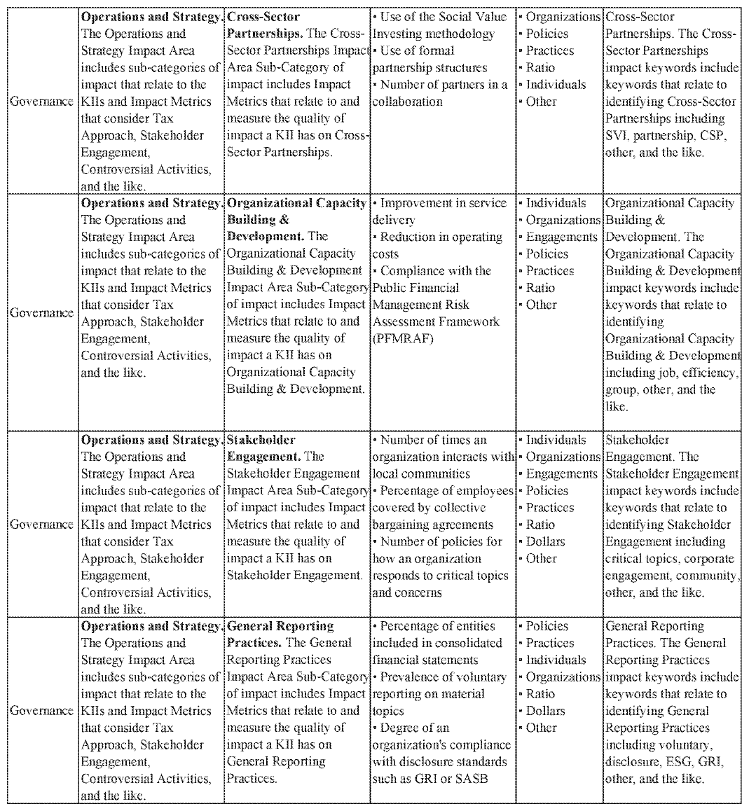

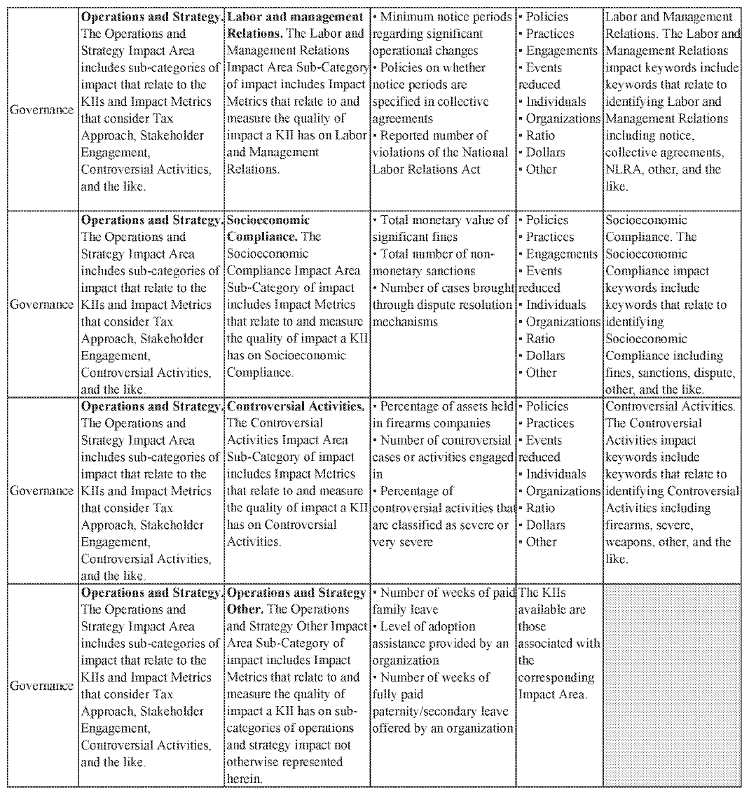

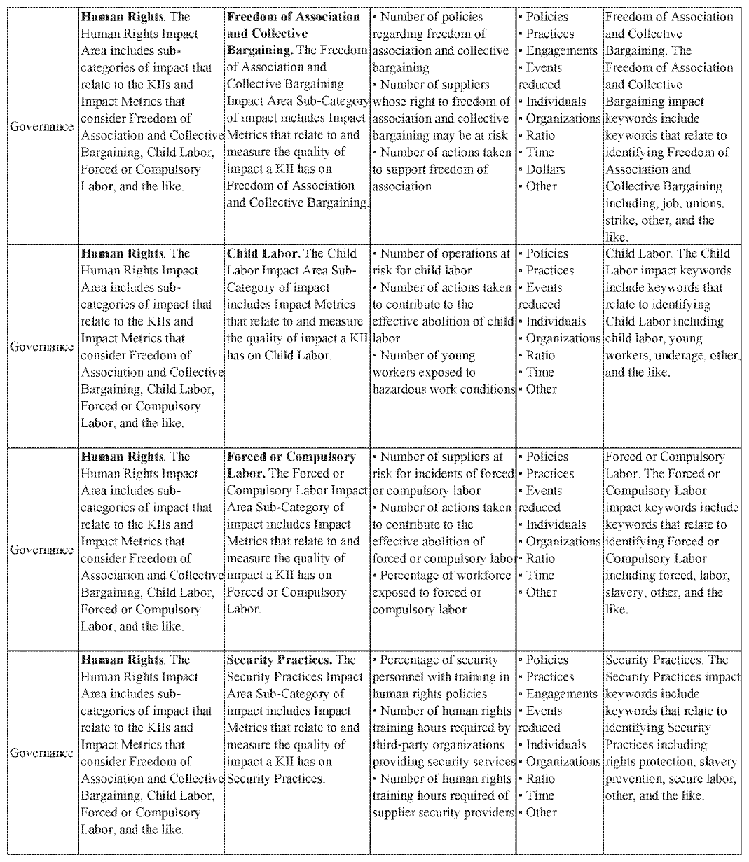

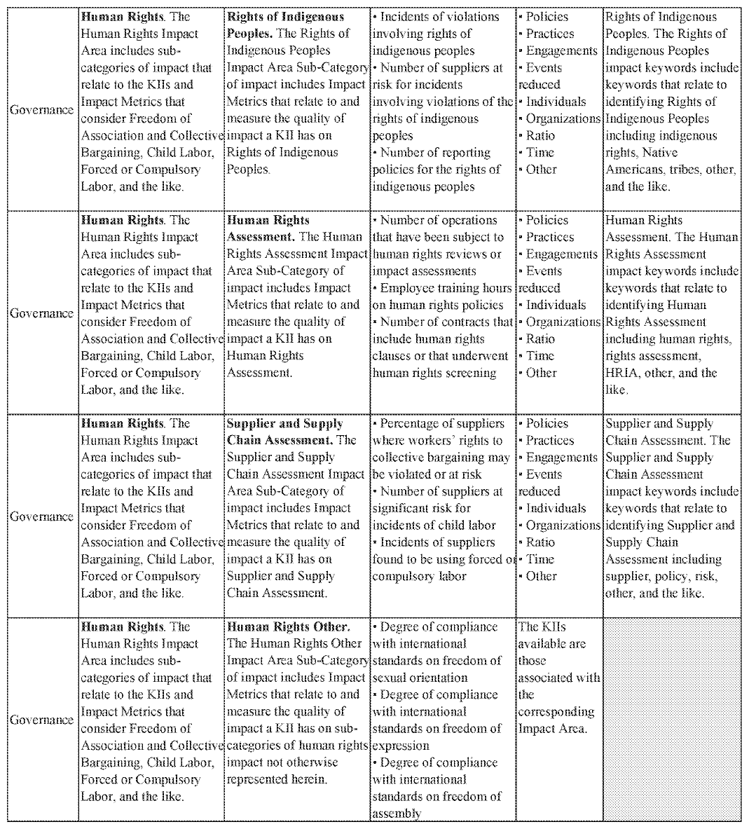

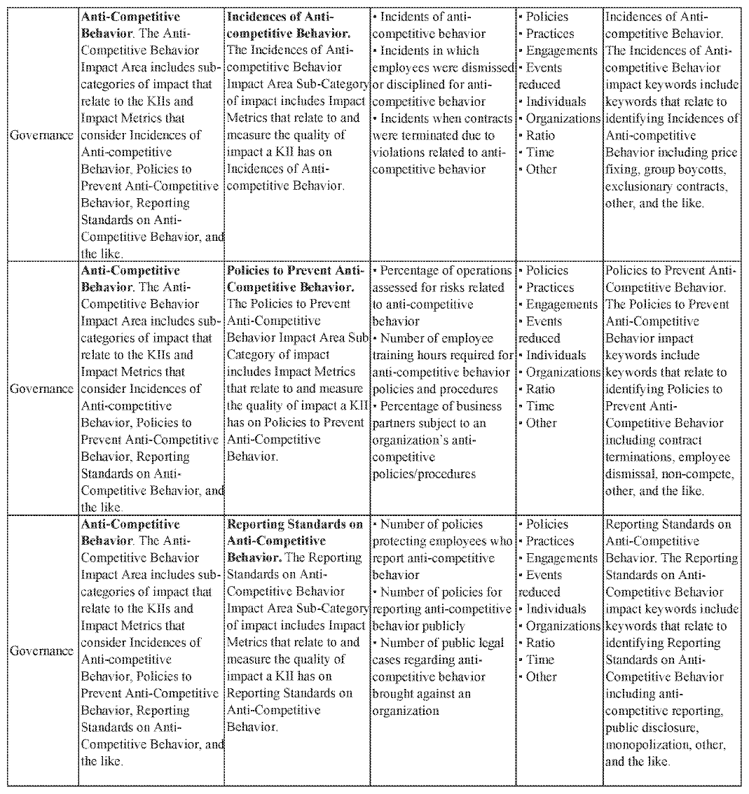

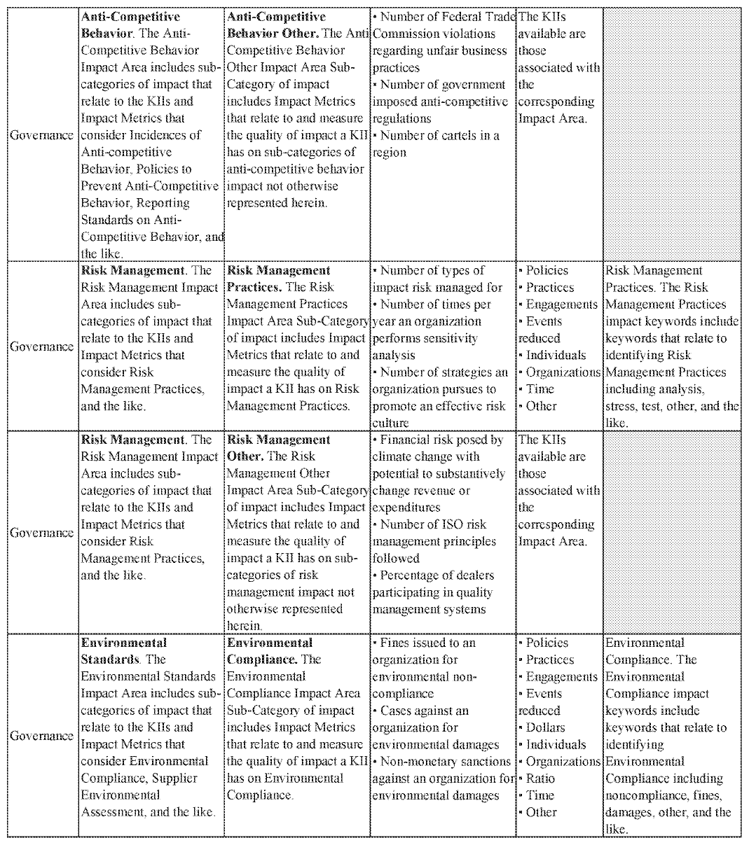

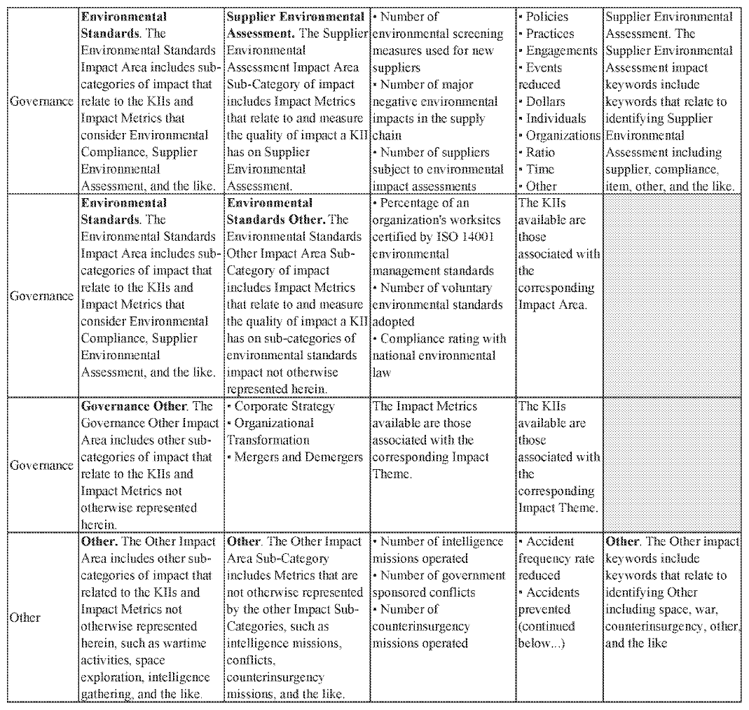

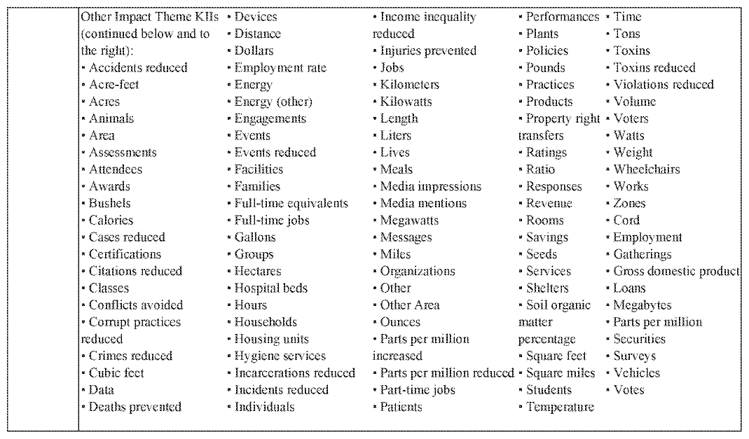

In 104, based upon the iRR calculation input, transmitting an impact theme selection output from the first computer system 202 to the second computer system 204 via the network 206. The impact theme selection output is configured for causing the impact theme selections to be provided to the second computer system 204, as represented in FIG. 3b. The impact theme selections may be based on type of impact (i.e. a social impact theme, an environmental impact theme, an economic impact theme, or a governance impact theme). The impact theme selections may be based on foci of activity (i.e. agriculture, air, biodiversity and ecosystems, climate, diversity and inclusion, education, employment, energy, financial services, health, infrastructure, land, oceans and costal zones, pollution, real estate, waste, and water). The impact theme selections may be based on objectives of activity based on predetermined standards (i.e. OZ, UN SDGs, or WB ESS) as shown in FIGS. 16 and 17. The impact theme selection output is further configured to display impact themes for selection, such as on a webpage via drop down menu, blank text box, scrolling menu, box selection, or the like.

The social impact theme includes activities that improve the social conditions of a person, of a group of people, of other living things, or of society at an individual, family, community, local, city, state, national, international, or global level. For example, activities in the social impact theme include preventing tenants from smoking within a building, increasing healthcare services offered at a clinic, providing new early childhood education classes in a neighborhood, improving pedestrian access to an underground subway stop, improving gender equality through the number of women elected to a state legislature, or constructing and operating a new drug rehabilitation clinic, and the like.

The environmental impact theme includes activities that improve the environmental conditions for living things, of a building, of a piece of land, of a defined geography, or of the planet at a site, community, local, city, state, national, international, or global level. For example, activities in the environmental impact theme may include installing solar panels on a rooftop building, preventing toxic waste dumping into a stream, installing water saving showerheads, planting trees of a specific type to prevent soil erosion, installing LED lightbulbs in a building, or converting a vehicle fleet to electric cars to reduce CO2 emissions, and the like.

The economic impact theme includes activities and outputs of an economic nature, including the measures, results, or the performance of a product, service, infrastructure investment, organization, or government entity and its impact on a person, a group of people, a defined geography or geographies, or of society at a community, local, city, state, national, international, or global level. For example, activities in the economic impact theme may include increasing the number of new full-time equivalent jobs created in a city, increasing state government tax revenue, or improving the number of small business loans disbursed nationally, and the like.

The governance impact theme includes activities that improve the governance, management, or decision making capabilities or processes of an organization, group, group of people, company, institution, locality, city, state, nation or multi-lateral organization. For example, activities in the governance impact theme may include increasing the gender and racial diversity of a corporation's board of directors, the adoption and enforcement of a conflicts of interest policy by a nonprofit entity, or the elimination of child slavery from an organization's supply chain, and the like.

The other impact theme includes activities that are not of a social, environmental, economic, or governance type of impact. For example, activities in the other impact theme may include wartime activities, space exploration, intelligence gathering, or conflict resolution, and the like.

The impact theme selections based on foci of activity include the activities that span types of impact. As such an impact theme based on a foci of activity incorporates impact areas from one or more impact themes as compared to an impact theme selection based on a type of impact.

The impact theme selections based on objectives of activity based on predetermined standards (i.e. OZ, UN SDGs, or WB ESS) include the activities that span types of impact. As such an impact theme based on the objective of activity incorporate impact areas from one or more impact themes as compared to an impact theme selection based on a type of impact.

In 106, receiving an impact theme selection input, the impact theme selection input having been transmitted from the second computer system 204 to the first computer system 202 via the network 206 based upon the impact selection theme. The impact selection theme is determined by the business entity user in response to the activity to be analyzed by the business entity, as represented in FIG. 3c. The business entity user selects one or more impact theme(s) for the impact theme selection (selected impact theme). The impact theme selection input is configured for causing the selected impact theme to be stored by the first computer system 202.

In 108, transmitting an impact area selection output to the second computer system 204 via the network 206 based upon the impact theme selection input in 106, the impact area selection output is configured to display an impact area selection by the second computer system, as represented in FIG. 3d. The impact area selection output is further configured for display by the second computer system, such as on the webpage through drop down menu, blank text box, scrolling menu, box selection, or the like.

As the impact area selection output is configured for display based on the impact theme selection input of 106, the impact area selections as shown in FIGS. 16 and 17 are available for each associated impact theme. These impact area selections are exemplary of the impact areas associated with each impact theme as defined herein. The impact area selection output will only display those impact areas associated with the impact theme selection input from 106. This association of impact areas with impact themes, and subsequent display, allows a business entity user to quickly and accurately identify the impact area associated within a theme for the activity. The impact area selection output is configured to allow selection of one or more impact areas.

In 110, receiving an impact area selection input, the impact area selection input having been transmitted from the second computer system 204 to the first computer system 202 via the network 206 based upon the impact area selections. The impact area selection theme is determined by the business entity user in response to the impact theme modality to be measured by the business entity in connection with the activity, as represented in FIG. 3e. The business entity user selects one or more impact areas as the impact area selection (selected impact area). The impact area selection input is configured for causing the selected impact area to be stored by the first computer system 202.

In 112, transmitting an impact area sub-category selection output to the second computer system 204 via the network 206 based upon the impact area selection input in 110, the impact area sub-category selection output is configured to display impact area sub-category selections by the second computer system 204, as represented in FIG. 3f. The impact area sub-category selection output is further configured for display by the second computer system 204, such as on the webpage through drop down menu, blank text box, scrolling menu, box selection, or the like.

As the impact area sub-category selection output is configured for display based on the impact area selection input of 110, the impact area sub-category selections are available for the correspondingly associated impact area as shown in FIG. 16. In the event the selected impact theme and corresponding selected impact area are from FIG. 17, the impact area sub-categories displayed still correspond to the impact area in FIG. 16. By way of example, if the impact theme of energy is selected as the focus of the activity and economic indicators is selected as the impact area, then sub-categories displayed are those associated with the economic indicators impact area of FIG. 16. These impact area sub-category selections are exemplary of the impact area sub-categories associated with each impact area as defined herein. The impact area sub-category selection output will only display those impact area sub-categories associated with the stored impact theme selection from 106. This association of impact area sub-categories with impact areas, and subsequent display, allows the business entity user to quickly and accurately identify the manner in which impact is delivered based on the activity's type of impact. Without the association of impact area sub-categories with impact areas, a business entity user may inaccurately identify the manner in which impact is delivered based on the activity's type of impact. Inaccurate identification of an impact area sub-category produces difficulty or inability to accurately identify the impact metric for measurement of impact for the activity, leading to an inaccurate iRR calculation. When the impact area selection input from 110 includes two or more impact areas, the impact area sub-category selection output is configured to display the impact area sub-categories associated with each impact area in separate selections, such as on the webpage through drop down menu, blank text box, scrolling menu, box selection, or the like.

In 114, receiving an impact area sub-category selection input, the impact area sub-category selection input having been transmitted from the second computer system 204 to the first computer system 202 via the network 206 based upon the impact area sub-category selection. The impact area sub-category selection is determined by the business entity user in response to the manner in which impact is delivered to the modality of the impact theme by the business entity in connection with the activity, as represented in FIG. 3g. A business entity user selects one or more impact area sub-categories in connection with each impact area as the impact area sub-category selection. The impact area sub-category selection input is configured for causing the impact area sub-category to be stored by the first computer system 202 in association with the corresponding impact area.

In 116, transmitting a KII selection output to the second computer system 204 via the network 206 based upon the impact area selection input in 110, the KII selection output configured to display a KII selection output by the second computer system 204, as represented in FIG. 3h. The KII selection output is further configured for display by the second computer system 204, such as on a webpage through drop down menu, blank text box, scrolling menu, box selection, or the like.

As the KII selection output is configured for display based on the impact area selection input of 110, the KII selections are available for each associated impact area, as shown in FIG. 16. In the event the selected impact theme and corresponding selected impact area are from FIG. 17, the KIIs displayed still correspond to the impact area in FIG. 16. By way of example, if the impact theme of energy is selected as the focus of the activity and economic indicators is selected as the impact area, then KIIs displayed are those associated with the economic indicators impact area of FIG. 16. These KIIs selections are exemplary of the KIIs associated with each impact area sub-category as defined herein. The association of KIIs with the impact areas, and the subsequent display, allows the business entity user to accurately and quickly identify the unit of measurement of an activity within the impact area (i.e. the KII). Without the association of KIIs with the impact area the business entity user may inaccurately identify the KII for an activity within the impact area. Inaccurate identification of the unit of measurement for an activity within the impact area produces an inaccurate or nonsensical iRR. The KII selection output will only display those KIIs associated with the impact area selection input from 110. When the impact area selection input from 110 includes two or more impact areas, the KII selection output is configured to display the KIIs associated with each impact area in separate selections, such as on the webpage through drop down menu, blank text box, scrolling menu, box selection, or the like.

In 118, receiving a KII selection input, the KII selection input having been transmitted from the second computer system 204 to the first computer system 202 via the network 206 based upon the KII selection. The KII is determined by the business entity user in response to the unit of measurement of an activity within an impact area selected by the business entity, as represented in FIG. 3i. The business entity user selects one KII as the KII selection input (selected KII). The KII selection input is configured for causing the selected KII to be stored by the first computer system 202.

In 120, transmitting an impact metric selection output to the second computer system 204 via the network 206 based upon the impact area sub-category selection input in 114, the impact metric selection output configured to display an impact metric selection output by the second computer system 204, as represented in FIG. 3j. The impact metric selection output is further configured for display by the second computer system 204, such as on a webpage through drop down menu, blank text box, scrolling menu, box selection, or the like.

As the impact metric selection output is configured for display based on the impact area sub-category selection input of 114, the impact metric selections are available for each associated impact area sub-category, as shown in FIG. 16. These impact metric selections are exemplary of the impact metrics associated with each impact area sub-category as defined herein. The impact metric selection output will only display those impact metrics associated with the impact area sub-category selection input from 114. The association of impact metrics with the impact area sub-categories, and the subsequent display, allows the business entity user to accurately and quickly identify the type of quantitative indicator (i.e. impact metric) to determine the quality of impact delivered through the KII for the respective impact metric. Without this association the business entity user may inaccurately identify the impact metric for the activity resulting non-conformity between the KII and impact metric producing an inaccurate or nonsensical iRR as the impact multiplier will not correspond to the KII. When the impact area sub-category selection input from 114 includes two or more impact area sub-categories, the impact metric selection output is configured to display the impact metrics associated with each impact area sub-category in separate selections, such as on the webpage through drop down menu, blank text box, scrolling menu, box selection, or the like.

In 122, receiving an impact metric selection input, the impact metric selection input having been transmitted from the second computer system 204 to the first computer system 202 via the network 206 based upon the impact metric selection. The impact metric selection is determined by the business entity user in response to the qualitative quality measurement for the activity, as represented in FIG. 3k. The business entity user selects at least one impact metric per impact area sub-category as the impact metric selection. The activity has at least one impact metric selection associated therewith. The impact metric selection input is configured for causing the impact metric selection including all of the selected impact metrics to be stored by the first computer system 202 in association with their corresponding impact area sub-category.

In 124, processing an impact metric value by the first computer system 202, where the impact metric value is associated with the impact metric selection. The impact metric value is equal to a value of 100. The processing is configured for assigning the impact metric value to the impact metric selection. The processing further including the impact metric value being stored by the first computer system 202.

In 128, processing an impact metric weight by the first computer system 202, where the impact metric weight is equal to 100%. For example, when a single impact metric is stored as the impact metric selection input from 122, the impact metric weight for the impact metric is 100%. When the impact metric selection contains two or more impact metrics, the impact metric weight further includes impact metric sub-weights. Each of the two or more impact metrics has an impact metric sub-weight. The first computer system 202 processes the impact metric sub-weights by assigning each an equal pro rata value. For example, if the impact metric selection has two impact metrics, the first computer system 202 processes impact metric sub-weights equal to 50% for each of the two impact metrics, where the impact metric weight remains equal to 100%. The processing further including the impact metric weight being stored by the first computer system 202.

In 130, processing an impact metric possible point value by the first computer system 202, where the impact metric possible point value is the product of the respective impact metric value and the respective impact metric weight as stored in 124 and 128, respectively. The impact metric possible point value is equal to 100. The impact metric possible point value is processed by multiplying the impact metric value stored in 124 by the impact metric weight stored in 128. For example, when a single impact metric is stored as the impact metric selection, the impact metric value is 100 and the impact metric weight selection is 100%, the impact metric possible point value is 100. When two or more impact metrics are stored as the impact metric selection, the impact metric possible point value includes impact metric possible point sub-values. Each of the two or more impact metrics has an impact metric possible point sub-value. The first computer system 202 processes the impact metric possible point sub-values by multiplying the corresponding impact metric sub-weights by the impact metric value. For example, if the impact metric selection has two impact metrics, the first computer system 202 processes impact metric possible point sub-values by multiplying 100 (the impact metric value) by 50% (the impact metric sub-weights) to assign 50 points to each impact metric, where the impact metric possible point value remains equal to 100. The processing further includes storing the impact metric possible point value by the first computer system 202.

In 132, transmitting an impact metric score range selection output to the second computer system 204 via the network 206 based upon the impact metric selection input in 122, the impact metric score range selection output configured to display an impact metric score range selection output by the second computer system 204, as represented in FIG. 3n. The impact metric score range output includes a percentage array or corresponding numerical value array for quantitative rates associated with each impact metric. For example, when the range is divided in five equal parts, there are 5 corresponding rates corresponding to the following: 0%, 25%, 50%, 75%, 100%. Each impact metric selection stored as the impact metric selection input in 122 has an associated impact metric score range selection. The impact metric score range selection output further includes a selection for the business entity user to increase or decrease the number of impact metric score range entries. For example, when the range is divided in 10 parts, the business entity user selects to increase the number of impact metric score range entries to 10 entries. The impact metric score range selection output is further configured for display by the second computer system 204, such as on the webpage through drop down menu, blank text box, scrolling menu, box selection, or the like.

In 134, receiving an impact metric score range selection input, the impact metric score range selection input having been transmitted from the second computer system 204 to the first computer system 202 via the network 206 based upon the impact metric score range selection. The impact metric score range selection is determined by the business entity user in response to the ranges of scores associated with each impact metric, as represented in FIG. 3o. For example, the business entity user may enter percentage ranges of 0%-50%, 50%-65%, 65%-80%, 80%-90%, and 90%-100% or numerical values of 0, 1, 2, 3, and 4, associated with the 0, 25^{th}, 50^{th}, 75^{th} and 100 th percentile, respectively, for each impact metric. Alternatively, for example, the business entity user may enter numerical values of 50, 100, 150, 200, and 250, associated with score rates of −50%, −25%, 0%, 25%, and 50%. The business entity user enters ranges for score rates based on historical data, industry knowledge, expert consultation, or a combination of the same. The impact metric score range selection input is configured for causing the selected impact metric score range to be stored in association with its impact metric by the first computer system 202.

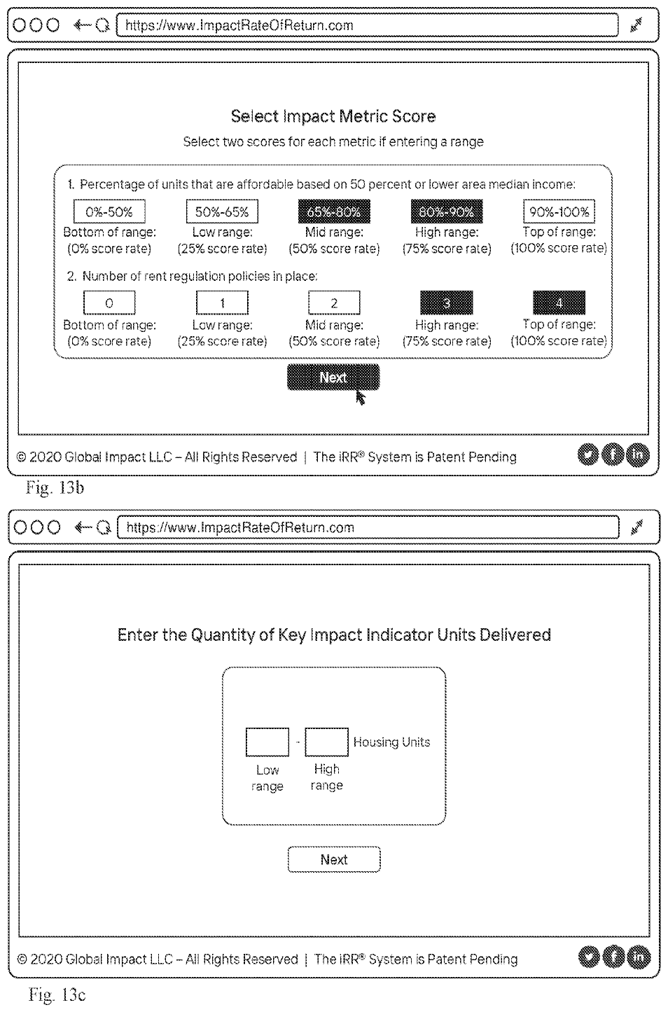

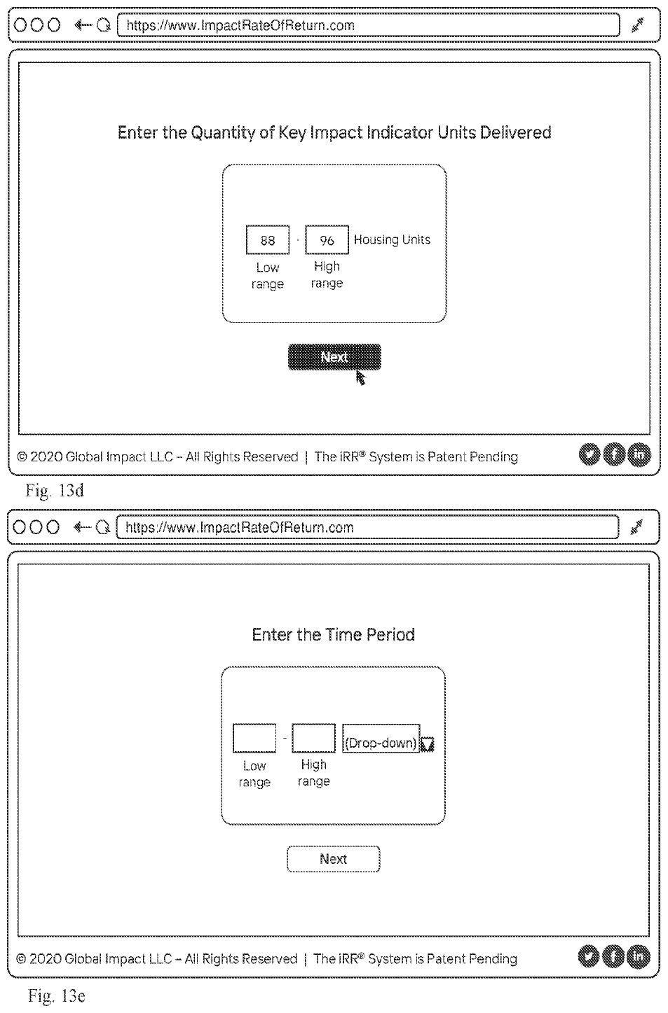

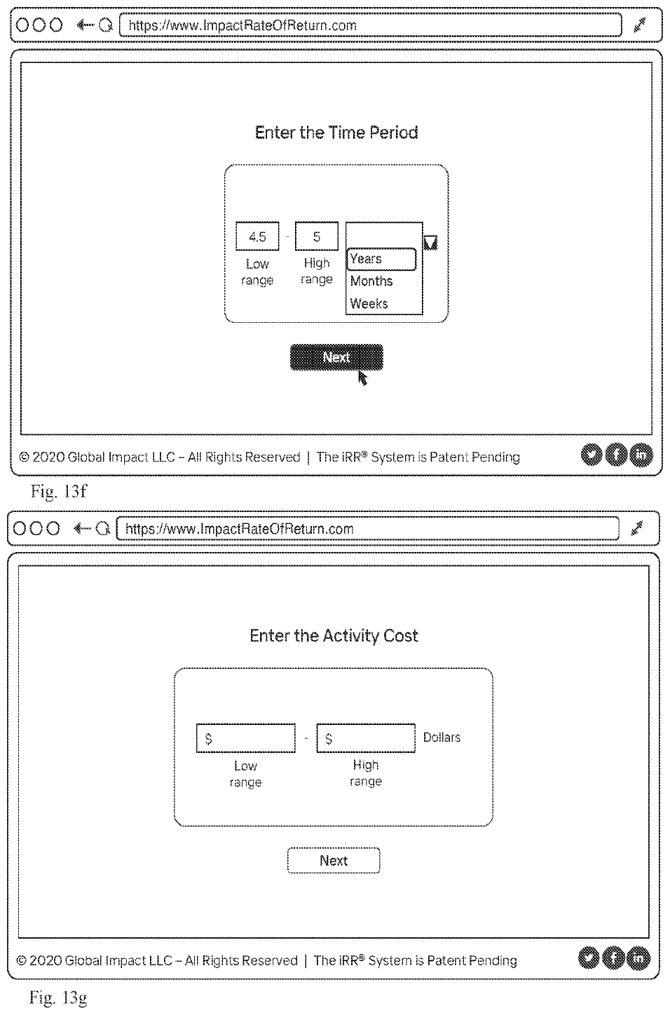

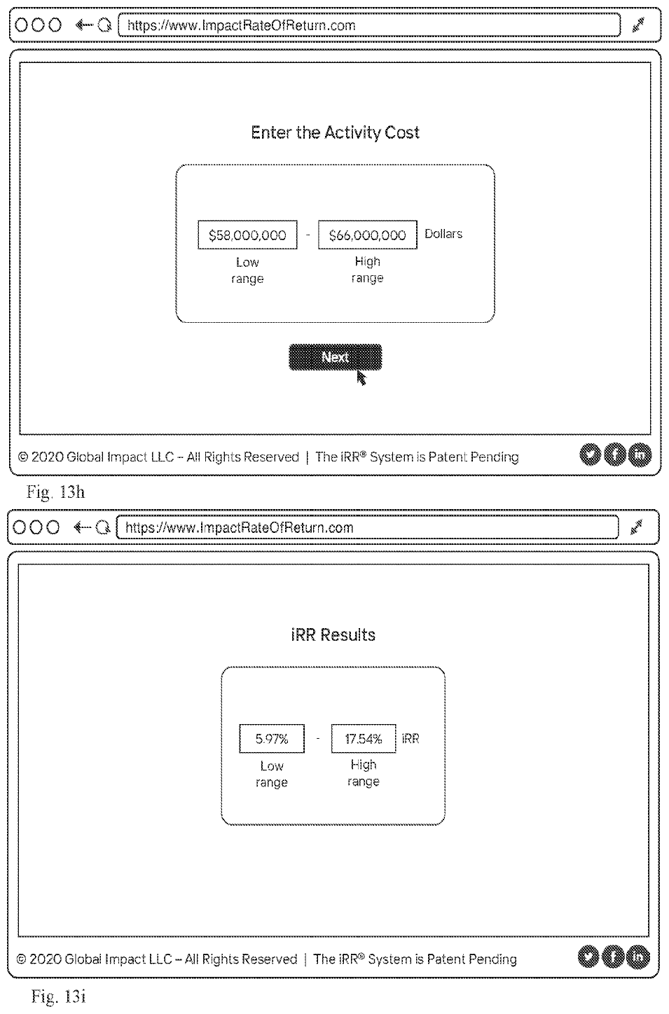

In 136, transmitting an impact metric score selection output to the second computer system 204 via the network 206 based upon the impact metric score range selection input stored in 134, the impact metric score selection output is configured to display an impact metric score selection output by the second computer system 204, as represented in FIG. 3p. The impact metric score selection output may include an upper and lower impact metric score selection of the associated impact metric's rate based on the indicator's potential variation in connection with the activity, as represented in FIG. 13a. Each stored impact metric score range of 134 has an associated impact metric score selection. The impact metric score selection output is further configured for display by the second computer system 204, such as on the webpage through drop down menu, blank text box, scrolling menu, box selection, or the like.

In 138, receiving an impact metric score selection input, the impact metric score selection input having been transmitted from the second computer system 204 to the first computer system 202 via the network 206 based upon the impact metric score selection output in 136. The impact metric score selection may be determined by the business entity user in response to the rate corresponding to the prevalence of the impact metric for an activity, as represented in FIG. 3q. For example, the business entity user may select the 75^{th} percentile range corresponding to an 80%-90% prevalence of the impact metric for the activity. The business entity user determines the impact metric score selection (selected impact metric score) by evaluating information associated with the activity, such as a prospectus or project proposal in the case of an ex-ante analysis, presently reported information in the case of ex-hoc analysis, or a project report in the case of ex-post analysis.

Or for example, the impact metric score selection may be determined by the business entity user to have an upper and lower impact metric score when the prevalence of the impact metric for an activity may be across two or more score rates, as represented in FIG. 13b. The impact metric score selection input is configured for causing the selected impact metric score to be stored in association with its impact metric by the first computer system 202. When the impact metric score selection input includes an upper and lower impact metric score selection, the impact metric score selection input is configured for causing the selected upper (highest) impact metric score and lower (lowest) impact metric score to be stored in association with its impact metric by the first computer system 202. Given that the impact metric score delivered in the activity may change over the course of the activity, this input allows the iRR to be measured over the course of the activity and across activities at various stages.

In 140, processing an impact metric score rate by the first computer system 202, where the impact metric score rate is associated with the respective impact metric score selection input stored in 138. The impact metric score rate may be processed by assigning the impact metric score selection its corresponding rate. For example, when the impact metric score selection is in the 80%-90% range for the 75% score rate, the processing includes assignment of 75% to the impact metric for the impact metric score rate. The impact metric score rate may be processed as the upper and lower impact metric score rate for each impact metric score selection when the stored impact metric score selection includes an upper and lower impact metric score. For example, when the upper impact metric score selection is in the 80%-90% range and the lower impact metric score selection is in the 65%-80% range, the processing includes an upper impact metric score rate of 75% and a lower impact metric score rate of 50%, each assigned to the respective upper and lower impact metric scores for the impact metric score rate. The processing further includes storing the impact metric score rate(s) by the first computer system 202 in association with the corresponding impact metric.

In 142, processing an impact metric point value by the first computer system 202, where the impact metric point value is associated with the respective impact metric possible point value stored in 130 and the impact metric score rate(s) stored in 140. The impact metric point value is processed by multiplying the impact metric possible point value by the impact metric score rate. For example, when the impact metric score rate is 75% and the impact metric possible point value is 100, the impact metric point value is 75. Or, when the impact metric score rate is −75% and the impact metric possible point value is 100, the impact metric point value is −75.

When the impact metric selection contains two or more impact metrics, the processing includes impact metric point sub-values. Each of the two or more impact metrics has an impact metric point sub-value. The first computer system 202 processes the impact metric point sub-values by multiplying the impact metric score rate by the impact metric possible point sub-value. For example, if the impact metric selection has two impact metrics, the first computer system 202 processes impact metric point sub-values by multiplying 75% (the impact metric score rate) by 50 (the impact metric possible point value) for an impact metric point sub-value of 37.5, and 100% (impact metric score rate) by 50 (the impact metric possible point value) for an impact metric point sub-value of 50.

When the impact metric score selection includes upper and lower impact metric score selections, the processing includes impact metric point upper and lower values. Each of the upper and lower impact metric score selections has an upper and lower impact metric point value, respectively. The first computer system 202 processes the upper and lower impact metric point values by multiplying the upper and lower impact metric score rates by the impact metric possible point value. For example, if the upper impact metric score selection is 80%-90%, the first computer system 202 processes the upper impact metric point value by multiplying 75% (the impact metric score rate) by 50 (the impact metric possible point value for two impact metrics) for an upper impact metric point value of 37.5. Further, if the lower impact metric score selection is 65%-80%, the first computer system 202 processes the lower impact metric point value by multiplying 50% (the impact metric score rate) by 50 (the impact metric possible point value for two impact metrics) for a lower impact metric point value of 25. The processing further includes storing the impact metric point value by the first computer system 202.

In 146, processing an impact multiplier value by the first computer system 202. The impact multiplier value is processed by dividing the impact metric point value by 100, where in the case of impact metric point sub-values the stored impact metric point sub-values from 142 are summed and divided by 100. The impact multiplier value may be processed as an upper and lower impact multiplier value when there is an upper and lower impact metric score selection stored in 138, an upper and lower impact metric score rate stored in 140, and an upper and lower impact metric point values in 142. However, in the instance where the sum of all the stored impact metric point sub-values equals −100, the impact multiplier value is converted to its lowest value of −0.999, and in the instance where the sum of all the stored impact metric point sub-values equals 100, the impact multiplier value is converted to its maximum value of 0.999. When the impact multiplier value is negative (between −0.999 and 0.000), the impact multiplier value is figured as an absolute value. The processing further includes storing the impact multiplier value, by the first computer system 202. The processing of the impact multiplier may further be configured for storing the upper and lower impact multiplier values by the first computer system 202.

In 148, transmitting an impact goal output to the second computer system 204 via the network 206 based upon the KII selection input and stored KII in the first computer system 202 from 118. The impact goal output is configured for the impact goal to be displayed, such as via the webpage, on the second computer system 204 for entry of the impact goal in the corresponding KII unit, represented by FIG. 3r. For example, when the KII is housing units, the display includes a blank entry for the impact goal per housing units.

In 150, receiving an impact goal input from the second computer 204 via the network 206. The impact goal input is determined by the business entity user in response to the impact goal output in 148 and the goal of the activity, represented in FIG. 3s. The business entity will accurately report the impact goal to maintain its reputation and for obtaining accurate iRR results for comparison across activities, where a manipulation to artificially lower the impact goal to artificially inflate the iRR detracts from either objective. The impact goal input is configured to be stored in the first computer system 202 as the impact goal for calculation of the impact quantity for the calculation of iRR.

In 152, transmitting a KII delivery output to the second computer system 204 via the network 206 based upon the KII selection input stored in the first computer system from 118. The KII delivery output is configured for display on the second computer system 204, such as on the webpage, for entry of the KIIs expected (in the case of ex-ante analysis), KIIs in delivery (in the case of ex-hoc analysis) or KIIs delivered (in the case of ex-post analysis) in connection with the activity in the corresponding KII unit, as represented in FIG. 3t. The KII delivery output may further be configured for display of an upper and lower KII delivery based on variation of KII units expected in an activity, as represented in FIG. 13c. For example, when the KII is housing units, the display includes a blank entry for the entry of the number of housing units in the analysis.

In 154, receiving a KII delivery input from the second computer system 204 via the network 206. The KII delivery input may be determined by the business entity user in response to the KII selection in 118 and the number of KII units of the activity at the particular analysis point in time for the activity, as represented by FIG. 3u. The KII delivery input may be determined by the business entity user as an upper and lower KII delivery input in response to a range of projected KII delivered, as represented in FIG. 13d. The KII delivery input is configured to be stored in the first computer system 202 as the KII units delivered (KIT delivery) for calculation of the impact quantity and impact efficiency for the calculation of iRR. When the KII delivery input includes an upper and lower KII delivery, the KII delivery input is configured for causing the upper (highest) KII delivery and lower (lowest) KII delivery to be stored as the KII units delivered (KIT delivery) for calculation of an upper and lower impact quantity and an upper and lower impact efficiency. Given that the KII units delivered in the activity may change over the course of the activity, this input allows the iRR to be measured over the course of the activity and across activities at various stages.

In 156, processing the impact quantity, based on the stored KII delivery from 154 and the stored impact goal from 150, by the first computer system 202. The processing is in accord with the algorithm where the impact quantity may be the KII delivery input divided by the impact goal. The processing of the impact quantity by the first computer system 202 may further include processing the upper impact quantity using the stored upper KII delivered of the KII delivery input divided by the impact goal, and processing the lower impact quantity using the stored lower KII delivery of the KII delivery input divided by the impact goal. The processing of the impact quantity by the first computer system 202 may be further configured for storing the processed impact quantity by the first computer system. The processing of the impact quantity by the first computer system 202 may further be configured for storing the upper and lower impact quantity by the first computer system 202.

In 158, transmitting a time period output to the second computer system 204 from the first computer system 202 via the network 206. The time period output is configured to display an entry for time period on the second computer system 204, such as on the webpage, as represented in FIG. 3v. The time period output may be configured to display an entry for an upper and lower time period of the second computer system 204, such as on the webpage, as represented in FIG. 13e. For example, the entry may be in weeks, months, or years.

In 160, receiving a time period input from the second computer system 204 via the network 206. The time period input is determined by the business entity user in response to the time horizon for analysis of the activity, as represented in FIG. 3w. The time period input may be determined by the business entity user in response to an upper and lower time horizon for analysis, as represented in FIG. 13f. The time period input is configured to be converted into years if entered in months or weeks (e.g. 30 months is converted to 2.5 years) and stored in the first computer system 202 as the time period in years for the analysis of the activity. The time period input may further be configured to store the upper (longest) and lower (shortest) time period in the first computer system as the upper time period and lower time period for the analysis of the activity. Given that the time period required for completion of the activity may change over the course of the activity, this input allows the iRR to be measured over the course of the activity and across activities at various stages.

In 162, transmitting an activity cost output to the second computer system 204 from the first computer system 202 via the network 206. The activity cost output is configured to display an entry for the cost in currency on the second computer system 204, such as through the webpage, as represented by FIG. 3x. The activity cost output may be configured to display entries for upper and lower activity cost for the cost in currency on the second computer system 204, such as through the webpage, as represented in FIG. 13g. For example, the entry may be in dollars.

In 164, receiving an activity cost input from the second computer system 204 via the network 206. The activity cost input is determined by the business entity user in response to the cost for the activity, as represented in FIG. 3y. The activity cost input may be determined by the business entity user in response to an upper and lower activity cost for analysis, as represented in FIG. 13h. The activity cost input is configured to be stored in the first computer system 202. The activity cost input may further be configured to store the upper (highest) and lower (lowest) activity cost in the first computer system as the upper activity cost and lower activity cost for the analysis of the activity. Given that the activity cost for the activity may change over the course of the activity, this input allows the iRR to be measured over the course of the activity and across activities at various stages.

In 166, processing an impact efficiency based on the stored activity cost of 164 and the stored KII delivery of 154 by the first computer system 202 in accordance with the algorithm. The processing may include processing an upper impact efficiency and lower impact efficiency based on the stored upper and lower activity cost of 164 and the stored upper and lower KII delivered of 154. The processing may include utilizing a log base 100. Alternatively, the processing of the impact efficiency may include benchmarking the impact efficiency for determining the log base value to utilize.

The benchmarking of the impact efficiency is configured to determine the log base value for determining the impact efficiency for use in processing the iRR. The log base is determined by the first computer system 202 benchmarking the impact efficiency against the hypothetical impact multiplier value, where the first computer system 202 may use the hypothetical impact multiplier value of 0.90 and determines the log base needed to yield a desired iRR (e.g. 20%). This first computer system 202 stores the log base determined by this benchmarking as the benchmarked log base value. Yielding the benchmarked log base value further allows for calculation of the iRR across activities for quantitative comparison. When the impact efficiency includes upper and lower impact efficiencies, the benchmarking is conducted using the upper values (activity cost, KII delivered) stored in the first computer system 202. The processing of the impact efficiency by the first computer system 202 includes storing the impact efficiency by the first computer system 202. The processing of the impact efficiency by the first computer system 202 may further include storing the upper impact efficiency and the lower impact efficiency by the first computer system 202.

In instances when the processing results in an impact efficiency value that is equal to or less than the processing may further include the first computer system 202 overriding the impact efficiency to a value greater than 0.0. For example, when the value is less than −5.340 the first computer system 202 overrides the impact efficiency to 0.0005, where the first computer system 202 will override the impact efficiency in increments of 0.03, corresponding to an increase in impact efficiency of 0.0005. This leads to the impact efficiencies of equal to −5.340 to −5.310 (but not including −5.310) having the first computer system 202 override the impact efficiency to 0.0010, impact efficiencies of equal to −5.310 to −5.280 (but not including −5.280) having the first computer system 202 override the impact efficiency to 0.0015, and this patterns continues until the impact efficiency is greater than or equal to 0.0.

In 168, processing the iRR by the first computer system 202 based on the stored impact multiplier value stored in 146, the stored KII delivered stored in 154, the stored time period stored in 160, the stored impact quantity stored in 156, and the stored impact efficiency stored in 166 in accord with the algorithm. Processing the iRR may further include processing an upper iRR based on the stored upper impact multiplier value stored in 146, the stored upper KII delivered stored in 154, the stored upper time period stored in 160, the stored upper impact quantity stored in 156, and the stored upper impact efficiency stored in 166 in accord with the algorithm, and processing a lower iRR based on the stored lower impact multiplier value stored in 146, the stored lower KII delivered stored in 154, the stored lower time period stored in 160, the stored lower impact quantity stored in 156, and the stored lower impact efficiency stored in 166 in accord with the algorithm. The processing of the iRR is configured to store the iRR in the first computer system 202. The processing may further be configured to store the upper iRR and the lower iRR in the first computer system 202.

In 170 transmitting an iRR output to the second computer system 204 via the network 206 based on the stored iRR in 168. The iRR output is configured to display the iRR on the second computer system 204, such as on the webpage, as represented in FIG. 3z. The iRR output is configured to display the upper iRR and the lower iRR on the second computer system 204, such as on the webpage, as represented in FIG. 13i.

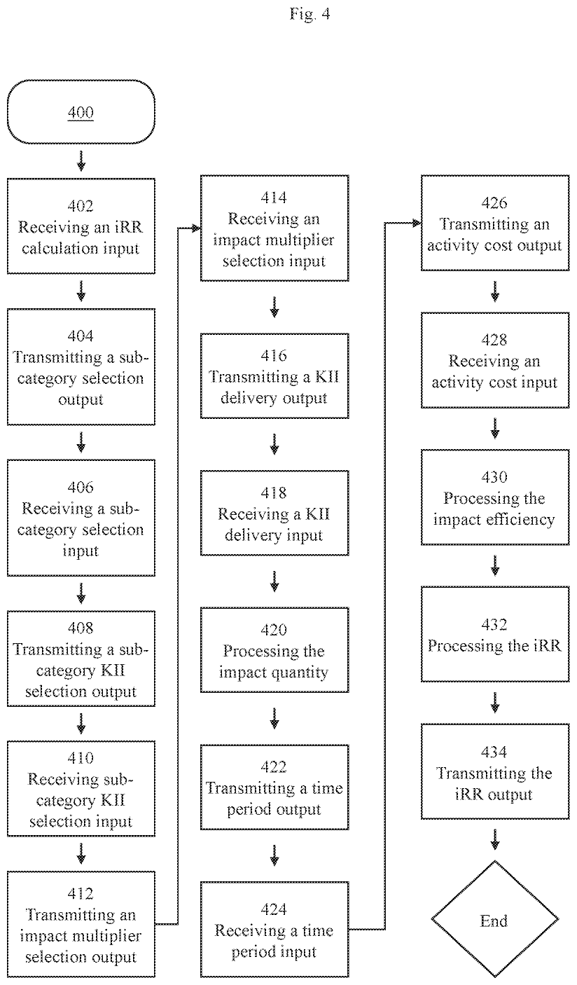

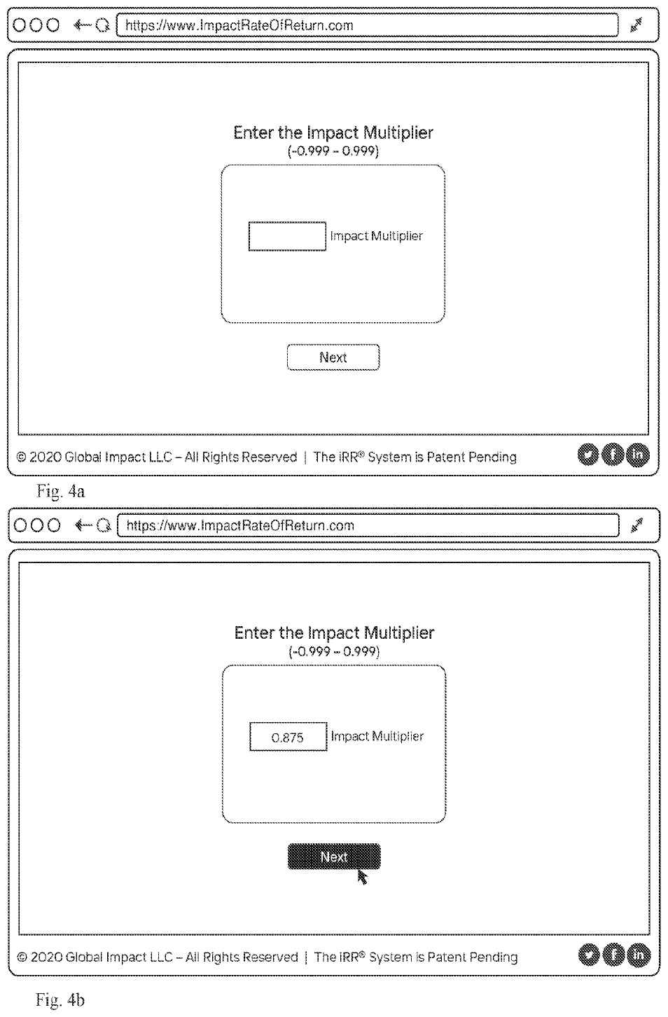

FIG. 4 represents a second method 400 used by the system for assessing the impact value of money by calculating the iRR of an activity. The second method 400 utilizes the algorithm of the method 100 and the system of FIG. 2.

In 402, the first computer system receives an iRR calculation input. The iRR calculation input having been transmitted via the computer network 206 from the second computer system 204. The iRR calculation input includes a request to begin calculation of the iRR.

In 404, transmitting a sub-category selection output to the second computer system 204 via the network 206 based upon the iRR calculation input in 402, the sub-category selection output is configured to display impact area sub-category selections by the second computer system 204. The sub-category selection output is further configured for display by the second computer system 204, such as on the webpage through drop down menu, blank text box, scrolling menu, box selection, or the like. The sub-category selection output is configured to display the impact area sub-categories below. The impact area sub-categories of the sub-category selection output set forth in FIG. 16 are exemplary of the impact area sub-categories as defined herein.

In 406, receiving a sub-category selection input, the sub-category selection input having been transmitted from the second computer system 204 to the first computer system 202 via the network 206 based upon the impact area sub-category selection. The impact area sub-category selection is determined by the business entity user in response to the manner in which impact is delivered by the business entity within a modality of an impact theme in connection with the activity. A business entity user selects one or more impact area sub-categories as the impact area sub-category selection. The sub-category selection input is configured for causing the selected impact area sub-category to be stored by the first computer system 202.

In 408, transmitting a sub-category KII selection output to the second computer system 204 via the network 206 based upon the sub-category selection input in 406, the sub-category KII selection output configured to display a KII selection output by the second computer system 204. The sub-category KII selection output is further configured for display by the second computer system 204, such as on a webpage through drop down menu, blank text box, scrolling menu, box selection, or the like.

As the sub-category KII selection output is configured for display based on the sub-category selection input of 406, the KII selections are available for each associated impact area sub-category, as shown in FIG. 16. These KIIs selections are exemplary of the KIIs associated with each impact area sub-category as defined herein. The sub-category KII selection output will only display those KIIs associated with the selected impact area sub-category of 406. The association of KIIs with the impact area sub-categories, and the subsequent display, allows the business entity user to accurately and quickly identify the unit of measurement of an activity within the impact area (i.e. the KII). Without this association the business entity user may inaccurately identify the KII for the activity within the impact area resulting in an inaccurate or nonsensical iRR as the impact multiplier will not correspond to the KII. When the sub-category selection input from 406 includes two or more selected impact area sub-categories, the sub-category KII selection output is configured to display the KIIs associated with each impact area sub-category in separate selections, such as on the webpage through drop down menu, blank text box, scrolling menu, box selection, or the like.

In 410, receiving a sub-category KII selection input, the sub-category KII selection input having been transmitted from the second computer system 204 to the first computer system 202 via the network 206 based upon the KII selection. The KII is determined by the business entity user in response to the unit of measurement of an activity within a selected impact area sub-category. The business entity user selects one KII as the sub-category KII selection input (selected KII). The sub-category KII selection input is configured for causing the selected KII to be stored by the first computer system 202.

In 412, transmitting an impact multiplier selection output to the second computer system 204 via the network 206, the impact multiplier selection output configured to display an impact multiplier selection output by the second computer system 204, as represented by FIG. 4a. The impact multiplier selection output is further configured for display by the second computer system 204, such as on a webpage through drop down menu, blank text box, scrolling menu, box selection, or the like.

In 414, receiving an impact multiplier selection input, the impact multiplier selection input having been transmitted from the second computer system 204 to the first computer system 202 via the network 206 based upon the impact multiplier selection, as represented by FIG. 4b. The impact multiplier selection is determined by the business entity user in response to an impact metric of an activity, when the impact metric is a pre-defined evaluation framework or provided by a third party certifier, validator, or method of analysis. The business entity determines the impact multiplier value for the impact multiplier selection based on this impact metric that is determined by a pre-defined framework, or certified, validated, or analyzed by the third party. For example, LEED certification, ESG scores, DALY values, Rainforest Alliance certification, GIIRS rating, B Impact Score, 60 Decibels results, or the like. The impact multiplier selection input is configured for causing the impact multiplier value to be stored by the first computer system 202.

In 416, transmitting a KII delivery output to the second computer system 204 via the network 206 based upon the KII selection input stored in the first computer system from 410. The KII delivery output is configured for display on the second computer system 204, such as on the webpage, for entry of the KIIs expected (in the case of ex-ante analysis), KIIs in delivery (in the case of ex-hoc analysis) or KIIs delivered (in the case of ex-post analysis) in connection with the activity in the corresponding KII unit. For example, when the KII is housing units, the display includes a blank entry for the entry of the number of housing units in the analysis.

In 418, receiving a KII delivery input from the second computer system 204 via the network 206. The KII delivery input is determined by the business entity user in response to the KII selection in 410 and the number of KII units of the activity at the particular analysis point in time for the activity. The KIT delivery input is configured to be stored in the first computer system 202 as the KII units delivered (KII delivery) for calculation of the impact quantity and impact efficiency for the calculation of iRR. Given that the KII units delivered in the activity may change over the course of the activity, this input allows the iRR to be measured over the course of the activity and across activities at various stages.

In 420, processing the impact quantity, based on the stored KII delivery from 418 by the first computer system 202. The processing is in accord with the algorithm where the impact quantity may be the log base 100 of the KII delivered, or the impact quantity may be the total number of KII units delivered. The processing of the impact quantity by the first computer system 202 is further configured for storing the processed impact quantity by the first computer system 202.

In 422, transmitting a time period output to the second computer system 204 from the first computer system 202 via the network 206. The time period output is configured to display an entry for time period on the second computer system 204, such as on the webpage. For example, the entry may be in weeks, months, or years.

In 424, receiving a time period input from the second computer system 204 via the network 206. The time period input is determined by the business entity user in response to the time horizon for analysis of the activity. The time period input is configured to be converted into years if entered in months or weeks (e.g. 30 months is converted to 2.5 years) and stored in the first computer system 202 as the time period in years for the analysis of the activity. Given that the time period required for completion of the activity may change over the course of the activity, this input allows the iRR to be measured over the course of the activity and across activities at various stages.

In 426, transmitting an activity cost output to the second computer system 204 from the first computer system 202 via the network 206. The activity cost output is configured to display an entry for the cost in currency on the second computer system 204, such as through the webpage. For example, the entry may be in dollars.

In 428, receiving an activity cost input from the second computer system 204 via the network 206. The activity cost input is determined by the business entity user in response to the cost for the activity. The activity cost input is configured to be stored in the first computer system 202. Given that the activity cost for the activity may change over the course of the activity, this input allows the iRR to be measured over the course of the activity and across activities at various stages.

In 430, processing an impact efficiency based on the stored activity cost of 428 and the stored KII delivery of 418 by the first computer system 202 in accord with the algorithm. The processing may include utilizing a log base 100. Alternatively, the processing of the impact efficiency may include benchmarking the impact efficiency for determining the log base value to utilize as described in the method 100.

In 432, processing the iRR by the first computer system 202 based on the stored impact multiplier value stored in 414, the stored KII delivered stored in 418, the stored time period stored in 424, the stored impact quantity stored in 420, and the stored impact efficiency stored in 430 in accord with the algorithm. The processing of the iRR is configured to store the iRR in the first computer system 202.

In 434 transmitting an iRR output to the second computer system 204 via the network 206 based on the stored iRR in 432. The iRR output is configured to display the iRR on the second computer system 204, such as on the webpage.

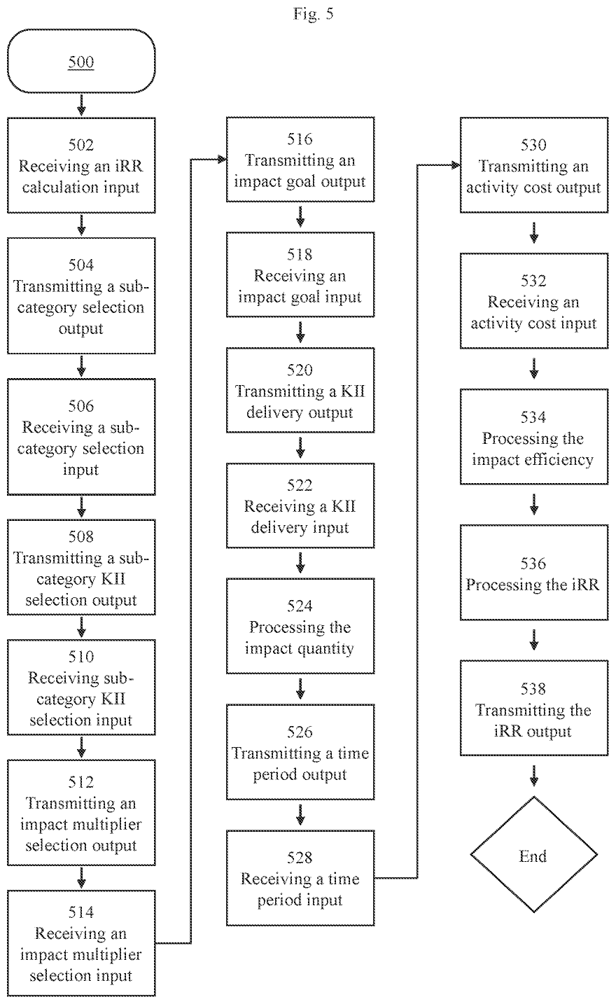

FIG. 5 represents a third method 500 used by the system for assessing the impact value of money by calculating the iRR of an activity. The third method 500 utilizes the algorithm of the method 100 and the system of FIG. 2.

In 502, the first computer system receives an iRR calculation input. The iRR calculation input having been transmitted via the computer network 206 from the second computer system 204. The iRR calculation input includes a request to begin calculation of the iRR.

In 504, transmitting a sub-category selection output to the second computer system 204 via the network 206 based upon the iRR calculation input in 502, the sub-category selection output is configured to display impact area sub-category selections by the second computer system 204. The sub-category selection output is further configured for display by the second computer system 204, such as on the webpage through drop down menu, blank text box, scrolling menu, box selection, or the like. The sub-category selection output is configured to display the impact area sub-categories in 404 of FIG. 4.

In 506, receiving an impact area sub-category selection input, the sub-category selection input having been transmitted from the second computer system 204 to the first computer system 202 via the network 206 based upon the impact area sub-category selection. The impact area sub-category selection is determined by the business entity user in response to the manner in which impact is delivered by the business entity within a modality of an impact theme in connection with the activity. A business entity user selects one or more impact area sub-categories as the impact area sub-category selection. The sub-category selection input is configured for causing the selected impact area sub-category to be stored by the first computer system 202.

In 508, transmitting a sub-category KII selection output to the second computer system 204 via the network 206 based upon the sub-category selection input in 506, the sub-category KII selection output configured to display a KII selection output by the second computer system 204. The sub-category KII selection output is further configured for display by the second computer system 204, such as on a webpage through drop down menu, blank text box, scrolling menu, box selection, or the like.

As the sub-category KII selection output is configured for display based on the sub-category selection input of 506, the KII selections are available for each associated impact area sub-category as described in 408 of FIG. 4. The sub-category KII selection output will only display those KIIs associated with the selected impact area sub-category of 506. The association of KIIs with the impact area sub-categories, and the subsequent display, allows the business entity user to accurately and quickly identify the unit of measurement of an activity within the impact area (i.e. the KII). Without this association the business entity user may inaccurately identify the KII for the activity within the impact area resulting in an inaccurate or nonsensical iRR as the impact multiplier will not correspond to the KII. When the sub-category selection input from 506 includes two or more selected impact area sub-categories, the sub-category KII selection output is configured to display the KIIs associated with each impact area sub-category in separate selections, such as on the webpage through drop down menu, blank text box, scrolling menu, box selection, or the like.

In 510, receiving a sub-category KII selection input, the sub-category KII selection input having been transmitted from the second computer system 204 to the first computer system 202 via the network 206 based upon the KII selection. The KII is determined by the business entity user in response to the unit of measurement of an activity within a selected impact area sub-category. The business entity user selects one KII as the sub-category KII selection input (selected KII). The sub-category KII selection input is configured for causing the selected KII to be stored by the first computer system 202.

In 512, transmitting an impact multiplier selection output to the second computer system 204 via the network 206, the impact multiplier selection output configured to display an impact multiplier selection output by the second computer system 204, as represented by FIG. 4a. The impact multiplier selection output is further configured for display by the second computer system 204, such as on a webpage through drop down menu, blank text box, scrolling menu, box selection, or the like.

In 514, receiving an impact multiplier selection input, the impact multiplier selection input having been transmitted from the second computer system 204 to the first computer system 202 via the network 206 based upon the impact multiplier selection, as represented in FIG. 4b. The impact multiplier selection is determined by the business entity user in response to an impact metric of an activity, when the impact metric is a pre-defined evaluation framework or provided by a third party certifier, validator, or method of analysis. The business entity determines the impact multiplier value for the impact multiplier selection based on this impact metric that is determined by a pre-defined framework, or certified, validated, or analyzed by the third party. For example, LEED certification, ESG scores, DALY values, Rainforest Alliance certification, GIIRS rating, B Impact Score, 60 Decibels results, or the like. The impact multiplier selection input is configured for causing the impact multiplier value to be stored by the first computer system 202.

In 516, transmitting an impact goal output to the second computer system 204 via the network 206 based upon the KII selection input and stored KII in the first computer system 202 from 510. The impact goal output is configured for the impact goal to be displayed, such as via the webpage, on the second computer system 204 for entry of the impact goal in the corresponding KII unit. For example, when the KII is housing units, the display includes a blank entry for the impact goal per housing units.

In 518, receiving an impact goal input from the second computer 204 via the network 206. The impact goal input is determined by the business entity user in response to the impact goal output in 516 and the goal of the activity. The business entity will accurately report the impact goal to maintain its reputation and for obtaining accurate iRR results for comparison across activities, where a manipulation to artificially lower the impact goal to artificially inflate the iRR detracts from either objective. The impact goal input is configured to be stored in the first computer system 202 as the impact goal for calculation of the impact quantity for the calculation of iRR.

In 520, transmitting a KII delivery output to the second computer system 204 via the network 206 based upon the KII selection input stored in the first computer system from 510. The KII delivery output is configured for display on the second computer system 204, such as on the webpage, for entry of the KIIs expected (in the case of ex-ante analysis), KIIs in delivery (in the case of ex-hoc analysis) or KIIs delivered (in the case of ex-post analysis) in connection with the activity in the corresponding KII unit. For example, when the KII is housing units, the display includes a blank entry for the entry of the number of housing units in the analysis.

In 522, receiving a KII delivery input from the second computer system 204 via the network 206. The KII delivery input is determined by the business entity user in response to the KII selection in 510 and the number of KII units of the activity at the particular analysis point in time for the activity. The KIT delivery input is configured to be stored in the first computer system 202 as the KII units delivered (KII delivery) for calculation of the impact quantity and impact efficiency for the calculation of iRR. Given that the KII units delivered in the activity may change over the course of the activity, this input allows the iRR to be measured over the course of the activity and across activities at various stages.

In 524, processing the impact quantity, based on the stored KII delivery from 522 and the stored impact goal from 518 by the first computer system 202. The processing is in accord with the algorithm where the impact quantity is the stored KII delivery divided by the stored impact goal. The processing of the impact quantity by the first computer system 202 is further configured for storing the processed impact quantity by the first computer system 202.

In 526, transmitting a time period output to the second computer system 204 from the first computer system 202 via the network 206. The time period output is configured to display an entry for time period on the second computer system 204, such as on the webpage. For example, the entry may be in weeks, months, or years.

In 528, receiving a time period input from the second computer system 204 via the network 206. The time period input is determined by the business entity user in response to the time horizon for analysis of the activity. The time period input is configured to be converted into years if entered in months or weeks (e.g. 30 months is converted to 2.5 years) and stored in the first computer system 202 as the time period in years for the analysis of the activity. Given that the time period required for completion of the activity may change over the course of the activity, this input allows the iRR to be measured over the course of the activity and across activities at various stages.

In 530, transmitting an activity cost output to the second computer system 204 from the first computer system 202 via the network 206. The activity cost output is configured to display an entry for the cost in currency on the second computer system 204, such as through the webpage. For example, the entry may be in dollars.

In 532, receiving an activity cost input from the second computer system 204 via the network 206. The activity cost input is determined by the business entity user in response to the cost for the activity. The activity cost input is configured to be stored in the first computer system 202. Given that the activity cost for the activity may change over the course of the activity, this input allows the iRR to be measured over the course of the activity and across activities at various stages.

In 534, processing an impact efficiency based on the stored activity cost of 532 and the stored KII delivery of 522 by the first computer system 202 in accord with the algorithm. The processing may include utilizing a log base 100. Alternatively, the processing of the impact efficiency may include benchmarking the impact efficiency for determining the log base value to utilize as described in the method 100.

In 536, processing the iRR by the first computer system 202 based on the stored impact multiplier value stored in 514, the stored KII delivered stored in 522, the stored time period stored in 528, the stored impact quantity stored in 524, and the stored impact efficiency stored in 534 in accord with the algorithm. The processing of the iRR is configured to store the iRR in the first computer system 202.

In 538, transmitting an iRR output to the second computer system 204 via the network 206 based on the stored iRR in 536. The iRR output is configured to display the iRR on the second computer system 204, such as on the webpage.

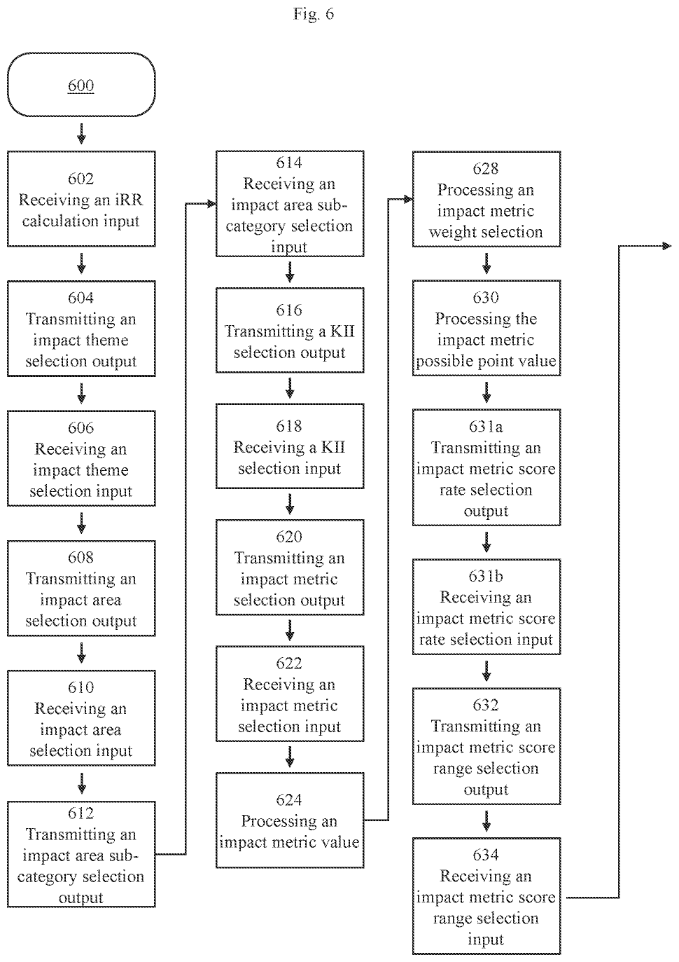

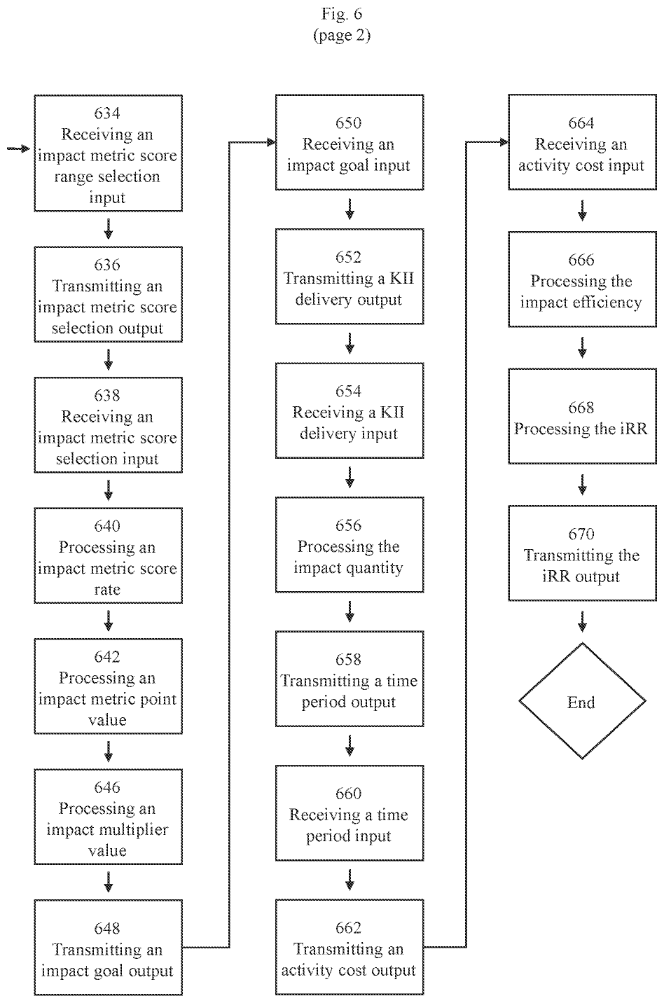

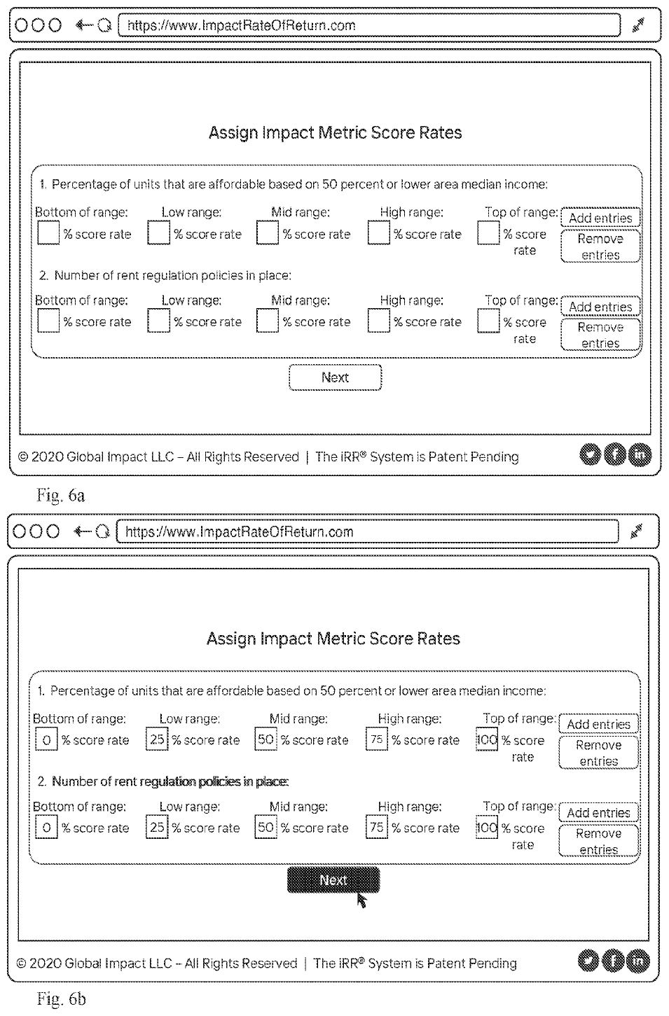

FIG. 6 represents a fourth method 600 used by the system for assessing the impact value of money by calculating the iRR of an activity. The fourth method 600 utilizes the algorithm of the method 100 and the system of FIG. 2. In 602, a first computer system 202 receives an iRR calculation input as described in 102 of FIG. 1.

In 604, based upon the iRR calculation input, transmitting an impact theme selection output from the first computer system 202 to the second computer system 204 via the network 206 as described in 104 of FIG. 1.

In 606, receiving an impact theme selection input, the impact theme selection input having been transmitted from the second computer system 204 to the first computer system 202 via the network 206 based upon the impact selection theme as described in 106 of FIG. 1.

In 608, transmitting an impact area selection output to the second computer system 204 via the network 206 based upon the impact theme selection input in 606, the impact area selection output is configured to display an impact area selection by the second computer system as described in 108 of FIG. 1.

In 610, receiving an impact area selection input, the impact area selection input having been transmitted from the second computer system 204 to the first computer system 202 via the network 206 based upon the impact area selections as described in 110 of FIG. 1.

In 612, transmitting an impact area sub-category selection output to the second computer system 204 via the network 206 based upon the impact area selection input in 610, the impact area sub-category selection output is configured to display impact area sub-category selections by the second computer system 204 as described in 112 of FIG. 1.

In 614, receiving an impact area sub-category selection input, the impact area sub-category selection input having been transmitted from the second computer system 204 to the first computer system 202 via the network 206 based upon the impact area sub-category selection as described in 114 of FIG. 1.

In 616, transmitting a KII selection output to the second computer system 204 via the network 206 based upon the impact area selection input in 610, the KII selection output configured to display a KII selection output by the second computer system 204 as described in 116 of FIG. 1.

In 618, receiving a KII selection input, the KII selection input having been transmitted from the second computer system 204 to the first computer system 202 via the network 206 based upon the KII selection as described in 118 of FIG. 1.

In 620, transmitting an impact metric selection output to the second computer system 204 via the network 206 based upon the impact area sub-category selection input in 614, the impact metric selection output configured to display an impact metric selection output by the second computer system 204 as described in 120 of FIG. 1.

In 622, receiving an impact metric selection input, the impact metric selection input having been transmitted from the second computer system 204 to the first computer system 202 via the network 206 based upon the impact metric selection as described in 122 of FIG. 1.

In 624, processing an impact metric value by the first computer system 202 as described in 124 of FIG. 1.

In 628, processing an impact metric weight by the first computer system 202 as described in 128 of FIG. 1.

In 630, processing an impact metric possible point value by the first computer system 202 as described in 130 of FIG. 1.

In 631a, transmitting an impact metric score rate selection output, to the second computer system 204 via the network 206 based upon the impact metric selection input in 622, the impact metric score rate selection output configured to display an impact metric score rate selection output by the second computer system 204, as represented in FIG. 6a. The impact metric score rate selection output includes a percentage array for quantitative score rates associated with each impact metric score. For example, when the array is divided in five parts, there are 5 corresponding impact metric score rate selections associated with the performance of the impact metric, corresponding to Bottom of range (poorest performance), Low range (poor performance), Mid range (acceptable performance), High range (better performance), Top of range (best performance). Each impact metric selection stored as the impact metric selection input in 622 has an associated impact metric score rate selection. The impact metric score rate selection output further includes a selection for the business entity user to increase or decrease the number of impact metric score rate entries. For example, when the percentage array is divided in 10 parts, the business entity user selects to increase the number of impact metric score rate entries to 10 entries. The impact metric score rate selection output is further configured for display by the second computer system 204, such as on the webpage through drop down menu, blank text box, scrolling menu, box selection, or the like.

In 631b, receiving an impact metric score rate selection input, the impact metric score rate selection input having been transmitted from the second computer system 204 to the first computer system 202 via the network 206 based upon the impact metric score rate selection. The impact metric score rate selection is determined by the business entity user in response to score rates associated with the performance of each impact metric, as represented in FIG. 6b. For example, the business entity user may enter values of 0%, 25%, 50%, 75%, 100% where 0% corresponds to Bottom of range impact metric performance and 100% corresponds with Top of range impact metric performance, respectively, for an impact metric. In another example, the business entity user may enter values of −50%, −25%, 0%, 25%, and 50%, where −50% corresponds to Bottom of range impact metric performance and 50% corresponds with Top of range impact metric performance, respectively, for an impact metric. The business entity user enters impact metric score rates based upon historical data, industry knowledge, expert consultation, or a combination of the same. The impact metric score rate selection input is configured for causing the selected impact metric score rate to be stored in association with its impact metric by the first computer system 202.

In 632, transmitting an impact metric score range selection output to the second computer system 204 via the network 206 based upon the impact metric selection input in 622, the impact metric score range selection output configured to display an impact metric score range selection output by the second computer system 204 as described in 132 of FIG. 1.

In 634, receiving an impact metric score range selection input, the impact metric score range selection input having been transmitted from the second computer system 204 to the first computer system 202 via the network 206 based upon the impact metric score range selection as described in 134 of FIG. 1.

In 636, transmitting an impact metric score selection output to the second computer system 204 via the network 206 based upon the impact metric score range selection input stored in 634, the impact metric score selection output is configured to display an impact metric score selection output by the second computer system 204 as described in 136 of FIG. 1.

In 638, receiving an impact metric score selection input, the impact metric score selection input having been transmitted from the second computer system 204 to the first computer system 202 via the network 206 based upon the impact metric score selection output in 636 as described in 138 of FIG. 1.

In 640, processing an impact metric score rate by the first computer system 202, where the impact metric score rate is associated with the respective impact metric score selection input stored in 638 as described in 140 of FIG. 1.

In 642, processing an impact metric point value by the first computer system 202, where the impact metric point value is associated with the respective impact metric possible point value stored in 630 and the impact metric score rate stored in 640 as described in 142 of FIG. 1.

In 646, processing an impact multiplier value by the first computer system 202 as described in 146 of FIG. 1.

In 648, transmitting an impact goal output to the second computer system 204 via the network 206 based upon the KII selection input and stored KII in the first computer system 202 from 618 as described in 148 of FIG. 1.

In 650, receiving an impact goal input from the second computer 204 via the network 206 as described in 150 of FIG. 1.

In 652, transmitting a KII delivery output to the second computer system 204 via the network 206 based upon the KII selection input stored in the first computer system from 618 as described in 152 of FIG. 1.

In 654, receiving a KII delivery input from the second computer system 204 via the network 206 as described in 154 of FIG. 1.

In 656, processing the impact quantity, based on the stored KII delivery from 654 and the stored impact goal from 650, by the first computer system 202 as described in 156 of FIG. 1.

In 658, transmitting a time period output to the second computer system 204 from the first computer system 202 via the network 206 as described in 158 of FIG. 1.

In 660, receiving a time period input from the second computer system 204 via the network 206 as described in 160 of FIG. 1.

In 662, transmitting an activity cost output to the second computer system 204 from the first computer system 202 via the network 206 as described in 162 of FIG. 1.

In 664, receiving an activity cost input from the second computer system 204 via the network 206 as described in 164 of FIG. 1.

In 666, processing an impact efficiency based on the stored activity cost of 664 and the stored KII delivery of 654 by the first computer system 202 in accord with the algorithm as described in 166 of FIG. 1.

In 668, processing the iRR by the first computer system 202 based on the stored impact multiplier value stored in 646, the stored KII delivered stored in 654, the stored time period stored in 660, the stored impact quantity stored in 656, and the stored impact efficiency stored in 666 in accord with the algorithm as described in 168 of FIG. 1.

In 670, transmitting an iRR output to the second computer system 204 via the network 206 based on the stored iRR in 668 as described in 170 of FIG. 1.

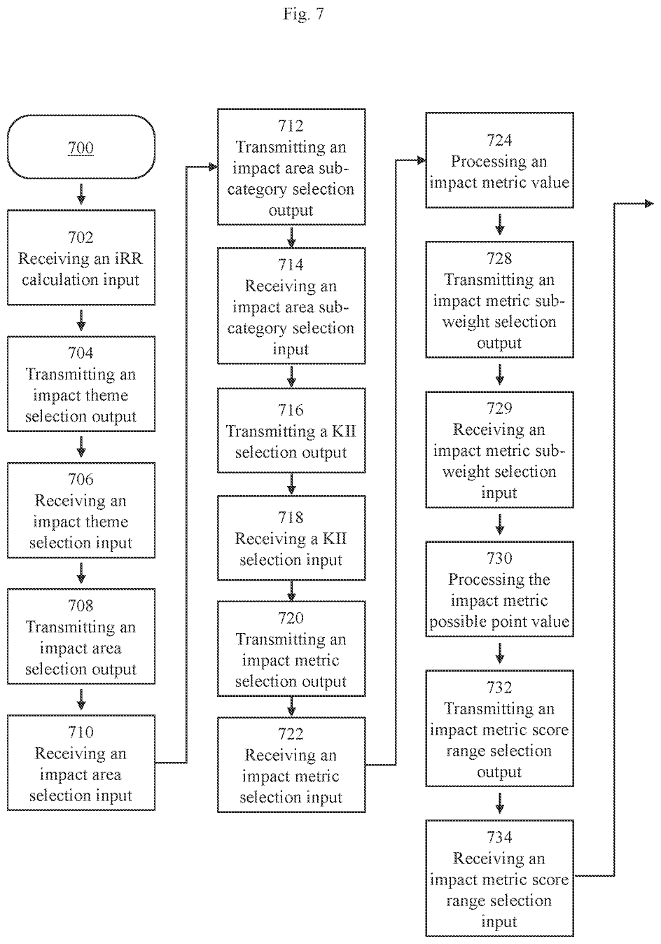

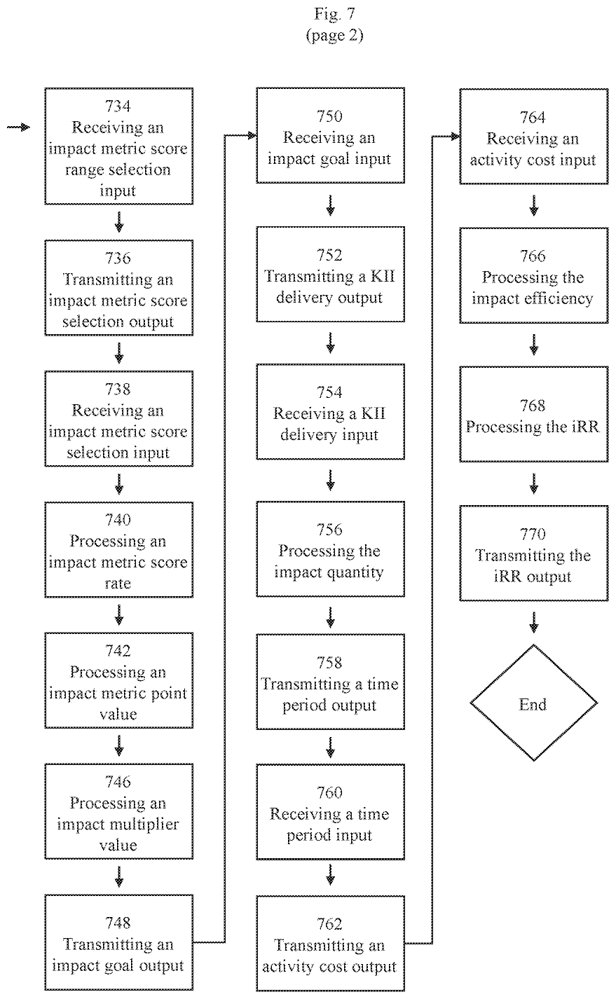

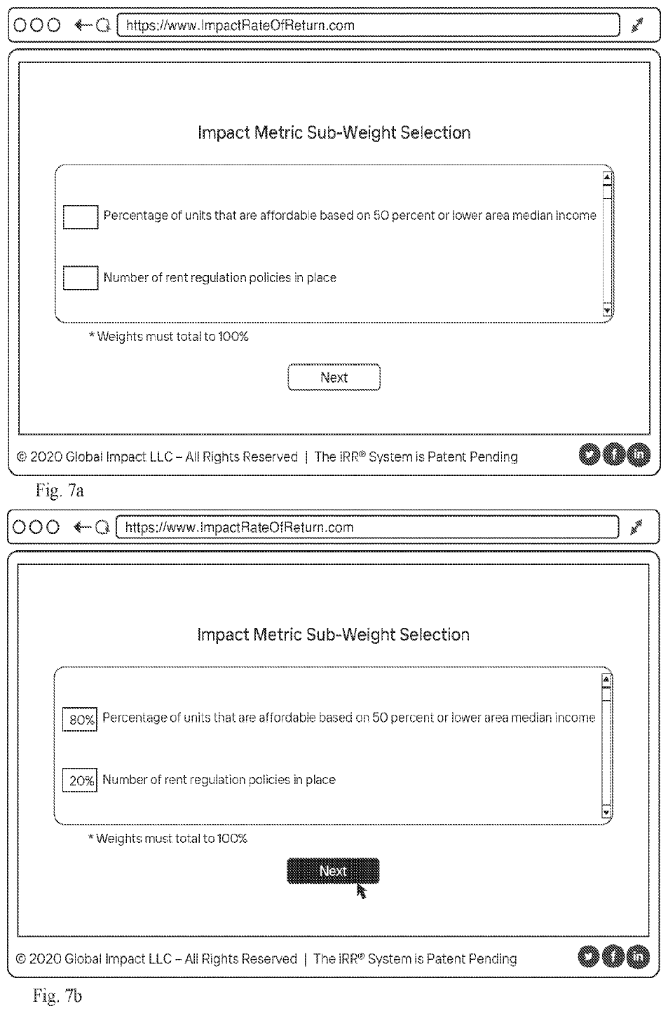

FIG. 7 represents a fifth method 700 used by the system for assessing the impact value of money by calculating the iRR of an activity. The fifth method 700 utilizes the algorithm of the method 100 and the system of FIG. 2. In 702, a first computer system receives an iRR calculation input as described in 102 of FIG. 1.

In 704, based upon the iRR calculation input, transmitting an impact theme selection output from the first computer system 202 to the second computer system 204 via the network 206 as described in 104 of FIG. 1.

In 706, receiving an impact theme selection input, the impact theme selection input having been transmitted from the second computer system 204 to the first computer system 202 via the network 206 based upon the impact selection theme as described in 106 of FIG. 1.

In 708, transmitting an impact area selection output to the second computer system 204 via the network 206 based upon the impact theme selection input in 706, the impact area selection output is configured to display an impact area selection by the second computer system as described in 108 of FIG. 1.

In 710, receiving an impact area selection input, the impact area selection input having been transmitted from the second computer system 204 to the first computer system 202 via the network 206 based upon the impact area selections as described in 110 of FIG. 1.

In 712, transmitting an impact area sub-category selection output to the second computer system 204 via the network 206 based upon the impact area selection input in 710, the impact area sub-category selection output is configured to display impact area sub-category selections by the second computer system 204 as described in 112 of FIG. 1.

In 714, receiving an impact area sub-category selection input, the impact area sub-category selection input having been transmitted from the second computer system 204 to the first computer system 202 via the network 206 based upon the impact area sub-category selection as described in 114 of FIG. 1.

In 716, transmitting a KII selection output to the second computer system 204 via the network 206 based upon the impact area selection input in 710, the KII selection output configured to display a KII selection output by the second computer system 204 as described in 116 of FIG. 1.

In 718, receiving a KII selection input, the KII selection input having been transmitted from the second computer system 204 to the first computer system 202 via the network 206 based upon the KII selection as described in 118 of FIG. 1.

In 720, transmitting an impact metric selection output to the second computer system 204 via the network 206 based upon the impact area sub-category selection input in 714, the impact metric selection output configured to display an impact metric selection output by the second computer system 204 as described in 120 of FIG. 1.

In 722, receiving an impact metric selection input, the impact metric selection input having been transmitted from the second computer system 204 to the first computer system 202 via the network 206 based upon the impact metric selection as described in 122 of FIG. 1.

In 724, processing an impact metric value by the first computer system 202 as described in 124 of FIG. 1.

In 728, transmitting an impact metric sub-weight selection output to the second computer system 204 via the network 206 based upon the impact metric selection input of 722, the impact metric sub-weight selection output configured to display an impact metric sub-weight output by the second computer system, such as on a webpage. The impact metric sub-weight selection output may be configured for display of custom sub-weight entries as blank fields for entry of any sub-weight percentages that sum to 100% as represented in FIG. 7a.

The impact metric sub-weight selection output may be configured to display the impact metrics as groupings of “primary,” “secondary,” and “tertiary,” such as through drag and drop, drop down menu, blank text box, scrolling menu, box selection, or the like (i.e. grouping display). Impact metrics within the primary grouping have an impact metric sub-weight equal to the pro rata share of 60% of the impact metric weight, impact metrics within the secondary grouping have an impact metric sub-weight equal to the pro rata share of 30% of the impact metric weight, and impact metrics in the tertiary grouping have an impact metric sub-weight equal to the pro rata share of 10% of the impact metric weight.

The impact metric sub-weight selection output may be configured to display the impact metrics as categories, such as through drag and drop, drop down menu, blank text box, scrolling menu, box selection, or the like. Each category has an entry for assignment of a percentage of the impact metric weight (where all categories must sum to 100%) and an entry for assignment of a percentage of the category's weight (where all metrics in a category must sum to 100%) (i.e. category display).

In 729, receiving an impact metric sub-weight selection input, the impact metric sub-weight selection input having been transmitted from the second computer system 204 to the first computer system 202 via the network 206 based upon the impact metric sub-weight selection. The impact metric sub-weight selection is determined by the business entity user in response to the weight the business entity user desires to assign to each of the at least one impact metrics. The impact metric sub-weight selection input is configured for causing the impact metric sub-weight input comprising all of the impact metric sub-weights to be stored by the first computer system 202 in association with the corresponding impact metric.

When the impact metric sub-weight selection output is configured for custom entry display, the impact metric sub-weight selection input includes impact metric sub-weights determined by the business entity user, where the impact metric sub-weights must sum to 100%, as represented in FIG. 7b. When the impact metric sub-weight selection output is configured for the grouping display, the impact metric sub-weight selection input includes the business entity user's assignment of the impact metric groupings for the assignment of the impact metric sub-weights. For example, the impact metric sub-weights for the primary grouping having two impact metrics is 30% for each impact metric.

When the impact metric sub-weight selection output is configured for category display, the impact metric sub-weight selection input includes the business entity user's assignment of the impact metric categories and the impact metric sub-weight assigned to the impact metrics within each category, and is configured for processing the impact metric sub-weights by the first computer system 202. The impact metric sub-weight is equal to the category percentage multiplied by the impact metric percentage within the category. For example, the activity may have impact metrics selected where 4 impact metrics relate to poverty, which may be grouped into one category and assigned a category percentage of 80% of the impact metric value. Each of the 4 impact metrics within the “poverty” category are then assigned impact metric percentages of 60%, 15%, 15%, and 10%, respectively. The impact metric sub-weights of these 4 impact metrics are 48%, 12%, 12%, and 8%, respectively.

In 730, processing an impact metric possible point value by the first computer system 202, where the impact metric possible point value is the product of the impact metric value and the respective impact metric sub-weights as stored in 724 and 729 respectively. When two or more impact metrics are stored as the impact metric selection, the impact metric possible point value includes impact metric possible point sub-values. Each of the two or more impact metrics has an impact metric possible point sub-value. The first computer system 202 processes the impact metric possible point sub-values by multiplying the corresponding impact metric sub-weights (as stored in 729) by the impact metric value (as stored in 724), where the impact metric possible point value remains equal to 100. The processing further includes storing the impact metric possible point sub-values by the first computer system 202 in association with their corresponding impact metrics.

In 732, transmitting an impact metric score range selection output to the second computer system 204 via the network 206 based upon the impact metric selection input in 722, the impact metric score range selection output configured to display an impact metric score range selection output by the second computer system 204 as described in 132 of FIG. 1.

In 734, receiving an impact metric score range selection input, the impact metric score range selection input having been transmitted from the second computer system 204 to the first computer system 202 via the network 206 based upon the impact metric score range selection as described in 134 of FIG. 1.

In 736, transmitting an impact metric score selection output to the second computer system 204 via the network 206 based upon the impact metric score range selection input stored in 734, the impact metric score selection output is configured to display an impact metric score selection output by the second computer system 204 as described in 136 of FIG. 1.

In 738, receiving an impact metric score selection input, the impact metric score selection input having been transmitted from the second computer system 204 to the first computer system 202 via the network 206 based upon the impact metric score selection output in 736 as described in 138 of FIG. 1.

In 740, processing an impact metric score rate by the first computer system 202, where the impact metric score rate is associated with the respective impact metric score selection input stored in 738 as described in 140 of FIG. 1.

In 742, processing an impact metric point value by the first computer system 202, where the impact metric point value is associated with the respective impact metric possible point value stored in 730 and the impact metric score rate stored in 740 as described in 142 of FIG. 1.

In 746, processing an impact multiplier value by the first computer system 202 as described in 146 of FIG. 1.

In 748, transmitting an impact goal output to the second computer system 204 via the network 206 based upon the KII selection input and stored KII in the first computer system 202 from 718 as described in 148 of FIG. 1.

In 750, receiving an impact goal input from the second computer 204 via the network 206 as described in 150 of FIG. 1.

In 752, transmitting a KII delivery output to the second computer system 204 via the network 206 based upon the KII selection input stored in the first computer system from 718 as described in 152 of FIG. 1.

In 754, receiving a KII delivery input from the second computer system 204 via the network 206 as described in 154 of FIG. 1.

In 756, processing the impact quantity, based on the stored KII delivery from 754 and the stored impact goal from 750, by the first computer system 202 as described in 156 of FIG. 1.

In 758, transmitting a time period output to the second computer system 204 from the first computer system 202 via the network 206 as described in 158 of FIG. 1.

In 760, receiving a time period input from the second computer system 204 via the network 206 as described in 160 of FIG. 1.

In 762, transmitting an activity cost output to the second computer system 204 from the first computer system 202 via the network 206 as described in 162 of FIG. 1.

In 764, receiving an activity cost input from the second computer system 204 via the network 206 as described in 164 of FIG. 1.

In 766, processing an impact efficiency based on the stored activity cost of 764 and the stored KII delivery of 754 by the first computer system 202 in accord with the algorithm as described in 166 of FIG. 1.

In 768, processing the iRR by the first computer system 202 based on the stored impact multiplier value stored in 746, the stored KII delivered stored in 754, the stored time period stored in 760, the stored impact quantity stored in 756, and the stored impact efficiency stored in 766 in accord with the algorithm as described in 168 of FIG. 1.

In 770, transmitting an iRR output to the second computer system 204 via the network 206 based on the stored iRR in 768 as described in 170 of FIG. 1.

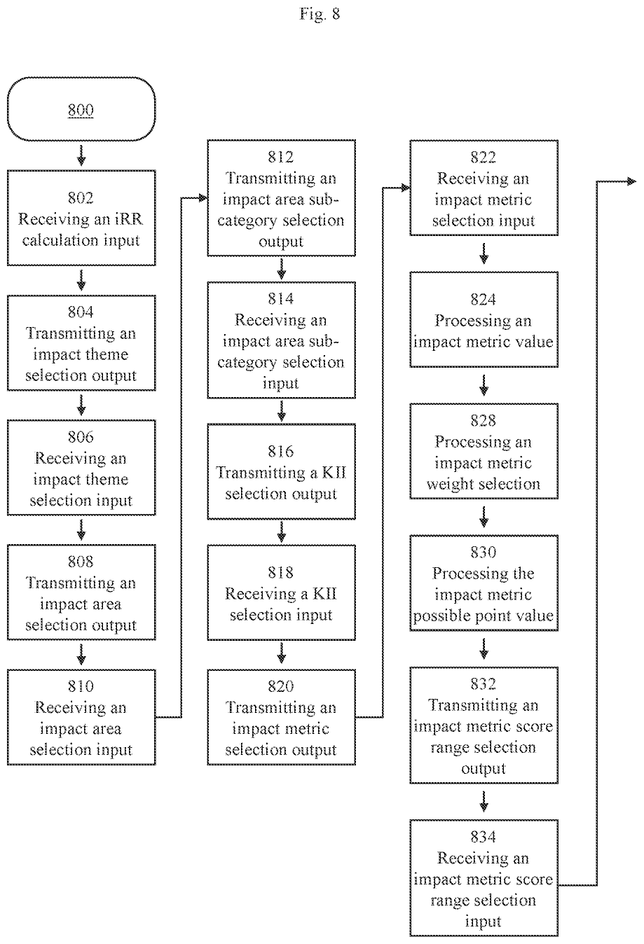

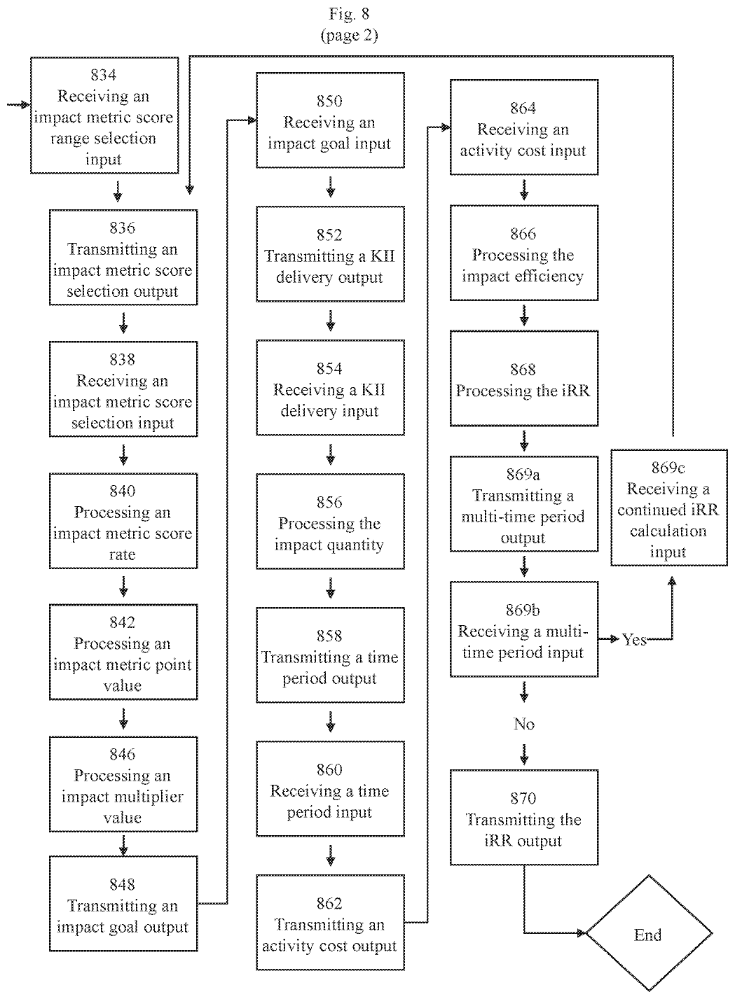

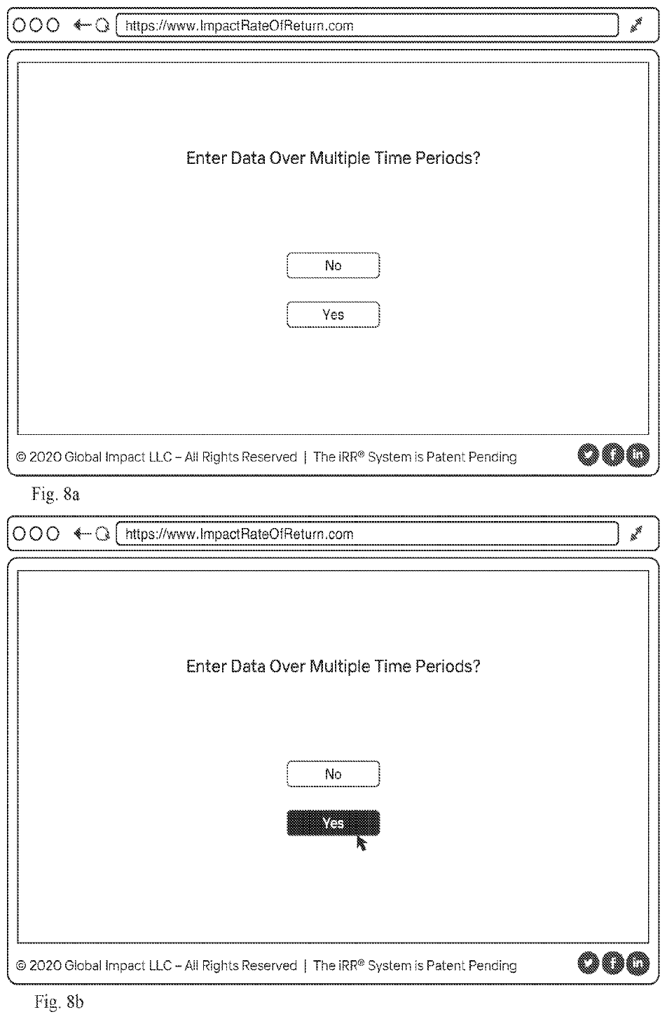

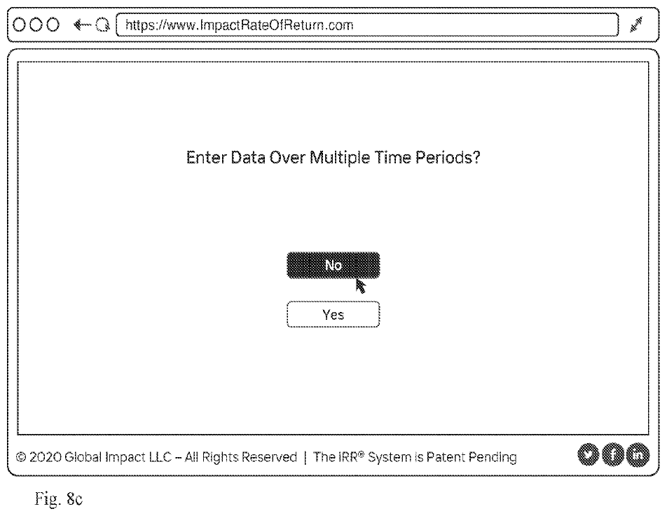

FIG. 8 represents a sixth method 800 used by the system for assessing the impact value of money by calculating the iRR of an activity for multi-time-period data. The sixth method 800 utilizes the algorithm of the method 100 and the system of FIG. 2. In 802, a first computer system receives an iRR calculation input as described in 102 of FIG. 1. The iRR calculation input may further be configured to include account login information for an account associated with a business entity.

Account login information corresponds to a registered account of the system. The business entity may have previously created its registered account with the system, where the registered account is associated with the business entity and may permit access to one or more business entity users. For example, a business entity user may create the registered account by transmitting a registration request input from a web page of the website of the second computer system 204 via the network 206 to the first computer system 202. In response to the registration request input, the second computer system 204 may transmit a registration request output, the registration request output configured for display on the second computer system 202. The registration request output having registration information data entry fields for allowing the business entity user to provide registration information, such as identifying individual information for business entity users (email, username, or the like), background information, unique passwords for each business user, and the like. In response to the registration request output, the first computer system 202 receives a registration information input via the network 206. The registration information input including the completed data entry fields of the registration request output (registration information) and is configured for creating a registered account and causing storage of the registration information in connection with the registered account.

In 804, based upon the iRR calculation input and validating account login information, transmitting an impact theme selection output from the first computer system 202 to the second computer system 204 via the network 206 as described in 104 of FIG. 1. The impact theme selection output may further be configured to include an activity name selection for the business entity user to name and refer to the iRR calculation for the activity.

In 806, receiving an impact theme selection input, the impact theme selection input having been transmitted from the second computer system 204 to the first computer system 202 via the network 206 based upon the impact selection theme as described in 106 of FIG. 1. The impact theme selection input further including the activity name selection determined by the business entity user, where the impact theme selection input is further configured for causing storage of the iRR calculation, including all data stored in association therewith, in further association with the business entity account under the activity name.

In 808, transmitting an impact area selection output to the second computer system 204 via the network 206 based upon the impact theme selection input in 806, the impact area selection output is configured to display an impact area selection by the second computer system as described in 108 of FIG. 1.

In 810, receiving an impact area selection input, the impact area selection input having been transmitted from the second computer system 204 to the first computer system 202 via the network 206 based upon the impact area selections as described in 110 of FIG. 1.

In 812, transmitting an impact area sub-category selection output to the second computer system 204 via the network 206 based upon the impact area selection input in 810, the impact area sub-category selection output is configured to display impact area sub-category selections by the second computer system 204 as described in 112 of FIG. 1.

In 814, receiving an impact area sub-category selection input, the impact area sub-category selection input having been transmitted from the second computer system 204 to the first computer system 202 via the network 206 based upon the impact area sub-category selection as described in 114 of FIG. 1.

In 816, transmitting a KII selection output to the second computer system 204 via the network 206 based upon the impact area selection input in 810, the KII selection output configured to display a KII selection output by the second computer system 204 as described in 116 of FIG. 1.

In 818, receiving a KII selection input, the KII selection input having been transmitted from the second computer system 204 to the first computer system 202 via the network 206 based upon the KII selection as described in 118 of FIG. 1.

In 820, transmitting an impact metric selection output to the second computer system 204 via the network 206 based upon the impact area sub-category selection input in 814, the impact metric selection output configured to display an impact metric selection output by the second computer system 204 as described in 120 of FIG. 1.

In 822, receiving an impact metric selection input, the impact metric selection input having been transmitted from the second computer system 204 to the first computer system 202 via the network 206 based upon the impact metric selection as described in 122 of FIG. 1.

In 824, processing an impact metric value by the first computer system 202 as described in 124 of FIG. 1.

In 828, processing an impact metric weight by the first computer system 202 as described in 128 of FIG. 1.

In 830, processing an impact metric possible point value by the first computer system 202 as described in 130 of FIG. 1.

In 832, transmitting an impact metric score range selection output to the second computer system 204 via the network 206 based upon the impact metric selection input in 822, the impact metric score range selection output configured to display an impact metric score range selection output by the second computer system 204 as described in 132 of FIG. 1.

In 834, receiving an impact metric score range selection input, the impact metric score range selection input having been transmitted from the second computer system 204 to the first computer system 202 via the network 206 based upon the impact metric score range selection as described in 134 of FIG. 1.

In 836, transmitting an impact metric score selection output to the second computer system 204 via the network 206 based upon the impact metric score range selection input stored in 834, the impact metric score selection output is configured to display an impact metric score selection output by the second computer system 204 as described in 136 of FIG. 1. In response to a continued iRR calculation input (869c), the impact metric score selection output may further be configured to display the stored, selected impact metric score by the second computer system 204, which may be modified by the business entity user.

In 838, receiving an impact metric score selection input, the impact metric score selection input having been transmitted from the second computer system 204 to the first computer system 202 via the network 206 based upon the impact metric score selection output in 836 as described in 138 of FIG. 1.

In 840, processing an impact metric score rate by the first computer system 202, where the impact metric score rate is associated with the respective impact metric score selection input stored in 838 as described in 140 of FIG. 1.

In 842, processing an impact metric point value by the first computer system 202, where the impact metric point value is associated with the respective impact metric possible point value stored in 830 and the impact metric score rate stored in 840 as described in 142 of FIG. 1.

In 846, processing an impact multiplier value by the first computer system 202 as described in 146 of FIG. 1.

In 848, transmitting an impact goal output to the second computer system 204 via the network 206 based upon the KII selection input and stored KII in the first computer system 202 from 818 as described in 148 of FIG. 1. In response to a continued iRR calculation input (869c), the impact goal output may further be configured to display the stored impact goal by the second computer system 204, which may be modified by the business entity user.

In 850, receiving an impact goal input from the second computer 204 via the network 206 as described in 150 of FIG. 1.

In 852, transmitting a KII delivery output to the second computer system 204 via the network 206 based upon the KII selection input stored in the first computer system from 818 as described in 152 of FIG. 1. In response to a continued iRR calculation input (869c), the KII delivery output may further be configured to display the stored KII delivery by the second computer system 204, which may be modified by the business entity user.

In 854, receiving a KII delivery input from the second computer system 204 via the network 206 as described in 154 of FIG. 1.

In 856, processing the impact quantity, based on the stored KII delivery from 854 and the stored impact goal from 850, by the first computer system 202 as described in 156 of FIG. 1.

In 858, transmitting a time period output to the second computer system 204 from the first computer system 202 via the network 206 as described in 158 of FIG. 1. In response to a continued iRR calculation input (869c), the time period output may further be configured to display the stored time period by the second computer system 204, which may be modified by the business entity user.

In 860, receiving a time period input from the second computer system 204 via the network 206 as described in 160 of FIG. 1.

In 862, transmitting an activity cost output to the second computer system 204 from the first computer system 202 via the network 206 as described in 162 of FIG. 1. In response to a continued iRR calculation input (869c), the activity cost output may further be configured to display the stored activity cost by the second computer system 204, which may be modified by the business entity user.

In 864, receiving an activity cost input from the second computer system 204 via the network 206 as described in 164 of FIG. 1.

In 866, processing an impact efficiency based on the stored activity cost of 864 and the stored KII delivery of 854 by the first computer system 202 in accord with the algorithm as described in 166 of FIG. 1.

In 868, processing the iRR by the first computer system 202 based on the stored impact multiplier value stored in 846, the stored KII delivered stored in 854, the stored time period stored in 860, the stored impact quantity stored in 856, and the stored impact efficiency stored in 866 in accord with the algorithm as described in 168 of FIG. 1.

In 869a, transmitting a multi-time period output to the second computer system 204 via the network 206, the multi-time period output configured to display a multi-time-period output by the second computer system 204, as represented in FIG. 8a. The multi-time-period output includes a selection of “yes” or “no” regarding whether the iRR calculation will be calculated over a multi-time-period.

In 869b, receiving a multi-time-period input, the multi-time-period input having been transmitted from the second computer system 204 to the first computer system 202 via the network 206 based upon the multi-time-period selection, as represented in FIGS. 8b and 8c. The business entity user determines whether the iRR calculation includes a multi-time-period. For example, if the business entity desires to measure iRR each year over a 5 year project, and the business entity user is in year two of the activity, the business entity user may select “yes.” In response to a “yes” multi-time-period input, the first computer system 202 stores the processed iRR from 868 in association with the multi-time-period input and may return the business entity user to a home page of the website or log the business entity user out of the account.

Or for example, if the business entity user has completed a multi-time-period activity of five years, the business entity user may select “no.” In response to a “no” the first computer system stores the processed iRR from 868 in association with the multi-time-period input and proceeds to 870.

In 869c, in response to a “yes” selection of the multi-time-period input, receiving a continued iRR calculation input, the iRR calculation input having been transmitted via a computer network 206 from a second computer system 204. The continued iRR calculation input may occur after a time period (e.g. 6 months, 1 year). The continued iRR calculation input is configured to include account login information for the account associated with the business entity and a request to continue the iRR calculation. The continued iRR calculation input is further configured to validate the account login information and begin the continued iRR calculation at 836 for the stored activity name.

In 870, in response to a “no” selection of the multi-time-period input transmitting an iRR output to the second computer system 204 via the network 206 based on the stored iRR in 868 as described in 170 of FIG. 1.

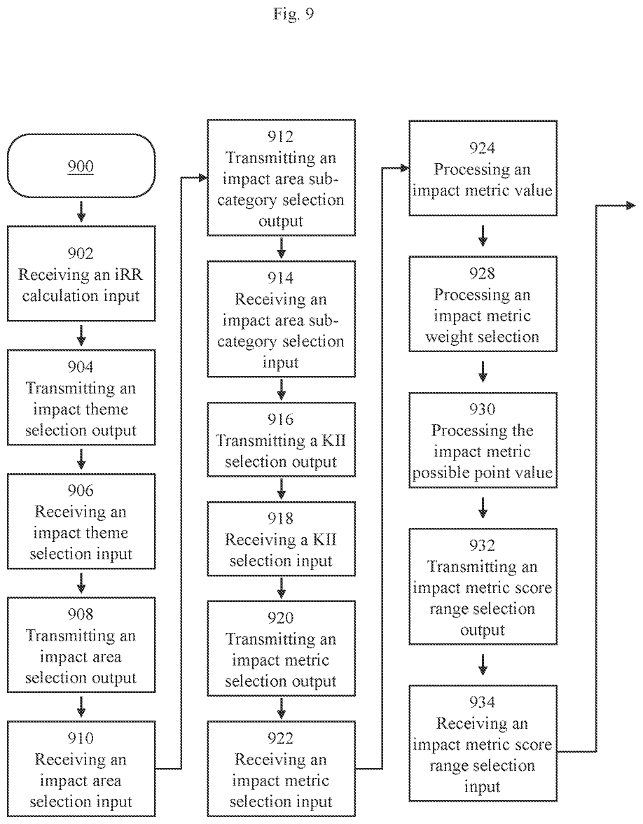

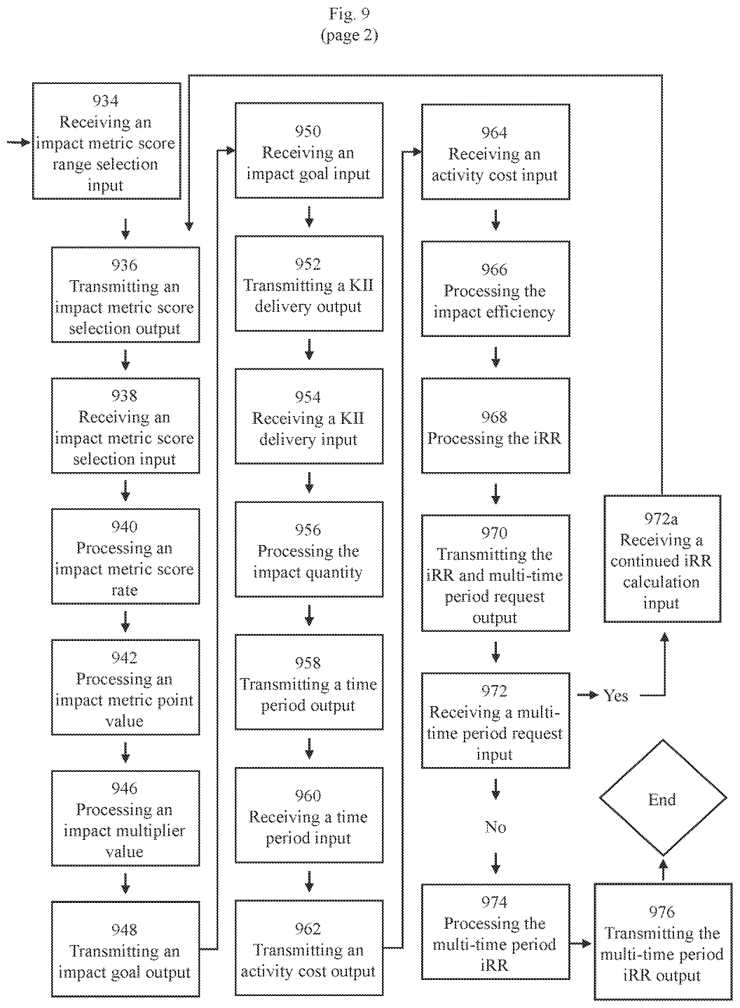

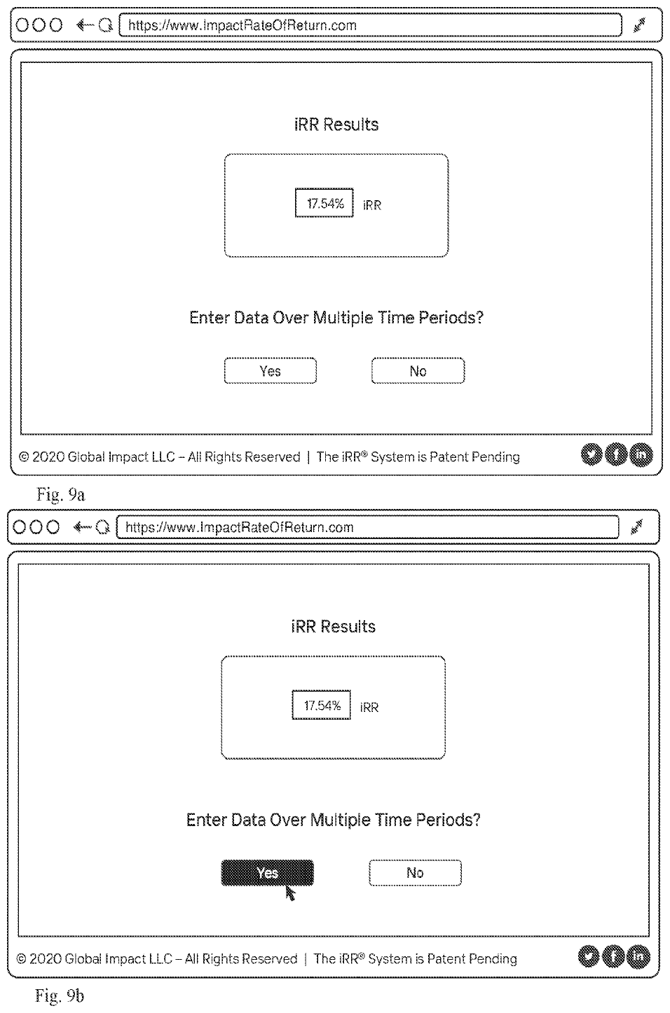

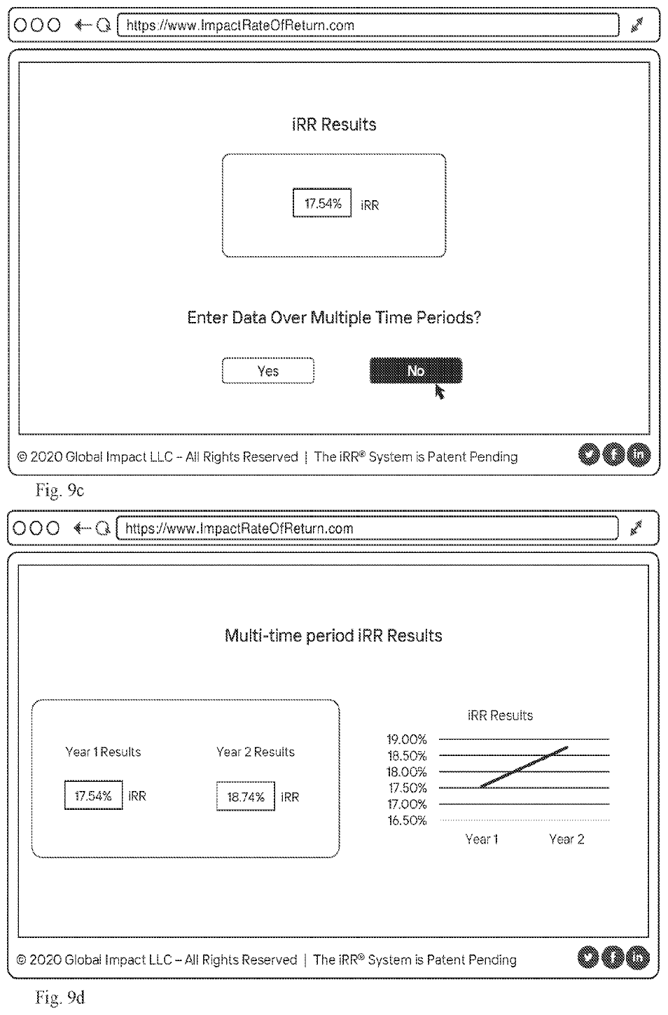

FIG. 9 represents a seventh method 900 used by the system for assessing the impact value of money by calculating the iRR of an activity for graphical representation of multi-time-period iRR calculations. Each time period (e.g. 1 year period) has an associated iRR time period calculation. The seventh method 900 utilizes the algorithm of the method 100 and the system of FIG. 2. In 902, a first computer system receives an iRR calculation input as described in 102 of FIG. 1. The iRR calculation input may further be configured to include account login information for an account associated with a business entity.

In 904, based upon the iRR calculation input and validating account login information, transmitting an impact theme selection output from the first computer system 202 to the second computer system 204 via the network 206 as described in 104 of FIG. 1. The impact theme selection output may further be configured to include an activity name selection for the business entity user to name and refer to the iRR calculation for the particular activity.

In 906, receiving an impact theme selection input, the impact theme selection input having been transmitted from the second computer system 204 to the first computer system 202 via the network 206 based upon the impact selection theme as described in 106 of FIG. 1. The impact theme selection input further includes the activity name selection determined by the business entity user, where the impact theme selection input is further configured for causing storage of the iRR calculation, including all data stored in association therewith, in further association with the business entity account under the activity name.

In 908, transmitting an impact area selection output to the second computer system 204 via the network 206 based upon the impact theme selection input in 906, the impact area selection output is configured to display an impact area selection by the second computer system as described in 108 of FIG. 1.

In 910, receiving an impact area selection input, the impact area selection input having been transmitted from the second computer system 204 to the first computer system 202 via the network 206 based upon the impact area selections as described in 110 of FIG. 1.

In 912, transmitting an impact area sub-category selection output to the second computer system 204 via the network 206 based upon the impact area selection input in 910, the impact area sub-category selection output is configured to display impact area sub-category selections by the second computer system 204 as described in 112 of FIG. 1.

In 914, receiving an impact area sub-category selection input, the impact area sub-category selection input having been transmitted from the second computer system 204 to the first computer system 202 via the network 206 based upon the impact area sub-category selection as described in 114 of FIG. 1.

In 916, transmitting a KII selection output to the second computer system 204 via the network 206 based upon the impact area selection input in 910, the KII selection output configured to display a KII selection output by the second computer system 204 as described in 116 of FIG. 1.

In 918, receiving a KII selection input, the KII selection input having been transmitted from the second computer system 204 to the first computer system 202 via the network 206 based upon the KII selection as described in 118 of FIG. 1.

In 920, transmitting an impact metric selection output to the second computer system 204 via the network 206 based upon the impact area sub-category selection input in 914, the impact metric selection output configured to display an impact metric selection output by the second computer system 204 as described in 120 of FIG. 1.

In 922, receiving an impact metric selection input, the impact metric selection input having been transmitted from the second computer system 204 to the first computer system 202 via the network 206 based upon the impact metric selection as described in 122 of FIG. 1.

In 924, processing an impact metric value by the first computer system 202 as described in 124 of FIG. 1.

In 928, processing an impact metric weight by the first computer system 202 as described in 128 of FIG. 1.

In 930, processing an impact metric possible point value by the first computer system 202 as described in 130 of FIG. 1.

In 932, transmitting an impact metric score range selection output to the second computer system 204 via the network 206 based upon the impact metric selection input in 922, the impact metric score range selection output configured to display an impact metric score range selection output by the second computer system 204 as described in 132 of FIG. 1.

In 934, receiving an impact metric score range selection input, the impact metric score range selection input having been transmitted from the second computer system 204 to the first computer system 202 via the network 206 based upon the impact metric score range selection as described in 134 of FIG. 1.

In 936, transmitting an impact metric score selection output to the second computer system 204 via the network 206 based upon the impact metric score range selection input stored in 934, the impact metric score selection output is configured to display an impact metric score selection output by the second computer system 204 as described in 136 of FIG. 1. In response to a continued iRR calculation input (972a), the impact metric score selection output may further be configured to display the stored, selected impact metric score by the second computer system 204, which may be modified by the business entity user.

In 938, receiving an impact metric score selection input, the impact metric score selection input having been transmitted from the second computer system 204 to the first computer system 202 via the network 206 based upon the impact metric score selection output in 936 as described in 138 of FIG. 1. In response to the continued iRR calculation input (972a), the impact metric score selection input is further configured to store the selected impact metric in association with its associated iRR time period calculation.

In 940, processing an impact metric score rate for the associated iRR time period calculation by the first computer system 202, where the impact metric score rate is associated with the respective impact metric score selection input stored in 938 as described in 140 of FIG. 1 and in association with its associated iRR time period calculation.

In 942, processing an impact metric point value for the associated iRR time period calculation by the first computer system 202, where the impact metric point value is associated with the respective impact metric possible point value stored in 930 and the impact metric score rate stored in 940 as described in 142 of FIG. 1 and in association with its associated iRR time period calculation.

In 946, processing an impact multiplier value by the first computer system 202 as described in 146 of FIG. 1 and in association with its associated iRR time period calculation.

In 948, transmitting an impact goal output to the second computer system 204 via the network 206 based upon the KII selection input and stored KII in the first computer system 202 from 918 as described in 148 of FIG. 1. In response to a continued iRR calculation input (972a), the impact goal output may further be configured to display the impact goal by the second computer system 204, which may be modified by the business entity user.

In 950, receiving an impact goal input from the second computer 204 via the network 206 as described in 150 of FIG. 1. In response to the continued iRR calculation input (972a), the impact goal input is further configured to store the selected impact goal in association with its associated iRR time period calculation.

In 952, transmitting a KII delivery output to the second computer system 204 via the network 206 based upon the KII selection input stored in the first computer system from 918 as described in 152 of FIG. 1. In response to a continued iRR calculation input (972a), the KII delivery output may further be configured to display the stored KII delivery by the second computer system 204, which may be modified by the business entity user.

In 954, receiving a KII delivery input from the second computer system 204 via the network 206 as described in 154 of FIG. 1. In response to the continued iRR calculation input (972a), the KII delivery input is further configured to store the KII units delivered in association with its associated iRR time period calculation.

In 956, processing the impact quantity for the associated iRR time period calculation, based on the stored KII delivery from 954 and the stored impact goal from 950, by the first computer system 202 as described in 156 of FIG. 1 and in association with its associated iRR time period calculation.

In 958, transmitting a time period output to the second computer system 204 from the first computer system 202 via the network 206 as described in 158 of FIG. 1. In response to a continued iRR calculation input (972a), the time period output may further be configured to display the stored time period by the second computer system 204, which may be modified by the business entity user.

In 960, receiving a time period input from the second computer system 204 via the network 206 as described in 160 of FIG. 1. In response to the continued iRR calculation input (972a), the impact goal input is further configured to store the time period in association with its associated iRR time period calculation.

In 962, transmitting an activity cost output to the second computer system 204 from the first computer system 202 via the network 206 as described in 162 of FIG. 1. In response to a continued iRR calculation input (972a), the activity cost output may further be configured to display the stored activity cost by the second computer system 204, which may be modified by the business entity user.

In 964, receiving an activity cost input from the second computer system 204 via the network 206 as described in 164 of FIG. 1. In response to the continued iRR calculation input (972a), the activity cost input is further configured to store the activity cost in association with its associated iRR time period calculation.

In 966, processing an impact efficiency for the associated iRR time period calculation based on the stored activity cost of 964 and the stored KII delivery of 954 by the first computer system 202 in accord with the algorithm as described in 166 of FIG. 1.

In 968, processing the iRR for the associated time period iRR calculation by the first computer system 202 based on the stored impact multiplier value stored in 946, the stored KII delivered stored in 954, the stored time period stored in 960, the stored impact quantity stored in 956, and the stored impact efficiency stored in 966 in accord with the algorithm as described in 168 of FIG. 1.

In 970 transmitting an iRR and multi-time-period request output to the second computer system 204 via the network 206 based on the stored iRR in 968. The iRR and multi-time period request output is configured to display the iRR for the associated time period iRR calculation and a multi-time-period output by the second computer system 204, as represented in FIG. 9a. The iRR and multi-time-period output includes a selection of “yes” or “no” regarding whether the iRR calculation will be calculated over a multi-time-period.

In 972, receiving a multi-time-period request input, the multi-time-period request input having been transmitted from the second computer system 204 to the first computer system 202 via the network 206 based upon the multi-time-period selection, as represented in FIGS. 9b and 9c. The business entity user determines whether the iRR calculation includes a multi-time-period. For example, if the business entity desires to measure iRR each year over a 5 year project, and the business entity user is in year two of the activity, the business entity user may select “yes.” In response to a “yes” multi-time-period input, the first computer system 202 stores the processed iRR from 968 in association with the time period iRR calculation and may return the business entity user to a home page of the website or log the business entity user out of the account.

Or for example, if the business entity user has completed a multi-time-period activity of five years, the business entity user may select “no.” In response to a “no” the first computer system stores processed iRR from 968 in association with the time period iRR calculation and proceeds to 974.

In 972a, in response to a “yes” selection of the multi-time-period input, receiving a continued iRR calculation input, the iRR calculation input having been transmitted via a computer network 206 from a second computer system 204. The continued iRR calculation input may occur after a time period (e.g. 6 months, 1 year). The continued iRR calculation input is configured to include account login information for the account associated with the business entity and a request to continue the iRR calculation. The continued iRR calculation input is further configured to validate the account login information and begin the continued iRR calculation at 936 for the stored activity name. The continued iRR calculation input may further be configured to include the time period for the time period iRR calculation (e.g. 1 year has passed since the previous time period iRR calculation).

In 974, in response to a “no” selection of the multi-time-period input, processing the multi-time-period iRR by the first computer system 202 based on the stored time period iRR calculations stored in 968. The processing is configured to store the iRR for each time period as a time period iRR calculation in association with the respective time period in the first computer system 202.

In 976, transmitting a multi-time-period iRR output to the second computer system 204 via the network 206 based on the stored multi-time-period iRR in 974. The iRR output is configured to display the iRR on the second computer system 204, such as on the webpage, in connection with each time period and graphically as represented in FIG. 9d.

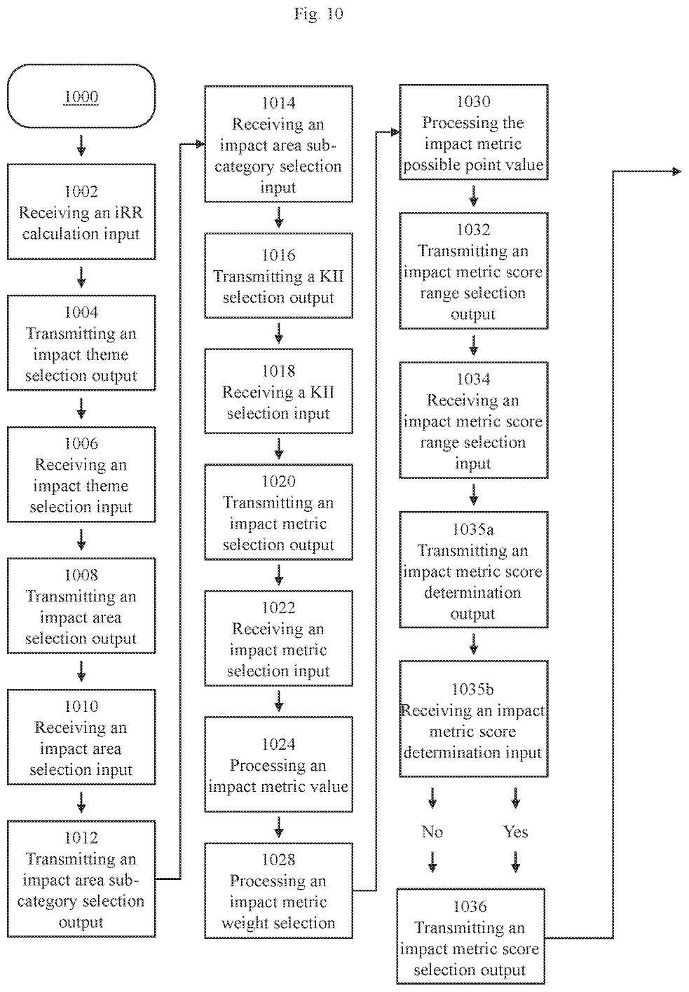

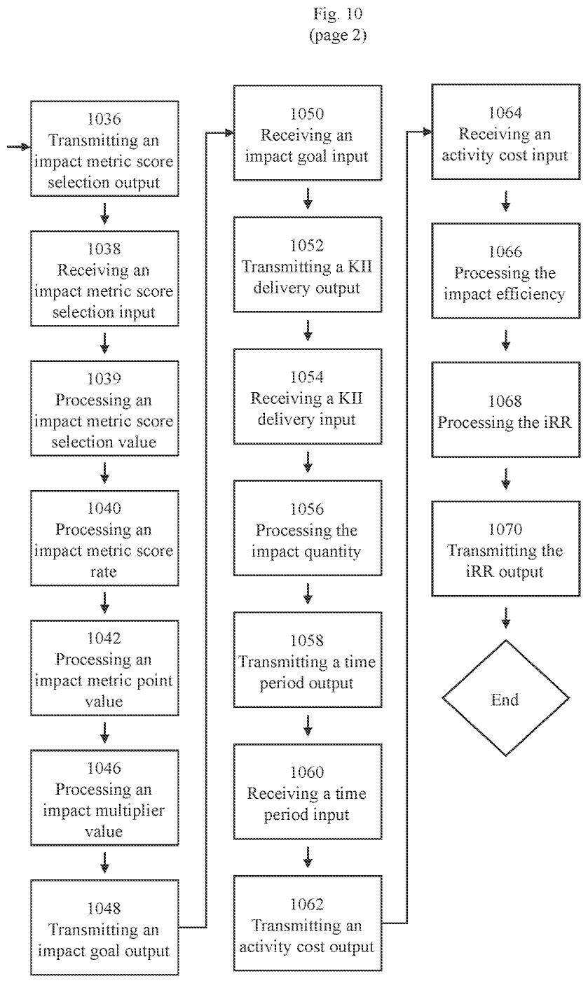

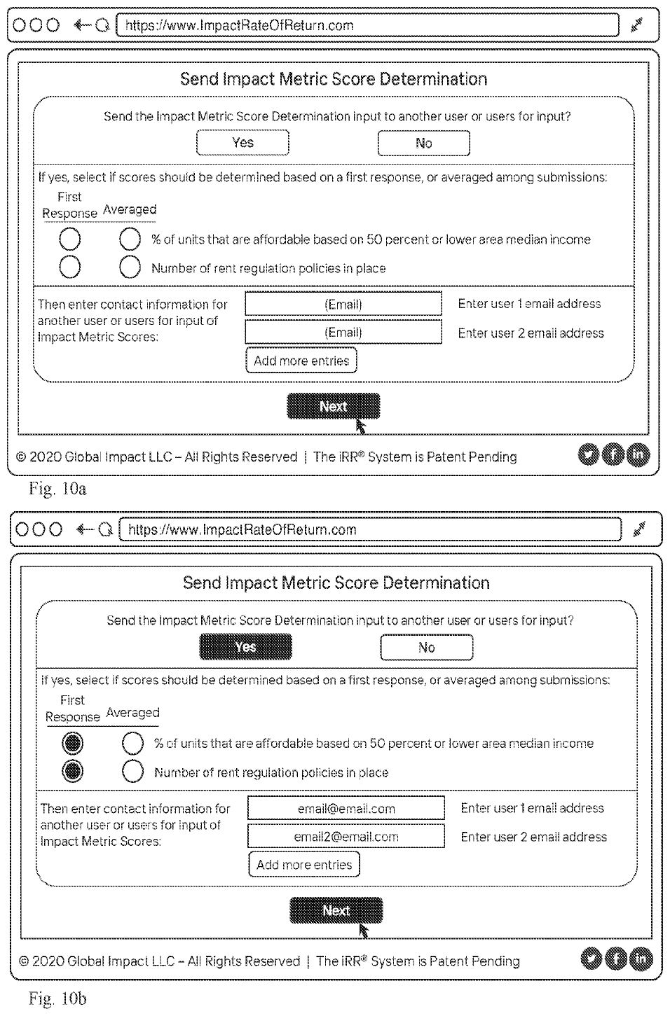

FIG. 10 represents an eighth method 1000 used by the system for assessing the impact value of money by calculating the iRR of an activity having input from one or more other business entity users or third parties. The eighth method 1000 utilizes the algorithm of the method 100 and the system of FIG. 2. In 1002, a first computer system receives an iRR calculation input as described in 102 of FIG. 1.

In 1004, based upon the iRR calculation input, transmitting an impact theme selection output from the first computer system 202 to the second computer system 204 via the network 206 as described in 104 of FIG. 1.

In 1006, receiving an impact theme selection input, the impact theme selection input having been transmitted from the second computer system 204 to the first computer system 202 via the network 206 based upon the impact selection theme as described in 106 of FIG. 1.

In 1008, transmitting an impact area selection output to the second computer system 204 via the network 206 based upon the impact theme selection input in 1006, the impact area selection output is configured to display an impact area selection by the second computer system as described in 108 of FIG. 1.

In 1010, receiving an impact area selection input, the impact area selection input having been transmitted from the second computer system 204 to the first computer system 202 via the network 206 based upon the impact area selections as described in 110 of FIG. 1.

In 1012, transmitting an impact area sub-category selection output to the second computer system 204 via the network 206 based upon the impact area selection input in 1010, the impact area sub-category selection output is configured to display impact area sub-category selections by the second computer system 204 as described in 112 of FIG. 1.

In 1014, receiving an impact area sub-category selection input, the impact area sub-category selection input having been transmitted from the second computer system 204 to the first computer system 202 via the network 206 based upon the impact area sub-category selection as described in 114 of FIG. 1.

In 1016, transmitting a KII selection output to the second computer system 204 via the network 206 based upon the impact area selection input in 1010, the KII selection output configured to display a KIT selection output by the second computer system 204 as described in 116 of FIG. 1.

In 1018, receiving a KII selection input, the KII selection input having been transmitted from the second computer system 204 to the first computer system 202 via the network 206 based upon the KII selection as described in 118 of FIG. 1.

In 1020, transmitting an impact metric selection output to the second computer system 204 via the network 206 based upon the impact area sub-category selection input in 1014, the impact metric selection output configured to display an impact metric selection output by the second computer system 204 as described in FIG. 1.

In 1022, receiving an impact metric selection input, the impact metric selection input having been transmitted from the second computer system 204 to the first computer system 202 via the network 206 based upon the impact metric selection as described in 122 of FIG. 1.

In 1024, processing an impact metric value by the first computer system 202, as described in 124 of FIG. 1.

In 1028, processing an impact metric weight by the first computer system 202, where the impact metric weight is equal to 100%, and where the impact metric weight further includes sub-weights as described in 128 of FIG. 1.

In 1030, processing an impact metric possible point value by the first computer system 202 as described in 130 of FIG. 1.

In 1032, transmitting an impact metric score range selection output to the second computer system 204 via the network 206 based upon the impact metric selection input in 1022, the impact metric score range selection output configured to display an impact metric score range selection output by the second computer system 204 as described in 132 of FIG. 1.

In 1034, receiving an impact metric score range selection input, the impact metric score range selection input having been transmitted from the second computer system 204 to the first computer system 202 via the network 206 based upon the impact metric score range selection as described in 134 of FIG. 1.

In 1035a, transmitting an impact metric score determination output to the second computer system 204 via the network 206 based upon the impact metric score range selection input stored in 1034, the impact metric score determination output is configured to display an impact metric score determination output by the second computer system 204 as represented in FIG. 10a. The impact metric score determination output includes a determination of whether one or more other business entity users or a third parties has relevant data to make an impact metric score selection, and information entry (i.e. email address) regarding the business entity user or a third party that will provide the impact metric score selection. The impact metric score determination output may further include a determination of whether data from two or more impact metric score selections will be averaged, or if the first response will be used. The impact metric score determination output is further configured for display by the second computer system 204, such as on the webpage through drop down menu, blank text box, scrolling menu, box selection, or the like.

In 1035b, receiving an impact metric score determination input to the first computer system 204 via the network 206 based upon the impact metric score determination output of 1035a. The impact metric score determination may be determined by the business entity user in response to the type of impact metrics selected for measurement in association with the activity, as represented in FIG. 10b. For example, the business entity user may input “yes,” when the business entity wants data from one or more business entity users or third parties at the site of the activity to provide real-time information, or the business entity may want data from the third parties with expertise on ascertaining the impact metric score associated with the impact metrics. Alternatively, the business entity user may input “no,” when the business entity user has the necessary data to make the impact metric score selection itself

Further, the impact metric score determination includes the business entity user's entry of the information of the one or more other business entity users and/or third parties that will provide the impact metric score selection. Finally the impact metric score determination includes the business entity user's input of whether the impact metric score selection input(s) will be averaged or whether the first impact metric score selection input will be the sole impact metric score selection input. The impact metric score determination input is configured for causing the selected impact metric score determination to be stored in association with the respective selected impact metrics by the first computer system 202.

In 1036, based upon a “no” impact metric score determination input stored in 1035b transmitting an impact metric score selection output to the second computer system 204 via the network 206 based upon the impact metric score range selection input stored in 1034, the impact metric score selection output is configured to display an impact metric score selection output by the second computer system 204, as described in 136 of FIG. 1.

In 1036, based on a “yes” impact metric score determination input stored in 1035b transmitting an impact metric score selection output to the one or more computer systems (i.e. second computer system 204, third computer system 208) associated with the information stored in 1035b and associated with the one or more other business entity users or third parties, the impact metric score selection output is configured to display an impact metric score selection output by the second computer system 204, as described in 136 of FIG. 1.

In 1038, receiving one or more impact metric score selection input(s), the one or more impact metric score selection input(s) having been transmitted from the computer system (i.e. first computer system 202, second computer system 204, third computer system 208) associated with the impact metric score selection output to the first computer system 202 via the network 206 based upon the impact metric score selection output(s) in 1036 as described in 138 of FIG. 1.

In 1039, processing the impact metric score selection value by the first computer system 202 based upon the impact metric score determination input stored in 1035b. In response to the impact metric score determination input in 1035b of “no” the first computer system 202 stores the impact metric score selection in association with the respective impact metric. In response to the impact metric score determination input stored in 1035b of the first impact metric score selection input for an impact metric, the first computer system 202 stores the first impact metric score selection input in association with the respective impact metric. In response to the impact metric score determination input stored in 1035b of the average for the impact metric score selection inputs for an impact metric, the first computer system 202 averages the impact metric score selection inputs and stores the averaged impact metric score selection input as the impact metric score selection in association with the respective impact metrics.

In 1040, processing an impact metric score rate by the first computer system 202, where the impact metric score rate is associated with the respective impact metric score selection input stored in 1038 as described in 140 of FIG. 1.

In 1042, processing an impact metric point value by the first computer system 202, where the impact metric point value is associated with the respective impact metric possible point value stored in 1030 and the impact metric score rate stored in 1040 as described in 142 of FIG. 1.

In 1046, processing an impact multiplier value by the first computer system 202 as described in 146 of FIG. 1.

In 1048, transmitting an impact goal output to the second computer system 204 via the network 206 based upon the KII selection input and stored KII in the first computer system 202 from 1018 as described in 148 of FIG. 1.

In 1050, receiving an impact goal input from the second computer 204 via the network 206 as described in 150 of FIG. 1.

In 1052, transmitting a KII delivery output to the second computer system 204 via the network 206 based upon the KII selection input stored in the first computer system from 1018 as described in 152 of FIG. 1.

In 1054, receiving a KII delivery input from the second computer system 204 via the network 206 as described in 154 of FIG. 1.

In 1056, processing the impact quantity, based on the stored KII delivery from 1054 and the stored impact goal from 1050, by the first computer system 202 as described in 156 of FIG. 1.

In 1058, transmitting a time period output to the second computer system 204 from the first computer system 202 via the network 206 as described in 158 of FIG. 1.

In 1060, receiving a time period input from the second computer system 204 via the network 206 as described in 160 of FIG. 1.

In 1062, transmitting an activity cost output to the second computer system 204 from the first computer system 202 via the network 206 as described in 162 of FIG. 1.

In 1064, receiving an activity cost input from the second computer system 204 via the network 206 as described in 164 of FIG. 1.

In 1066, processing an impact efficiency based on the stored activity cost of 1064 and the stored KII delivery of 1054 by the first computer system 202 in accord with the algorithm as described in 166 of FIG. 1.

In 1068, processing the iRR by the first computer system 202 based on the stored impact multiplier value stored in 1046, the stored KII delivered stored in 1054, the stored time period stored in 1060, the stored impact quantity stored in 1056, and the stored impact efficiency stored in 1066 in accord with the algorithm as described in 168 of FIG. 1.

In 1070, transmitting an iRR output to the second computer system 204 via the network 206 based on the stored iRR in 1068 as described in 170 of FIG. 1.

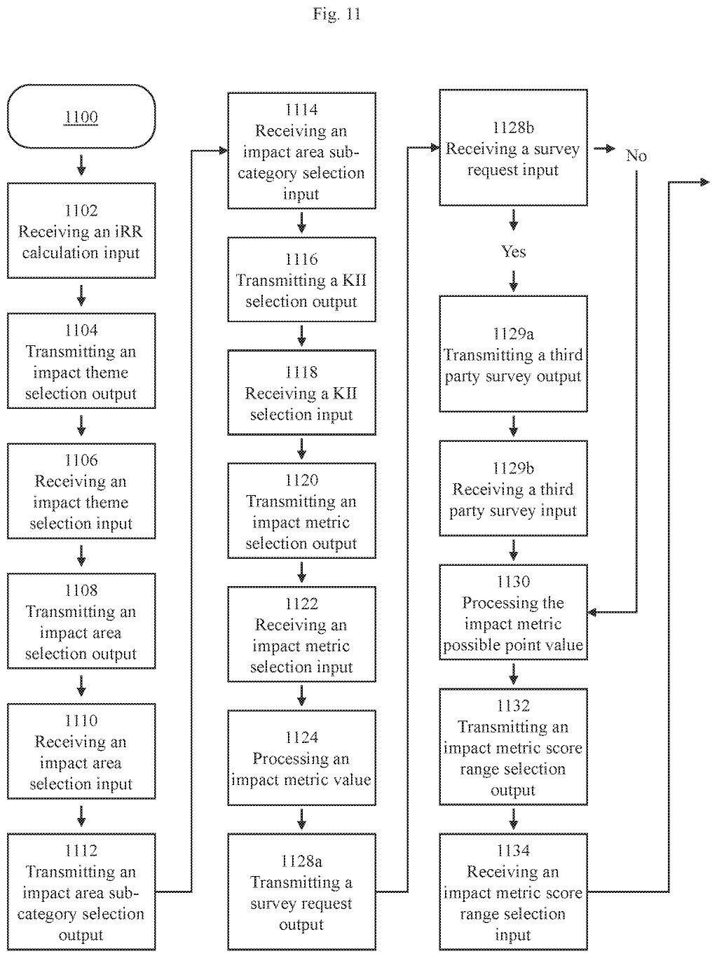

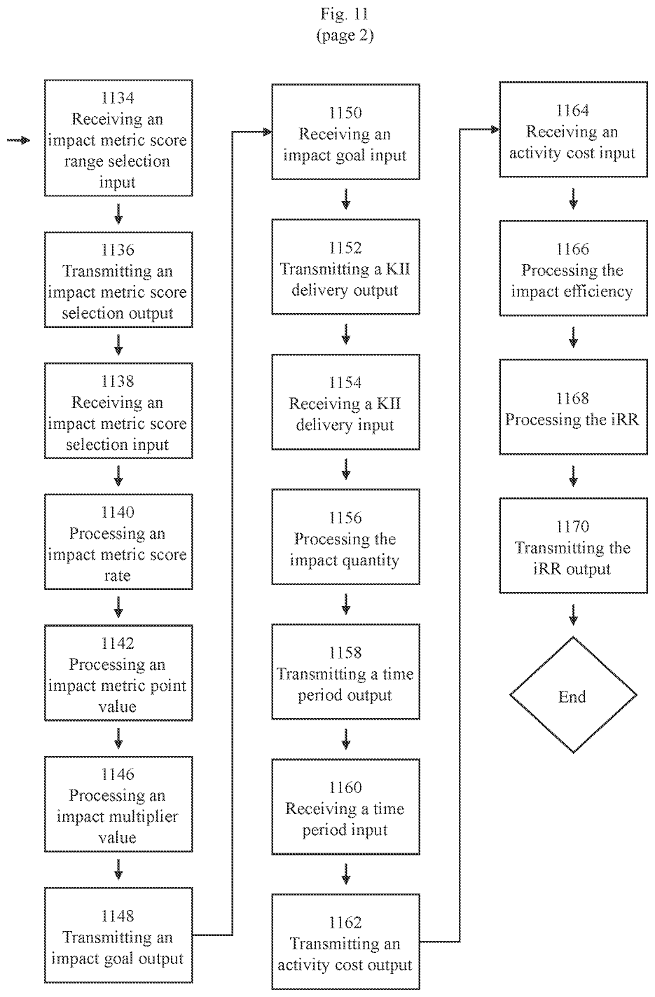

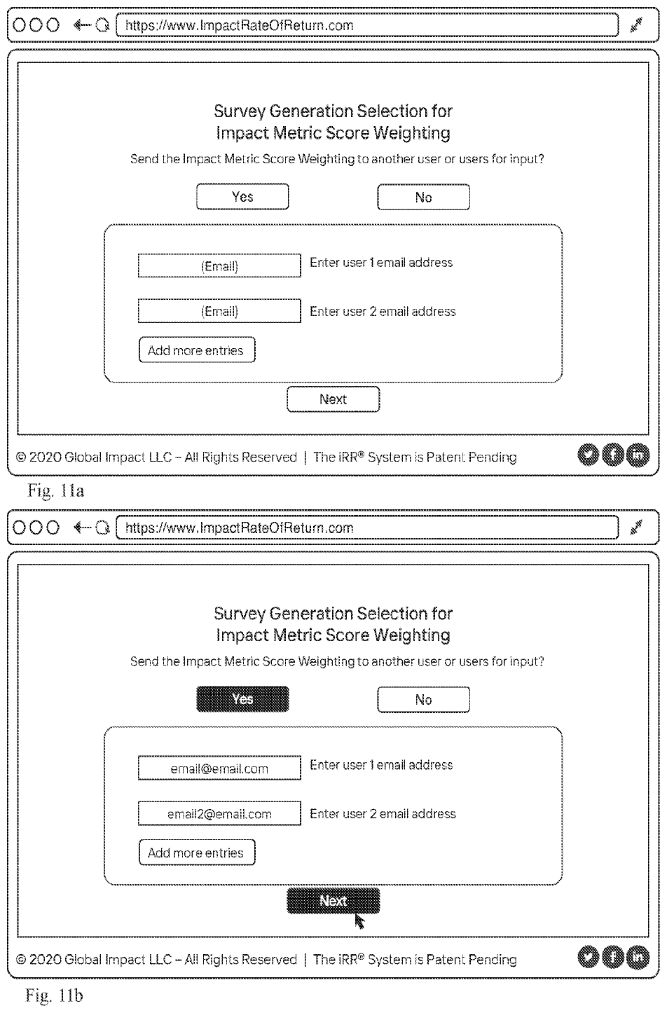

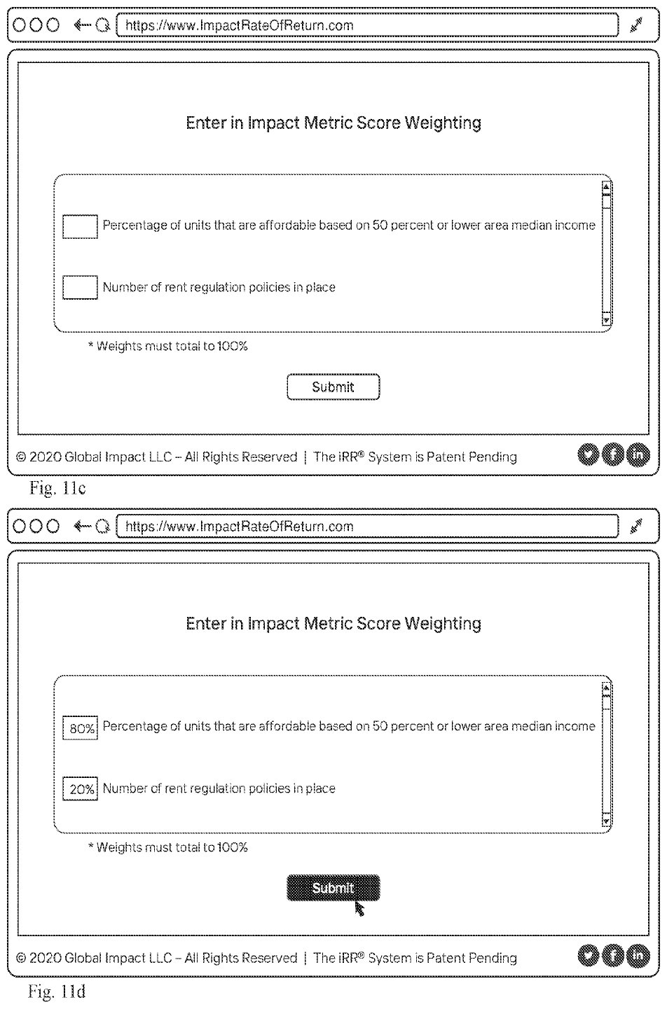

FIG. 11 represents a ninth method 1100 used by the system for assessing the impact value of money by calculating the iRR of an activity having input from a third party regarding the impact metric weight selection. The ninth method 1100 utilizes the algorithm of the method 100 and the system of FIG. 2. In 1102, a first computer system receives an iRR calculation input as described in 102 of FIG. 1.

In 1104, based upon the iRR calculation input, transmitting an impact theme selection output from the first computer system 202 to the second computer system 204 via the network 206 as described in 104 of FIG. 1.

In 1106, receiving an impact theme selection input, the impact theme selection input having been transmitted from the second computer system 204 to the first computer system 202 via the network 206 based upon the impact selection theme as described in 106 of FIG. 1.

In 1108, transmitting an impact area selection output to the second computer system 204 via the network 206 based upon the impact theme selection input in 1106, the impact area selection output is configured to display an impact area selection by the second computer system as described in 108 of FIG. 1.

In 1110, receiving an impact area selection input, the impact area selection input having been transmitted from the second computer system 204 to the first computer system 202 via the network 206 based upon the impact area selections as described in 110 of FIG. 1.

In 1112, transmitting an impact area sub-category selection output to the second computer system 204 via the network 206 based upon the impact area selection input in 1110, the impact area sub-category selection output is configured to display impact area sub-category selections by the second computer system 204 as described in 112 of FIG. 1.

In 1114, receiving an impact area sub-category selection input, the impact area sub-category selection input having been transmitted from the second computer system 204 to the first computer system 202 via the network 206 based upon the impact area sub-category selection as described in 114 of FIG. 1.

In 1116, transmitting a KII selection output to the second computer system 204 via the network 206 based upon the impact area selection input in 1110, the KII selection output configured to display a KIT selection output by the second computer system 204 as described in 116 of FIG. 1.

In 1118, receiving a KII selection input, the KII selection input having been transmitted from the second computer system 204 to the first computer system 202 via the network 206 based upon the KII selection as described in 118 of FIG. 1.

In 1120, transmitting an impact metric selection output to the second computer system 204 via the network 206 based upon the impact area sub-category selection input in 1114, the impact metric selection output configured to display an impact metric selection output by the second computer system 204 as described in FIG. 1.

In 1122, receiving an impact metric selection input, the impact metric selection input having been transmitted from the second computer system 204 to the first computer system 202 via the network 206 based upon the impact metric selection as described in 122 of FIG. 1.

In 1124, processing an impact metric value by the first computer system 202, as described in 124 of FIG. 1.

In 1128a, transmitting a survey request output to the second computer system 204 via the network 206, the survey request output configured to display a survey request by the second computer system 204, as represented in FIG. 11a. The survey output includes a selection of whether the impact metric score weighting will be sent to one or more third parties. The survey output includes entry of information (i.e. email) associated with the one or more other business entity users or third parties. The survey request output is further configured for display by the second computer system 204, such as on the webpage through drop down menu, blank text box, scrolling menu, box selection, or the like.

In 1128b, receiving a survey request input, the survey request input having been transmitted from the second computer system to the first computer system 202 via the network 206 based upon the survey request. The survey request is determined by the business entity user in response to its determination that one or more other business entity users or third parties has data (e.g. information relevant to how impact metrics should be weighted, a position of how impact metrics should be weighted) regarding the impact metric score weight, as represented in FIG. 11b. For example, the business entity user that is a foundation may determine “yes” that third parties that are community members have information (i.e. a position or opinion) as to how impact metrics should be weighted. Further, the survey request input includes the entry of information associated with the one or more third parties. The survey request input is configured for causing the survey request input to be stored in association with the activity by the first computer system 202.

In 1129a, based upon a “yes” survey request input and the information stored in 1128b, transmitting one or more third party survey output(s) to the third computer system 208 via the network 206, the third party survey output configured for display of impact metric weight selections, where the impact metric weights may be custom sub-weight entries as blank fields, as represented in FIG. 11c. The third party survey output is further configured for display by the third computer system 208, such as in an email or on a webpage through drop down menu, blank text box, scrolling menu, box selection, or the like.

In 1129b, receiving a third party survey input, the third party survey input having been transmitted from the third computer system 208 to the first computer system 202 via the network 206 based upon the impact metric weight selection. The third party survey input is determined by the third party in response to the weight the third party desires to assign to each of the at least one impact metrics. When the third party survey output is configured for custom sub-weight entry display, the third party survey input includes impact metric sub-weights determined by the third party, where the impact metric sub-weights must sum to 100%, as represented in FIG. 11d. The third party survey input is configured for causing the third party survey input comprising all of the impact metric sub-weights to be stored by the first computer system 202 in association with the corresponding impact metrics.

In 1130, based upon a “yes” selection stored in the survey request input of 1128b, processing an impact metric possible point value by the first computer system 202, where the impact metric possible point value is the product of the impact metric value and the respective impact metric sub-weights as stored in 1124 and 1129b respectively. When two or more impact metrics are stored as the impact metric selection, the impact metric possible point value includes impact metric possible point sub-values. Each of the two or more impact metrics has an impact metric possible point sub-value. The first computer system 202 processes the impact metric possible point sub-values by multiplying the corresponding impact metric sub-weights (as stored in 1129b) by the impact metric value (as stored in 1124), where the impact metric possible point value remains equal to 100. When two or more third party survey inputs are stored in 1129b, the processing includes averaging the impact metric possible point values, including the impact metric possible point sub-values, processed for each third party survey input stored. The processing further includes storing the impact metric possible point sub-values by the first computer system 202 in association with their corresponding impact metrics.

In 1130, based upon a “no” selection stored in the survey request input of 1128b, processing the impact metric possible point value by the first computer system 202, where the impact metric possible point value is the product of respective impact metric value stored in 1124 and an impact metric weight of 100%. The impact metric possible point value is equal to 100. When two or more impact metrics are stored as the impact metric selection, the impact metric possible point value includes impact metric possible point sub-values. Each of the two or more impact metrics has an impact metric possible point sub-value. The first computer system 202 processes the impact metric possible point sub-values by multiplying the corresponding impact metric sub-weights as determined on a pro rata basis of the impact metric weight by the impact metric value. For example, if the impact metric selection has two impact metrics, the first computer system 202 processes impact metric possible point sub-values by multiplying 100 (the impact metric value) by 50% (the impact metric sub-weights) to assign 50 points to each impact metric, where the impact metric possible point value remains equal to 100. The processing further includes storing the impact metric possible point value by the first computer system 202.

In 1132, transmitting an impact metric score range selection output to the second computer system 204 via the network 206 based upon the impact metric selection input in 1122, the impact metric score range selection output configured to display an impact metric score range selection output by the second computer system 204 as described in 132 of FIG. 1.

In 1134, receiving an impact metric score range selection input, the impact metric score range selection input having been transmitted from the second computer system 204 to the first computer system 202 via the network 206 based upon the impact metric score range selection as described in 134 of FIG. 1.

In 1136, transmitting an impact metric score selection output to the second computer system 204 via the network 206 based upon the impact metric score range selection input stored in 1134, the impact metric score selection output is configured to display an impact metric score selection output by the second computer system 204 as described in 136 of FIG. 1.

In 1138, receiving an impact metric score selection input, the impact metric score selection input having been transmitted from the second computer system 204 to the first computer system 202 via the network 206 based upon the impact metric score selection output in 1136 as described in 138 of FIG. 1.

In 1140, processing an impact metric score rate by the first computer system 202, where the impact metric score rate is associated with the respective impact metric score selection input stored in 1138 as described in 140 of FIG. 1.

In 1142, processing an impact metric point value by the first computer system 202, where the impact metric point value is associated with the respective impact metric possible point value stored in 1130 and the impact metric score rate stored in 1140 as described in 142 of FIG. 1.

In 1146, processing an impact multiplier value by the first computer system 202 as described in 146 of FIG. 1.

In 1148, transmitting an impact goal output to the second computer system 204 via the network 206 based upon the KII selection input and stored KII in the first computer system 202 from 1118 as described in 148 of FIG. 1.

In 1150, receiving an impact goal input from the second computer 204 via the network 206 as described in 150 of FIG. 1.

In 1152, transmitting a KII delivery output to the second computer system 204 via the network 206 based upon the KII selection input stored in the first computer system from 1118 as described in 152 of FIG. 1.

In 1154, receiving a KII delivery input from the second computer system 204 via the network 206 as described in 154 of FIG. 1.

In 1156, processing the impact quantity, based on the stored KII delivery from 1154 and the stored impact goal from 1150, by the first computer system 202 as described in 156 of FIG. 1.

In 1158, transmitting a time period output to the second computer system 204 from the first computer system 202 via the network 206 as described in 158 of FIG. 1.

In 1160, receiving a time period input from the second computer system 204 via the network 206 as described in 160 of FIG. 1.

In 1162, transmitting an activity cost output to the second computer system 204 from the first computer system 202 via the network 206 as described in 162 of FIG. 1.

In 1164, receiving an activity cost input from the second computer system 204 via the network 206 as described in 164 of FIG. 1.

In 1166, processing an impact efficiency based on the stored activity cost of 1164 and the stored KII delivery of 1154 by the first computer system 202 in accord with the algorithm as described in 166 of FIG. 1.

In 1168, processing the iRR by the first computer system 202 based on the stored impact multiplier value stored in 1146, the stored KII delivered stored in 1154, the stored time period stored in 1160, the stored impact quantity stored in 1156, and the stored impact efficiency stored in 1166 in accord with the algorithm as described in 1168 of FIG. 1.

In 1170, transmitting an iRR output to the second computer system 204 via the network 206 based on the stored iRR in 1168 as described in 170 of FIG. 1.

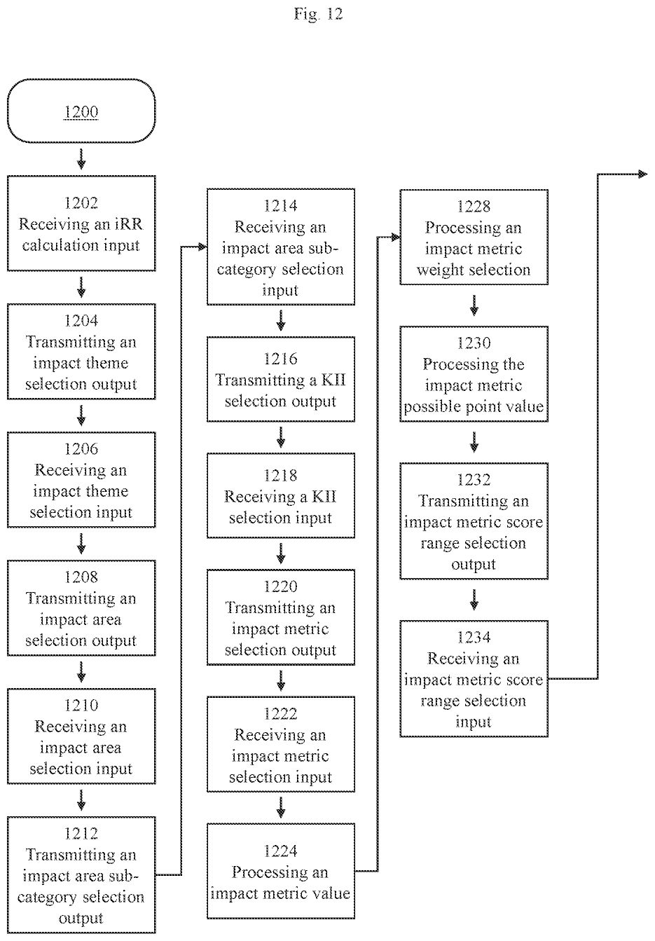

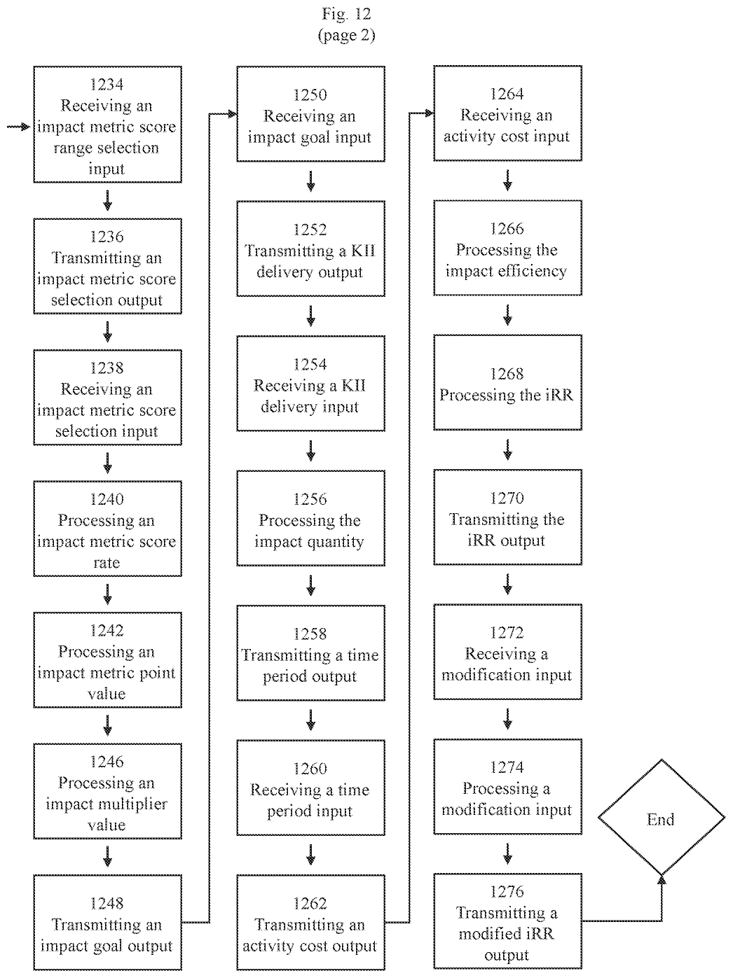

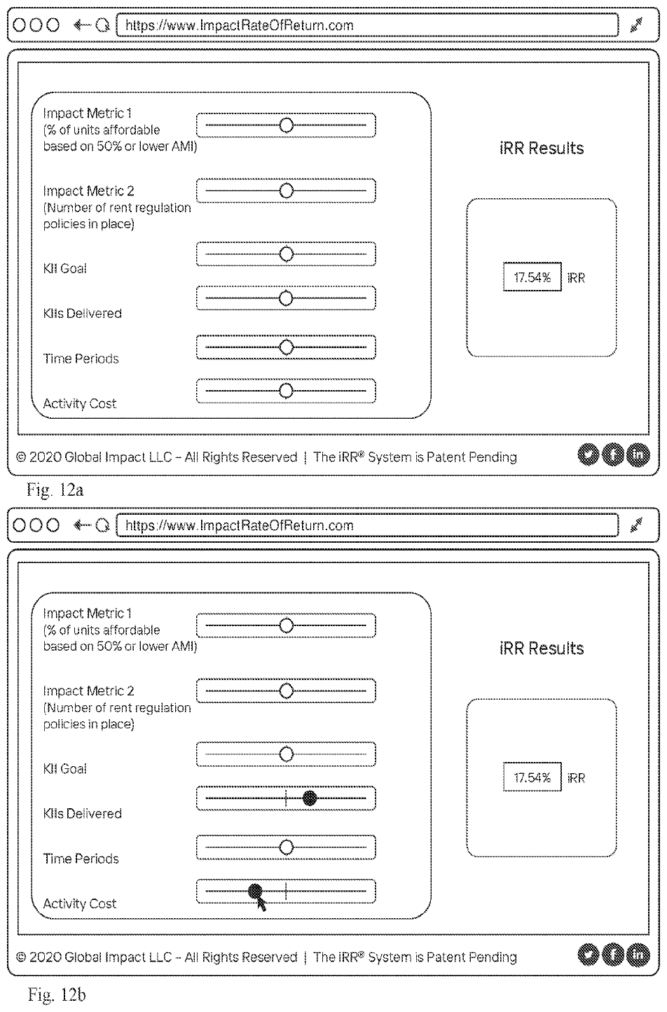

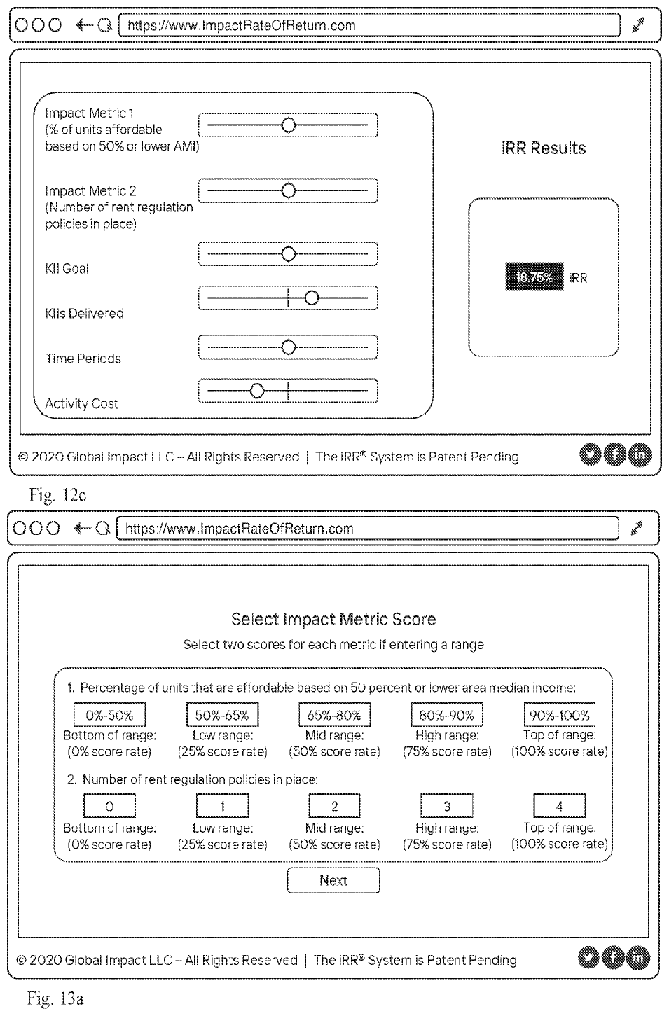

FIG. 12 represents a tenth method 1200 used by the system for assessing the impact value of money by calculating the iRR of an activity by allowing the business entity to determine variations in the iRR based upon changes in the qualitative and quantitative indicators of the iRR calculation. The tenth method 1200 utilizes the algorithm of the method 100 and the system of FIG. 2. In 1202, a first computer system receives an iRR calculation input as described in 102 of FIG. 1.

In 1204, based upon the iRR calculation input, transmitting an impact theme selection output from the first computer system 202 to the second computer system 204 via the network 206 as described in 104 of FIG. 1.

In 1206, receiving an impact theme selection input, the impact theme selection input having been transmitted from the second computer system 204 to the first computer system 202 via the network 206 based upon the impact selection theme as described in 106 of FIG. 1.

In 1208, transmitting an impact area selection output to the second computer system 204 via the network 206 based upon the impact theme selection input in 1206, the impact area selection output is configured to display an impact area selection by the second computer system as described in 108 of FIG. 1.

In 1210, receiving an impact area selection input, the impact area selection input having been transmitted from the second computer system 204 to the first computer system 202 via the network 206 based upon the impact area selections as described in 110 of FIG. 1.

In 1212, transmitting an impact area sub-category selection output to the second computer system 204 via the network 206 based upon the impact area selection input in 1210, the impact area sub-category selection output is configured to display impact area sub-category selections by the second computer system 204 as described in 112 of FIG. 1.

In 1214, receiving an impact area sub-category selection input, the impact area sub-category selection input having been transmitted from the second computer system 204 to the first computer system 202 via the network 206 based upon the impact area sub-category selection as described in 114 of FIG. 1.

In 1216, transmitting a KII selection output to the second computer system 204 via the network 206 based upon the impact area selection input in 1210, the KII selection output configured to display a KIT selection output by the second computer system 204 as described in 116 of FIG. 1.

In 1218, receiving a KII selection input, the KII selection input having been transmitted from the second computer system 204 to the first computer system 202 via the network 206 based upon the KII selection as described in 118 of FIG. 1.

In 1220, transmitting an impact metric selection output to the second computer system 204 via the network 206 based upon the impact area sub-category selection input in 1214, the impact metric selection output configured to display an impact metric selection output by the second computer system 204 as described in FIG. 1.

In 1222, receiving an impact metric selection input, the impact metric selection input having been transmitted from the second computer system 204 to the first computer system 202 via the network 206 based upon the impact metric selection as described in 122 of FIG. 1.

In 1224, processing an impact metric value by the first computer system 202, where the impact metric value is equal to 100, and where the impact metric value further includes sub-values as described in 124 of FIG. 1.

In 1228, processing an impact metric weight by the first computer system 202, where the impact metric weight is equal to 100%, and where the impact metric weight further includes sub-weights as described in 128 of FIG. 1.

In 1230, processing an impact metric possible point value by the first computer system 202, where the impact metric possible point value is the product of respective impact metric sub-values and the respective impact metric sub-weights as stored in 1224 and 1228 respectively, and as described in 130 of FIG. 1.

In 1232, transmitting an impact metric score range selection output to the second computer system 204 via the network 206 based upon the impact metric selection input in 1222, the impact metric score range selection output configured to display an impact metric score range selection output by the second computer system 204 as described in 132 of FIG. 1.

In 1234, receiving an impact metric score range selection input, the impact metric score range selection input having been transmitted from the second computer system 204 to the first computer system 202 via the network 206 based upon the impact metric score range selection as described in 134 of FIG. 1.

In 1236, transmitting an impact metric score selection output to the second computer system 204 via the network 206 based upon the impact metric score range selection input stored in 1234, the impact metric score selection output is configured to display an impact metric score selection output by the second computer system 204 as described in 136 of FIG. 1.

In 1238, receiving an impact metric score selection input, the impact metric score selection input having been transmitted from the second computer system 204 to the first computer system 202 via the network 206 based upon the impact metric score selection output in 1236 as described in 138 of FIG. 1.

In 1240, processing an impact metric score rate by the first computer system 202, where the impact metric score rate is associated with the respective impact metric score selection input stored in 1238 as described in 140 of FIG. 1.

In 1242, processing an impact metric point value by the first computer system 202, where the impact metric point value is associated with the respective impact metric possible point value stored in 1230 and the impact metric score rate stored in 1240 as described in 142 of FIG. 1.

In 1246, processing an impact multiplier value by the first computer system 202 as described in 146 of FIG. 1.

In 1248, transmitting an impact goal output to the second computer system 204 via the network 206 based upon the KII selection input and stored KII in the first computer system 202 from 1218 as described in 148 of FIG. 1.

In 1250, receiving an impact goal input from the second computer 204 via the network 206 as described in 150 of FIG. 1.

In 1252, transmitting a KII delivery output to the second computer system 204 via the network 206 based upon the KII selection input stored in the first computer system from 1218 as described in 152 of FIG. 1.

In 1254, receiving a KII delivery input from the second computer system 204 via the network 206 as described in 154 of FIG. 1.

In 1256, processing the impact quantity, based on the stored KII delivery from 1254 and the stored impact goal from 1250, by the first computer system 202 as described in 156 of FIG. 1.

In 1258, transmitting a time period output to the second computer system 204 from the first computer system 202 via the network 206 as described in 158 of FIG. 1.

In 1260, receiving a time period input from the second computer system 204 via the network 206 as described in 160 of FIG. 1.

In 1262, transmitting an activity cost output to the second computer system 204 from the first computer system 202 via the network 206 as described in 162 of FIG. 1.

In 1264, receiving an activity cost input from the second computer system 204 via the network 206 as described in 164 of FIG. 1.

In 1266, processing an impact efficiency based on the stored activity cost of 1264 and the stored KII delivery of 1254 by the first computer system 202 in accord with the algorithm as described in 166 of FIG. 1.

In 1268, processing the iRR by the first computer system 202 based on the stored impact multiplier value stored in 1246, the stored KII delivered stored in 1254, the stored time period stored in 1260, the stored impact quantity stored in 1256, and the stored impact efficiency stored in 1266 in accord with the algorithm as described in 168 of FIG. 1.

In 1270, transmitting an iRR output to the second computer system 204 via the network 206 based on the stored iRR in 1268 as described in 170 of FIG. 1. The iRR output may further be configured to display adjustable inputs such as sliding scales, dials, numeric values, combinations of the sliding scales, dials, or numeric values, or the like for each of the qualitative and quantitative indicators, as represented in FIG. 12a. For example, sliding scales may be displayed as centered for each of the associated qualitative and quantitative indicators representing the stored impact metric score selections, stored KII goal, stored KIIs delivered, stored time periods, and stored activity cost. The sliding scales may be modified by the business entity user, allowing the business entity user to see a modified iRR based on variations in the respective variables.

In 1272, receiving a modification input from the second computer system 204 via the network 206, based upon the modified adjustable inputs of the iRR output of 1270. The modification input is determined by the business entity user in response to inquiries the business entity user has regarding how the iRR is modified based on variations in the respective qualitative and quantitative indicators. For example, the business entity user may inquiry how the iRR will be modified based on a higher delivered KII and a lower activity cost. The modification input is configured to be stored in the first computer system 202, where each modified qualitative and quantitative indicator is stored as a modified qualitative and quantitative indicator in association with the stored qualitative and quantitative indicators (e.g. the modified delivered KII is stored as modified delivered KII in association with the stored delivered KII).

In 1274, processing a modification input based on the stored modified qualitative and quantitative indicators and the stored qualitative and quantitative indicators of 1272 by the first computer system 202 in accord with the algorithm to produce a modified iRR. For example, when a modified KII and modified activity cost are stored in 1272, the processing includes using the stored impact multiplier value stored in 1246, the modified KII delivered stored in 1272, the stored time period stored in 1260, processing a modified impact quantity based upon the modified KII delivered stored in 1272 and the stored impact goal of 1250, and processing a modified impact efficiency based upon the modified activity cost and modified KII delivered stored in 1272. The processing of the modified iRR is configured to store the modified iRR in the first computer system 202.

In 1276, transmitting a modified iRR output the second computer system 204 via the network 206 based on the stored modified iRR in 1274. The modified iRR output is configured to display the modified iRR on the second computer system 204, such as on the webpage, as represented in FIG. 12c. The iRR output may further be configured to display adjustable inputs for each of the qualitative and quantitative indicators as modified in the modification input of 1272. For example, the modified iRR may be increased from the iRR based upon the modified KII delivered and modified activity cost.

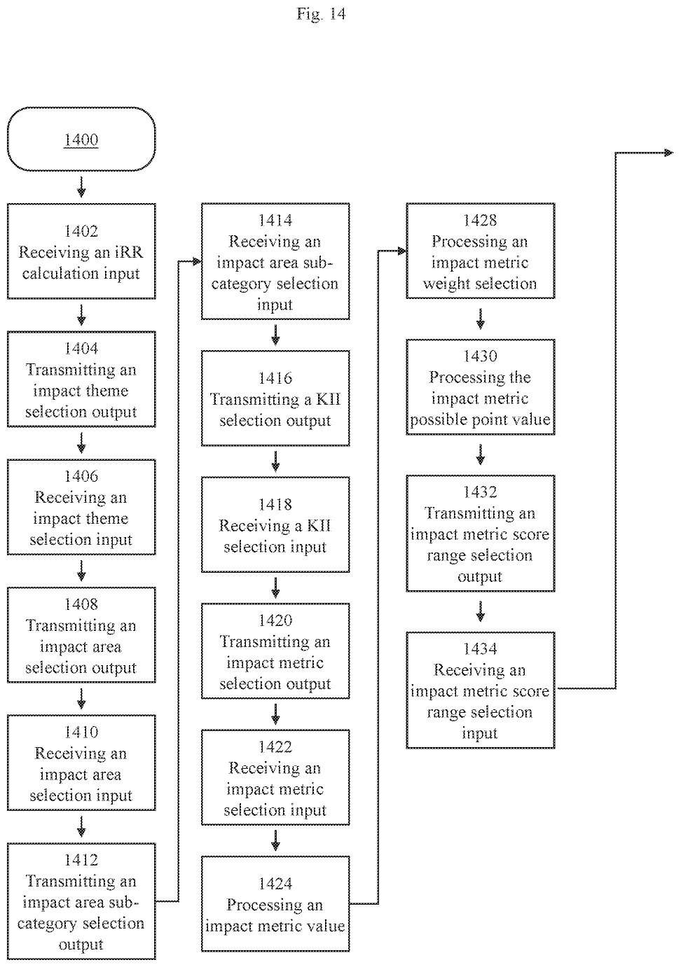

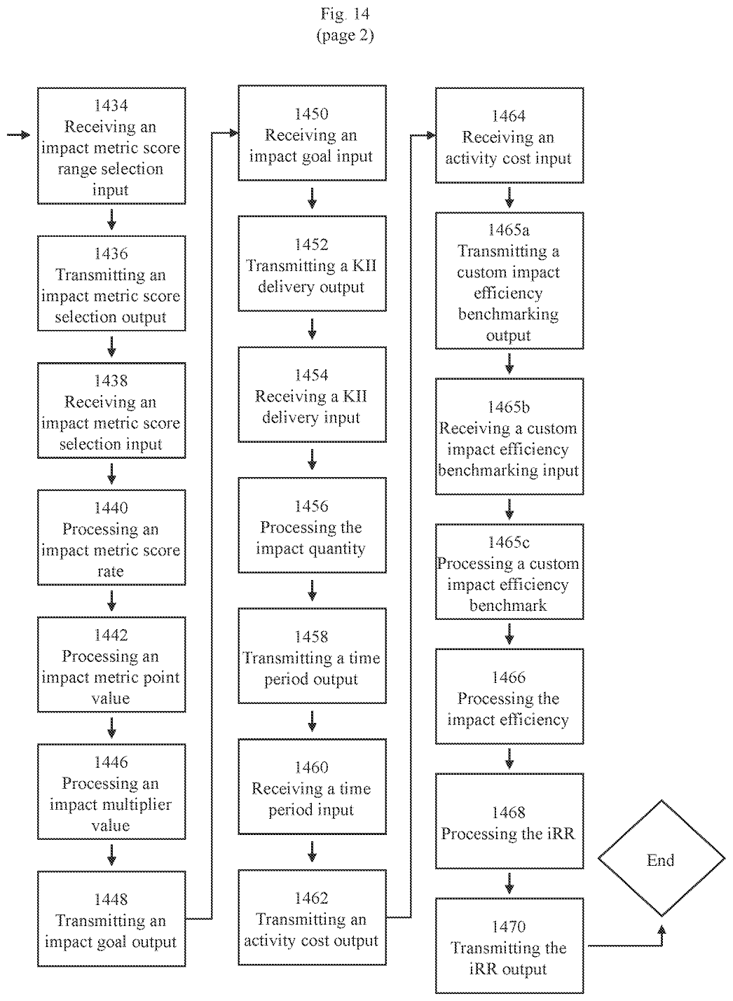

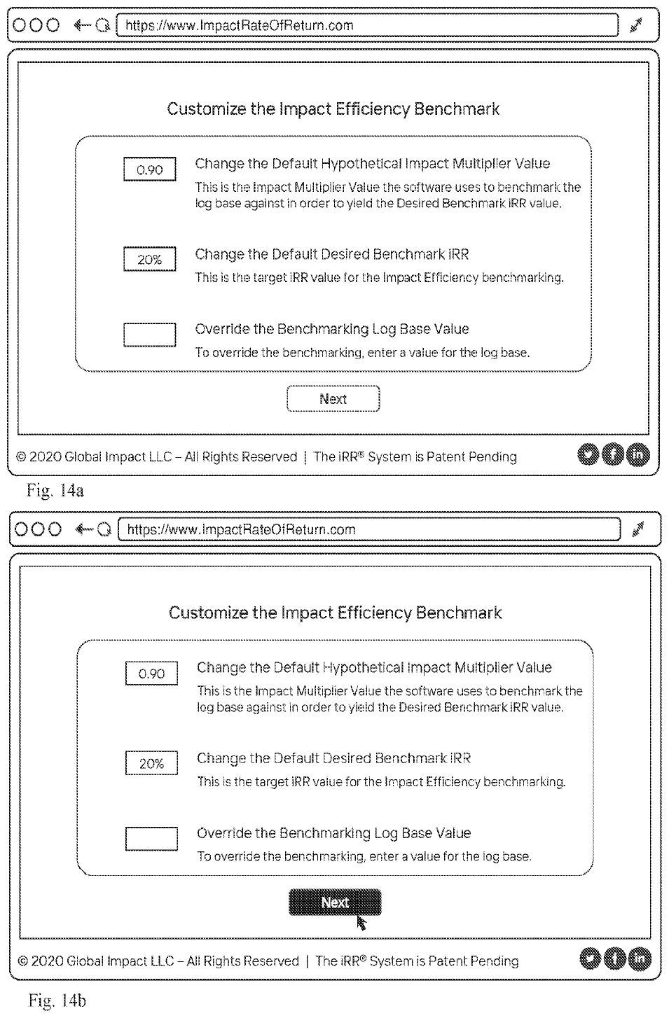

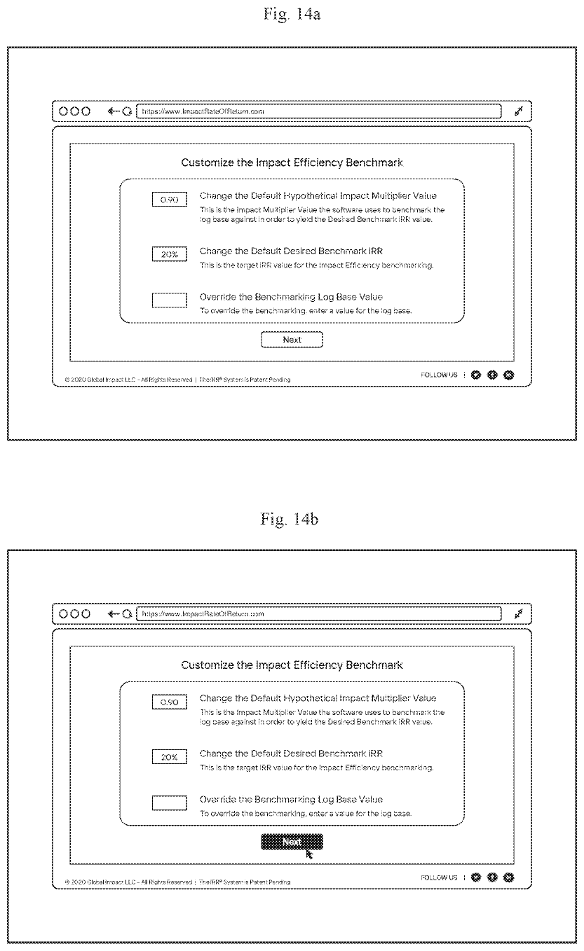

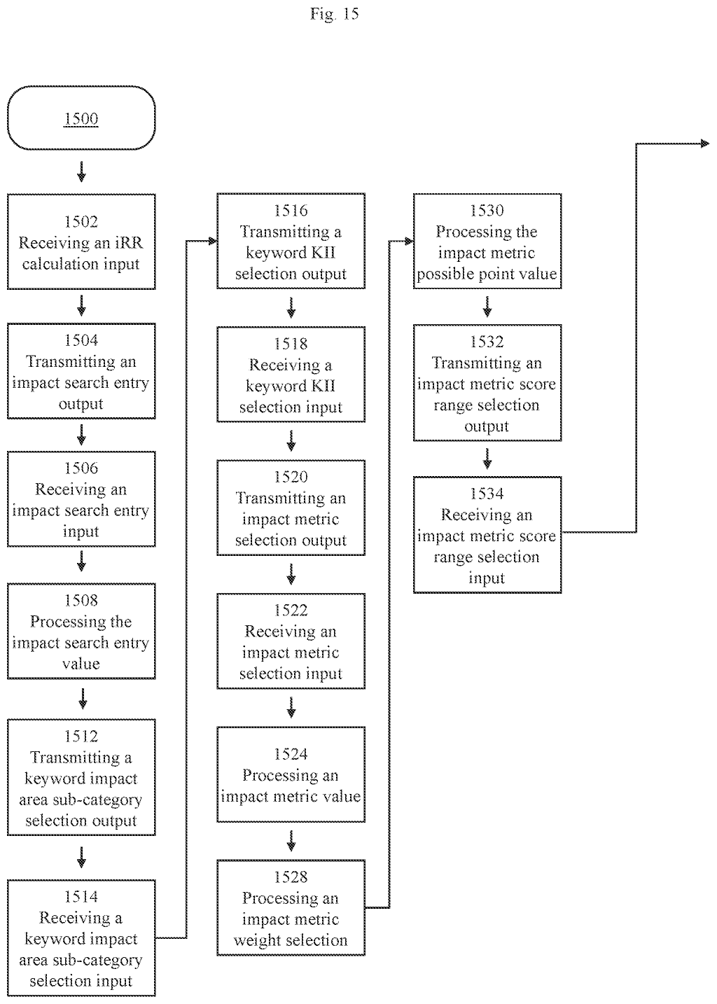

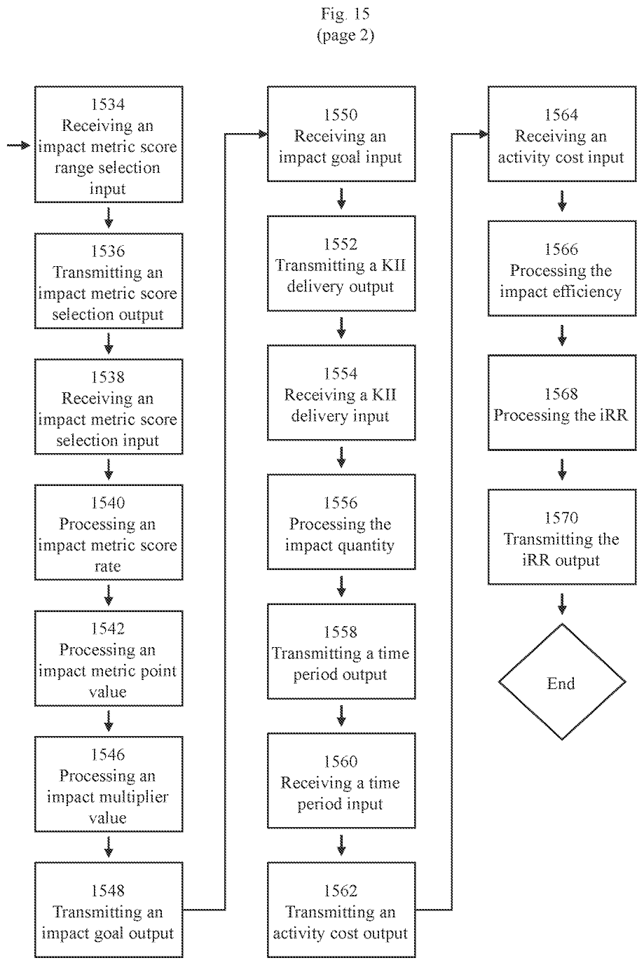

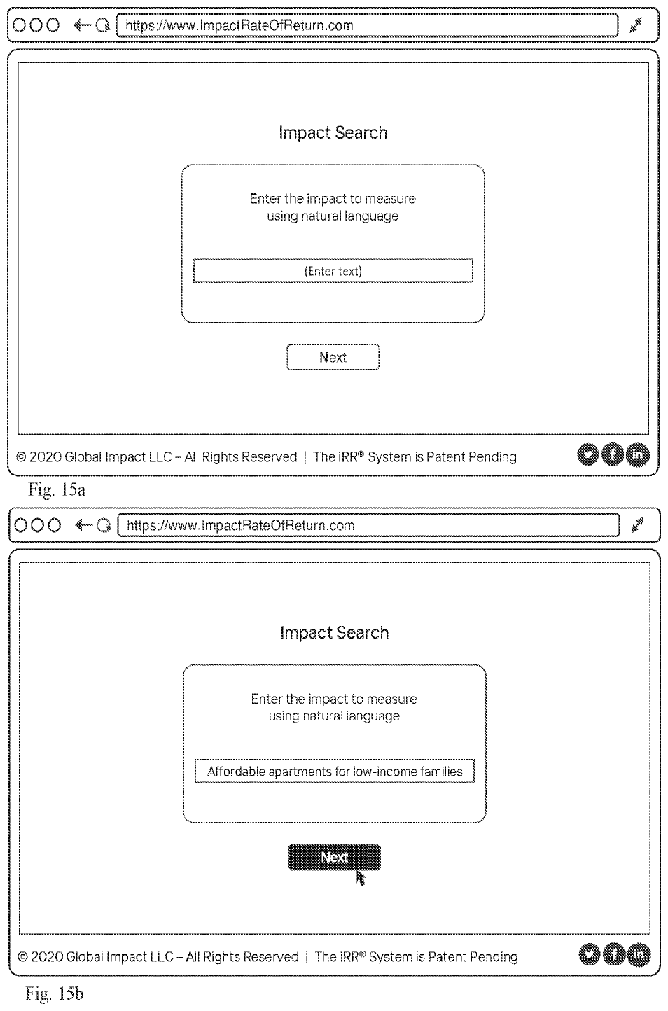

FIG. 14 represents an eleventh method 1400 used by the system for assessing the impact value of money by calculating the iRR of an activity having a custom benchmarked efficiency. The eleventh method 1400 utilizes the algorithm of the method 100 and the system of FIG. 2. In 1402, a first computer system receives an iRR calculation input as described in 102 of FIG. 1.

In 1404, based upon the iRR calculation input, transmitting an impact theme selection output from the first computer system 202 to the second computer system 204 via the network 206 as described in 104 of FIG. 1.

In 1406, receiving an impact theme selection input, the impact theme selection input having been transmitted from the second computer system 204 to the first computer system 202 via the network 206 based upon the impact selection theme as described in 106 of FIG. 1.

In 1408, transmitting an impact area selection output to the second computer system 204 via the network 206 based upon the impact theme selection input in 1406, the impact area selection output is configured to display an impact area selection by the second computer system as described in 108 of FIG. 1.

In 1410, receiving an impact area selection input, the impact area selection input having been transmitted from the second computer system 204 to the first computer system 202 via the network 206 based upon the impact area selections as described in 110 of FIG. 1.

In 1412, transmitting an impact area sub-category selection output to the second computer system 204 via the network 206 based upon the impact area selection input in 1410, the impact area sub-category selection output is configured to display impact area sub-category selections by the second computer system 204 as described in 112 of FIG. 1.

In 1414, receiving an impact area sub-category selection input, the impact area sub-category selection input having been transmitted from the second computer system 204 to the first computer system 202 via the network 206 based upon the impact area sub-category selection as described in 114 of FIG. 1.

In 1416, transmitting a KII selection output to the second computer system 204 via the network 206 based upon the impact area selection input in 1410, the KII selection output configured to display a KIT selection output by the second computer system 204 as described in 116 of FIG. 1.

In 1418, receiving a KII selection input, the KII selection input having been transmitted from the second computer system 204 to the first computer system 202 via the network 206 based upon the KII selection as described in 118 of FIG. 1.

In 1420, transmitting an impact metric selection output to the second computer system 204 via the network 206 based upon the impact area sub-category selection input in 1414, the impact metric selection output configured to display an impact metric selection output by the second computer system 204 as described in 120 of FIG. 1.

In 1422, receiving an impact metric selection input, the impact metric selection input having been transmitted from the second computer system 204 to the first computer system 202 via the network 206 based upon the impact metric selection as described in 122 of FIG. 1.

In 1424, processing an impact metric value by the first computer system 202 as described in 124 of FIG. 1.

In 1428, processing an impact metric weight by the first computer system 202 as described in 128 of FIG. 1.

In 1430, processing an impact metric possible point value by the first computer system 202 as described in 130 of FIG. 1.

In 1432, transmitting an impact metric score range selection output to the second computer system 204 via the network 206 based upon the impact metric selection input in 1422, the impact metric score range selection output configured to display an impact metric score range selection output by the second computer system 204 as described in 132 of FIG. 1.

In 1434, receiving an impact metric score range selection input, the impact metric score range selection input having been transmitted from the second computer system 204 to the first computer system 202 via the network 206 based upon the impact metric score range selection as described in 134 of FIG. 1.

In 1436, transmitting an impact metric score selection output to the second computer system 204 via the network 206 based upon the impact metric score range selection input stored in 1434, the impact metric score selection output is configured to display an impact metric score selection output by the second computer system 204 as described in 136 of FIG. 1.

In 1438, receiving an impact metric score selection input, the impact metric score selection input having been transmitted from the second computer system 204 to the first computer system 202 via the network 206 based upon the impact metric score selection output in 1436 as described in 138 of FIG. 1.

In 1440, processing an impact metric score rate by the first computer system 202, where the impact metric score rate is associated with the respective impact metric score selection input stored in 1438 as described in 140 of FIG. 1.

In 1442, processing an impact metric point value by the first computer system 202, where the impact metric point value is associated with the respective impact metric possible point value stored in 1430 and the impact metric score rate stored in 1440 as described in 142 of FIG. 1.

In 1446, processing an impact multiplier value by the first computer system 202 as described in 146 of FIG. 1.

In 1448, transmitting an impact goal output to the second computer system 204 via the network 206 based upon the KII selection input and stored KII in the first computer system 202 from 1418 as described in 148 of FIG. 1.

In 1450, receiving an impact goal input from the second computer 204 via the network 206 as described in 150 of FIG. 1.

In 1452, transmitting a KII delivery output to the second computer system 204 via the network 206 based upon the KII selection input stored in the first computer system from 1418 as described in 152 of FIG. 1.

In 1454, receiving a KII delivery input from the second computer system 204 via the network 206 as described in 154 of FIG. 1.

In 1456, processing the impact quantity, based on the stored KII delivery from 1454 and the stored impact goal from 1450, by the first computer system 202 as described in 156 of FIG. 1.

In 1458, transmitting a time period output to the second computer system 204 from the first computer system 202 via the network 206 as described in 158 of FIG. 1.

In 1460, receiving a time period input from the second computer system 204 via the network 206 as described in 160 of FIG. 1.

In 1462, transmitting an activity cost output to the second computer system 204 from the first computer system 202 via the network 206 as described in 162 of FIG. 1.

In 1464, receiving an activity cost input from the second computer system 204 via the network 206 as described in 164 of FIG. 1.

In 1465a, transmitting a custom impact efficiency benchmarking output, to the second computer system 204 from the first computer system 202 via the network 206, the custom impact efficiency benchmarking output configured to display a custom impact efficiency benchmarking selection output by the second computer system 204, as represented in FIG. 1465a. The custom impact efficiency benchmarking output includes selections for changing the benchmarking of the impact efficiency via selection of a default hypothetical impact multiplier value or default desired benchmark iRR. For example, the business entity user may increase or decrease the default hypothetical benchmarking impact multiplier value or the desired benchmarking iRR. The custom impact efficiency benchmarking may further include a selection for the business entity user to override the benchmarked log base value by entering a desired log base for processing an impact efficiency that is used in lieu of a benchmarked log base value (an override log base value). The custom impact efficiency benchmarking output is further configured for display by the second computer system 204, such as on the webpage through drop down menu, blank text box, scrolling menu, box selection, or the like.

In 1465b, receiving a custom impact efficiency benchmarking input, the custom impact efficiency benchmarking input having been transmitted from the second computer system 204 to the first computer system 202 via the network 206 based upon the custom impact efficiency benchmarking selection as represented in FIG. 1465b. The custom impact efficiency benchmarking is determined by the business entity user in response to a desired benchmarking level. The business entity user enters a custom impact efficiency benchmarking based upon historical data, industry knowledge, expert consultation, or a combination of the same. The custom impact efficiency benchmarking selection input is configured for causing the selected custom impact efficiency benchmarking to be stored by the first computer system 202.

In 1465c, processing a custom impact efficiency benchmark to determine the log base value for processing the impact efficiency by using the selected custom impact efficiency benchmarking stored in 1465b as described in 166 of FIG. 1. When the selected custom impact efficiency benchmarking stored in 1465b includes an override log base value the processing is configured to store the override log base value as the log base value for calculation of the impact efficiency.

In 1466, processing an impact efficiency based on the stored activity cost of 1464, the stored KII delivery of 1454, and the stored log base value of 1465c by the first computer system 202 in accord with the algorithm as described in 166 of FIG. 1.

In 1468, processing the iRR by the first computer system 202 based on the stored impact multiplier value stored in 1446, the stored KII delivered stored in 1454, the stored time period stored in 1460, the stored impact quantity stored in 1456, and the stored impact efficiency stored in 1466 in accord with the algorithm as described in 168 of FIG. 1.

In 1470, transmitting an iRR output to the second computer system 204 via the network 206 based on the stored iRR in 1468 as described in 170 of FIG. 1.

FIG. 15 represents a twelfth method 1500 used by the system for assessing the impact value of money by calculating the iRR of an activity where a user may search for the type of impact delivered in association with an activity. The twelfth method 1500 utilizes the algorithm of the method 100 and the system of FIG. 2. In 1502, a first computer system receives an iRR calculation input as described in 102 of FIG. 1.

In 1504, based upon the iRR calculation input, transmitting an impact search entry output from the first computer system 202 to the second computer system 204 via the network 206. The impact search entry output is configured to display an impact search entry having a search query by the second computer system 204, as represented in FIG. 15a. The impact search entry output is further configured for display by the second computer system 204, such as on the webpage through drop down menu, blank text box, scrolling menu, box selection, or the like.

In 1506, receiving an impact search entry input, the impact search entry input having been transmitted from the second computer system 204 to the first computer system 202 via the network 206 based upon the impact search entry. The search query of the impact search entry is determined by the business entity user in response to the manner in which impact is delivered in connection with the activity, as represented in FIG. 15b. The business entity user enters a search query associated with the activity. For example, the business entity user may enter the search query “affordable apartments for low-income families”. The impact search entry input is configured for causing the impact search entry to be stored by the first computer system 202.

In 1508, processing the impact search entry by the first computer system 202, where the impact search entry contains one or more words that relate to impact area sub-categories (impact keywords), and one or more words the relate to KIIs (KII keywords). The processing is configured for associating impact keywords with impact area sub-categories. The association of the impact keywords with impact area sub-categories, and the subsequent display, allows the business entity user to quickly and accurately identify the impact area sub-category associated with the activity without identifying the precise impact area sub-category. The use of a search query to identify the impact area sub-category quickly narrows the impact area sub-categories to those relevant categories for selection. The impact keywords may be available for each associated impact search entry as associated with corresponding impact area sub-categories, as shown in FIG. 16.

The processing is further configured for assigning the stored impact search entry to the one or more associated impact keywords. The processing is further configured for assigning the one or more impact keywords to the one or more associated impact area sub-categories. The processing further includes storing the one or more associated impact area sub-categories by the first computer system 202. The processing is further configured such that if the impact search entry contains no impact keywords associated with an impact area sub-category, all impact area sub-categories are stored by the first computer system 202.

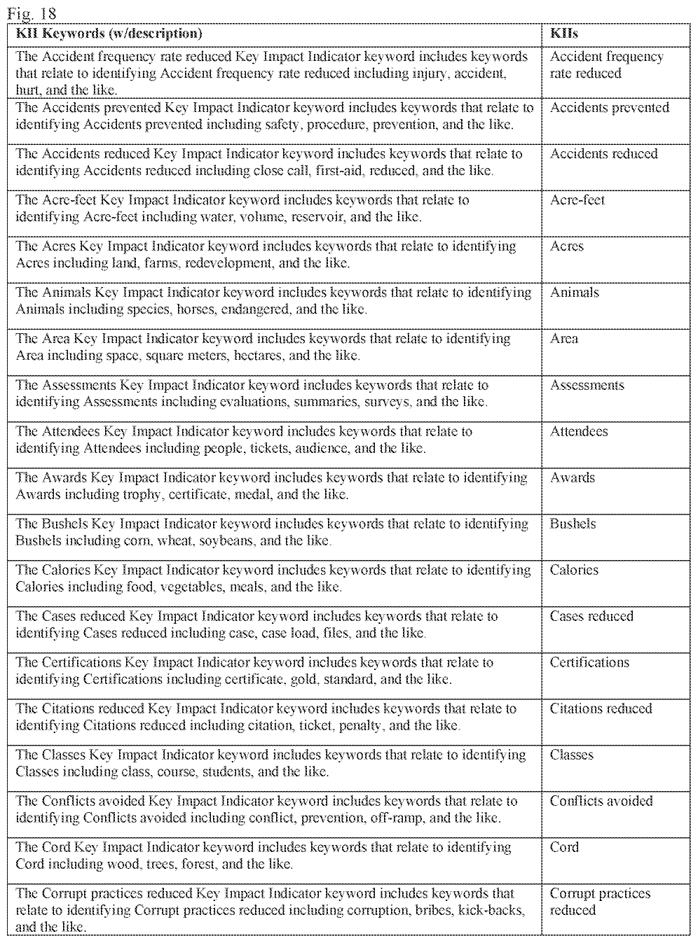

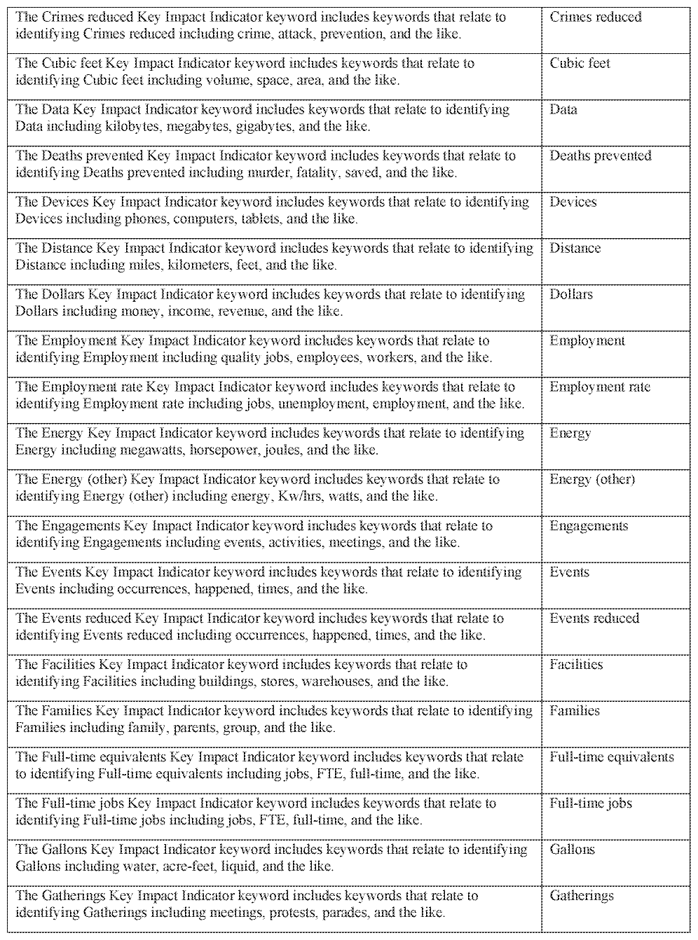

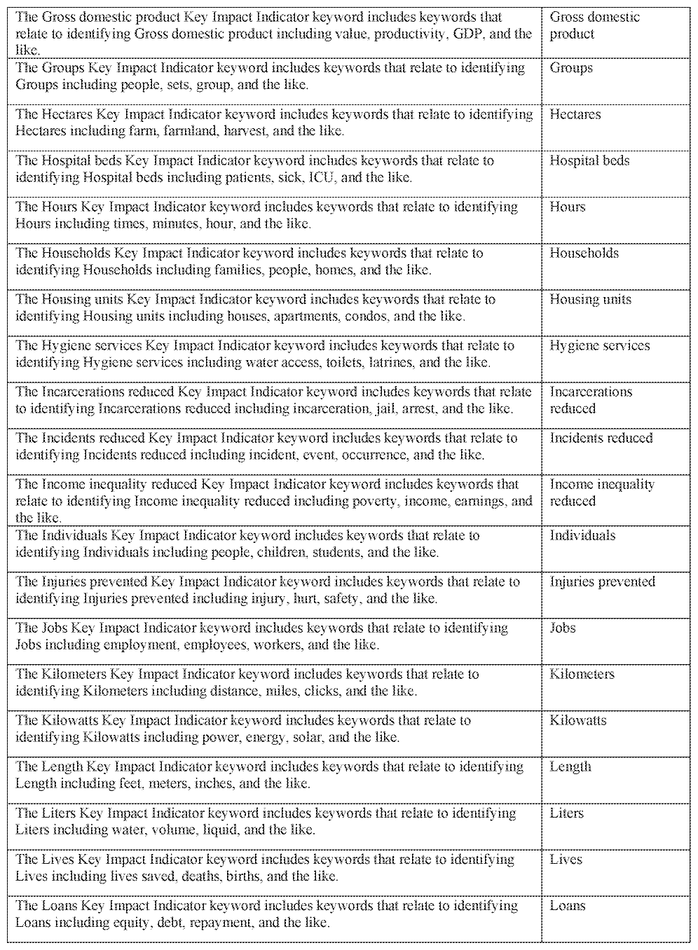

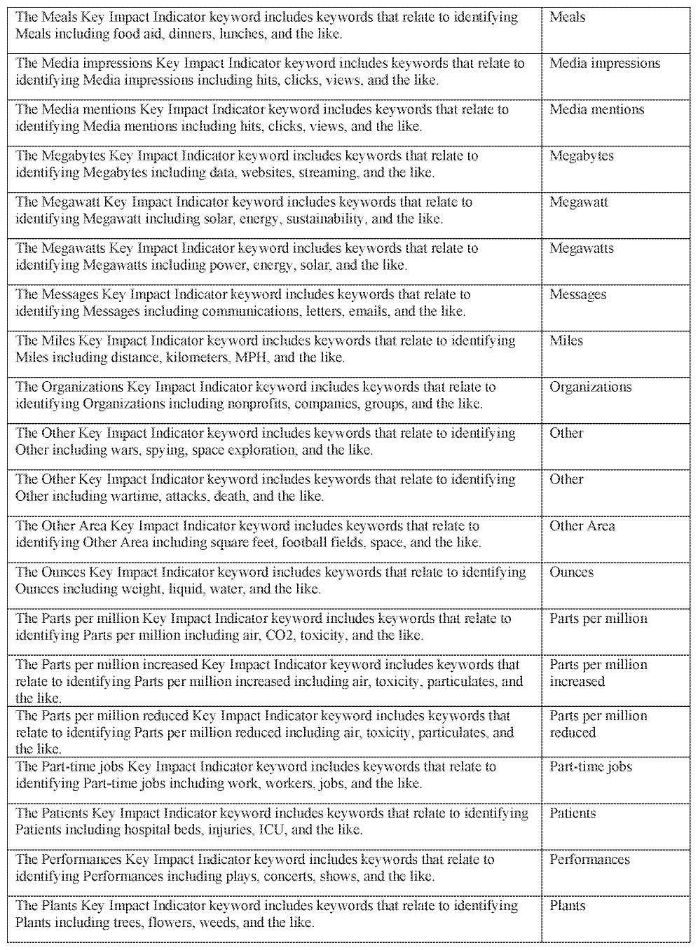

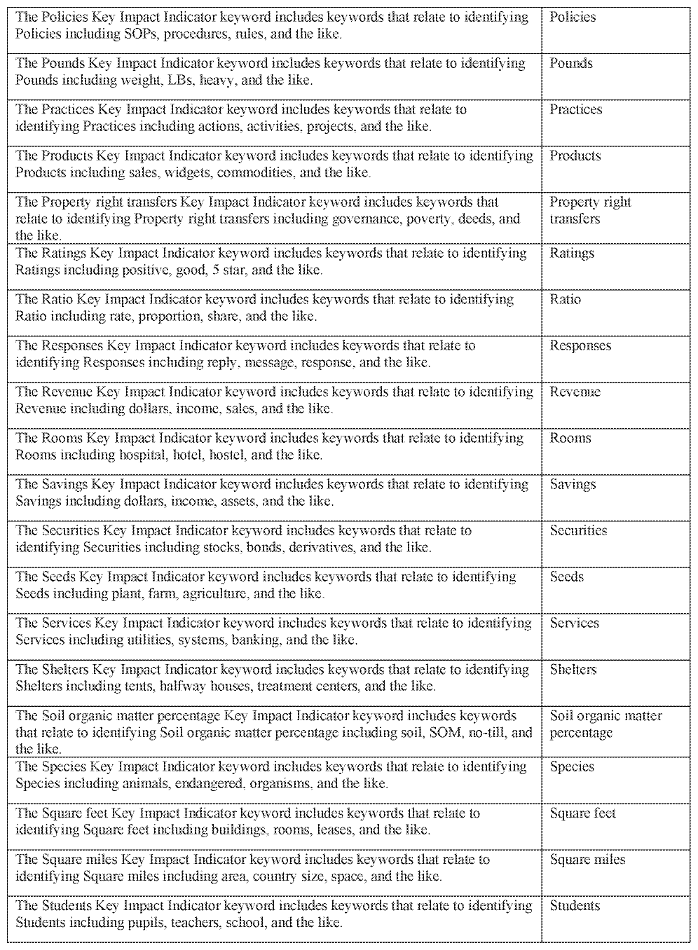

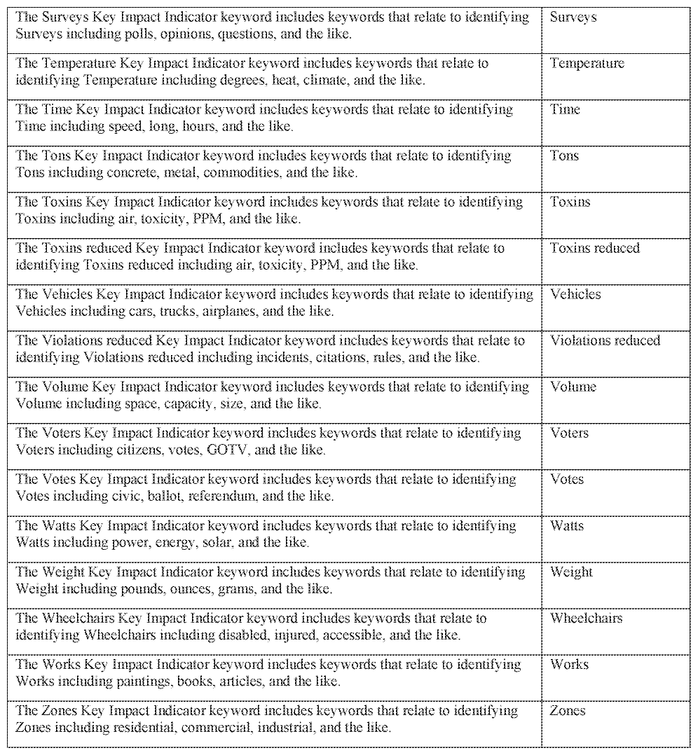

The processing may further be configured for associating KII keywords with KIIs. The association of KII keywords with KIIs, and the subsequent display, allows the business entity user to quickly and accurately identify the KII associated with the activity without identifying the precise KII. The use of a search query to identify the KII quickly narrows the KIIs to those relevant for selection. The KII keywords may be available for each associated impact search entry as associated with corresponding KIIs, as shown in FIG. 18.

The processing is further configured for assigning the stored impact search entry to the one or more associated KII keywords. The processing further includes storing the one or more associated KIIs by the first computer system 202. The processing is further configured such that if the impact search entry contains no KII keywords associated with a KII, all KIIs are stored by the first computer system 202.

The processing may be configured to use natural language processing (e.g. the first computer system 202 process the impact search entry by analyzing natural language data using neural networks employing machine learning) or semantic search (e.g. the first computer system 202 processes the impact search entry to create associations with relevant impact area sub-categories and KIIs using a machine learning or rules-based approach to parse the impact search entry) to associate the impact search entry with impact area sub-categories and KIIs as described in Yunyao Li, Davood Rafiei, Natural Language Data Management and Interfaces (2018).

In 1512, transmitting a keyword impact area sub-category selection output to the second computer system 204 via the network 206 based upon the impact search entry processed in 1508, the keyword impact area sub-category selection output is configured to display stored impact area sub-categories associated with the impact keywords of the impact search entry by the second computer system 204 as described in 112 of FIG. 1.

In 1514, receiving a keyword impact area sub-category selection input, the keyword impact area sub-category selection input having been transmitted from the second computer system 204 to the first computer system 202 via the network 206 based upon the impact area sub-category selection as described in 114 of FIG. 1.

In 1516, transmitting a keyword KII selection output to the second computer system 204 via the network 206 based upon the impact search entry processed in 1508, the keyword KII selection output is configured to display KIIs associated with the KII keywords of the impact search entry by the second computer system 204 as described in 116 of FIG. 1.

In 1518, receiving a keyword KII selection input, the keyword KII selection input having been transmitted from the second computer system 204 to the first computer system 202 via the network 206 based upon the KII selection as described in 410 of FIG. 4.

In 1520, transmitting an impact metric selection output to the second computer system 204 via the network 206 based upon the impact area sub-category selection input in 1514, the impact metric selection output configured to display an impact metric selection output by the second computer system 204 as described in 120 of FIG. 1.

In 1522, receiving an impact metric selection input, the impact metric selection input having been transmitted from the second computer system 204 to the first computer system 202 via the network 206 based upon the impact metric selection as described in 122 of FIG. 1.

In 1524, processing an impact metric value by the first computer system 202 as described in 124 of FIG. 1.

In 1528, processing an impact metric weight by the first computer system 202 as described in 128 of FIG. 1.

In 1530, processing an impact metric possible point value by the first computer system 202 as described in 130 of FIG. 1.

In 1532, transmitting an impact metric score range selection output to the second computer system 204 via the network 206 based upon the impact metric selection input in 1522, the impact metric score range selection output configured to display an impact metric score range selection output by the second computer system 204 as described in 132 of FIG. 1.

In 1534, receiving an impact metric score range selection input, the impact metric score range selection input having been transmitted from the second computer system 204 to the first computer system 202 via the network 206 based upon the impact metric score range selection as described in 134 of FIG. 1.

In 1536, transmitting an impact metric score selection output to the second computer system 204 via the network 206 based upon the impact metric score range selection input stored in 1534, the impact metric score selection output is configured to display an impact metric score selection output by the second computer system 204 as described in 136 of FIG. 1.

In 1538, receiving an impact metric score selection input, the impact metric score selection input having been transmitted from the second computer system 204 to the first computer system 202 via the network 206 based upon the impact metric score selection output in 1536 as described in 138 of FIG. 1.

In 1540, processing an impact metric score rate by the first computer system 202, where the impact metric score rate is associated with the respective impact metric score selection input stored in 1538 as described in 140 of FIG. 1.

In 1542, processing an impact metric point value by the first computer system 202, where the impact metric point value is associated with the respective impact metric possible point value stored in 1530 and the impact metric score rate stored in 1540 as described in 142 of FIG. 1.

In 1546, processing an impact multiplier value by the first computer system 202 as described in 146 of FIG. 1.

In 1548, transmitting an impact goal output to the second computer system 204 via the network 206 based upon the KII selection input and stored KII in the first computer system 202 from 1518 as described in 148 of FIG. 1.

In 1550, receiving an impact goal input from the second computer 204 via the network 206 as described in 150 of FIG. 1.

In 1552, transmitting a KII delivery output to the second computer system 204 via the network 206 based upon the KII selection input stored in the first computer system from 1518 as described in 152 of FIG. 1.

In 1554, receiving a KII delivery input from the second computer system 204 via the network 206 as described in 154 of FIG. 1.

In 1556, processing the impact quantity, based on the stored KII delivery from 1554 and the stored impact goal from 1550, by the first computer system 202 as described in 156 of FIG. 1.

In 1558, transmitting a time period output to the second computer system 204 from the first computer system 202 via the network 206 as described in 158 of FIG. 1.

In 1560, receiving a time period input from the second computer system 204 via the network 206 as described in 160 of FIG. 1.

In 1562, transmitting an activity cost output to the second computer system 204 from the first computer system 202 via the network 206 as described in 162 of FIG. 1.

In 1564, receiving an activity cost input from the second computer system 204 via the network 206 as described in 164 of FIG. 1.

In 1566, processing an impact efficiency based on the stored activity cost of 1564 and the stored KII delivery of 1554 by the first computer system 202 in accord with the algorithm as described in 166 of FIG. 1.

In 1568, processing the iRR by the first computer system 202 based on the stored impact multiplier value stored in 1546, the stored KII delivered stored in 1554, the stored time period stored in 1560, the stored impact quantity stored in 1556, and the stored impact efficiency stored in 1566 in accord with the algorithm as described in 168 of FIG. 1.

In 1570, transmitting an iRR output to the second computer system 204 via the network 206 based on the stored iRR in 1568 as described in 170 of FIG. 1.

In aspects, the first computer system 202 may implement pre-determined selections of the impact theme, impact area, impact area sub-category, KII selection, impact metric selection, and impact metric score range selection stored in the first computer system 202, as well as the processed impact metric value, impact metric weight, and impact metric possible point value that are also stored in the first computer system 202. This storage of pre-determined selections may be stored by the system as a template for conducting an iRR calculation. Storing the foregoing values for iRR calculations is previously discussed with respect to methods 800 and 900, and creation of templates is inherent to these stored values.

In such aspects a user of the second computer system in connection with the iRR calculation input request as described in 102 of FIG. 1, further selects a template stored by the first computer system 102. Upon selection of a template, the first and second computer systems then conducts the iRR calculation as described in steps 136-170 of FIG. 1 utilizing the stored impact theme, impact area, impact area sub-category, KII selection, impact metric selection, and impact metric score range selection, and the stored processed impact metric value, impact metric weight selection, and impact metric possible point value.

It is to be understood that the present disclosure may be conveniently implemented in forms of a software package. Such a software package may be a computer program product which employs a non-transitory computer-readable storage medium including stored computer code which is used to program a computer to perform the disclosed function and process of the present disclosure. The non-transitory computer-readable medium may include, but is not limited to, any type of conventional floppy disk, optical disk, CD-ROM, magnetic disk, hard disk drive, magneto-optical disk, ROM, RAM, EPROM, EEPROM, magnetic or optical card, or any other suitable non-transitory media for storing electronic instructions.

Further disclosure is provided in the statements below:

Statement 1: A computer-implemented method for quantitatively calculating an impact rate of return (iRR) of an activity via a computer network, the method comprising:
receiving an iRR calculation input at a first computer system, the iRR calculation input having been transmitted via the computer network from a second computer system, the iRR calculation input comprising a request to begin calculation of the iRR, the first computer system being associated with a service provider, the second computer system being associated with an entity;
transmitting a plurality of selection outputs from the first computer system to the second computer system via the computer network, each of the selection outputs being configured to cause a respective selection to be provided to the second computer system, wherein
providing each respective selection includes causing a webpage having the respective selection to be displayed via a display of the second computer system, the webpage being associated with a website of the service provider;
receiving a plurality of selection inputs at the first computer system, the each of the selection inputs being associated with a respective one of the selections provided to the second computer system and each of the selection inputs having been transmitted from the second computer system to the first computer system via the computer network, each of the selection inputs comprising a selected option and storing the selected option by the first computer system;
processing the selected options by the first computer system to determine the iRR associated with the activity, storing the iRR associated with the activity by the first computer system; and
based upon the stored iRR, transmitting an iRR output to the second computer system via the computer network, the iRR output configured to cause the stored iRR to be provided to the second computer system, wherein
providing the stored iRR includes causing the webpage having the stored iRR to be displayed via the display of the second computer system.

The method of statement 1 may provide the technical effect of improving the computer-implemented method. By providing the processing steps on the first computer system, the processing may be separated from the selection taking place on the second computer system. This leads to a modular system in which the first (central) computer system may provide processing for many other (second) computer systems via the computer network. However, the processing may remain easily modifiable as the processing steps all take place at the central (first) computer system. As such, the computer-implemented method of statement 1 may be easily modifiable and can be updated readily while being utilizable by many second computer systems.

Statement 2: The computer-implemented method of statement 1, wherein processing the selected options includes calculating the following algorithm:

$$f ( M ) = \{ \begin{matrix}- \frac{\frac{K}{G} ⋁ {Log}_{b} K ⋁ K}{( 1 - \vert M ⋁ \frac{{\sum }_{i = 1}^{N} {Q}_{i}}{100} \vert ) \times ( {Log}_{b} \frac{C}{K} ) \times T} & - 1 < M < 0 \\ \frac{\frac{K}{G} ⋁ {Log}_{b} K ⋁ K}{( 1 - M ⋁ \frac{{\sum }_{i = 1}^{N} {Q}_{i}}{100} ) \times ( {Log}_{b} \frac{C}{K} ) \times T} & 0 \leq M < 1\end{matrix}$$

where

$$\frac{K}{G} ⋁ {Log}_{b} K ⋁ K$$

is an impact quantity of the activity,

where

$$M ⋁ \frac{{\sum }_{i = 1}^{N} {Q}_{i}}{100}$$

is an impact multiplier value of the activity,

where

$${Log}_{b} \frac{C}{K}$$

is an impact efficiency of the activity, such that

$$0 < {Log}_{b} \frac{C}{K} ,$$

where T is a time period of the activity, such that 0<T, T∈ [symbol] ,

where K is a number of key impact indicator units, KII, of the activity,

where G is an impact goal of the entity expressed in terms of K,

where b is a base of a logarithmic function, such that 1<b, b∈ [symbol] ,

where M is an impact multiplier value of the activity, such that −1<M<1, M∈ [symbol] ,

where i is an impact metric point value, Q is a set of the impact metric point values and N is a number of values in the set Q,

where C is a cost of the activity, and

where V is the operator “or”.

Statement 3: The computer-implemented method of statement 1 or 2, wherein the selection outputs, respective selections, associated selection inputs, and respective selected options comprise:
an impact theme selection output, an impact theme selection, an impact theme selection input and a selected impact theme, and/or
an impact area selection output, an impact area selection, an impact area selection input and a selected impact area, and/or
an impact area sub-category selection output, an impact area sub-category selection, an impact area sub-category selection input, a selected impact area sub-category, and/or
a KII selection output, a KII selection, a KII selection input, and a selected KII, and/or,
an impact metric selection output, an impact metric selection, an impact metric selection input, and a selected impact metric, and/or,
an impact metric score range selection output, an impact metric score range selection, an impact metric score range selection input, and a selected impact metric score range, and/or,
an impact metric score selection output, an impact metric score selection, an impact metric score selection input, and a selected impact metric score, and/or,
an impact goal selection output, an impact goal selection, an impact goal selection input, and a selected impact goal, and/or,
a KII delivery selection output, a KII delivery selection, a KII delivery selection input, and a selected KII delivery, and/or,
a time period selection output, a time period selection, a time period selection input, and a selected time period, and/or,
an activity cost selection output, an activity cost selection, an activity cost an activity cost selection input, and a selected activity cost.

Statement 4: The computer-implemented method of statement 3, wherein
the impact area selection output is transmitted based on the stored selected impact theme, and/or
the impact area sub-category selection output is transmitted based on the stored selected impact area, and/or
the KII selection output is transmitted based on the stored selected impact area, and/or
the impact metric selection output is transmitted based on the stored selected impact area sub-category, and/or
the impact metric score range selection output is transmitted based on the stored selected impact metrics, and/or
the impact metric score selection output is transmitted based on the stored impact metric score range, and/or
the impact goal output is transmitted based on the stored selected KII, and/or
the KII delivery output is transmitted based on the stored selected KII.

The method of statement 4 may provide the technical effect of improving the computer-implemented method. By basing the transmission of the selection outputs on relevant stored values, the selections can be reduced in size and can be more efficiently transmitted, received and processed.

Statement 5: The computer-implemented method of statement 4, wherein the processing the selected options by the first computer system to determine the iRR associated with the activity comprises:
processing an impact metric score rate, the impact metric score rate being processed by the first computer system, where the processing is configured to assign an impact metric score rate to the impact metric based upon the stored impact metric score and to store the impact metric score rate by the first computer system;
processing an impact metric point value, the impact metric point value being processed by the first computer system, where the processing is configured to assign the impact metric with an impact metric point value by multiplying the stored impact metric score rate and the stored impact metric possible point value and to store the impact metric point value by the first computer system;
processing an impact multiplier value, the impact multiplier value being processed by the first computer system, where the processing is configured to assign the impact multiplier value by dividing the impact metric point value by 100 and to store the impact multiplier value;
based upon the stored KII delivery and the stored impact goal, processing the impact quantity, the impact quantity being processed by the first computer system, where the processing is configured to assign the impact quantity of the activity by dividing the stored KII delivery by the stored impact goal and to store the impact quantity by the first computer system;
based upon the stored activity cost and stored KII delivery, processing an impact efficiency, the impact efficiency being processed by the first computer system, where the processing is configured to assign the impact efficiency of the activity, and to store the impact efficiency by the first computer system;
based upon the stored impact multiplier value, the stored KII delivery, the stored time period, the stored impact quantity, and the stored impact efficiency, processing the iRR, the iRR being processed by the first computer system, where the processing is configured to assign the iRR of the activity by and to store the iRR associated with the activity by the first computer system.

The method of statement 5 may provide the technical effect of improving the efficiency of the computer-implemented method. By basing the processing of the impact quantity on the already stored KII delivery and impact goal, the processing is quick and effective.

Statement 6: The computer-implemented method of statement any preceding statement, wherein processing the selected options by the first computer system to determine the iRR associated with the activity comprises:
calculating an impact efficiency based on a stored activity cost and a stored KII delivery by the first computer system,
processing an upper impact efficiency and lower impact efficiency based on stored upper and lower activity costs and stored upper and lower KII deliveries, and
   utilizing a log base 100, or benchmarking the impact efficiency to determine the log base value.

Statement 7: The computer-implemented method of statement 3, wherein the display of the impact metric score range selections comprises five pro rata percentiles.

Statement 8: The computer-implemented method of any preceding statement, wherein the entity is selected from the group consisting of a government agency, a for-profit legal entity, a non-profit legal entity, and an individual user.

The method of statement 8 may provide the technical effect of providing an improved computer-implemented method via a second computer system of a selected entity. By providing the processing steps on the first computer system, the computer-implemented method is able to be utilized with any one of the listed entities. The processing may be separated from the selection taking place on the entity's second computer system. This shows a modular system in which the first (central) computer system may provide processing for the (second) computer system of the selected entity via the computer network. However, the processing may remain easily modifiable as the processing steps all take place at the central (first) computer system. As such, the computer-implemented method of statement 8 may be easily modifiable and can be updated readily while being utilizable by a second computer system of the selected entity.

Statement 9: The computer-implemented method of statement 3, wherein the impact theme selection output comprises a social impact theme, an environmental impact theme, an economic impact theme, and a governance impact theme.

Statement 10: The computer-implemented method of statement 8, wherein the impact theme selection input comprises the social impact theme, and wherein the impact area selection comprises housing and shelter, smallholders and family farmers, education, connectivity, employment, health and human services, equity and access, financial services and inclusion, community and stakeholder engagement, safety, and other.

Statement 11: The computer-implemented method of statement 8, wherein the impact theme selection input comprises the environmental impact theme, and wherein the impact area selection comprises natural resources and ecosystems, climate, energy pollution and waste, food production, materials, animals and wildlife, buildings and real assets, and other.

Statement 12: The computer-implemented method of statement 8, wherein the impact theme selection input comprises the economic impact theme, and wherein
the impact area selection comprises infrastructure, real estate and property value, economic indicators, community or stakeholder ownership, economic performance, economic practices, research and development, and other.

Statement 13: The computer-implemented method of statement 8, wherein the impact theme selection input comprises the governance impact theme, and wherein the impact area selection comprises diversity and inclusion, corruption, transparency and disclosure, pay and compensation, governance practices, operations and strategy, human rights, anti-competitive behavior, risk management, environmental standards, and other.

The method of statements 9 to 13 may provide the technical effect of improving the efficiency of the computer-implemented method. By receiving a selection output of one of the listed themes, the remainder of the processing may be streamlined to the selected theme to reduce the number of available options for the impact area selection.

Statement 14: The computer-implemented method of statement 3 and 4, or any of statements 5 to 13 when dependent on statement 3 and statement 4, wherein
the impact metric selection comprises at least two selected impact metrics and is configured to store each of the at least two selected impact metrics in association with the impact area sub-category; and wherein
processing the impact metric weight comprises pro-rata assignment of at least two impact metric sub-weights to the at least two impact metrics, and wherein
processing the impact metric possible point value comprises assigning each of the at least two impact metric sub-weights an impact metric possible point sub-value, wherein each of the impact metric possible point sub-values is the product of the stored impact metric value and each of the respective at least two impact metric sub-weights; and wherein
providing the impact metric score range selection includes at least two impact metric score ranges to be displayed in association with the corresponding impact metrics of the at least two impact metrics via the display of the second computer system, and wherein
the impact metric score range selection input comprises at least two selected impact metric score ranges and is configured to store each of the at least two selected impact metric score ranges in association with the respective impact metrics of the at least two impact metrics; and wherein
providing the impact metric score selection comprises at least two impact metric scores to be displayed in association with the corresponding impact metrics of the at least two impact metrics via the display of the second computer system, and wherein
the impact metric score selection input comprises at least two selected impact metric scores and is configured to store each of the at least two selected impact metric scores in association with the respective impact metrics of the at least two impact metrics; and wherein
processing the impact metric score rate comprises assigning each of the at least two impact metrics an impact metric score;
processing the impact metric point value comprises assigning each of the at least two impact metrics an impact metric point sub-value, the processing configured to store the at least two impact metric point sub-values, wherein each of the impact metric possible point sub-values is the product of each of the stored impact metric rates and the at least two impact metric possible point sub-values for each respective impact metric of the at least two impact metrics.

Statement 15: The computer-implemented method of statement 14, wherein
the impact area sub-category selection input comprises at least two selected impact area sub-categories and is configured to store the at least two selected impact area sub-categories in association with the respective impact area of the at least two impact areas; and wherein
providing the impact metric selection includes causing the webpage having the impact metric selections to be displayed in association with the corresponding impact area sub-categories of the at least two impact area sub-categories via the display of the second computer system.

Statement 16: The computer-implemented method of statement 15, wherein
the impact area selection input comprises at least two selected impact areas and is configured to store each of the at least two selected impact areas in association with the corresponding impact theme; and wherein
providing the impact area sub-category selection includes causing the webpage having the impact area sub-category selections to be displayed in association with the corresponding impact area of the at least two selected impact areas via the display of the second computer system, and wherein
providing the KII selection includes causing the webpage having the KII selections to be displayed in association with the corresponding impact area for each of the at least two impact areas via the display of the second computer system; and wherein
the KII selection input comprises at least two selected KIIs and is configured to store each of the at least two selected KIIs by the first computer system.

Statement 17: The computer-implemented method of statement 3 and 4, or any of statements 5 to 16 when dependent on statement 3 and statement 4, wherein the iRR calculation input further comprises account login information and transmitting the impact theme selection output is based upon validating the account login information,
wherein providing the impact theme selection includes causing a webpage having impact theme selections and an activity name entry to be displayed via a display of the second computer system, the webpage being associated with a website of the service provider,
wherein the impact theme selection input comprising a selected impact theme and activity name and storing the selected impact theme and activity name by the first computer system, and
the computer-implemented method further comprises:
transmitting a multi-time period output to the second computer system via the computer network, the multi-time period output causing a selection to determine the iRR calculation over a multi-time-period to be provided to the second computer system, wherein providing the multi-time-period output includes causing the webpage having the multi-time period iRR calculation selection to be displayed via the display of the second computer system;
receiving a multi-time-period input, the multi-time-period input having been transmitted from the second computer system to the first computer system via the computer network, the multi-time period input comprising an affirmative multi-time-period iRR calculation selection and storing the affirmative multi-time-period iRR calculation in association with the stored iRR; and receiving a continued iRR calculation input, the continued iRR calculation having been transmitted from the second computer system to the first computer system via the computer network, the continued iRR calculation input comprising the account login information and a request to continue the iRR calculation and validating the account login information and beginning a continued iRR calculation at the transmitting the impact metric score selection output.

Statement 18: The computer-implemented method of any preceding statement, wherein the iRR calculation input comprises a request to begin calculation of the iRR from a template, where the template comprises one or more predetermined, stored selections.

The method of statement 18 may provide the technical effect of further improving the efficiency of the computer-implemented method. By receiving a request from a template comprising predetermined selections, the processing may be streamlined to reduce the number of selection outputs needing transmission.

Statement 19: A non-transitory computer-readable medium having computer-executable instructions for performing a method for quantitatively calculating the impact rate of return (iRR) of an activity via a computing device, according to any of statements 1 to 18.

Statement 20: A first computer system configured to perform the computer-implemented method of any of statements 1 to 18.

The first computer system of statement 20 provides the technical effect of providing an improved computer system. The first computer system is configured to perform the processing, so that the processing may be separated from the selection taking place on a separate the second computer system. This leads to a modular system in which the first (central) computer system may provide processing for many other (second) computer systems via the computer network. The first computer system may provide a central system at which modifications to processing steps may be made which will implement the processing changes across computer-implemented methods involving any number of second computer systems. As such, the first computer system of statement 20 may make the method it is configured to perform more easily modifiable so that the method can be updated readily while being utilizable by many second computer systems.

1.-20. (canceled)

21. A method for quantitatively calculating the impact rate of return (iRR) of an activity via a computer network, the method comprising:
receiving an iRR calculation input at a first computer system, the iRR calculation input having been transmitted via the computer network from a second computer system, the iRR calculation input comprising a request to begin calculation of the iRR, the first computer system being associated with a service provider, the second computer system being associated with a business entity;
transmitting an impact theme selection output from the first computer system to the second computer system via the computer network, the impact theme selection output configured for causing the impact theme selection to be provided to the second computer system, wherein
providing the impact theme selection includes causing a webpage having impact theme selections to be displayed via a display of the second computer system, the webpage being associated with a website of the service provider;
receiving an impact theme selection input at the first computer system, the impact theme selection input having been transmitted from the second computer system to the first computer system via the computer network, the impact theme selection input comprising a selected impact theme and configured for storing the selected impact theme by the first computer system;
based upon the stored selected impact theme, transmitting an impact area selection output to the second computer system via the computer network, the impact area selection output configured for causing the impact area selection to be provided to the second computer system, wherein
providing the impact area selection includes causing the webpage having the impact area selections to be displayed via the display of the second computer system;
receiving an impact area selection input, the impact area selection input having been transmitted from the second computer system to the first computer system via the computer network, the impact area selection input comprising a selected impact area and configured for storing the selected impact area by the first computer system;
based upon the stored selected impact area, transmitting an impact area sub-category selection output to the second computer system via the computer network, the impact area sub-category selection output configured for causing the impact area sub-category selection to be provided to the second computer system, wherein
providing the impact area sub-category selection includes causing the webpage having impact area sub-category selections to be displayed via the display of the second computer system;
receiving an impact area sub-category selection input, the impact area sub-category selection input having been transmitted from the second computer system to the first computer system via the computer network, the impact area sub-category selection input comprising a selected impact area sub-category and configured for storing the selected impact area sub-category by the first computer system;
based upon the stored selected impact area, transmitting a KII selection output to the second computer system via the computer network, the KII selection output configured for causing the KII selection to be provided to the second computer system, wherein
providing the KII selection includes causing the webpage having KII selections to be displayed via the display of the second computer system;
receiving a KII selection input, the KII selection input having been transmitted from the second computer system to the first computer system via the computer network, the KII selection input comprising a selected KII and configured for storing the selected KII by the first computer system;
based upon the stored selected impact area sub-category, transmitting an impact metric selection output to the second computer system via the computer network, the impact metric selection output configured for causing an impact metric selection to be provided to the second computer system, wherein
providing the impact metric selection includes causing the webpage having impact metric selections to be displayed via the display of the second computer system;
receiving an impact metric selection input, the impact metric selection input having been transmitted from the second computer system to the first computer system via the computer network, the impact metric selection input comprising a selected impact metric and configured for storing the selected impact metric by the first computer system;
processing an impact metric value, the impact metric value being processed by the first computer system, the processing of the impact metric value configured to assign an impact metric value to the impact metric and store the impact metric value;
processing an impact metric weight, the impact metric weight being processed by the first computer system, the processing of the impact metric weight configured to assign an impact metric weight to the impact metric and store the impact metric weight;
processing an impact metric possible point value, the impact metric possible point value being processed by the first computer system, the processing of the impact metric possible point value configured to assign an impact metric possible point value to the impact metric and to store the impact metric possible point value in association with the impact metric, wherein
the impact metric possible point value is the product of the stored impact metric value and the impact metric weight;
based upon the stored selected impact metrics, transmitting an impact metric score range selection output to the second computer system via the computer network, the impact metric score range selection output configured for causing an impact metric score range selection to be provided to the second computer system, wherein
providing the impact metric score range selection includes causing the webpage having impact metric score range selections to be displayed via the display of the second computer system;
receiving an impact metric score range selection input, the impact metric score range selection input having been transmitted from the second computer system to the first computer system via the computer network, the impact metric score range selection input comprising an impact metric score range for the impact metric and configured for storing the impact metric score range in association with the impact metric by the first computer system;
based upon the stored impact metric score range, transmitting an impact metric score selection output to the second computer system via the computer network, the impact metric score selection output configured for causing an impact metric score selection to be provided to the second computer system, wherein
providing the impact metric score selection includes causing the webpage having impact metric score selections to be displayed via the display of the second computer system;
receiving an impact metric score selection input, the impact metric score selection input having been transmitted from the second computer system to the first computer system via the computer network, the impact metric score selection input comprising a selected impact metric score for the impact metric and configured for storing the selected impact metric score in association with the impact metric by the first computer system;
processing an impact metric score rate, the impact metric score rate being processed by the first computer system, where the processing is configured to assign an impact metric score rate to the impact metric based upon the stored impact metric score and to store the impact metric score rate by the first computer system;
processing an impact metric point value, the impact metric point value being processed by the first computer system, where the processing is configured to assign the impact metric with an impact metric point value by multiplying the stored impact metric score rate and the stored impact metric possible point value and to store the impact metric point value by the first computer system;
processing an impact multiplier value, the impact multiplier value being processed by the first computer system, where the processing is configured to assign the impact multiplier value by dividing the impact metric point value by 100 and to store the impact multiplier value;
based upon the stored selected KII, transmitting an impact goal output to the second computer system via the computer network, the impact goal output configured for causing an impact goal to be provided to the second computer system, wherein
providing the impact goal includes causing the webpage having an impact goal corresponding to the stored selected KII to be displayed via the display of the second computer system;
receiving an impact goal input, the impact goal input having been transmitted from the second computer system to the first computer system via the computer network, the impact goal input comprising the impact goal and configured for storing the impact goal in association with the stored selected KII by the first computer system;
based upon the stored selected KII, transmitting a KII delivery output to the second computer system via the computer network, the KII delivery output configured for causing a KII delivery to be provided to the second computer system, wherein
providing the KII delivery includes causing the webpage having a KII delivery corresponding to the stored selected KII to be displayed via the display of the second computer system;
receiving a KII delivery input, the KII delivery input having been transmitted from the second computer system to the first computer system via the computer network, the KII delivery input comprising the KII delivery and configured for storing the KII delivery in association with the stored selected KII by the first computer system;
based upon the stored KII delivery and the stored impact goal, processing the impact quantity, the impact quantity being processed by the first computer system, where the processing is configured to assign the impact quantity of the activity by dividing the stored KII delivery by the stored impact goal and to store the impact quantity by the first computer system;
transmitting a time period output to the second computer system via the computer network, the time period output configured for causing a time period entry to be provided to the second computer system, wherein
providing the time period entry includes causing the webpage having a time period entry to be displayed via the display of the second computer system;
receiving a time period input, the time period input having been transmitted from the second computer system to the first computer system via the computer network, the time period input comprising the time period and configured for storing the time period in years by the first computer system;
transmitting an activity cost output to the second computer system via the computer network, the activity cost output configured for causing an activity cost entry to be provided to the second computer system, wherein
providing the activity cost entry includes causing the webpage having an activity cost entry to be displayed via the display of the second computer system;
receiving an activity cost input, the activity cost input having been transmitted from the second computer system to the first computer system via the computer network, the activity cost input comprising the activity cost and configured for storing the activity cost by the first computer system;
based upon the stored activity cost and stored KII delivery, processing an impact efficiency, the impact efficiency being processed by the first computer system, where the processing is configured to assign the impact efficiency of the activity, and to store the impact efficiency by the first computer system;
based upon the stored impact multiplier value, the stored KII delivery, the stored time period, the stored impact quantity, and the stored impact efficiency, processing the iRR, the iRR being processed by the first computer system, where the processing is configured to assign the iRR of the activity by and to store the iRR associated with the activity by the first computer system;
based upon the stored iRR, transmitting an iRR output to the second computer system via the computer network, the iRR output configured for causing the stored iRR to be provided to the second computer system, wherein
providing the stored iRR includes causing the webpage having the stored iRR to be displayed via the display of the second computer system.

22. The method of claim 21, wherein
The display of the impact metric score range selections comprises five pro rata percentiles.

23. The method of claim 21, wherein the business entity is selected from the group consisting of a government agency, a for-profit legal entity, a non-profit legal entity, and an individual user.

24. The method of claim 21, wherein the impact theme selection output comprises a social impact theme, an environmental impact theme, an economic impact theme, and a governance impact theme.

25. The method of claim 24, wherein the impact theme selection input comprises the social impact theme, and wherein
the impact area selection comprises housing and shelter, smallholders and family farmers, education, connectivity, employment, health and human services, equity and access, financial services and inclusion, community and stakeholder engagement, safety, and other.

26. The method of claim 24, wherein the impact theme selection input comprises the environmental impact theme, and wherein
the impact area selection comprises natural resources and ecosystems, climate, energy pollution and waste, food production, materials, animals and wildlife, buildings and real assets, and other.

27. The method of claim 24, wherein the impact theme selection input comprises the economic impact theme, and wherein
the impact area selection comprises infrastructure, real estate and property value, economic indicators, community or stakeholder ownership, economic performance, economic practices, research and development, and other.

28. (canceled)

29. The method of claim 21, wherein
the impact metric selection comprises at least two selected impact metrics and is configured for storing each of the at least two selected impact metrics in association with the impact area sub-category; and wherein
processing the impact metric weight comprises pro-rata assignment of at least two impact metric sub-weights to the at least two impact metrics, and wherein
processing the impact metric possible point value comprises assigning each of the at least two impact metric sub-weights an impact metric possible point sub-value, wherein each of the impact metric possible point sub-values is the product of the stored impact metric value and each of the respective at least two impact metric sub-weights; and wherein
providing the impact metric score range selection includes at least two impact metric score ranges to be displayed in association with the corresponding impact metrics of the at least two impact metrics via the display of the second computer system, and wherein
the impact metric score range selection input comprises at least two selected impact metric score ranges and is configured for storing each of the at least two selected impact metric score ranges in association with the respective impact metrics of the at least two impact metrics; and wherein
providing the impact metric score selection comprises at least two impact metric scores to be displayed in association with the corresponding impact metrics of the at least two impact metrics via the display of the second computer system, and wherein
the impact metric score selection input comprises at least two selected impact metric scores and is configured for storing each of the at least two selected impact metric scores in association with the respective impact metrics of the at least two impact metrics; and wherein
processing the impact metric score rate comprises assigning each of the at least two impact metrics an impact metric score;
processing the impact metric point value comprises assigning each of the at least two impact metrics an impact metric point sub-value, the processing configured to store the at least two impact metric point sub-values, wherein each of the impact metric possible point sub-values is the product of each of the stored impact metric rates and the at least two impact metric possible point sub-values for each respective impact metric of the at least two impact metrics.

30. The method of claim 29, wherein
the impact area sub-category selection input comprises at least two selected impact area sub-categories and is configured for storing the at least two selected impact area sub-categories in association with the respective impact area of the at least two impact areas; and wherein
providing the impact metric selection includes causing the webpage having the impact metric selections to be displayed in association with the corresponding impact area sub-categories of the at least two impact area sub-categories via the display of the second computer system.

31. The method of claim 30, wherein
the impact area selection input comprises at least two selected impact areas and is configured for storing each of the at least two selected impact areas in association with the corresponding impact theme; and wherein
providing the impact area sub-category selection includes causing the webpage having the impact area sub-category selections to be displayed in association with the corresponding impact area of the at least two selected impact areas via the display of the second computer system, and wherein
providing the KII selection includes causing the webpage having the KII selections to be displayed in association with the corresponding impact area for each of the at least two impact areas via the display of the second computer system; and wherein
the KII selection input comprises at least two selected KIIs and is configured for storing each of the at least two selected KIIs by the first computer system.

32. (canceled)

33. A method for quantitatively calculating the impact rate of return (iRR) of an activity via a computer network, the method comprising:
receiving an iRR calculation input at a first computer system, the iRR calculation input having been transmitted via the computer network from a second computer system, the iRR calculation input comprising a request to begin calculation of the iRR, the first computer system being associated with a service provider, the second computer system being associated with a business entity;
transmitting a sub-category selection output to the second computer system via the computer network, the sub-category selection output configured for causing impact area sub-category selections to be provided to the second computer system, wherein
providing the impact area sub-category selections includes causing the webpage having impact area sub-category selections to be displayed via the display of the second computer system;
receiving a sub-category selection input, the sub-category selection input having been transmitted from the second computer system to the first computer system via the computer network, the sub-category selection input comprising a selected impact area sub-category and configured for storing the selected impact area sub-category by the first computer system;
based upon the stored selected impact area sub-category, transmitting a sub-category KIT selection output to the second computer system via the computer network, the sub-category KII selection output configured for causing the KII selection to be provided to the second computer system, wherein
providing the KII selection includes causing the webpage having KII selections to be displayed via the display of the second computer system;
receiving a sub-category KII selection input, the sub-category KII selection input having been transmitted from the second computer system to the first computer system via the computer network, the sub-category KII selection input comprising a selected KII and configured for storing the selected KII by the first computer system;
transmitting an impact multiplier selection output to the second computer system via the computer network, the impact multiplier selection output configured for causing an impact multiplier selection to be provided to the second computer system, wherein
providing the impact multiplier selection includes causing the webpage having impact multiplier selections to be displayed via the display of the second computer system;
receiving an impact multiplier selection input, the impact multiplier selection input having been transmitted from the second computer system to the first computer system via the computer network, the impact multiplier selection input comprising a selected impact multiplier and configured for storing the selected impact multiplier by the first computer system;
based upon the stored selected KII, transmitting a KII delivery output to the second computer system via the computer network, the KII delivery output configured for causing a KII delivery to be provided to the second computer system, wherein
providing the KII delivery includes causing the webpage having a KII delivery corresponding to the KII to be displayed via the display of the second computer system;
receiving a KII delivery input, the KII delivery input having been transmitted from the second computer system to the first computer system via the computer network, the KII delivery input comprising the KII delivery and configured for storing the KII delivery in association with the KII by the first computer system;
based upon the stored KII delivery, processing the impact quantity, the impact quantity being processed by the first computer system, where the processing is configured to store the impact quantity by the first computer system;
transmitting a time period output to the second computer system via the computer network, the time period output configured for causing a time period entry to be provided to the second computer system, wherein
providing the time period entry includes causing the webpage having a time period entry to be displayed via the display of the second computer system;
receiving a time period input, the time period input having been transmitted from the second computer system to the first computer system via the computer network, the time period input comprising the time period and configured for storing the time period in years by the first computer system;
transmitting an activity cost output to the second computer system via the computer network, the activity cost output configured for causing an activity cost entry to be provided to the second computer system, wherein
providing the activity cost entry includes causing the webpage having an activity cost entry to be displayed via the display of the second computer system;
receiving an activity cost input, the activity cost input having been transmitted from the second computer system to the first computer system via the computer network, the activity cost input comprising the activity cost and configured for storing the activity cost by the first computer system;
based upon the stored activity cost and stored KII delivery, processing an impact efficiency, the impact efficiency being processed by the first computer system, where the processing is configured to assign the impact efficiency of the activity, and to store the impact efficiency by the first computer system;
based upon the stored impact multiplier value, the stored KII delivery, the stored time period, the stored impact quantity, and the stored impact efficiency, processing the iRR, the iRR being processed by the first computer system, where the processing is configured to assign the iRR of the activity by and to store the iRR associated with the activity by the first computer system;
based upon the stored iRR, transmitting an iRR output to the second computer system via the computer network, the iRR output configured for causing the stored iRR to be provided to the second computer system, wherein
providing the stored iRR includes causing the webpage having the stored iRR to be displayed via the display of the second computer system.

34. The method of claim 33, wherein
the processing of the impact quantity is further configured to assign the impact quantity by calculating the log base 100 of the stored KII delivery.

35. The method of claim 33, wherein
the processing of the impact quantity is further configured to assign the impact quantity by assigning the stored KII delivery as the impact quantity.

36. (canceled)

37. A non-transitory computer-readable medium having computer-executable instructions for performing a method for quantitatively calculating the impact rate of return (iRR) of an activity via a computer network, the method comprising:
receiving an iRR calculation input at a first computer system, the iRR calculation input having been transmitted via the computer network from a second computer system, the iRR calculation input comprising a request to begin calculation of the iRR, the first computer system being associated with a service provider, the second computer system being associated with a business entity;
transmitting an impact theme selection output from the first computer system to the second computer system via the computer network, the impact theme selection output configured for causing the impact theme selection to be provided to the second computer system, wherein
providing the impact theme selection includes causing a webpage having impact theme selections to be displayed via a display of the second computer system, the webpage being associated with a website of the service provider;
receiving an impact theme selection input at the first computer system, the impact theme selection input having been transmitted from the second computer system to the first computer system via the computer network, the impact theme selection input comprising a selected impact theme and configured for storing the selected impact theme by the first computer system;
based upon the stored selected impact theme, transmitting an impact area selection output to the second computer system via the computer network, the impact area selection output configured for causing the impact area selection to be provided to the second computer system, wherein
providing the impact area selection includes causing the webpage having the impact area selections to be displayed via the display of the second computer system;
receiving an impact area selection input, the impact area selection input having been transmitted from the second computer system to the first computer system via the computer network, the impact area selection input comprising a selected impact area and configured for storing the selected impact area by the first computer system;
based upon the stored selected impact area, transmitting an impact area sub-category selection output to the second computer system via the computer network, the impact area sub-category selection output configured for causing the impact area sub-category selection to be provided to the second computer system, wherein
providing the impact area sub-category selection includes causing the webpage having impact area sub-category selections to be displayed via the display of the second computer system;
receiving an impact area sub-category selection input, the impact area sub-category selection input having been transmitted from the second computer system to the first computer system via the computer network, the impact area sub-category selection input comprising a selected impact area sub-category and configured for storing the selected impact area sub-category by the first computer system;
based upon the stored selected impact area, transmitting a KII selection output to the second computer system via the computer network, the KII selection output configured for causing the KII selection to be provided to the second computer system, wherein
providing the KII selection includes causing the webpage having KII selections to be displayed via the display of the second computer system;
receiving a KII selection input, the KII selection input having been transmitted from the second computer system to the first computer system via the computer network, the KII selection input comprising a selected KII and configured for storing the selected KII by the first computer system;
based upon the stored selected impact area sub-category, transmitting an impact metric selection output to the second computer system via the computer network, the impact metric selection output configured for causing an impact metric selection to be provided to the second computer system, wherein
providing the impact metric selection includes causing the webpage having impact metric selections to be displayed via the display of the second computer system;
receiving an impact metric selection input, the impact metric selection input having been transmitted from the second computer system to the first computer system via the computer network, the impact metric selection input comprising a selected impact metric and configured for storing the selected impact metric by the first computer system;
processing an impact metric value, the impact metric value being processed by the first computer system, the processing of the impact metric value configured to assign an impact metric value to the impact metric and store the impact metric value;
processing an impact metric weight, the impact metric weight being processed by the first computer system, the processing of the impact metric weight configured to assign an impact metric weight to the impact metric and store the impact metric weight;
processing an impact metric possible point value, the impact metric possible point value being processed by the first computer system, the processing of the impact metric possible point value configured to assign an impact metric possible point value to the impact metric and to store the impact metric possible point value in association with the impact metric, wherein
the impact metric possible point value is the product of the stored impact metric value and the impact metric weight;
based upon the stored selected impact metrics, transmitting an impact metric score range selection output to the second computer system via the computer network, the impact metric score range selection output configured for causing an impact metric score range selection to be provided to the second computer system, wherein
providing the impact metric score range selection includes causing the webpage having impact metric score range selections to be displayed via the display of the second computer system;
receiving an impact metric score range selection input, the impact metric score range selection input having been transmitted from the second computer system to the first computer system via the computer network, the impact metric score range selection input comprising an impact metric score range for the impact metric and configured for storing the impact metric score range in association with the impact metric by the first computer system;
based upon the stored impact metric score range, transmitting an impact metric score selection output to the second computer system via the computer network, the impact metric score selection output configured for causing an impact metric score selection to be provided to the second computer system, wherein
providing the impact metric score selection includes causing the webpage having impact metric score selections to be displayed via the display of the second computer system;
receiving an impact metric score selection input, the impact metric score selection input having been transmitted from the second computer system to the first computer system via the computer network, the impact metric score selection input comprising a selected impact metric score for the impact metric and configured for storing the selected impact metric score in association with the impact metric by the first computer system;
processing an impact metric score rate, the impact metric score rate being processed by the first computer system, where the processing is configured to assign an impact metric score rate to the impact metric based upon the stored impact metric score and to store the impact metric score rate by the first computer system;
processing an impact metric point value, the impact metric point value being processed by the first computer system, where the processing is configured to assign the impact metric with an impact metric point value by multiplying the stored impact metric score rate and the stored impact metric possible point value and to store the impact metric point value by the first computer system;
processing an impact multiplier value, the impact multiplier value being processed by the first computer system, where the processing is configured to assign the impact multiplier value by dividing the impact metric point value by 100 and to store the impact multiplier value;
based upon the stored selected KII, transmitting an impact goal output to the second computer system via the computer network, the impact goal output configured for causing an impact goal to be provided to the second computer system, wherein
providing the impact goal includes causing the webpage having an impact goal corresponding to the stored selected KII to be displayed via the display of the second computer system;
receiving an impact goal input, the impact goal input having been transmitted from the second computer system to the first computer system via the computer network, the impact goal input comprising the impact goal and configured for storing the impact goal in association with the stored selected KII by the first computer system;
based upon the stored selected KII, transmitting a KII delivery output to the second computer system via the computer network, the KII delivery output configured for causing a KII delivery to be provided to the second computer system, wherein
providing the KII delivery includes causing the webpage having a KII delivery corresponding to the stored selected KII to be displayed via the display of the second computer system;
receiving a KII delivery input, the KII delivery input having been transmitted from the second computer system to the first computer system via the computer network, the KII delivery input comprising the KII delivery and configured for storing the KII delivery in association with the stored selected KII by the first computer system;
based upon the stored KII delivery and the stored impact goal, processing the impact quantity, the impact quantity being processed by the first computer system, where the processing is configured to assign the impact quantity of the activity by dividing the stored KII delivery by the stored impact goal and to store the impact quantity by the first computer system;
transmitting a time period output to the second computer system via the computer network, the time period output configured for causing a time period entry to be provided to the second computer system, wherein
providing the time period entry includes causing the webpage having a time period entry to be displayed via the display of the second computer system;
receiving a time period input, the time period input having been transmitted from the second computer system to the first computer system via the computer network, the time period input comprising the time period and configured for storing the time period in years by the first computer system;
transmitting an activity cost output to the second computer system via the computer network, the activity cost output configured for causing an activity cost entry to be provided to the second computer system, wherein
providing the activity cost entry includes causing the webpage having an activity cost entry to be displayed via the display of the second computer system;
receiving an activity cost input, the activity cost input having been transmitted from the second computer system to the first computer system via the computer network, the activity cost input comprising the activity cost and configured for storing the activity cost by the first computer system;
based upon the stored activity cost and stored KII delivery, processing an impact efficiency, the impact efficiency being processed by the first computer system, where the processing is configured to assign the impact efficiency of the activity, and to store the impact efficiency by the first computer system;
based upon the stored impact multiplier value, the stored KII delivery, the stored time period, the stored impact quantity, and the stored impact efficiency, processing the iRR, the iRR being processed by the first computer system, where the processing is configured to assign the iRR of the activity by and to store the iRR associated with the activity by the first computer system;
based upon the stored iRR, transmitting an iRR output to the second computer system via the computer network, the iRR output configured for causing the stored iRR to be provided to the second computer system, wherein
providing the stored iRR includes causing the webpage having the stored iRR to be displayed via the display of the second computer system.

38.-48. (canceled)

49. The method of claim 21, wherein the impact theme selection output comprises impact themes based on a foci of the activity.

50. The method of claim 21, wherein the impact theme selection output comprises impact themes based on assessing objectives of the activity.

51. The method of claim 21, wherein processing the impact efficiency further comprises overriding the assigned impact efficiency when the assigned impact efficiency is equal to or less than zero, where the first computer system assigns an overridden impact efficiency from 0 to 0.0015 for the impact efficiency.

52. (canceled)
